(19) United States
(12) Patent Application Publication
(10) Pub. No.: US 2026/0203625 A1
(43) Pub. Date: Jul. 16, 2026

(54) COMPUTER LANGUAGE AND CODE FOR APPLICATION DEVELOPMENT AND ELECTRONIC AND OPTICAL COMMUNICATION

(71) Applicant: Robert Lyden, Ashland, OR (US)

(72) Inventor: Robert Lyden, Ashland, OR (US)

(21) Appl. No.: 19/025,396

(22) Filed: Jan. 16, 2025

(51) Int. Cl. G06N 10/40; G06E 1/00; G06E 3/00

(52) U.S. Cl. CPC G06N 10/40; G06E 1/00; G06E 3/005

(57) ABSTRACT

The present disclosure relates to a computer language and code for software application development, data compression, and memory devices for use with conventional, optical, hybrid electro-optical and quantum computers.

### FIELD

The disclosure relates to a computer language and code for software application development, data compression, and memory devices for use with conventional, optical, hybrid electro-optical and quantum computers.

### BACKGROUND

For many years, computer languages and codes have used the binary number system and different series of zeros (0's) and ones (1's) to represent, manipulate, communicate, and store data and information. In 1963, the American Standard Code For Information Exchange (ASCII) developed the original ASCII code which included 128 characters and used 7 bit character encodings. The ASCII code was later succeeded in 1986 by the ISO/IEC 8859 code which expanded ASCII and used 8 bit character encodings. In 1991, the Unicode Consortium then published the first Universal Coded Character Set (USC) Unicode standard which has over 1.1 million possible code points available for use. The Unicode standard has since been updated many times and it is also synchronized with the work of the International Organization for Standardization (ISO) which develops and publishes international standards, and while not being identical with Unicode which is updated more frequently, the current version of ISO/IEC 10646 is largely consistent with Unicode.

In this regard, when using the binary number system each letter of the alphabet as well as other numbers, symbols, and operations are typically identified using at least 8 bits made of zeros (0's) and ones (1's) something which is known as one byte of information. Accordingly, to reproduce and communicate the simple phrase “Run Tag Run” requires at least 72 bits or 9 bytes of digital information. This digital information is most often communicated digitally in the form of a series of square waves with the top of the square wave which corresponds to its maximum amplitude being used to represent the number 1, whereas a portion of the signal having less amplitude or resting at zero is used to represent the value 0. The data is typically communicated, manipulated, and stored with the use of switches which can be either placed in an “on” and closed state which is typically represented by the number 1, or an “off” and open state which is often represented by the value 0 by using millions of small transistors which are included on a Central Processing Unit (CPU) logic chip or memory chip, or alternatively by using capacitors which can store an electrical charge. These transistor switches or capacitors are typically configured to indicate one of three different states or conditions, namely, an “and” state, an “or” state, or a “not” state. In this regard, typical laptop computers and other home computers are not configured today so as to be able to provide a state that represents the possibility of both 1 and 0, “and” and “or”, “yes” and “no”, or “maybe” at the same time. As a result, the use of the binary system in digital communication is associated in a long string or series of bits which are typically communicated and processed sequentially which can take considerable time and also consume substantial memory. Further, the use of the binary system for representing numbers and mathematical operations can result in certain inaccuracies. The present disclosure is directed to a computer language, and code for software application development which can replace and/or work in association with the binary number system and digital forms of communication.

The ability to make smaller and faster computer chips in order to enhance the performance of computers is beginning to hit certain limitations or barriers having to do with limited space. In this regard, one MegaHerz (MHz) equals 1,000,000 or one million cycles per second. One GigaHerz (GHz) equals 1,000,000,000 or one trillion cycles per second, one TeraHerz (THz) equals 1,000,000,000,000 cycles per second, and one PicoHerz (PHz) equals 0.000000000001 cycles per second. One picosecond (ps) is 10⁻¹² and 0.000000000001 second, and one femtosecond (fs) is 10⁻¹⁵ and 0.000000000000001 second. The speed of light is 299,792,458 meters/second, thus light travels 299.792458 meters in one MHz cycle. One mm equals 1,000,000 nanometers (nm). A petabit equals a terabit times 1,000 which is 1,000,000,000,000,000 bits. A gigabyte contains 8,000,000,000 bits, and a terabyte equals 1,000 gigabytes. A petabyte equals 1,000 terabytes which is 1,000,000 gigabytes. The size of a hydrogen atom is 0.1 nm. The size of a silicon atom is about 0.2 nm. The size of a DNA molecule is about 1 nm. The size of a red blood cell is between about 6,000-8,000 nm. The width of a human hair is about 80,000-100,000 nm. Modern computer chips have what are called 10 nm, 7 nm, and 5 nm configurations, and IBM has recently made a 2 nm configuration, but this does not refer to the size of their actual structure. An Intel Core i7 CPU has 1.86 billion transistors. In this regard, there are about 100,000,000 transistors in one square mm, and so about 100,000 or perhaps in some cases about 134,000 transistors are disposed side by side in one mm of space on a modern computer chip. In this regard, the transistors are about 14 nm across which is about 14 times larger than DNA molecules. Given than silicon atoms have a size of about 0.2 nm, these transistors are about 70 silicon atoms wide on modern computer chips. Accordingly, there is a limit to how small a transistor can be made, and also how fast data can be communicated when using the binary system, electrons, and conductive wires to perform digital communication. Some individuals are calling the next stage of evolution in computer technology quantum computing. The quantum computing market is anticipated to reach 65 billion by 2030. In order to perform quantum computing various complex structures such as artificial neural networks composed of artificial neurons or nodes are being created which attempt to reproduce or emulate the complex structure and function of the human brain. A simple neural network typically includes an input layer, and hidden layer, and an output layer. They are being used to perform machine learning and the reinforcement learning which is typically required in order to create artificial intelligence (AI). Some neural networks and other structures associated with present efforts to create artificial intelligence can permit what is called quantum entanglement which is known to be the exchange of quantum information between two particles at a distance. Quantum superposition is a different principle of quantum physics which holds that somewhat like waves in classical physics it is possible for two or more quantum states to be added together and superposed to create another valid quantum state, and that the resultant quantum state can be represented as a sum of two or more quantum states. In this regard, superposition is held to be the uncertainly of a particle being in several states at once which is called a superposition state. Accordingly, quantum computers which can include neural networks and are capable of producing entanglement and/or superposition can not only represent and process a “yes” or “no,” and/or “1” or “0” like conventional computers, but rather they can also process the possibility of “yes” and “no,” “1” and “0”, or “maybe.” The condition associated with both of these possibilities is called a superposition state. Accordingly, the data and information obtained from these quantum states is typically referred to as a quantum bit, or “qubit(s).” As the scale of conventional transistor manufacturing on silicon CPU's, chips, chiplets, and microchips approaches the molecular and atomic level, and the desire for faster computing speeds using electrons in metal wires results in increases in heat production and energy use, the introduction of optical computers, hybrid electro-optical computers, and quantum computers holds promise for the future. Optical computers which are sometimes also called photonic computers are being developed for performing complex and high speed quantum computing. In order to perform optical computing, it is necessary to have an optical processor, fiber optic cable, and optical storage. Instead of using electrons, an optical computer uses photons, that is, a form of light in the electromagnetic spectrum to communicate data and information, perform calculations, and to persist and store information in memory. Light travels at the speed of light which is 299,792,458 meters/second and in fiber optic cables it travels slower, but there is then relatively little dampening and energy loss. Photons can move about 20 times faster than electrons, and in fiber optic cable they do not suffer from the same level of resistance that electrons do when they move in metallic wires or other electrical conductors. In this regard, electrons do not actually move very fast in metal conductors, but rather it is their associated electric and magnetic fields which can move and/or change quickly. Nevertheless, electrons moving in metal conductors encounter resistance which is associated with dampening, heat, and energy loss. The production of heat and the high energy costs of operation are some of the issues associated with Supercomputers and also Quantum computers which rely upon electronic signals which travel in electrically conductive metal materials, e.g., see, “The AI Boom Could Use a Shocking Amount of Electricity,” by Lauren Leffer, Oct. 13, 2023, Scientific American, https://www.scientificamerican.com/article/the-ai-boom-could-use-a-shocking-amount-of-electricity/, and “Projecting the Electricity Demand Growth of Generative AI Large Language Models in the US,” by Jafari et al., Jul. 17, 2024, https://www.energypolicy.columbia.edu/projecting-the-electricity-demand-growth-of-generative-ai-large-language-models-in-the-us/.

There are two kinds of optical computers, that is, pure or complete optical computers, and electro-optical hybrid computers. Visible light falls in the range of the electromagnetic spectrum between ultraviolet and infrared light. Visible light frequencies are between about 4×10¹⁴ and 8×10¹⁴ cycles per second (Hz) which is about 430-750 trillion Hz (THz) and have wavelengths in the range between approximately 380-740 nanometers (nm). The ultraviolet light spectrum includes wavelengths in the range between approximately 10 nm and 400 nm which corresponds to frequencies in the range between approximately 30 PHz-750 THz. The infrared light spectrum includes wavelengths in the range between approximately 700 nm-1 mm and corresponds to frequencies in the range between approximately 430 THz-300 GHz. In this regard, it is known that there can be some overlap as between the visible light spectrum and the infrared and ultraviolet light spectrums. Visible light frequencies and wavelengths correspond in duration of time to about 2 femtoseconds.

The University of California at Santa Barbara (UCSB) is one of the leading centers of optical computing research and development here in the United States. A number of companies including D-Wave Systems, Inc., Honeywell International, Inc., Google, IBM, Intel, Microsoft, and Xanadu Quantum Technologies, Inc. are working on making quantum computers. D-Wave Systems located in British Columbia, Canada has one of the largest patent portfolios in this subject area and can provide quantum computer products and services for the general public. At the present time, the leader in making a practical optical quantum computer is believed to be Xanadu Quantum Technologies, Inc. located in Toronto, Canada. The Xanadu X8 quantum photonic processor has been made available online. The Xanadu X8 photonic processor can be programmed using “Strawberry Fields,” which is Xanadu's Python library for simulating and running programs on photonic quantum hardware and “PennyLane” which is the company's Python library for quantum machine learning and computing. In this regard, see the article published online in the IEEE Spectrum entitled “In the Race to Hundreds of Qubits, Photons May Have Quantum Advantage, by Charles Q. Choi, on Mar. 5, 2021: https://spectrum.ieee.org/race-to-hundreds-of-photonic-qubits-xanadu-scalable-photon.

U.S. patents relating to optical computers and/or quantum computers include: U.S. Pat. Nos. 12,034,404, 11,995,513, 11,957,065, 11,930,721, 11,861,455, 11,847,534, 11,816,536, 11,681,940, 11,501,195, 11,494,638, 11,449,784, 11,348,024 B2, 11,288,073, 11,263,547, 11,238,131, 11,182,230, 11,157,817, 11,138,511, 11,127,893, 11,105,866, 11,100,418, 11,100,416, 11,093,440, 11,064,637, 11,062,227, 11,042,811, 11,038,095, 11,031,537, 11,023,821, 11,010,683, 10,991,755, 10,938,346, 10,922,381, 10,897,068, 10,891,554, 10,885,459, 10,817,796, 10,789,540, 10,789,329, 10,769,545, 10,755,190, 10,748,079, 10,700,256, 10,691,633, 10,671,937, 10,657,198, 10,621,140, 10,599,988, 10,552,757, 10,552,755, 10,528,886, 10,489,477, 10,468,793, 10,467,545, 10,467,543, 10,454,015, 10,453,894, 10,378,803, 10,346,508, 10,346,349, 10,326,071, 10,318,881, 10,290,798, 10,275,422, 10,268,622, 11,182,230, 11,157,817, 11,138,511, 11,127,893, 11,105,866, 11,100,418, 11,100,416, 11,093,440, 11,064,637, 11,062,227, 11,042,811, 11,038,095, 11,031,537, 11,023,821, 11,010,683, 10,991,755, 10,938,346, 10,922,381, 10,897,068, 10,891,554, 10,885,459, 10,817,796, 10,789,540, 10,789,329, 10,769,545, 10,755,190, 10,748,079, 10,700,256, 10,691,633, 10,671,937, 10,657,198, 10,621,140, 10,599,988, 10,552,757, 10,552,755, 10,528,886, 10,489,477, 10,468,793, 10,467,545, 10,467,543, 10,454,015, 10,453,894, 10,378,803, 10,346,508, 10,346,349, 10,326,071, 10,318,881, 10,290,798, 10,275,422, 10,268,622, 8,032,474, 8,018,244, 8,008,991, 8,008,942, 7,990,662, 7,984,012, 7,969,805, 7,932,515, 7,899,852, 7,898,282, 7,880,529, 7,877,333, 7,876,248, 7,870,087, 7,844,656, 7,843,209, 7,800,395, 7,788,192, 7,687,938, 7,639,035, 7,624,088, 7,619,437, 7,613,765, 7,613,764, 7,605,600, 7,533,068, 7,418,283, 7,335,909, 7,332,738, 7,307,275, 7,268,576, 7,253,654, 7,230,266, 7,135,701, 7,042,005, 7,018,852, 7,015,499, 7,002,174, 6,987,282, 6,979,836, 6,960,780, 6,943,368, 6,936,841, 6,930,320, 6,919,579, 6,911,664, 6,905,887, 6,900,456, 6,900,454, 6,897,468, 6,885,325, 6,822,255, 6,812,484, 6,803,599, 6,791,109, 6,784,451, 6,753,546, 6,728,131, 6,670,630, 6,627,916, 6,627,915, 6,614,047, 6,605,822, 6,580,102, 6,576,951, 6,573,202, 6,563,311, 6,563,310, 6,537,847, 6,504,172, and 6,459,097 which are assigned to D-Wave Systems, Inc.; U.S. Pat. Nos. 11,900,144, 11,442,891, 10,997,522, 10,951,002, 10,804,871, 10,760,954, 10,733,524, 10,340,052, 10,145,792, 9,766,071, 9,715,950, 9,588,047, 8,426,871, and 4,128,843 which are assigned to Honeywell International, Inc.; U.S. Pat. Nos. 11,177,912, 11,177,375, 11,158,731, 11,158,714, 11,107,891, 11,101,352, 11,075,293, 11,063,138, 10,991,802, 10,992,166, 10,635,990, and 6,661,943 which are assigned to the Intel Corporation; U.S. Pat. No. 8,064,065 assigned to Lawrence Livermore National Security, LLD.; U.S. Pat. Nos. 11,188,842, 11,170,302, 11,157,828, 11,151,470, 11,138,354, 11,132,617, 11,127,820, 11,121,303, 11,120,359, 11,119,773, 11,113,084, 11,081,634, 11,010,684, 11,010,682, 11,010,450, 11,004,008, 10,997,337, 10,990,677, 10,972,133, 10,963,125, 10,879,464, 10,860,759, 10,846,608, 10,811,587, 10,777,605, 10,740,689, 10,699,209, 10,699,208, 10,692,010, 10,665,701, 10,664,761, 10,664,249, 10,651,808, 10,635,988, 10,574,268, 10,546,621, 10,496,933, 10,490,600, 10,469,087, 10,430,162, 10,423,887, 10,417,370, 10,411,713, 10,374,610, 10,366,339, 10,346,761, 10,346,348, 10,331,163, 10,320,394, 10,320,360, 9,256,834, 9,152,924, 8,581,227, 7,598,514, 7,566,896, 7,518,138, 7,394,092, 7,376,547, 7,321,131, 7,250,624, and 7,109,593 which are assigned to the Microsoft corporation also known as Microsoft Technology Licensing, LLC.; U.S. Pat. No. 10,586,566 which is assigned to Sony Interactive Entertainment, Inc.; U.S. Pat. Nos. 9,246,602, and 8,744,075 which are assigned to the Sony Corporation; U.S. Pat. No. 6,823,140 assigned to Sun Microsystems, Inc.; U.S. Pat. Nos. 11,125,773, 11,003,046, 10,809,592, 10,520,024, and 10,272,400 assigned to Xanadu Quantum Technologies, Inc. of Toronto, Canada; U.S. Pat. No. 10,534,189 B2 by Miller assigned to Stanford University, and all of the patents recited in this paragraph are hereby incorporated by reference herein.

The JAVA computer language is believed to be one of the best for software program application development, and so the following list of U.S. patents originally assigned to Sun Microsystems, Inc. which developed JAVA is provided: U.S. Pat. Nos. 7,685,430, 7,650,505, 7,647,415, 7,634,779, 7,584,302, 7,574,710, 7,565,647, 7,548,946, 7,546,605, 7,543,288, 7,533,156, 7,451,393, 7,426,721, 7,421,687, 7,409,439, 7,398,533, 7,370,322, 7,318,128, 7,305,671, 7,296,235, 7,290,045, 7,266,822, 7,266,816, 7,246,345, 7,246,134, 7,243,356, 7,228,533, 7,219,331, 7,210,127, 7,209,960, 7,197,750, 7,181,724, 7,177,934, 7,167,894, 7,165,108, 7,162,711, 7,159,213, 7,155,501, 7,131,120, 7,131,111, 7,130,773, 7,117,489, 7,096,467, 7,069,554, 7,065,747, 7,058,934, 7,055,133, 7,054,890, 7,043,738, 7,043,732, 7,039,904, 7,016,966, 7,003,778, 7,000,235, 6,996,824, 6,996,587, 6,986,129, 6,983,465, 6,981,246, 6,980,979, 6,978,456, 6,978,401, 6,976,061, 6,964,033, 6,961,933, 6,961,843, 6,959,430, 6,957,428, 6,957,427, 6,951,014, 6,934,946, 6,934,726, 6,922,796, 6,918,109, 6,912,569, 6,901,591, 6,898,786, 6,889,227, 6,886,157, 6,877,111, 6,862,674, 6,850,953, 6,839,647, 6,823,504, 6,804,681, 6,799,185, 6,772,178, 6,766,349, 6,754,796, 6,751,790, 6,745,387, 6,742,006, 6,721,777, 6,711,739, 6,651,140, 6,637,021, 6,633,876, 6,542,900, 6,466,974, 6,446,084, 6,430,567, 6,427,153, 6,418,444, 6,407,759, 6,401,134, 6,366,898, 6,349,333, 6,308,315, 6,282,568, 6,260,078, 6,260,077, 6,253,256, 6,233,582, 6,223,346, 6,216,227, 6,141,794, 6,134,627, 6,134,600, 6,122,745, 6,070,239, 6,061,520, 6,058,482, 6,044,218, 6,026,485, 6,003,038, 5,966,542, 5,925,123, 5,815,718, 5,754,857, 5,706,502, 5,692,047, RE 38,104, and all of these U.S. patents are hereby incorporated by reference herein.

In 2010, Sun Microsystems, Inc. was purchased by the Oracle Corporation which has continued to develop the JAVA computer language and related software program applications and the following list of U.S. patents relating to JAVA which are assigned to the Oracle Corporation is provided: U.S. Pat. Nos. 10,826,975, 10,558,434, 10,547,664, 10,476,938, 10,474,998, 10,373,139, 10,324,692, 10,268,456, 10,229,032, 10,225,323, 10,133,827, 10,127,259, 10,103,946, 10,049,127, 9,971,618, 9,930,129, 9,880,938, 9,875,122, 9,843,629, 9,811,359, 9,740,597, 9,667,430, 9,648,084, 9,626,488, 9,600,546, 9,588,742, 9,552,277, 9,542,222, 9,519,466, 9,509,745, 9,467,355, 9,448,928, 9,430,222, 9,417,992, 9,411,566, 9,239,814, 9,231,995, 9,213,562, 9,185,054, 9,183,013, 9,177,033, 9,171,096, 9,160,749, 9,141,539, 9,058,471, 9,043,768, 9,037,542, 8,978,023, 8,959,485, 8,959,106, 8,924,789, 8,881,099, 8,875,113, 8,875,094, 8,863,126, 8,856,805, 8,856,460, 8,856,294, 8,850,412, 8,838,669, 8,832,710, 8,826,246, 8,813,031, 8,806,493, 8,805,896, 8,799,885, 8,793,670, 8,776,053, 8,732,191, 8,713,546, 8,695,006, 8,639,787, 8,635,660, 8,635,185, 8,627,328, 8,615,734, 8,601,447, 8,572,579, 8,566,826, 8,555,264, 8,533,383, 8,495,107, 8,490,120, 8,463,852, 8,429,650, 8,387,076, 8,365,157, 8,332,835, 8,321,450, 8,316,083, 8,261,269, 8,255,680, 8,250,572, 8,245,206, 8,219,609, 8,196,128, 8,195,721, 8,180,746, 8,156,482, 8,082,489, 8,046,772, 8,032,872, 7,962,925, 7,962,902, 7,962,527, 7,953,773, 7,949,760, 7,925,952, 7,921,169, 7,873,979, 7,873,951, 7,870,112, 7,840,967, 7,840,939, 7,827,535, 7,814,472, 7,802,240, 7,802,239, 7,793,255, 7,788,489, 7,784,043, 7,752,626, 7,730,523, 7,730,492, 7,720,877, 7,716,339, 7,716,274, 7,644,403, 7,490,330, 7,461,395, 7,454,428, 7,346,889, 7,032,216, 6,873,984, 6,854,114, and all of these U.S. patents are hereby incorporated by reference herein.

The following patents which relate to the JAVA computer language and related software programs are assigned to the Intel Corporation, Inc.: U.S. Pat. Nos. 7,191,453, 6,928,456, 6,854,122, 6,611,864, 6,484,188, 6,370,685, 6,317,869, 6,289,506, 6,289,504, 6,170,083, 6,158,048, 6,131,191, 6,093,216, and all of these U.S. patents are hereby incorporated by reference herein.

The following patents which relate to the JAVA computer language and related software programs are assigned to the Microsoft Corporation: U.S. Pat. Nos. 10,115,116, 8,965,950, 8,661,407, 7,739,665, 7,546,590, 7,480,921, 7,194,729, 6,996,826, 6,981,255, 6,748,588, 6,665,865, 6,625,803, 6,522,343, 6,504,554, 6,499,035, 6,484,312, 6,484,311, 6,415,334, 6,367,012, 6,349,344, 6,230,172, 6,229,537, 6,173,317, 6,035,119, 6,006,241, 6,003,050, 5,920,720, 5,892,904, and all of these U.S. patents are hereby incorporated by reference herein.

The following patents several of which relate to computer languages, software programs and the enforcement of licensing agreements are assigned to Apple, Inc.: U.S. Pat. Nos. 9,952,841, 8,781,971, 8,452,712, 8,027,925, 7,900,215, 7,448,042, and 6,188,995, and all of these U.S. patents are hereby incorporated by reference herein. Other patents relating to computer languages include: U.S. Pat. No. 10,606,568 assigned to Alibaba Group Holding Limited, U.S. Pat. No. 9,804,946 assigned to Oracle International Corporation, U.S. Pat. No. 7,509,631 originally assigned to Bea Systems, Inc., U.S. Pat. No. 7,240,338 assigned to ITT Manufacturing Enterprises, Inc., U.S. Pat. No. 7,047,524 assigned to Hyperformix, U.S. Pat. No. 6,230,182 assigned to the Hewlett-Packard Company, U.S. Pat. No. 6,031,993 assigned to the Tandem Company, and U.S. Pat. No. 5,247,693 assigned to the Foxboro Company, and all of the U.S. patents are hereby incorporated by reference herein.

In the future, whether computing will include and be called optical computing, electro-optical computing, or quantum computing, and the information which is communicated be called waves, vibes, quwaves, quvibes, that is, instead of conventional bits or qubits which have been associated with digital information, there is need for a computer language for software application development which can communicate data and information optically using photons in sinusoidal wave form, sine wave form, wavelet form, and pulse form. Further, there is a need for a computer language which can communicate information using a hybrid combination of optical and digital signals. In addition, there is a need for a computer language which can represent and communicate words, numbers, and operations using fewer bits than the binary digital system, and also for data compression which can permit faster communication and processing of data and information. Moreover, there is need for a computer language and related computer software application that is easy for members of the public to understand and use.

Human beings do not normally process information in a binary manner with the input and output being communicated in a string of information one bit at a time. Seeing, hearing and speaking are things which all happen in a frequency domain. We constantly process information from multiple sensory sources, actions, and events at the same time. Accordingly, a computer language which permits similar multitasking is conducive to optical and quantum computing, the use of neural networks which can permit entanglement, superposition, and the making and use of artificial intelligence. The present disclosure is directed in to a computer language and code for software application development, data compression, and computers which can perform conventional, but also optical, hybrid electro-optical, and/or quantum computing. This language can permit data and information to be converted to and from other existing computer languages which are typically communicated using the binary number system, and also devices, methods, and processes which presently use electronic signals and digital means of communication.

### SUMMARY

A first aspect of the present disclosure is a method of making a computer language which includes providing a dictionary including a list including a plurality of member alphabetical letters and/or words and/or numbers and/or symbols, each member of the plurality being represented by a corresponding wave form having a specific frequency and wavelength.

Optionally, the wave form is in the electromagnetic spectrum.

Optionally, the wave form is a photonic wave in the visible light spectrum and/or invisible portion of the infrared light spectrum.

Optionally, the wave form is a sine wave.

Optionally, the wave form is an electronic wave.

Optionally, the wave form is a square wave.

Optionally, the wave form is a product of data compression.

Optionally, the list of alphabetic letters and/or words further includes a plurality of sub-lists including the following categories: noun, verb, adjective, adverb, pronoun, preposition, conjunction, determiner, and exclamation.

Optionally, the plurality of member numbers are represented by a first wave form having a first frequency and wavelength which represents the base portion of a specific number, and a second wave form having a second frequency and wavelength which represents the exponent portion of the specific number, whereby the value of the specific number can be represented and communicated.

Optionally, a difference exists in time and/or space between the start of the first wave form and the second wave form and the second wave form is substantially identical in amplitude and shape to the first wave form, but the second wave form is phase shifted relative to the first wave form, and the first wave form represents the base portion of the specific number, and the amount to which the second wave form is phase shifted in time and/or space represents the value of the exponent corresponding to the specific number, whereby the value of the specific number can be represented and communicated.

Optionally, the absence of a break between two of the plurality of member numbers which are represented and/or communicated in a series represents a mathematic function of addition.

Optionally, the absence of a break between two of the plurality of member numbers which are represented and/or communicated in a series represents a mathematical function of multiplication.

Optionally, a break between two of the plurality of member letters and/or words and/or numbers and/or symbols represents a separation between the plurality member letters and/or words and/or numbers and/or symbols.

Optionally, the presence of a wave form representing a symbol disposed between two of the plurality of member numbers represents a mathematical function and operation between the member numbers.

A second aspect of the present disclosure includes a method of making a computer language for representing any positive number using the values and numbers 0, 1, 2, 2^{nth} exponential power, 3, and 3^{nth} exponential power and/or a sum of two or more of these values and numbers.

A third aspect of the present disclosure includes a method of making a computer language for representing and communicating values or numbers, each of the values or numbers including a base portion consisting of one or more of the following 0, 1, 2, 3, 4, 5, 6, 7, 8, 9, and an exponent portion, the base portion being represented and communicated by a wave form having a first frequency and wavelength, said exponent portion being represented by a second wave form having a second frequency and wavelength, wherein a difference exists in time and/or space between the start of the first wave form and the second wave form, and the second wave form is substantially identical in amplitude and shape to the first wave form, and the second wave form is phase shifted relative to the first wave form, and the amount to which the second wave form is phase shifted in time and/or space represents and communicates the exponent, whereby said values or numbers can be represented and communicated.

Optionally, the first wave form and the second wave form comprise square waves.

Optionally, the first wave form and the second wave form comprise sine waves.

Optionally, the first wave form and the second wave form have different frequencies and wavelengths.

A fourth aspect of the present disclosure includes a method of making a computer language for representing and communicating a value or number in a known base number system, the value or number having a base portion equal to the known base number in the known base number system and an exponent portion having a value obtained from a list in a table of algorithms, the known base number in the known base number system and the exponent portion being configured to be manipulated by a mathematical function by which a resultant wave form having a specific wavelength is derived to represent and communicate the value or number.

Optionally, the base number in the known base number system is the number 10 in the base 10 number system.

Optionally, the base number in the known base number system is the natural logarithm value e.

A fifth aspect of the present disclosure includes an optical keyboard configured to communicate data and information using visible light and/or infrared light.

A sixth aspect of the present disclosure includes an optical game controller configured to communicate data and information using visible light and/or infrared light.

A seventh aspect of the present disclosure includes a computer keyboard including means for producing an output including photons and a plurality of sine waves in the visible light spectrum and/or invisible portion of the infrared light spectrum, the output including representations of a plurality of alphabetical letters and/or words and/or numbers and/or symbols and/or commands and/or functions and/or operations, the output being communicated by fiber optic cable to a computer selected from the group of computers consisting of an electronic computer, an optical computer, an electro-optical computer, and a quantum computer.

An eighth aspect of the present disclosure includes a method of communicating a computer language including providing a dictionary including a list including a plurality of member alphabetical letters and/or words and/or numbers and/or symbols, each of the plurality of member alphabetical letters and/or words and/or numbers and/or symbols being represented by a corresponding wave form having a specific frequency and wavelength.

A ninth aspect of the present disclosure includes a computer language including a dictionary including a list of a plurality of member alphabetical letters and/or words and/or numbers and/or symbols, each of the plurality of member alphabetical letters and/or words and/or numbers and/or symbols being represented by a corresponding wave form having a specific frequency and wavelength.

A tenth aspect of the present disclosure includes a method of making a computer language including selecting a value or number X in a base number system consonant with a logarithmic function and expression Log_{b}ⁿ=X, where b is the base portion of a number in the base number system, and where n is the exponent portion of the number in the base number system to which b is raised to produce the value or number X, taking and using n as a first factor, and multiplying n by at least a second factor to yield a specific frequency and associated wavelength in a portion of the electromagnetic spectrum. An eleventh aspect of the present disclosure includes a method of making a computer language including selecting a value or number X in a base number system consonant with a logarithmic function and expression Log_{b}ⁿ=X where b is the base portion of a number in the base number system, and where n is the exponent portion of the number in the base number system to which b is raised to produce the value or number X, taking and using n as a first factor, and randomly generating a third factor, and multiplying n as the first factor by a second factor and the third factor to yield a specific frequency and associated wavelength in a portion of the electromagnetic spectrum. Further, the portion of the electromagnetic spectrum can be a portion of the visible light spectrum and/or infrared light spectrum.

A twelfth aspect of the present disclosure includes a method of making a computer language including selecting a plurality of wave forms corresponding to specific frequencies and associated wavelengths in the visible light spectrum and/or invisible portion of the infrared light spectrum, and combining at least two of the plurality of wave forms corresponding to specific frequencies and wavelengths to create a coding point. Alternatively, at least four of the plurality of wave forms can be combined to create a coding point. In this regard, a coding point can be used to represent at least one of an alphabetical letter, a word, a number, a symbol, a command, a function, and an operation. Further, at least two of the plurality of wave forms can be combined to form a plurality of sets, and the plurality of sets can be disposed in series and/or in parallel to provide a plurality of coding points. In addition, the number of permutations of the plurality of coding points can correspond to the formula: Permutations=(Number of Sets)!/(Number of Sets−2)!, and the number of combinations of the coding points can correspond to the formula: Combinations=(Number of Sets)!/2!×(Number of Sets−2)!.

A thirteenth aspect to the present disclosure includes a computer non-transitory readable medium which configures at least one of an optical computer, an electro-optical computer, and/or a quantum computer including a power supply, at least one input device, at least one output device, a processor device, a memory device, and/or a combined processor and memory device to cause the least one input device to receive a first plurality of different wavelengths and corresponding frequencies of visible and/or invisible light configured to directly represent and encode a first plurality of data and information which includes at least one of an alphabetical letter, a word, a symbol, a number, or an image, and/or to cause the at least one output device to send or transmit a second plurality of different wavelengths and corresponding frequencies of visible and/or invisible light configured to directly represent and encode a second plurality of data and information which includes at least one of an alphabetical letter, a word, a symbol, a number, or an image, and/or to cause the processor device, the memory device, and/or the combined processor and memory device to manipulate the first plurality of data and information and/or the second plurality of data and information and to perform processing of and/or perform processing relating to the first plurality of data and information and/or the second plurality of data and information and/or to cause the first plurality of data and information and/or the second plurality of data and information and/or the result of the processing to be persisted or stored in the memory device and/or the combined processor and memory device.

Optionally, the first plurality of data and information and/or the second plurality of data and information comprises an optical pattern selected from the group of optical patterns comprising a linear optical pattern, a circular optical pattern, or other two-dimensional optical pattern, a holographic optical pattern, or other three-dimensional optical pattern, and a four-dimensional optical pattern in which time is the fourth dimension.

Optionally, the optical pattern is used or manipulated to perform computations or other computer operations or functions.

Optionally, the first plurality of different wavelengths and corresponding frequencies of visible and/or invisible light and/or the second plurality of different wavelengths and corresponding frequencies of visible and/or invisible light comprising a signal, the signal comprising at least one of a continuous or discontinuous signal type, the signal type further comprising at least one of a sinusoidal wave form, a sine wave, a cosine wave, a square wave, a triangular wave, a sawtooth wave, a wavelet, a Morlet wavelet, a pulse, and a Gaussian pulse.

Optionally, the at least one input device and/or the at least one output device includes a plurality of optical channels, and the first plurality of data and information is configured to be received in parallel and/or in serial or a sequence, and/or the second plurality of data and information is configured to be sent or transmitted in parallel and/or in series or a sequence, and the first plurality of data and information and/or the second plurality of data and information is correlated to the plurality of optical channels in order to create, establish or encode and/or to determine, decode or decipher an identifiable sequence, whereby the first plurality of data and information and/or the second plurality of data and information is configured to be received in parallel, and is also further configured to be rendered and/or manipulated in series or a sequence with the use of the identifiable sequence.

Optionally, the optical pattern further encodes a binary number system representation and encoding of at least one of an alphabetical letter, a word, a symbol, a number, or an image.

Optionally, the optical pattern includes a constellation configuration associated with a type of modulation, and the first plurality of different wavelengths and corresponding frequencies of visible and/or invisible light and/or the second plurality of different wavelengths and corresponding frequencies of visible and/or invisible light comprising a signal, the signal comprising at least one of a continuous or discontinuous signal type, the signal type further comprising at least one of a sinusoidal wave form, a sine wave, a cosine wave, a square wave, a triangular wave, a sawtooth wave, a wavelet, a Morlet wavelet, a pulse, and a Gaussian pulse, and the signal is configured to be modulated with the use of wavelength and frequency modulation and/or phase shifting modulation and/or amplitude modulation and/or a by a combination of two or more of the signal types, and the modulated signal is configured to be transmitted by at least one of a wire, a fiber optic cable or other waveguide, or wirelessly.

Optionally, the optical pattern is configured to represent and encode a number including a base portion, and an index, a place holder value, or an exponential value.

Optionally, the circular optical pattern includes a center and at least one position or point located at a radial distance from the center, wherein the at least one position or point is configured to represent and encode a number in the range between and including 0-9.

Optionally, the at least one position or point which is used to represent and encode the number in the range between and including 0-9 is further configured using a wavelength and corresponding frequency of visible and/or invisible light which is also used to represent and encode the number, whereby both the optical pattern associated with the position or point, and also the wavelength and corresponding frequency of visible and/or invisible light which is disposed at the position or point represent and encode the number.

Optionally, the at least one position or point includes a set or group of 4 positions or points located at the radial distance from the center which correspond to 4 binary number system digits which each represent and encode either a one (1) or a zero (0) and which together represent and encode the number in the range between and including 0-9.

Optionally, the computer non-transitory readable medium according to clause 46, wherein the circular optical pattern is used or manipulated to perform mathematical computations.

Optionally, the signal is manipulated to comprise half wave rectification and/or full wave rectification.

Optionally, the signal is configured to be analyzed for error using one or more of the following: determining with a sine wave unit circle equation whether the first signal and/or the second signal is consistent with cos² x+sin² x=1, error correction code (ECC), block codes, convolutional codes, forward error control (FEC), channel codes, An codes, Algebraic geometry code, BCH code, Barker code, Berger code, Burst error-correcting code, Constant-weight code, Convolutional code, Expander codes, Group codes, Golay codes, Binary Golay code, Goppa code, Hadamard code, Hagelbarger code, Hamming code, Latin square based code Lexicographic code, Linear Network coding, Long code, Low-density parity-check code, Gallager code, LT code, Fountain code, M of N codes, Nordstrom-Robinson code, Online code, Polar code, Raptor code, Reed-Solomon error correction, Reed-Muller code, Repeat-accumulate code, Repetition codes such as Triple modular redundancy, Spinal code, and Tornado code.

Optionally, the first plurality of different wavelengths and corresponding frequencies of visible and/or invisible light includes a first wavelength and corresponding frequency of visible and/or invisible light which includes a first point, and a second wavelength and corresponding frequency of visible and/or invisible light which includes a second point, and the first point and the second point are entangled and in superposition, and/or the third plurality of different wavelengths and corresponding frequencies of visible and/or invisible light includes a third wavelength and corresponding frequency of visible and/or invisible light and includes a third point, and the fourth plurality of different wavelengths and corresponding frequencies of visible and/or invisible light includes a fourth wavelength and corresponding frequency of visible and/or invisible light and comprising a fourth point, and the third point and the fourth point are entangled and in superposition.

Optionally, the first point and the second point are entangled and in superposition because the first wavelength and corresponding frequency of visible and/or invisible light and the second wavelength and corresponding frequency of visible and/or invisible light both originated from the same light source, and/or were manipulated by a prism, a diffraction grating, a filter, or other optical device or method performing optical manipulation, and the third point and the fourth point are entangled and in superposition because the third wavelength and corresponding frequency of visible and/or invisible light and fourth wavelength and corresponding frequency of visible and/or invisible light both originated from the same light source, and/or were manipulated by a prism, a diffraction grating, a filter, or other optical device or method of performing optical manipulation, wherein the entanglement and the superposition of the first point with the second point and/or the entanglement and the superposition of the third point with the fourth point is configured to perform at least one computation or other computer operation or function.

Optionally, the first wavelength and corresponding frequency of visible and/or invisible light and the second wavelength and corresponding frequency of visible and/or invisible light have sinusoidal wave forms having the same amplitude, and the maximum peak positive amplitude of the first point, the second point, and/or the third point, and the fourth point is configured to represent and encode white and a presence of all colors and all wavelengths and corresponding frequencies within the visible and/or invisible light spectrums, and the maximum peak negative amplitude of the first point, the second point, and/or the third point, and the fourth point is configured to represent and encode black or a dark color or no colors or wavelengths and corresponding frequencies within the visible and/or invisible light spectrums, and/or no data and information, and the range of the all colors and all wavelengths and corresponding frequencies within the visible and/or invisible light spectrums are in the range between and including the maximum peak negative amplitude and the maximum peak positive amplitude, and the range is configured to be used to represent and encode and to manipulate the data and information in order to perform computations, and other computer operations or functions.

A fourteenth aspect to the present disclosure includes an optical computer, and/or an electro-optical computer, and/or a quantum computer comprising a power supply, an input device and/or output device including at least one light source and a plurality of optical signal channels configured to receive and/or to send or transmit a plurality of different wavelengths and corresponding frequencies of visible and/or invisible light which directly represent and encode data and information including at least one of an alphabetical letter, a word, a sentence, a symbol, a number, or an image, at least two of the plurality of different wavelengths and corresponding frequencies being entangled and in superposition, and a processor device, an optical memory device, and/or a combined optical processor and memory device including a holographic memory device, or a glass or crystal memory device.

Optionally, the optical computer, and/or an electro-optical computer, and/or a quantum computer according to clause 53, wherein the light source includes at least one of a laser, a femtosecond laser, a laser diode, a micro laser diode, a LED, and a micro laser LED.

Optionally, the optical computer, and/or an electro-optical computer, and/or a quantum computer according to clause 53, further including at least one of a lens, a filter, a shutter, a beam shaper, a beam splitter, a loop, a polarizer, a mirror, a prism, a diffraction grating, a camera, a photodetector, a photodetector array, a CMOS photodetector, a spatial light modulator, a multiplexer, a demultiplexer, a wave division multiplexer, an Optical Add Drop Multiplexer (OADM), a transceiver, a transponder, an analog to digital converter, a digital to analog converter, an optical switch, an optical splitter, an optical amplifier, an Erbium doped fiber amplifier, a Raman amplifier, a waveguide, an optical processor device, an optical logic processor device, a wire, a fiber optic cable, a waveguide, an optical connection.

Optionally, the optical computer, and/or an electro-optical computer, and/or a quantum computer according to clause 53, wherein the optical memory device further includes at least one of a holographic memory device, a holographic glass or crystal memory device, an optical disk memory device, a cache memory, a RAM memory, a ROM memory, an image, photo, video, or a film memory, a magnetic or optical tape memory, a color coded memory, a DNA color coded memory, a red, green blue (RGB) color coded memory, a sRGB color coded memory.

Optionally, the optical computer, and/or an electro-optical computer, and/or a quantum computer according to clause 53, wherein the input device and/or the output device includes at least one of a keyboard, a mouse, a microphone, a voice recognition device or voice command, a camera, a photodetector, a photodetector array, a CMOS device, a video camera, a CD disk, a DVD disk, an optical disk, a holographic optical disk, a magnetic tape, an optical tape, an optical film, an analog to digital converter, a digital to analog converter, a multiplexer, a demultiplexer, a wave division demultiplexer, a transponder, a transceiver, a computer monitor, a computer touchscreen monitor, an oscilloscope, a spectrum analyzer, a Solid State Drive (SSD), a removable Flash drive, a wire, waveguide, a fiber optic cable, a wireless device, a computer printer.

Optionally, the optical computer, and/or an electro-optical computer, and/or a quantum computer according to clause 53, wherein the holographic memory device and/or combined processor and holographic memory device includes a geometric shape selected from the group of three-dimensional geometric shapes consisting of a cube, a cylinder, a cone, a sphere, a triangular prism, a pentagonal prism, a hexagonal prism, an octagonal prism, or other polyhedron structure.

Optionally, the optical computer, and/or an electro-optical computer, and/or a quantum computer according to clause 58, wherein the data and information corresponding to a specific subject area or field is configured to be persisted or stored in close proximity and within a specific defined range of the plurality of wavelengths and corresponding frequencies in the visible light spectrum and frequencies in the infrared light spectrum.

Optionally, the optical computer, and/or an electro-optical computer, and/or a quantum computer according to clause 53, wherein the data and information includes an optical pattern or array in the holographic memory device, and/or the combined processor and holographic memory device.

A fifteenth aspect to the present disclosure includes a holographic memory device for use with an optical computer, and/or an electro optical computer, and/or a quantum computer comprising: a holographic storage medium having a geometric shape including a top surface, a bottom surface, at least one inside surface extending between the top surface and the bottom surface, the inside surface defining an opening, and at least one outside surface extending between the top surface and the bottom surface; at least one optical detector device disposed proximate to the at least one outside surface; at least one light source, at least one beam splitter, and at least one mirror disposed in the opening proximate to the at least one inside surface including at least one data beam and at least one reference beam for sending or transmitting and/or for retrieving data and information to and from the holographic storage medium for the purpose of persisting or storing the data and information and/or retrieving the data and information from the holographic storage medium.

Optionally, the holographic memory device further includes at least one of a base, a beam shaper, a lens, a filter, a shutter, a loop, a polarizer, a prism, a diffraction grating, a camera, a photodetector, a photodetector array, a CMOS photodetector, a spatial light modulator, a multiplexer, a demultiplexer, a wave division multiplexer, an Optical Add Drop Multiplexer (OADM), a transceiver, a transponder, an analog to digital converter, a digital to analog converter, an optical switch, an optical splitter, an optical amplifier, an Erbium doped fiber amplifier, a Raman amplifier, a waveguide, an optical processor device, an optical logic processor device, a wire, a fiber optic cable, a waveguide, an optical connection, a positive electrical lead, and a negative electrical ground lead.

Optionally, the holographic memory device further includes a turret disposed proximate a middle of the opening, the turret including the at least one light source and the at least one beam splitter and the at least one mirror, at least one of the turret, the at least one light source, the at least one beam spitter, and the at least one mirror configured to move such that a plurality of data beams and/or a plurality of reference beams are configured to be selectively directed to the holographic storage medium.

Optionally, the holographic storage medium includes a plurality sections or portions, each of the plurality of sections or portions includes a portion of the at least one inside surface and also a portion of the at least one outside surface, the turret having a plurality of sides corresponding to the number of the plurality of sections or portions, each of the plurality of sides of the turret including the at least one light source, the at least one beam splitter, and the at least one mirror, whereby a plurality of the sections or portions of the holographic storage medium can be simultaneously placed in optical communication with the plurality of data beams and/or the plurality of reference beams which include a plurality of optical channels, and at least a portion of one of the sections or portions is configured to provide cache memory, and at least a portion of one of the sections or portions is configured to provide read only memory (ROM) memory, and at least a portion of one of the sections or portions is configured to provide random access memory (RAM) memory.

Optionally, the holographic memory device further includes a processor device.

Optionally, the processor device includes an optical processor device and/or optical logic processor device which is disposed proximate to the holographic memory device, and the optical processor device and/or optical logic processor device includes at least one direct optical connection to the holographic memory device, a positive electrical lead, and a negative electrical or ground lead.

Optionally, the holographic storage medium includes an octagonal configuration and the at least one inside surface includes eight inside surface portions, and the turret includes eight sides each comprising the at least one light source which is capable of providing a data beam and/or reference beam to each of the eight inside surface portions of the holographic storage medium.

Optionally, the at least one light source includes at least one wavelength and corresponding frequency of visible and/or invisible light which is used to represent and encode a plurality of binary number digits representing zero (0) and/or one (1) which are represented and encoded as an optical pattern comprising a plurality of positions or points.

Optionally, the plurality of positions and/or points includes at least four positions and/or points.

Optionally, the plurality of data beams and/or the plurality of reference beams which include the plurality of optical channels are configured to send or transmit and/or to receive a plurality of wavelengths and corresponding frequencies of visible and/or invisible light which represent and encode the data and information, and the data and information is configured to be correlated to a specific one of the plurality of optical channels which is used to send or transmit and/or to receive data and information such as to create, establish, or encode an identifiable sequence, whereby the data and information can be transmitted in parallel and/or in series or a sequence, and be read, written, persisted or stored in parallel and/or in series or a sequence, and the data and information can be accessed and retrieved in parallel and/or series or a sequence, and the data and information can be manipulated or processed in parallel and/or in series or a sequence by a processor device.

Optionally, the data and information which is represented and encoded by the wavelengths and corresponding frequencies of visible and/or invisible light is persisted and/or stored in a red, green, blue (RGB) holographic memory device and/or a combined RGB processor and holographic memory device.

### BRIEF DESCRIPTION OF THE DRAWINGS

FIG. 1 shows a representation of the screen of an oscilloscope showing square waves representing an alphabetical letter and two words.

FIG. 2 shows a representation of the screen of an oscilloscope showing square waves representing three words.

FIG. 3 shows a representation of the screen of an oscilloscope showing sine waves representing alphabetical letter and two words.

FIG. 4 shows a representation of the screen of an oscilloscope showing sine waves representing three words.

FIG. 5 shows a representation of the screen of an oscilloscope showing square waves representing the base portion of numbers 1, 2, and 3, and also square waves representing the exponent portion of the numbers.

FIG. 6 shows a representation of the screen of an oscilloscope showing sine waves representing the base portion of the numbers 1, 2, and 3, and also sine waves representing the exponent portion of the numbers.

FIG. 7 shows a representation of the screen of an oscilloscope showing square waves representing the base portion of numbers 1, 2, and 3, and also sine waves representing the exponent portion of the numbers.

FIG. 8 shows a representation of the screen of an oscilloscope showing sine waves representing the base portion of numbers 1, 2, and 3, and also square waves representing the exponent portion of the numbers.

FIG. 9 shows a representation of the screen of an oscilloscope showing multiple square waves representing the base portion of numbers 1, 2, and 3, and also square waves representing the exponent portion of the numbers.

FIG. 10 shows a representation of the screen of an oscilloscope showing multiple sine waves representing the base portion of numbers 1, 2, and 3, and also sine waves representing the exponent portion of the numbers.

FIG. 11 shows a representation of the screen of an oscilloscope showing square waves representing the base portion of numbers 1, 2, and 3, and also square waves representing the exponent portion of the numbers which are offset in time.

FIG. 12 shows a representation of the screen of an oscilloscope showing sine waves representing the base portion of numbers 1, 2, and 3, and also sine waves representing the exponent portion of the numbers which are offset in time.

FIG. 13 shows a representation of the screen of an oscilloscope showing sine waves representing the base portion of numbers 1 and 2, and also sine waves representing the exponent portion of the numbers and which are disposed on the same 0 axis.

FIG. 14 shows a representation of the screen of an oscilloscope showing sine waves representing the base portion of number 3, and also sine waves representing 2 which is the exponent portion of the number 3 and which are disposed on the same 0 axis.

FIG. 15 shows a representation of the screen of an oscilloscope showing square waves representing the base portion of numbers 1 and 2, and also sine waves representing the exponent portion of the numbers and which are disposed on nearly the same axis.

FIG. 16 shows a representation of the screen of an oscilloscope showing square waves representing the base portion of number 3, and also sine waves representing the exponent portion of the numbers and which are disposed on nearly the same axis.

FIG. 17 shows a representation of the screen of an oscilloscope showing large square waves representing the base portion of the numbers 2 and 3, and also small and sometimes multiple square waves having about half the amplitude representing the exponent portion following the base portion of the numbers and which are disposed on the same axis.

FIG. 18 shows a representation of the screen of an oscilloscope showing large square waves representing the base portion of the numbers 2 and 3, and also small single square waves having about half the amplitude representing the exponent portion following the base portion of the numbers and which are disposed on the same axis.

FIG. 19 shows a representation of the screen of an oscilloscope showing large sine waves representing the base portion of the numbers 2 and 3, and also small and sometimes multiple sine waves having less than half the amplitude representing the exponent portion following the base portion of the numbers and which are disposed on the same axis.

FIG. 20 shows a representation of the screen of an oscilloscope showing large sine waves representing the base portion of the numbers 2 and 3, and also small single sine waves having less than half the amplitude representing the exponent portion following the base portion of the numbers and which are disposed on the same axis.

FIG. 21 shows a representation of the screen of an oscilloscope showing a series of large square waves representing the base portion of the numbers 1, 2 and 3 which are disposed on the same axis.

FIG. 22 shows a representation of the screen of an oscilloscope showing a series of single large sine waves representing the base portion of the numbers 1, 2 and 3 which are disposed on the same axis.

FIG. 23 shows a representation of the screen of an oscilloscope showing a series of sine waves representing the base portions and also the exponent portions of several individual numbers which can be used to represent and communicate the number 124.

FIG. 24 shows a representation of the screen of an oscilloscope showing a series of sine waves representing the base portions and also the exponent portions of several individual numbers which can be used to represent and communicate the number 124.

FIG. 25 shows a representation of the screen of an oscilloscope showing two sine waves which are phase shifted relative to one another and which represent the base portion 10 and also the exponent 2 portion to represent 10² which can be used to represent and communicate the number 100.

FIG. 26 shows a representation of the screen of an oscilloscope showing a plurality of sine waves which are phase shifted relative to one another and which represent the base portion and also the exponent portion of three numbers which can be used to represent and communicate the number 124.

FIG. 27 is a prior art representation of an ultra-short pulse which can be used to communicate information.

FIG. 28 is a representation showing two different sine waves and also two different square waves which are each separated by break.

FIG. 29 shows a flow chart relating to a conventional computer, an optical computer, a hybrid electro-optical computer and/or quantum computer.

FIG. 30 shows a keyboard, a game controller, a mouse, and also a headset including a microphone for communicating data and information to a computer which has an integral keyboard and touch pad, and which can be a conventional computer, an optical computer, a hybrid electro-optical computer, and/or quantum computer.

FIG. 31 shows a representation of the screen of an oscilloscope showing a resultant wave form which is derived from a base number portion in a known base number system and an exponent portion which have been manipulated by a mathematical function to derive the resultant wave form having a specific wavelength and which represents and communicates a value or number.

FIG. 32 shows a representation of the screen of an oscilloscope showing three different resultant wave forms which are each derived from a base number portion in a known base number system and an exponent portion and which have been manipulated by a mathematical function to derive the three different resultant wave forms each having a specific wavelength which represents and communicates a value or number.

FIG. 33 shows a representation of the screen of an oscilloscope showing two cycles of each of three different resultant wave forms which are each derived from a base number portion in a known base number system and an exponent portion and which have been manipulated by a mathematical function to derive the three different resultant wave forms each having a specific wavelength which represents and communicates a value or number.

FIG. 34 shows a representation of the screen of an oscilloscope showing two cycles of three different sine waves corresponding to visible and/or invisible light having different frequencies and wavelengths.

FIG. 35 shows a resultant wave form derived from the summation and combination of the three different sine waves shown in FIG. 34.

FIG. 36 shows the result of a Fast Fourier Transform of the data and information associated with the resultant wave shown in FIG. 35.

FIG. 37 shows a prior art representation of a square wave having an amplitude of +1 over time.

FIG. 38 shows a prior art representation of a sine wave having an amplitude of +1 and −1 over time.

FIG. 39 shows a representation of a sine wave at the top, the same sine wave when manipulated by half wave rectification in the middle, and the same sine wave when manipulated by full wave rectification at the bottom.

FIG. 40 shows a plurality of different geometric shapes which can be used with regards to the configuration of a holographic storage medium.

FIG. 41 is a top view of an optical memory device, and in particular, a holographic memory device.

FIG. 42 is a side view of an optical memory device, and in particular, a holographic memory device resembling the one shown in FIG. 41, and an optical processor device, and/or a combination optical memory and processor device.

FIG. 43 shows a representation of plurality of pulses with their amplitudes plotted over time.

FIG. 44. shows a representation of a plurality of wavelets with their amplitudes plotted over time.

FIG. 45 shows a plurality of patterns and/or constellation configurations or diagrams.

FIG. 46 shows a pattern and/or constellation configuration or diagram for use in representing numbers, symbols, and performing calculations.

FIG. 47 shows a linear pattern for use in representing numbers, symbols, alphabetical letters, or words, or images.

FIG. 48 shows a circular pattern and/or constellation configuration or diagram for use in representing numbers, symbols, alphabetical letters, words, or images FIG. 49 shows a table indicating numbers between 0-10 and a corresponding binary number system representation and code using 4 digits in connection with a positional number system.

FIG. 50 shows a circular pattern and/or constellation configuration or diagram for use in representing numbers, symbols, alphabetical letters, words, or images.

FIG. 51 shows a cross-sectional side view of the holographic device and holographic storage medium shown in FIGS. 41 and 42, taken along Line A-A in FIG. 42.

FIG. 52 shows a light source and a light beam that is divided by a beam splitter and two resulting light beams directed to two prisms.

FIG. 53 is a prior art drawing of a gem cut diamond.

FIG. 54 shows a plurality of incident light beams entering a diamond and resulting light beams which have been diffracted exiting the diamond.

### DETAILED DESCRIPTION

When using the binary system in digital communication each letter of the alphabet, as well as other numbers, symbols, and operations, are each identified using at least 8 bits made of zeros (0's) and ones (1's) which is also known as one byte of information. Accordingly, to reproduce and communicate the simple phrase “Run Tag Run” requires at least 72 bits or 9 bytes of digital information. This digital information is most often communicated in the form of a series of square waves with the top of a square wave which corresponds to its maximum amplitude being used to represent the number 1, whereas a portion having less amplitude or resting at zero is used to represent the value 0. As a result, the use of the binary system in digital communication can result in a long string or series of bits which are communicated sequentially and this can consume substantial memory.

Morse Code is an example of a different binary system which uses only 5 bits to represent numbers between 1-10 as shown below:

| | |
|---|---|
| 1 | .---- |
| 2 | ..--- |
| 3 | ...-- |
| 4 | ....- |
| 5 | ..... |
| 6 | -.... |
| 7 | --... |
| 8 | ---.. |
| 9 | ----. |
| 10 | ----- |

Morse code is a different binary system than the one which is typically being used today in digital communication which uses ones (1's) and zeros (0's). However, it is possible to send morse code using visible light or invisible light in the infrared portion or other invisible portion of the electromagnetic spectrum to a computer using fiber optical cable by using a single sine wave or a short burst and transmission of sine waves to represent a dot, and either a longer burst and transmission of sine waves or no burst and transmission of light to represent a dash, or vice-versa. Alternatively, when using a conventional electronic computer, morse code can be sent using wires and a digital system to a computer by using a single square wave or a short burst and transmission of square waves to represent a dot, and either a longer burst or no burst of square waves to represent a dash. This method of communication resembles sending morse code by using a flashlight and turning it on and off for different durations of time.

Further, it is possible to send morse code using visible light or invisible light in the infrared portion or other invisible portion of the electromagnetic spectrum to a computer using fiber optical cable by using a sine wave having greater amplitude or intensity to represent a dot, and a sine wave having the same frequency and wavelength, but having less amplitude or intensity to represent a dash, or vice-versa. Alternatively, when using a conventional electronic computer, morse code can be sent using wires and the digital system to a computer by using a single square wave or a short burst and transmission of square waves having greater amplitude or intensity to represent a dot, and a square wave or a short burst and transmission of square waves having the same frequency and wavelength, but having less amplitude or intensity to represent a dash, or vice-versa. This method of communication would resemble sending morse code using two flashlights with one being noticeably brighter than the other, or using one flashlight which has two different brightness settings.

In addition, it is possible to send morse code using visible light or invisible light in the infrared portion or other invisible portion of the electromagnetic spectrum to a computer using fiber optical cable by using a sine wave having a specific frequency and wavelength of light to represent and communicate a dot, and a different sine wave having a different specific frequency and wavelength of light to represent and communicate a dash. Alternatively, when using a conventional electronic computer, morse code can be sent using wires and the digital system to a computer by using a single square wave or a short burst and transmission of square waves having one frequency and wavelength to represent a dot, and a different square wave or a short burst and transmission of square waves having a different frequency and wavelength to represent a dash, or vice-versa. This method of communication would resemble using two flashlights having two different colors.

Generally similar methods to those just described with reference to morse code can also be used to communicate the ones (1's) and zeros (0's) associated with the binary number system which is typically being used in digital communication. In this regard, it is possible send digital information using visible light or invisible light in the infrared portion or other invisible portion of the electromagnetic spectrum to a computer using fiber optical cable by using a single sine wave or a short burst and transmission of sine waves and light to represent a one (1), and either a longer burst and transmission of light or no burst and transmission of sine waves to represent a zero (0), or vice-versa. Alternatively, when using a conventional electronic computer, digital information can be sent using wires to a computer by using a single square wave or a short burst and transmission of square waves to represent a one (1), and either a longer burst or no burst of square waves to represent a zero (0). This method resembles sending digital information by using a flashlight and turning it on and off for different durations of time.

Further, it is possible to send digital information using visible light or invisible light in the infrared portion or other invisible portion of the electromagnetic spectrum to a computer using fiber optical cable by using a sine wave having greater amplitude or intensity to represent a one (1), and a sine wave having the same frequency and wavelength, but having less amplitude or intensity to represent a zero (0), or vice-versa. Alternatively, when using a conventional electronic computer, digital information can be sent using wires to a computer by using a single square wave or a short burst and transmission of square waves having greater amplitude or intensity to represent a one (1), and a square wave or a short burst and transmission of square waves having the same frequency and wavelength, but having less amplitude or intensity to represent a zero (0), or vice-versa. This method of communication would resemble sending digital information using two flashlights with one being noticeably brighter than the other, or using one flashlight which has two different brightness settings.

In addition, it is possible to send digital information using visible light or invisible light in the infrared portion or other invisible portion of the electromagnetic spectrum to a computer using fiber optic cable by using a sine wave having a specific frequency and wavelength of light to represent and communicate a one (1), and a different sine wave having a different specific frequency and wavelength of light to represent and communicate a zero (0). Alternatively, when using a conventional electronic computer, digital information can be sent using metal wires to a computer by using a single square wave or a short burst and transmission of square waves having one frequency and wavelength to represent a one (1), and a different square wave or a short burst and transmission of square waves having a different the frequency and wavelength to represent a zero (0), or vice-versa. This method of communication would resemble using two flashlights having two different colors.

If and when values or conditions other than 1 or 0 are desired or required when using digital communication, it can be possible to use three or more square waves having different positive amplitudes to represent those different values or conditions. For example, 1=yes or true can be communicated by a square wave having an amplitude “a”, and 0=no or false can be communicated by a flat line having no amplitude resting at 0 or other amplitude “b”, and maybe and the expression and/or can be communicated by a square wave having a different amplitude “c.” However, this method would take more time and energy for a computer to process. In this regard, see the discussion of what is called 3 Base and/or ternary computing the articles: Computing Science: Third Base, by Brian Hayes, 12-XX-2001, https://www.jstor.org/stable/27857554, Ternary Computing Testbed 3-Trit Computer Architecture, by Jeff Connelly, Aug. 29, 2008, http://xyzzy.freeshell.org/trinary/CPE%20Report%20-%20Ternary%20Computing%20Testbed%20-%20RC6a.pdf, and the video entitled: Hackaday 10th Anniversary: Non-Binary Computing, Oct. 7, 2014, https://youtu.be/TFTK074nG_M?si=DRwZwCgBrq0VO4jT.

Alternatively, it is possible to communicate 1, 0, and maybe and/or by using sine waves having different amplitudes and/or different frequencies and wavelengths using photons and light in the visible light spectrum and/or the infrared light spectrum, or other portion of the invisible electromagnetic light spectrum, as discussed below. Instead of flashlights, LED lights and lasers are typically used to communicate information over fiber optical cables in modern digital communication. In this regard, there are three basic ways of modulating binary data including ones (1's) and zeros (0's), namely, amplitude shift keying (ASK), phase shift keying (PSK), and frequency shift keying (FSK). As discussed in the article entitled “Understanding Modern Digital Modulation Techniques,” by Lou Frenzel, published Jul. 14, 2021 on the ElectronicDesign website: https://www.electronicdesign.com/technologies/communications/article/21798737/understanding-modern-digital-modulation-techniques, and also the article “Coherent Binary Modulation techniques” published online by an unknown author, date unknown, on the website: https://ee.eng.usm.mv/eeacadmandeep/EEE436/Chp%204.pdf, with reference to radio frequency communication and digital communication, there are two types of amplitude modulation, namely on-off keying (OOK) which is like turning a flashlight on and off to communicate morse code, and in this case ones (1's) and zeros (0's) associated with the binary number system, and amplitude shift keying (ASK) which resembles sending digital information using two flashlights with one being noticeably brighter than the other or using one flashlight which has two different brightness settings. The latter kind of modulation is sometimes called intensity modulation or amplitude modulation (AM).

Another form of digital communication is frequency shift keying (FSK) and a popular version of this is called minimum shift keying (MSK) in which a higher frequency is used to indicate and represent what is called a mark which could identify a one (1), and another lower frequency is used to indicate and represent what is called a space which can be used to identify a zero (0). The use of Gaussian low pass filters with (MSK) which is sometimes indicated as (GMSK) has been used to improve the spectral efficiency of communication on cell phones.

Other methods of digital modulation include binary phase shifting keying (BPSK) which shifts the carrier wave 180 degrees for each change in the binary state when indicating ones (1's) and zeros (0's) so that the starting and ending points of the different values begin and end at zero on the reference line, and differential (BPSK) or (DPSK) which compares the phase of the received bit of information with the phase of the previously received one. Alternatively, a variation of BPSK known as quadrature PSK (QPSK) produces two carrier signals orientated 90 degrees apart, and the binary data then modulates each phase to produce four sine signals shifted by 45 degrees from one another. This permits twice as much data to be transmitted.

Quadrature amplitude modulation (QAM) uses four carrier phases and at least two amplitude levels, and there exist 16 QAM, 64 QAM, and 256 QAM variations which can transmit more bits per symbol by using a mix of different amplitudes and phases. In this regard, see the document entitled: “Lesson 21, Digital Modulation U.S. Naval Academy,” published by an unknown author, date unknown, on the website: https://www.usna.edu/ECE/ec312/Lessons/wireless/EC312_Lesson_21_Digital_Modulation_Course_No_tes.pdf, which provides a discussion and illustrations showing the different basic ways of modulating binary data including ones (1's) and zeros (0's) in modern digital communication. The QAM method has been used with regards to cable television, and also with wireless communication such as cell phones. A hybrid form of PSK and QAM known as amplitude phase shift keying (APSK) which uses two different amplitudes and 16 different phase positions has been used in satellite communication. Orthogonal frequency division multiplexing (OFDM) is a combination of modulation and also multiplexing which creates many different sub-channels which are orientated in an orthogonal configuration within a given transmission channel, and this is one of the most widely used forms of digital communication being used today in digital subscriber line (DSL) and 4G cellular systems.

### Representing Alphabetical Letters and Words

The current Webster's dictionary includes about 470,000 words, and the concise Oxford dictionary includes between about 171,476 words. However, it has been estimated that most individuals only have knowledge of about 15,000-20,000 word families which are called lemmas in their native language, and individuals seldom have knowledge of more than 2,000-3,000 word families in a foreign language. Accordingly, a concise dictionary for use with a computer language can include less than 20,000 lemmas, and even less than 5,000 lemmas. If even only 1,000 or 2,000 and certainly less than 3,000-5,000 alphabetical letters, words, symbols, and numbers are each individually assigned and coded in order to be represented and communicated in the form of a square wave or a sine wave having a specific frequency and wavelength, then the amount of data in bits, waves, vibes, quwaves, quvibes, qubits, or whatever name or form would be given to the data and information, can possibly be decreased by over 75%. The following two websites having 1000 and 3000 word lists include the most commonly used words in English: https://gonaturalenglish.com; and, http://basicenglishspeaking.com. According to the website http://basicenglishspeaking.com: “If you know these 3000 most common words, you can understand at least 95% of all conversations, e-mails, newspapers, and books.” This is one way to create faster computers which do not consume as much time and energy as they do today, that is, if the desire is to make computers 20 times faster, then one way to accomplish this is to make a new computer language which uses a lot less data signals in order to communicate the same amount data and information. The following word classes exist in the English language: noun, verb, adjective, adverb, pronoun, preposition, conjunction, determiner, and exclamation. In this regard, a list of words which can be subdivided into these subclasses can be selected, and also a list of symbols, a list of numbers, and a list of key words or terms relating to computer programming language and operations can be selected, listed, and compiled for making the computer language.

A formal computer language can include and/or be used to create a construction language, a command language, a configuration language, a programming language, a query language, a transformation language, a data exchange language, a markup language, a modeling language, an architecture description language, a hardware description language, a printed page language, a simulation language, a specification language, a sheet style language, a domain-specific language, a general-purpose language, a natural language processing language. In the Java computer programming language, the following words are keywords which have a special meaning: abstract, assert, Boolean, break, byte, case, char, class, const, continue, default, do, double, else, enum, extends, false, final, finally, float, for, goto, if, implements, import, instanceof, int, interface, long, native, new, null, package, synchronized, this, throw, throws, transient, true, try, void, volatile, while, and these and other keywords and terms can be coded in order to be represented by individual square or sine wave forms having a specific frequency and wavelength. Further, in the JAVA computer programming language the following operators are used to perform arithmetic, assign values, and compare values: +, −, *, /, %, ++, −−, +, +=, −=, *=, /=, %=, ==, !=, >, >=, <, <=, and these and other operators can be coded in order to be represented by individual square or sine wave forms having a specific frequency and wavelength.

The present disclosure is directed to a computer language for software application development which is not dependent or necessarily based on the binary system that is now commonly being used in electronic digital communication. The computer language which is being disclosed can be communicated with the use of photons and sinusoidal waves, sine waves, cosine waves, square waves, wavelets, and pulses in the visible and/or invisible portion of the electromagnetic light spectrum. Alternatively, the computer language can be communicated with the use of electrons and in an electronic form using square waves, or other wave forms. Alternatively, the computer language can be communicated in a hybrid form with the use of photons and sine waves in the visible and/or invisible portion of the electromagnetic light spectrum, and in combination with electrons using electronic square waves, or other wave forms.

When the amplitude of a wave is being modulated using square or sine waves it can be thought of as a form of amplitude modulation (AM), that is, even though the signal may not be broadcast using radio waves which is the most common association that most people would have with the term amplitude modulation. It is possible to communicate capital letters and the other symbols on a keyboard which are normally made with the use of the shift, alt, ctrl, and function keys by using amplitude modulation, and to have this method and process match to the character map and ROM, RAM, and/or Flash memory, Solid State Drive (SSD) memory, or other means of persisting data and information associated with the integrated circuit present on a keyboard and/or computer. Alternatively, specific representation and encoding of letters, capital letters, entire words, numbers, and other symbols or operations, and conditions such as yes, no, maybe, and/or can be made using frequency modulation of a square wave or sine wave as discussed below.

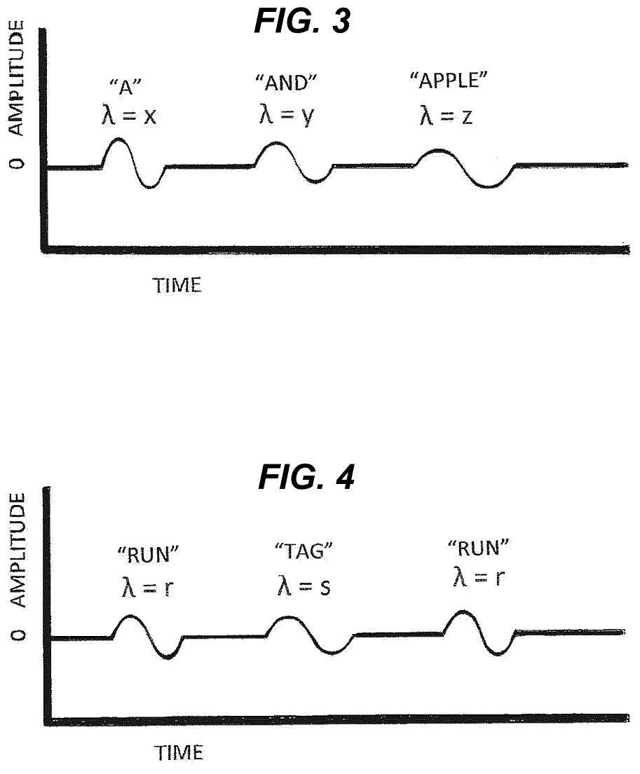

Again, the simple phrase “Run Tag Run” requires at least 72 bits or 9 bytes of digital information using conventional 0's and 1's. However, the letter “r” can be alternatively be represented using a square wave or sine wave having an amplitude and a specific frequency and wavelength. In this regard, the same amplitude of a square wave or sine wave can be used to represent all of the letters, capital letters, symbols, numbers, and operations normally provided on a keyboard, but the frequency and wavelength of the wave can be varied to represent and identify the specific letter, capital letter, symbol, number, or operation. Moreover, frequency modulation can not only be used to identify letters, capital, letters, symbols, numbers, and operations, but also entire words. An entire word can be communicated by a single square or sine wave. As shown in FIGS. 2 and 4, two square waves having wavelengths “r” and “s” are used to represent the words “run tag run.” Accordingly, a single square or sine wave can possibly be used to identify an entire word, or larger groups of words, phrases, sentences, paragraphs, documents, and images.

If the desire is to operate at high speeds in the MHz, GHz, or THz range, or even faster, the frequency and wavelength of the square wave or sine wave to be used is configured to provide information within the desired frequency range and the intended or desired speed of communication. For example, the letter “A” can be identified and encoded by a square or sine wave having a frequency of 1 MHz. All of the words included in a selected dictionary which is listed in the associated software program that would start with the letter “A” can also be assigned square or sine waves having different frequencies between 2 and let's say 200 hundred MHz. Alternatively, a different range could be used to include however many words will be included in the dictionary which begin with the letter “A.” The same thing can also be done for every other letter and word in the dictionary B-Z. Alternatively, the listing, assignment and encoding of alphabetical letters, words, symbols, numbers, and operations, can be done at higher frequencies and shorter wavelengths in the GHz or THz range. When using photons in the visible or invisible light spectrum to communicate data and information and possibly then also perform optical and quantum computing, the typical frequencies for use can be in the GHz and THz range.

When one square wave is being used to communicate one piece of information using a digital process it is normally called one bit of information. Alternatively, when a photon and sine wave corresponding to the visible light spectrum or an invisible portion of the infrared light spectrum in the larger electromagnetic spectrum is being used to communicate data or information, it can possibly be called a wave, a vibe, quwave, quvibe, or a qubit of information. As a result, the three words or phrase “run tag run” could then only require 3 waves, vibes, or qubits to be communicated instead of at least 72 bits of information. The ratio 3/72=X/100, and solving for X equals 4.16%. Accordingly, the amount of data being communicated could be reduced by about 95%. This can result in faster communication speeds, less heat production during operation which is something often associated with the fatigue and failure of electronic components, and also less energy use.

The speed of communication can also be increased by recognizing that certain letters and words are typically used more frequently than others. For example, the letters q, j, z, and x are used relatively infrequently in the English language. Letters, words, or symbols which are used less frequently can be assigned to square or sine waves having lower frequencies withing the range of frequencies and wavelengths being used for communication relative to other letters or words which are more often used. This can be related to a form of data compression which is known as Huffman Coding. In this regard, a Huffman Coding like algorithm can be made and used with letters of the alphabet, words, and also numbers. For example, the following list which was derived from an analysis of letters occurring in the main entries of the “Concise Oxford Dictionary,” 9^{th} Edition, 1995 which can be found on the website: https://www3.nd.edu/~busiforc/handouts/cryptograhy/letterfreguencies.html, ranks the frequency of use of the individual letters of the alphabet from most frequent to least frequent use: E, A, R, I, O, T, N, S, L, C, U, D, P, M, H, G, B, F, Y, W, K, V, X, Z, J, and Q. However, other rankings of alphabetical letters are possible and could be more suitable in view of the nature of the subject matter which is expected to be communicated and most common letter and word usage of a given population of users.

In the making of the associated computer software, the desired letters, words, numbers, symbols, and operations which are to be included can be provided in lists which can be included in the software application and/or the data and information and lists can be embedded or otherwise included in RAM, ROM, Flash-memory, Solid State Drive (SSD) memory, optical memory, or other form of memory in which the information can be persisted, and then be readily accessed by a computer or other data storage and communication device and user.

It is possible to communicate data and information using electronic input devices which use metal wire and digital electronic signals which are connected to a typical silicon based CPU processor chip or device and silicon based memory chip or device in a conventional electronic computer. In this regard, an oscillator circuit such as a 555 or 955 timer circuit, a quartz crystal integrated circuit, a vacuum tube oscillator, or other oscillator can be used to generate a baseline or carrier signal in the desired frequency range, and each of the possible keystrokes on a keyword or other input device can be routed to a capacitor, resistor, or other electronic component that is in communication with the oscillator circuit and which can change the frequency and wavelength of its baseline output to communicate the specific frequency and wavelength which has been assigned, coded, and mapped to the specific letter, word, number, symbol, operation or function, and then communicate this data and information to the silicon based CPU and memory chip of a conventional electronic computer which includes one or more software applications including necessary and sufficient programs, commands, and algorithms to communicate and process the data and information for a user. However, photonic and optical forms of communication, and optical, electro-optical, and/or quantum computers are capable of performing more complex computations and at faster speeds. In this regard, photons in the visible portion of the light spectrum and/or infrared light in the invisible portion of the electromagnetic spectrum can be used to communicate letters, words, symbols, numbers, operations, and functions.

Visible light falls in the range of the electromagnetic spectrum between ultraviolet and infrared light. Visible light frequencies are between about 4×10¹⁴ and 8×10¹⁴ cycles per second (Hz) or about 430-750 trillion Herz (THz), wavelengths in the range between approximately 380-740 nm. One cycle of visible light associated with wavelengths between 400-700 nm corresponds to durations in time in the range between about 1.3 and 2.3 femtoseconds. The ultraviolet light spectrum includes wavelengths in the range between approximately 10 nm and 400 nm which corresponds to frequencies in the range between approximately 30 PHz-750 THz. The infrared light spectrum includes wavelengths in the range between approximately 700 nm-1 mm and corresponds to frequencies in the range between approximately 430 THz-300 GHz. In this regard, it is known that there can be some overlap as between the visible light spectrum and the infrared and ultraviolet light spectrums. The invisible portion of the infrared light spectrum which includes near infrared has a wavelength between approximately 0.75-1.4 micrometers, short infrared has a wavelength between approximately 1.4-3 micrometers, mid-length infrared has a wavelength between approximately 3-8 micrometers, long wavelength infrared has a wavelength between approximately 8-15 micrometers, and far infrared has a wavelength between approximately 15-1,000 micrometers.

LED diodes and laser diodes can be used as a source of photons and light in the visible light spectrum and/or invisible portion of the infrared light spectrum or other invisible portion of the electromagnetic spectrum such as the ultraviolet spectrum. LED diodes emit light by spontaneous emission can be made from a semiconductor compound, e.g., gallium arsenide phosphide which can provide infrared radiation having a wavelength of approximately 850 nm. Other semiconductor compounds can be used in making LED diodes which can provide photons and light in other portions of the visible light and/or infrared light spectrums. LED diodes are available from https://www.mouser.com. Laser diodes emit light by stimulated emission and are also available in different wavelengths in the ultraviolet, visible, and infrared light spectrums. In this regard, see https://www.thorlabs.com which is the website for Thorlabs which makes many laser diodes having different wavelengths in the range between 375-2000 nm.

Lasers can be used as a source of photons and light in the visible light spectrum and/or invisible portion of the infrared light spectrum or other invisible portion of the electromagnetic spectrum. For example, so-called ultrafast lasers, femtosecond lasers, picosecond lasers, mode-locked lasers, mode-locked fiber lasers, mode-locked diode lasers, and titanium-sapphire lasers can possibly be used as a source of photons and light, and some of these lasers are capable of generating photon and light pulses which have a duration of less than five femtoseconds. In the field of optics, femtosecond pulse shaping is used to manipulate and configure the temporal domain of an ultra-short laser pulse, and/or the frequency domain of an ultra-short laser pulse the latter being obtained using the Fast Fourier Transform (FFT). In this regard, a Michelson interferometer is one example of a direct space to time pulse shaper which uses a moving mirror. Femtosecond pulse shapers can be collinear or transverse and either static or programmable. Collinear static shapers typically use a chirped mirror, whereas programmable collinear shapers use an Acousto-optic programmable dispersive filter (AOPDF). Static transverse pulse shapers typically use a stretcher/compressor, whereas programmable transverse pulse shapers use a spatial light modulator. Another method and technique for manipulating and configuring an ultrashort laser pulse is called a multiphoton intrapulse interference phase scan which can use a liquid crystal, a diffractive grating, and a spatial light modulator (SLM).

One cycle of visible light associated with wavelengths between 400-700 nm corresponds to durations in time which are the range between about 1.3 and 2.3 femtoseconds. Accordingly, some of the aforementioned lasers can possibly generate between one to four complete cycles of visible light in less than 5 femtoseconds depending of the specific visible light wavelengths. There are numerous types of lasers being used today for fiber optic transmitters, e.g., Vertical-Cavity Surface-Emitting Lasers (VCSEIs), Fabry-Perot (FP) lasers, and Distributed Feedback (DFP) lasers. In this regard, diode pumped solid state which include fibers doped with dysprosium, erbium, holmium, neodymium, praseodymium, thulium, and ytterbium can be used. For manufacturers of lasers for optical communications, see, e.g., https://www.TeraXion.com, https://www.Quantifiphotonics.com, https://www.modulight.com, and, https://www.Vitextech.com.

As previously discussed, a portion of the invisible infrared light spectrum is being used today by members of the telecom industry to transmit signals through optical fiber cable. Fiber optical cable can transmit about 100 terabytes (Tb)/second in C and L bands: the C band is between 1530-1565 nm; the L band is between 1565-1625 nm; the O band is between 1260-1360 nm, the E band is between 1360-1460 nm, the S band is between 1460-1530 nm, and the U band is between 1625-1675 nm. Digital to optical converters, and optical to digital converters, and what are often called optical transceivers are used in order to convert binary digital data into light and back again. Optical transceivers use a plurality of lasers having different specific wavelengths to convert digital signals from data switches to optical signals which can be transmitted used fiber optic cables and typically using the wavelengths between 1260-1675 nm which is an invisible portion of the infrared light spectrum.

Different types of optical transceivers which are made in different forms in accordance with the multisource agreement include, e.g., Gbic, SFP, SFP+, CFP, CFP2, CFP4, and QSFP28. In brief, there are two main kinds of optical transceivers, namely, grey or standard transceivers which are single channel devices, and single fiber bi-directional transceivers which use two different wavelength channels one to transmit and the other to receive data and information over a single optical fiber strand. Grey transceivers come in different types: short range (SR) 850 nm, long range (LR) 1310 nm, extended range 1550 nm, and further extended reach (ZR) also 1550 nm. Single fiber bi-directional transceivers typically have two channels at 1310 nm and 1550 nm, but for long distance transmission typically the two channels are at 1510 nm and 1570 nm.

The ultraviolet light spectrum is approximately between 10-400 nm. In this regard, UV-A is between 315-400 nm, UV-B is between 280-315 nm, UV-C is between 100-280 nm, near ultraviolet (N-UV) is between 300-400, middle ultraviolet (M-UV) is between 200-300 nm, far ultraviolet (F-UV) is between 122-200 nm, hydrogen Lyman-alpha is between 121-122 nm, extreme ultraviolet (E-UV) is between 10-121 nm, and vacuum ultraviolet (G) is between 10-200 nm. It is possible to use a portion of the ultraviolet spectrum to communicate data and information.

When making a computer language for use with a conventional electronic computer, an optical computer, a hybrid optical/electronic computer, and/or a quantum computer, the letters of the alphabet, words, symbols and at least some numbers can be coded and assigned different specific frequencies and wavelengths. Whether the signal is an electronic one and includes square waves, or the signal is made using sine waves which are being communicated in the visible light spectrum, invisible infrared light spectrum, or other portion of the electromagnetic spectrum, the different wave forms can be made distinguishable and separated by one or more nanometers in wavelength and/or frequency in picoseconds, femtoseconds, MHz, GHz, PHz, THz, or other detectable difference in waveform, amplitude, phase, frequency and wavelength, and/or speed so they can be detected with desired accuracy. It is possible to detect a single photon. Further, differences in color which correspond to differences in frequency and wavelength can be easily detected with an accuracy between 5-10 nanometers (nm), and even differences of a single nanometer (nm) can be detected using a light sensor and/or spectrometer. In this regard, the difference in frequency and wavelength which can be detected with a required or desired level of accuracy will here be called the desired detectable wavelength difference and be indicated in the drawing figures as (DAD). Alternately, the difference in frequency and wavelength which can be detected with a required or desired level of accuracy could also be called the desired detectable difference in frequency DDF. The desired separation in space and/or time between the end and start of different alphabetical letters, words, symbols, numbers, or commands which can be detected with a required or desired level of accuracy will here be called the desired detectable separation and be indicated in the drawing figures as (DS), and the desired difference in amplitude which can be detected with a required or desired level of accuracy will here be called the desired detectable amplitude and be indicated in the drawing figures as (DA). Communication of different letters of the alphabet, words, symbols, and numbers in the form of photons and sine waves can be made using fiber optic cables which are known to have little or no impedance.

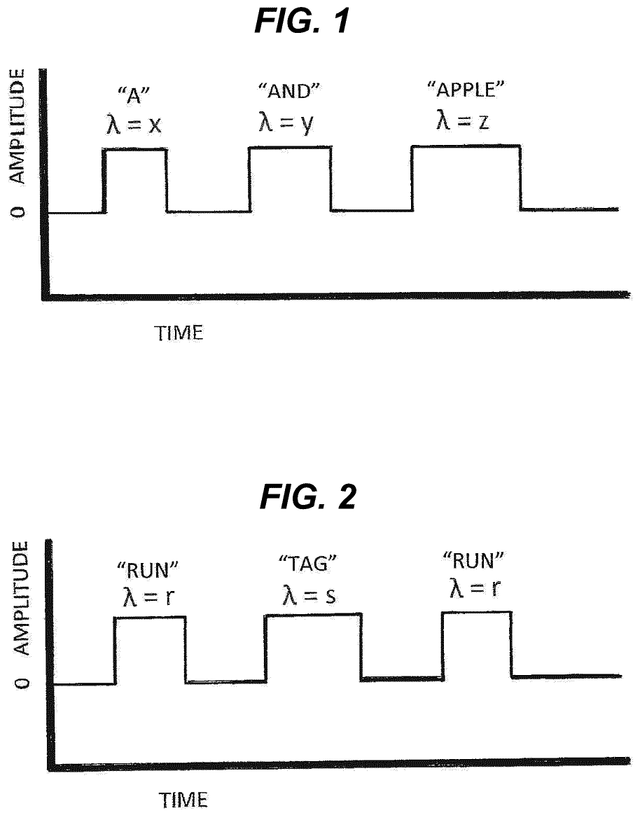

As previously discussed, there are many different forms and means of frequency modulation which have been used with radio communication and/or digital communication including, but not limited to the following: Slope detection; Ratio detection; Foster-Seeley FM discriminator; Phased Locked-Loop demodulator (PLL); Quadrature detector/demodulator; Minimum Shift Keying Modulation (MSK); and, Gaussian Minimum Shift Keying (GMSK). RF frequency synthesizers are widely used in radio communications and these include but are not limited to: Direct Analogue frequency synthesizers; Direct Digital frequency synthesizers (DDS); Indirect Analogue frequency synthesizers (analogue PPL frequency synthesis); Indirect Digital frequency synthesizers (digital PPL frequency synthesis); and Multiloop PLL Frequency Synthesizers. Some of these methods, techniques, and devices can be applied to photonic communication using the visible light spectrum and/or invisible infrared light spectrum, or other invisible portion of the electromagnetic spectrum. FIG. 1 shows a representation of the screen of an oscilloscope showing square waves representing the alphabetical letter “a” and the two words “and” and “apple.” As shown, the letter “a” is represented by a square wave having a wavelength (A) “x,” whereas the word “and” is represented by a square wave having a wavelength “y,” and the word “apple” is represented by a square wave having a wavelength “z.” As shown, the square waves can be associated with an electronic form of communication which is not based solely on detecting differences in amplitude, but rather on detecting differences in the frequency and wavelength of the square waves. Alternatively, other forms of waves can be used, such as triangular or sawtooth waves.

In brief, instead of using the amplitude of square waves to communicate binary digital data and information in the form of a series of 0's and 1's, the frequency and wavelength of square waves or other wave forms are being changed and/or modulated to communicate data and information. It is possible to detect the start or rise and end or fall of a square wave or other wave form, e.g., using an oscilloscope which can include an adjustable trigger threshold, and so the length of any given wave form can be detected and known. At this time, there are a number of software applications for oscilloscopes which can be installed and used on Windows PCs, e.g., “Winscope,” “Soundcard Oscilloscope,” “Oscilloscope,” “Real-Time Spectrum,” “VisualAnalyser,” “Analog Discovery 2,” and “Frequency Analyser,” which are reviewed in the article entitled: “7 Best Oscilloscope Software for Windows,” by Ivan Jenic, published Apr. 15, 2020, on the website: https://windowsreport.com/oscilloscope-software-pc-laptop. Other forms of frequency modulation have been used with radio communication, and similar techniques can be applied to the detection of electronic wave forms and/or photonic or optical wave forms which can be used to communicate data and information in a computer environment. For the sake of simplicity, the possibility of having square waves which could also include a negative portion that would appear on or below what is called the 0 and/or reference line are not shown in the drawing figures which are provided and discussed in this disclosure.

FIG. 2 shows a representation of the screen of an oscilloscope showing square waves representing the three words “run tag run.” The word “run” is represented by a square wave having a wavelength “r” and the word “tag” is represented by a square wave having a wavelength “s.” As shown, the square waves can be associated with an electronic form of communication which is not based solely on detecting differences in amplitude, but rather on detecting differences in the frequency and wavelength of the square waves. Alternatively, other forms of waves can be used, such as triangular or sawtooth waves.

FIG. 3 shows a representation of the screen of an oscilloscope showing sine waves representing an alphabetical letter “a” and the two words “and” and “apple.” As shown, the letter “a” is represented by a sine wave having a wavelength “x,” whereas the word “and” is represented by a sine wave having a wavelength “y,” and the word “apple” is represented by a sine wave having a wavelength “z.” The use of the term “sine wave” in this disclosure shall be used to broadly refer to any sine wave form such a sine wave, a cosine wave, or analog wave form which is smooth and continuous, whereas square waves are stepping, square, and discrete. Sine waves can be associated with a form of sound or audio communication and/or a form of photonic and optical communication. In this regard, it is possible for sound or audio communication to be converted to photonic or optical communication, and vice-versa. Perhaps, the first example of such a device is taught in U.S. Pat. No. 235,199 by Alexander Graham Bell, and this patent is hereby incorporated by reference herein, and also see, e.g., Light Modulator, by Grand Illusions, Mar. 1, 2019, https://youtu.be/7bh1aeTFDzA?si=2_Nle7dx9Z6ymH21, and, The Light Modulator, by Make Science Run, Jun. 8, 2018, https://youtu.be/-rx779tOVrM?si=5Mf7SBZJk9CSIsmr. Further, the sound track of feature films is optically embedded in the film substrate, and in the past this process was synchronized using a movieola device. The sound track(s) on feature films is later converted into audio output with the use of optical-electrical converters included in the film projectors used in movie theaters so that it can be heard.

FIG. 4 shows a representation of the screen of an oscilloscope showing sine waves representing the three words “run tag run.” The word “run” is represented by a sine wave having a wavelength “r” and the word “tag” is represented by a sine wave having a wavelength “s.” As shown, the sine waves can be associated with an electronic form of communication which is not based solely on detecting differences in amplitude, but rather on detecting differences in the frequency and wavelength of the sine waves.

### Representing Numbers

The use of the binary number system and digital communication for representing numbers and operations in computer languages can result in certain inaccuracies, and also consume substantial memory. When using the binary number system with a computer each number between 1-10 requires 8 bits or one byte of information. Most individuals do not use many large numbers in their daily communications, but scientists often do so and computers now use the binary system and digital methods in order to communicate numbers and perform calculations. In order to improve the speed of transmission and processing of the large numbers of bits which are typically used in digital communication, various means and methods of bit-rate reduction and/or data compression have been created and used. For example, Lempel-Ziv-Welch (LZW), MP3, discrete cosine transform (DCT), JPEG, Blue Ray, and Dolby True HD are some examples of communication formats which use different forms of data compression.

It is possible to assign to each commonly used value or number in a given base number system a specific frequency and wavelength which can then serve as its code to represent and communicate the individual value or number. Most individuals do not often use numbers having a value greater than one million, and numbers having a value less than 1,000 are the most commonly used. Accordingly, for some software applications and user populations encoding a relatively small and finite number of values and numbers can be efficacious. However, because there are infinite numbers in the mathematical universe, assigning to each number a specific frequency and wavelength of a square or sine wave in order to identify and code a number could be impractical or impossible, that is, depending on how many numbers are to be represented and encoded. Accordingly, there is a need for other efficient ways to represent and communicate numbers.

Before modern electronic calculators and computers were made available to the general public in the 1970's, slide rule devices, and logarithms which were first developed by John Napier in 1614 were commonly used to simplify mathematical calculations. In brief, a logarithm is the inverse function to exponentiation. The logarithm of a number x is the exponent to which another number which is known as the base must be raised to produce that number x. For example, the notation log₂ 8=3 which is 2×2×2 or 2³=8 is an example of a binary logarithm. The logarithm which uses base number 10 is called the decimal or common logarithm and is often used in science and engineering. The so-called natural logarithm uses the base number e=2.718 and it is often used in the fields of mathematics and physics. Many calculations can be simplified by using logarithms. For example, the multiplication or product of log_{b} (xy)=log_{b} x+log_{b} y; the division or quotient of log_{b} x/y=log_{b} x−log_{b} y; the power of log_{b} x^{p}=p log_{b} x; and the root of log_{b} ^{p}√/x=log_{b} x/p. Tables of logarithms were created by Henry Biggs in 1617, and then were later greatly expanded. Logarithms, and various mathematical equations and operations using them, as well as large tables of logarithms can be written and placed into a computer language, code, and related algorithms. As discussed earlier in the background section, the speed and efficiency of modern computer chips and computers is beginning to encounter certain limitations. Accordingly, the use of exponential and/or logarithm representation of numbers and also simple mathematical operations such as addition, subtraction, multiplication, and division can help to provide for the development of methods and processes for reducing the amount of data which is presently required and commonly being used to represent and communicate numbers. In number theory, the decomposition of a composite number into a product of smaller integers is called integer factorization. If and when these factors are restricted to prime numbers the process is called prime factorization. When the numbers being factored are sufficiently large, there is currently no known efficient algorithm which can run on a classical or conventional computer to calculate these factors in polynomial time, that is, in a timely manner. In order to introduce this subject and disclose an alternative method of compressing data and representing numbers, here are some values and/or numbers between 0-100: 0; 1; and there exist 26 prime numbers between 0-100, namely, 2, 3, 5, 7, 11, 13, 17, 19, 23, 29, 31, 37, 41, 43, 47, 53, 59, 61, 67, 71, 73, 79, 83, 89, and 97. All of the rest of the numbers between 0-100 are composite numbers. In this regard, the composite numbers between 0-100 can be expressed by 14 prime numbers, namely, 2, 3, 5, 7, 11, 13, 17, 19, 23, 29, 37, 41, 43, and 47, as discussed and shown below. In brief, besides the values or numbers 0 and 1 only 24 prime numbers are required to express all values and numbers between 0-100, which is a total of 26 values and/or numbers. This can be used to perform what is here called prime number data compression. 101 values or numbers minus 26 values or numbers equals a reduction of 75 values or numbers which is approximately 75%. Accordingly, it is possible to use a form of prime factorization to reduce what can be seen as the redundancy associated with having to express each individual composite number. While classical computers have lacked the computing power and speed to perform integer and/or prime factorization in polynomial time, something which is typically calculated using what is called Big O Notation, quantum computers which can use Peter Shor's Algorithm created in 1994 are capable of performing such tasks, e.g., see the article “How Peter Shor's Algorithm Dooms RSA Encryption To Failure,” by John Loeffler, published May 2, 2019, on the website: https://interestingengineering.com/how-peter-shors-algorithm-dooms-rsa-encrytion-to-failure. In this regard, the numbers 2 and 3 are the most often used prime number factors when expressing composite numbers up to 100. For example, here are some of the possible factors that can be used to represent and produce composite numbers up to 100.

### Prime Number Data Compression

$$2 \times 2 = 4 \qquad {2}^{2} = 4$$

$$2 \times 3 = 6$$

$$2 \times 2 \times 2 = 8 \qquad {2}^{3} = 8$$

$$3 \times 3 = 9 \qquad {3}^{3} = 9$$

$$2 \times 5 = 10$$

$$2 \times 2 \times 3 = 12 \qquad {2}^{2} \times 3 = 12$$

$$2 \times 7 = 14$$

$$3 \times 5 = 15$$

$$2 \times 2 \times 2 \times 2 = 16 \qquad {2}^{4} = 16$$

$$2 \times 3 \times 3 = 18 \qquad 2 \times {3}^{2} = 18$$

$$2 \times 2 \times 5 = 20 \qquad {2}^{2} \times 5 = 20$$

$$3 \times 7 = 21$$

$$2 \times 11 = 22$$

$$2 \times 2 \times 2 \times 3 = 24 \qquad {2}^{3} \times 3 = 24$$

$$5 \times 5 = 25 \qquad {5}^{2} = 25$$

$$2 \times 13 = 26$$

$$3 \times 3 \times 3 = 27 \qquad {3}^{3} = 27$$

$$2 \times 2 \times 7 = 28 \qquad {2}^{2} \times 7 = 28$$

$$2 \times 3 \times 5 = 30$$

$$2 \times 2 \times 2 \times 2 \times 2 = 32 \qquad {2}^{5} = 32$$

$$3 \times 11 = 33$$

$$2 \times 17 = 34$$

$$2 \times 2 \times 3 \times = 36 \qquad {2}^{2} \times {3}^{2} = 36$$

$$2 \times 19 = 38$$

$$2 \times 2 \times 2 \times 5 = 40 \qquad {2}^{3} \times 5 = 40$$

$$2 \times 3 \times 7 = 42$$

$$2 \times 2 \times 11 = 44 \qquad {2}^{2} \times 11 = 44$$

$$3 \times 3 \times 5 = 45 \qquad {3}^{2} \times 5 = 45$$

$$2 \times 23 = 46$$

$$2 \times 2 \times 2 \times 2 \times 3 = 48 \qquad {2}^{4} \times 3 = 48$$

$$2 \times 5 \times 5 = 50 \qquad 2 \times {5}^{2} = 50$$

$$2 \times 2 \times 13 = 52 \qquad {2}^{2} \times 13 = 52$$

$$2 \times 3 \times 3 \times 3 = 54 \qquad 2 \times {3}^{3} = 54$$

$$5 \times 11 = 55$$

$$2 \times 2 \times 2 \times 7 = 56 \qquad {2}^{3} \times 7 = 56$$

$$2 \times 29 = 58$$

$$2 \times 2 \times 3 \times 5 = 60 \qquad {2}^{2} \times 3 \times 5 = 60$$

$$2 \times 31 = 62$$

$$3 \times 21 = 63$$

$$2 \times 2 \times 2 \times 2 \times 2 \times 2 = 64 \qquad {2}^{5} = 64$$

$$5 \times 13 = 65$$

$$2 \times 3 \times 11 = 66$$

$$2 \times 2 \times 17 = 68 \qquad {2}^{2} \times 17 = 68$$

$$3 \times 23 = 69$$

$$2 \times 5 \times 7 = 70$$

$$2 \times 2 \times 2 \times 3 \times 3 = 72 \qquad {2}^{3} \times {3}^{2} = 72$$

$$2 \times 37 = 74$$

$$3 \times 5 \times 5 = 75 \qquad 3 \times {5}^{2} = 75$$

$$2 \times 2 \times 19 = 76 \qquad {2}^{2} \times 19 = 76$$

$$7 \times 11 = 77$$

$$2 \times 3 \times 13 = 78$$

$$2 \times 2 \times 2 \times 2 \times 5 = 80 \qquad {2}^{4} \times 5 = 80$$

$$3 \times 3 \times 3 \times 3 = 81 \qquad {3}^{4} = 81$$

$$2 \times 41 = 82$$

$$2 \times 2 \times 3 \times 7 = 84 \qquad {2}^{2} \times 3 \times 7 = 84$$

$$5 \times 17 = 85$$

$$2 \times 43 = 86$$

$$3 \times 29 = 87$$

$$2 \times 2 \times 2 \times 11 = 88 \qquad {2}^{3} \times 11 = 88$$

$$2 \times 3 \times 3 \times 5 = 90 \qquad 2 \times {3}^{2} \times 5 = 90$$

$$7 \times 13 = 91$$

$$2 \times 2 \times 23 = 92 \qquad {2}^{2} \times 23 = 92$$

$$3 \times 31 = 93$$

$$2 \times 47 = 94$$

$$5 \times 19 = 95$$

$$2 \times 2 \times 2 \times 2 \times 2 \times 3 = 96 \qquad {2}^{5} \times 3 = 96$$

$$2 \times 7 \times 7 = 98 \qquad 2 \times {7}^{2} = 98$$

$$3 \times 3 \times 11 = 99 \qquad {3}^{2} \times 11 = 99$$

$$2 \times 2 \times 5 \times 5 = 100 \qquad {2}^{2} \times {5}^{2} = 100$$

Even if and when the desire is to express composite numbers in the binary base 2 number system, this same method of data compression can be used. Data Compression Using the Values and/or Numbers: 0, 1, 2, 2ⁿ, 3, 3ⁿ. All of the values and numbers between 0-100 can be expressed by the following: 0, 1, 2, 2², 2³, 2⁴, 2⁵, 2⁶, 3, 3², 3³, 3⁴, and the use of addition. Here are the values and numbers between 0-100 showing some of the possible prime number combinations which provide solutions:

$$0$$

$$1$$

$$2$$

$$3$$

$$4 = {2}^{2}$$

$$5 = 2 + 3$$

$$6 = {2}^{2} + 2$$

$$7 = {2}^{2} + 3$$

$$8 = {2}^{3}$$

$$9 = {3}^{2}$$

$$10 = {2}^{3} + 2$$

$$11 = {3}^{2} + 2$$

$$12 = {3}^{2} + 3 \qquad or {2}^{3} + 2$$

$$13 = {3}^{2} + {2}^{2}$$

$$14 = {3}^{2} + 3 + 2 \qquad or {2}^{3} + {2}^{2} + 2$$

$$15 = {3}^{2} + {2}^{2} + 2$$

$$16 = {2}^{4}$$

$$17 = {3}^{2} + {2}^{3}$$

$$18 = {3}^{2} + {3}^{2}$$

$$19 = {2}^{4} + 3$$

$$20 = {2}^{4} + {2}^{2}$$

$$21 = {3}^{2} + {2}^{3} + {2}^{2}$$

$$22 = {2}^{3} + {2}^{2} + 2$$

$$23 = {2}^{3} + {2}^{2} + 3$$

$$25 = {3}^{2} + {2}^{4} \qquad or {5}^{2}$$

$$26 = {3}^{2} + {3}^{2} + {2}^{3}$$

$$27 = {3}^{3}$$

$$28 = {2}^{4} + {2}^{3} + {2}^{2}$$

$$29 = {3}^{3} + 2$$

$$30 = {3}^{3} + 3$$

$$31 = {3}^{3} + {2}^{2}$$

$$32 = {2}^{5}$$

$$33 = {3}^{2} + {2}^{4} + {2}^{3}$$

$$34 = {3}^{2} + {3}^{2} + {2}^{4}$$

$$35 = {3}^{3} + {2}^{3}$$

$$36 = {2}^{5} + {2}^{2}$$

$$37 = {3}^{2} + {2}^{4} + {2}^{3}$$

$$38 = {3}^{3} + {2}^{3} + 3$$

$$39 = {3}^{3} + {2}^{4} + {2}^{2}$$

$$40 = {2}^{5} + {2}^{2}$$

$$41 = {3}^{2} + {2}^{5}$$

$$42 = {3}^{2} + {3}^{2} + {2}^{4} + {2}^{3} \qquad or {2}^{5} + {2}^{3} + 2$$

$$43 = {3}^{3} + {2}^{4}$$

$$44 = {2}^{5} + {2}^{3} + {2}^{2}$$

$$45 = {3}^{2} + {2}^{5} + {2}^{2}$$

$$46 = {2}^{5} + {2}^{3} + {2}^{2} + 2$$

$$47 = {3}^{3} + {2}^{4} + {2}^{2}$$

$$48 = {2}^{5} + {2}^{4}$$

$$49 = {3}^{2} + {2}^{5} + {2}^{3}$$

$$50 = {3}^{2} + {3}^{2} + {2}^{5}$$

$$51 = {3}^{3} + {2}^{3} + {2}^{4}$$

$$52 = {2}^{5} + {2}^{4} + {2}^{2}$$

$$53 = {3}^{2} + {2}^{5} + {2}^{3} + {2}^{2}$$

$$54 = {3}^{3} + {3}^{3}$$

$$53 = {3}^{2} + {2}^{5} + {2}^{3} + {2}^{2}$$

$$54 = {3}^{3} + {3}^{3}$$

$$55 = {3}^{3} + {2}^{4} + {2}^{3} + {2}^{2}$$

$$56 = {2}^{5} + {2}^{4} + {2}^{3}$$

$$57 = {3}^{2} + {2}^{5} + {2}^{4}$$

$$58 = {3}^{3} + {3}^{2} + {2}^{2} + 2$$

$$59 = {3}^{3} + {2}^{5}$$

$$60 = {2}^{5} + {2}^{4} + {2}^{3} + {2}^{2}$$

$$61 = {3}^{3} + {2}^{5} + 2 \qquad or {3}^{2} + {2}^{5} + {2}^{4} + {2}^{2}$$

$$62 = {3}^{3} + {3}^{3} + {2}^{3}$$

$$63 = {3}^{3} + {2}^{5} + {2}^{2}$$

$$64 = {2}^{5}$$

$$66 = {2}^{5} + 2$$

$$\begin{matrix}67 = {2}^{5} + 3 & or {3}^{3} +\end{matrix} {3}^{3} + {3}^{2} + {2}^{2}$$

$$68 = {2}^{5} + {2}^{2}$$

$$69 = {2}^{5} + 3 + 2$$

$$70 = {2}^{5} + {2}^{2} + 2$$

$$71 = {3}^{3} + {3}^{2} + {2}^{5} + 3$$

$$72 = {2}^{5} + {2}^{3}$$

$$73 = {3}^{2} + {2}^{5}$$

$$74 = {3}^{3} + {3}^{2} + {2}^{5} + {2}^{4}$$

$$75 = {3}^{3} + {2}^{5} + {2}^{4} {5}^{3} \qquad or {5}^{3}$$

$$76 = {3}^{3} + {3}^{2} + {2}^{5} + {2}^{3}$$

$$77 = {3}^{2} + {2}^{5} + {2}^{2}$$

$$78 = {3}^{3} + {3}^{3} + {2}^{5} + 2$$

$$79 = {3}^{3} + {2}^{5} + {2}^{4} + {2}^{2}$$

$$80 = {2}^{5} + {2}^{4}$$

$$81 = {3}^{4}$$

$$82 = {3}^{2} + {3}^{2} + {2}^{5}$$

$$83 = {3}^{4} + 2$$

$$84 = {2}^{5} + {2}^{4} + {2}^{2}$$

$$85 = {3}^{4} + {2}^{2}$$

$$86 = {3}^{4} + 2 + 3$$

$$87 = {3}^{4} + {2}^{2} + 2$$

$$88 = {2}^{5} + {2}^{4} + {2}^{3}$$

$$89 = {3}^{4} + {2}^{3}$$

$$90 = {3}^{4} + {3}^{2}$$

$$91 = {3}^{3} + {2}^{5}$$

$$92 = {2}^{5} + {2}^{4} + {2}^{3} + {2}^{2}$$

$$93 = {3}^{2} + {2}^{5} + {2}^{4} + {2}^{2}$$

$$94 = {3}^{4} + {3}^{2} + {2}^{2}$$

$$95 = {3}^{3} + {2}^{5} + {2}^{2}$$

$$96 = {2}^{5} + {2}^{5}$$

$$97 = {3}^{4} + {2}^{4}$$

$$98 = {3}^{3} + {2}^{5} + {2}^{2} + 3$$

$$99 = {2}^{5} + {2}^{5} + 3$$

$$100 = {3}^{4} + {2}^{4} + 3$$

In fact, all positive whole numbers can be expressed by the values and numbers 0, 1, 2, 2ⁿ, 3, 3ⁿ, and the use of addition. For example, here is the number 678=3⁵+3³+2⁸+2⁷+2⁴+2³. The number 678 can be represented by 6 sine waves, vibes, or qubits, plus 5 more for the plus signs for a total of 11 waves, vibes, or qubits. However, when it would be understood and/or programmed with computer software that the series of numbers or values would be added then only 6 waves, vibes, quwaves, quvibes, or qubits would be required, whereas the same number in binary is 01010100110 which is 11 bits. It is common to represent large numbers by indicating their nth exponential power in base 10, e.g., one million=1×10⁶. This discussion and the examples show that it is possible to represent a positive number in some combination of the values or numbers 0, 1, 2, 2ⁿ, 3, 3ⁿ. For example, in order to represent all numbers between 0-678, only the values and/or numbers 0, 1, 2, 2² 2³, 2⁴, 2⁵, 2⁶, 2⁷, 2⁸, 3, 3², 3³, 3⁴ (and perhaps a few more exponential powers of 2 and 3) would be required, thus a total of only about 14 different values and numbers. Accordingly, it is possible to use 0, 1, 2, 2ⁿ, 3, 3ⁿ in order to represent positive numbers and the number of bits and amount of processing time and memory normally required to do so can sometimes then be reduced relative to the current at least 8 bit per number method that is being widely used today. This method of using the values and numbers 0, 1, 2, 2ⁿ, 3, 3ⁿ as factors can sometimes be efficient, and then be referred to as bitwise for certain tasks when using a classical or conventional computer, and one of these tasks could be to identify the factors of a large number, and in particular, a large prime number.

$${2}^{10} = 1 , 024 {3}^{10} = 59 , 049$$

$${3}^{20} = 3 , 486 , 784 , 401$$

In binary language, the number 3,486,784,401 is: 0110011111110101000001101110010001 which is 34 bits. Each of these values and/or numbers can be communicated using either a square wave having a specific frequency and wavelength which is conducive to digital communication, and/or a sine wave having a specific frequency and wavelength which is conducive to optical communication and also optical and quantum computing. In either case, only 1 or 2 photonic or optical waves, vibes, quwaves, quvibes, or qubits would be required to represent 3²⁰ which is equal to 3,486,784,401 and coded as 0110011111110101000001101110010001 in binary notation. Instead of only using of the values and numbers 0, 1, 2, 2ⁿ, 3, 3ⁿ, the prime number 5, 5ⁿ, or other larger numbers could also be used in order to reduce the number of bits required to express larger numbers.

$${5}^{10} = 9 , 765 , 625$$

$${5}^{20} = 95 , 367 , 431 , 600 , 000$$

Accordingly, it is possible to represent very large numbers without using exponents which have values greater than 20. The numbers 0, 1, 2, 2ⁿ, 3, 3ⁿ, 5, 5ⁿ with n up to the 20^{th} power can be placed into ROM, RAM, Flash, Solid State Drive (SSD) and/or optical memory, or other means of persisting data and information. This does not require the listing or storage of many different values and numbers. Obviously, other prime numbers and their exponential forms can be used to represent large numbers. Accordingly, the present disclosure relates to the development of a language and code for software development to perform mathematical computations on a conventional CPU logic chip, an optical CPU logic chip, a hybrid CPU logic and memory chip, a hybrid optical CPU logic and memory optical chip, or a hybrid CPU logic chip and optical memory chip or device, or vice-versa, using a form of data compression. As a result, the length of resulting digital and/or optical communications and the power required to make calculations can be reduced and processing speed increased. In this regard, one example of a hybrid and combined logic and memory chip is now being called a processing in memory (PIM) circuit or chip which uses neural networks and resistive random access memory (RRAM-PIM) to process and persist data and information, as discussed in the article “Research Brings Analog Computers Just One Step From Digital,” by Brandie Jefferson published by Techxplore.com on Dec. 8, 2021: https://techxplore.com/news/2021-12-analog-digital.html. Square waves or sine waves can be used to represent and encode both the base portion of a number and also the exponent portion.

In this regard, it may be helpful to discuss some of the common terminology which is used when representing and discussing numbers both within the specification of this patent application, and also elsewhere. When using the decimal system which is base 10, one or more single digits which are in the range between and including the digits 0-9 are typically used to represent what is called the base or base portion of a number. For example, only one digit is typically required to represent and communicate the number 7, and that digit is 7 and this portion of the number 7 can and will be called the base portion of the number 7 in this specification. The exponent portion of the number 7 in base 10 can be written as 7 to the 0 index, exponent, or power of 10 or 7×100 which is simply 7 because any number to the 0 exponent, index, or power such as 10⁰ is simply 1, and 7×1=7. However, for the sake of simply, and by convention we do not typically discuss or need to represent this level of complexity when indicating or communicating simple and relatively small numbers. Further, in order to make clear the meaning and typical use of this terminology when it is used to discuss, represent, and communicate numbers which include multiple digits, e.g., the number 144, this number includes three digits, namely, 1, 4, and 4 and moving from left to right 1 is then associated with the index and power of 2, that is, 1×10² which is 100, and 4 is then associated with the index and power of 1, that is, 4×10¹ which is 40, and the last 4 on the right is associated with the index and power of 0, that is 4×10⁰ which is 4, and these three digits in these positions are then commonly used to represent and communicate the larger number in a positional number system which is simply represented as 144. In this regard, also see the discussion below relating to FIG. 49 which shows the number 2793, and its associated index, and digits.

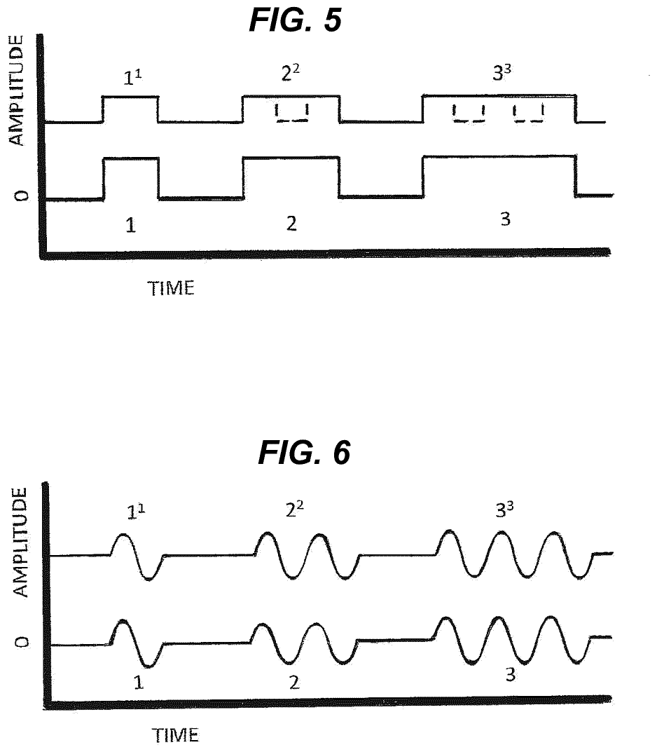

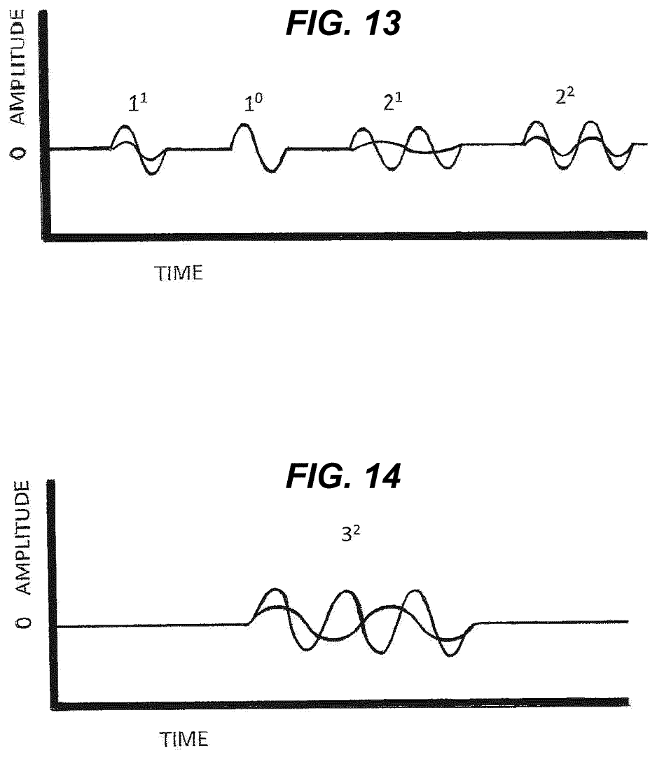

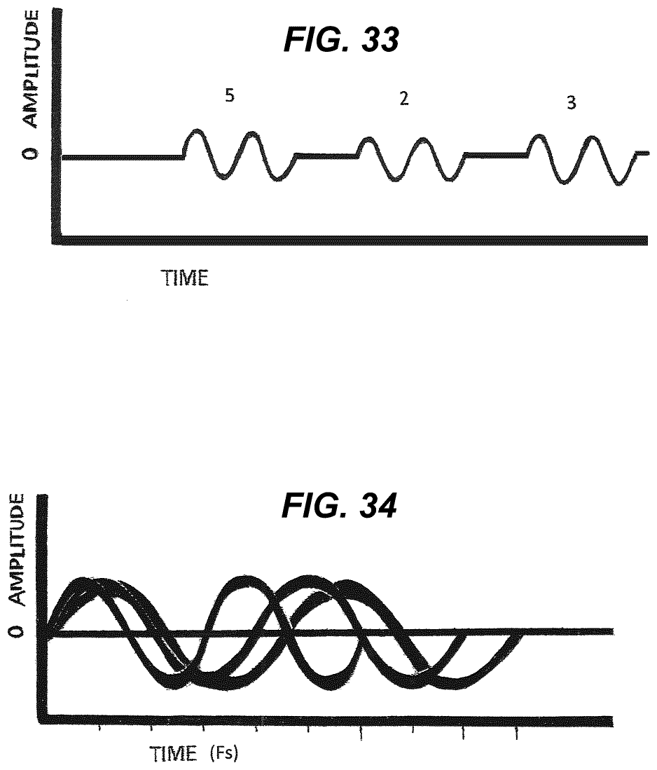

In drawing FIGS. 5-12, 15, and 16, for the sake of simplicity and in order to facilitate understanding and comprehension for the readers of this disclosure the base portion and the exponent portions of various numbers are shown on two separate lines which resemble two different signal channels as could be seen on an oscilloscope. It can be readily understood that if the wave forms shown in FIGS. 5-12, 15, and 16 on the two lines would be added and combined there would instead be one or more resultant wave forms shown on a single line. Drawing FIGS. 13-14, 25, and 26 show sine waves representing the base portion and exponent portions of various numbers individually on a single line. It can be readily understood that if the sine waves showing the base portions and exponent portions in FIGS. 13-14, 25, and 26 would be added and combined then one or more larger resultant sine waves could then be derived and shown on a single line. Drawing FIGS. 32-33 show the numbers 5, 2, 3 represented as individual sine waves on a single line. It can be readily understood that if the three numbers 5, 2, 3 would be summed together and/or communicated at the same time then one or more larger resultant sine wave could be derived and shown on a single line.

When multiple individual wave forms are combined to derive and create a resultant wave form the frequencies of the individual wave forms can nevertheless be known, represented and communicated using the Fast Fourier Transform (FFT) Algorithm which computes the discrete Fourier Transform (DFT) of a sequence, or its inverse which is called the inverse discrete Fourier Transform (IDFT). The Faster Fourier Transform FFT is widely used in engineering, mathematics, music, and science, e.g., see https://en.wikipedia.org/wiki/Fast (Fourier Transform), https://youtu.be/h7apO7q16V0, and the Lecture Collection entitled “The Fourier Transforms and Its Applications,” by Professor Brad Osgood of Stanford University which includes 30 lectures, the following Youtube links being to Lectures 1-5: https://youtu.be/gZNm7L96pfY, https://youtu.be/1rqJI7Rs6ps, https://youtu.be/BjBb5llrNsQ, https://youtu.be/n5lBM7nn2eA_, and https://youtu.beggRpgfQld4. For information on using the Fast Fourier Transform FFT Algorithm with the Java computer language, see, e.g., the article “Fun With Java, Understanding the Fast Fourier Transform (FFT) Algorithm,” by Richard G. Baldwin published Jan. 5, 2005, on the website, https://developer.com/java/fun-with-Java-understanding-the-fast-fourier-transform-fft-algorithm/; “FFT.java,” published on the website, https://introcs.cs.princeton.edu/java/97data/FFT.java.html_, by Princeton University, author unknown, on Jan. 14, 2020; and, “FFT in Java,” published on the website, https://www.imaging.utk.edu/research/inarvaez/ece572/reports/FFTjava%20tips.pdf, by Ingrid Narvaez, of the University of Tennessee. Accordingly, data and information in wave form can be represented and communicated with the amplitude being shown on the vertical axis and time being shown on the horizontal axis of a graph, and the data and information can possibly include a plurality of individual wave forms which may overlap one another and then form one or more resultant wave forms, but with the use of the Fast Fourier Transform the data and information can be processed and represented to show amplitude on the x axis and frequency on the y axis of a graph, or another other tangible medium of expression in order to represent and show the individual frequencies of the plurality of individual wave forms which are included in the resultant wave forms. For example, see drawing FIGS. 34-36 and related discussion of this subject in greater detail below. In this regard, it is possible to communicate a plurality of letters, words, symbols, numbers, or commands, simultaneously, or nearly so, using photons and visible light and/or invisible infrared light, or other invisible light portions of the electromagnetic spectrum, and the individual wave forms and frequencies which have been assigned and coded to represent each letter, word, symbol, number, or command can be represented, identified, read and understood by a user of a computer or other data storage and processing device which includes a software application which includes a compilation of programs, codes, lists, tables, arrays, algorithms, commands for processing, manipulating, and storing data and information. While the use of an optical computer, electro-optical hybrid computer, or quantum computer can provide for higher processing speeds and the ability to perform more complex calculations and operations, the use of square waves and digital communication using the binary system can also be used to represent and process data and information in the temporal domain and the Fast Fourier Transform can then be used to show information in the frequency domain.

FIG. 5 shows a representation of the screen of an oscilloscope showing large square waves representing the base portion of numbers 1, 2, and 3, and small square waves representing the exponent portion of the numbers. As shown, the value of the exponent portion can be communicated in a single block or multiple portions which are shown in phantom dashed lines. FIG. 6 shows a representation of the screen of an oscilloscope showing large sine waves representing the base portion of numbers 1, 2, and 3, and small sine waves representing the exponent portion of the numbers.

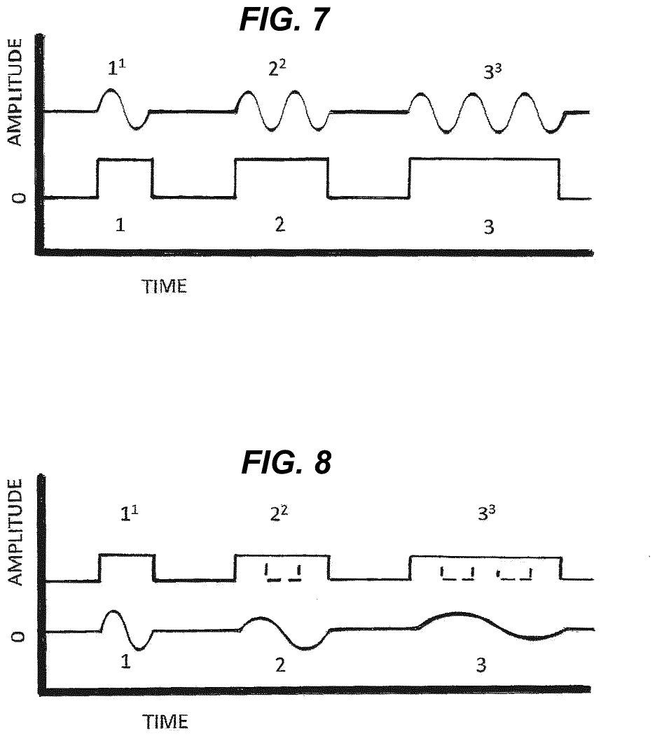

Alternatively, it is possible to combine both a square wave and sine wave in communication and then use, e.g., a sine wave to represent the base portion of a number and a square wave to represent the exponent portion, or vice-versa. In this regard, FIG. 7 shows a representation of the screen of an oscilloscope showing large square waves representing the base portion of numbers 1, 2, and 3, and sine waves representing the exponent portion of the numbers. FIG. 8 shows a representation of the screen of an oscilloscope showing sine waves representing the base portion of numbers 1, 2, and 3, and square waves representing the exponent portion of the numbers.

As shown in FIG. 5, a square wave having an amplitude and wavelength can be used to represent the base portion of the number 1 and a smaller square wave can be used to represent its exponent portion 1, thus the value of the number in view of its exponent is 1. Further, a square wave having a different wavelength can be used to represent the base portion of the number 2 and either one or two smaller square waves can be used to represent its exponent 2, thus the value of the number in view of the exponent is 4. In addition, a square wave having a different wavelength can be used to represent the base portion of the number 3, and either one or three smaller square waves can be used to represent its exponent 3, thus the value of the number in view the exponent is 27: 1¹=1, and 2²=4, and 3³=27, and so a sum of these three numbers would be 32. In this example, it can be seen that the frequency and wavelength of the square waves representing the base portion of the numbers 1, 2, and 3 are proportional, but this need not be the case.

As shown in FIG. 6, a sine wave having an amplitude and wavelength can be used to represent the base portion of the number 1 and a smaller sine wave can be used to represent its exponent 1, thus the value of the number in view of its exponent is 1. Further, a sine wave having a different wavelength can be used to represent the base portion of the number 2 and two smaller sine waves can be used to represent its exponent 2, thus the value of the number in view of the exponent is 4. In addition, a sine wave having a different wavelength can be used to represent the base portion of the number 3, and three smaller sine waves can be used to represent the exponent 3: 1¹=1, and 2²=4 and 3³=27, and so the sum of these three numbers would be 32. In this example, it can be seen that the frequency and wavelength of the sine waves representing the base portion of the numbers 1, 2, and 3 are proportional, but this need not be the case.

As shown in FIG. 7, the same kind of thing can be done using square waves to represent the base and sine waves to represent the exponent of a number: 1¹=1, and 2²=4, and 3³=27. If and when desired, the sum of these three numbers would be 32. In this example, it can be seen that the frequency and wavelength of the sine waves representing the base portion of the numbers 1, 2, and 3 are proportional, but this need not be the case. Further, it would not typically be the case that a digital square wave would be used to communicate one portion of the value of a number, and then a sine wave be used to represent another portion of the value of a number, at least not unless the information was being processed in series or parallel and then possibly by hybrid chip that would be capable of both a digital and optical processing capability. Alternatively, it can be readily understood that if the sine waves having values 1¹=1, and 2²=4, and 3³ would instead be changed to have the values 1, 2, and 3 in this drawing figure, then drawing FIG. 7 could be used to show a possible conversion of data and information from a digital format which uses square waves to an analog one which uses sine waves.

As shown in FIG. 8, the same kind of thing can be done using sine waves to represent the base and square waves to represent the exponent: 1¹=1, and 2²=4, and 3³=27. If and when desired the sum of these three numbers would be 32. In this example, it can be seen that the frequency and wavelength of the sine waves representing the base portion of the numbers 1, 2, and 3 are proportional, but this need not be the case. Once again, it would not typically be the case that a digital square wave would be used to communicate one portion of the value of a number, and then a sine wave be used to represent another portion of the value of a number, at least not unless the information was being processed in series or parallel and then possibly by hybrid processor device that would be capable of both a digital and optical processing capability. Alternatively, it can be readily understood that if the values 1¹=1, and 2²=4, and 3³ would be changed to 1, 2, and 3 in this drawing figure, then drawing FIG. 8 could be used to represent a possible conversion of data and information from a digital format which uses square waves to an analog one which uses sine waves.

Again, 3²⁰=3,486,784,401. In binary, this number is coded and represented as: 0110011111110101000001101110010001 which is 34 bits. However, a sine wave having a specific frequency and wavelength could be used to represent and communicate the base number 3 in 3²⁰, and a different sine wave having a specific frequency and wavelength which can be communicated nearly or actually simultaneously could be used to represent the exponent 10²⁰. This would only require one or two waves, vibes or qubits of information, as opposed to the 34 bits of information required when using the binary system.

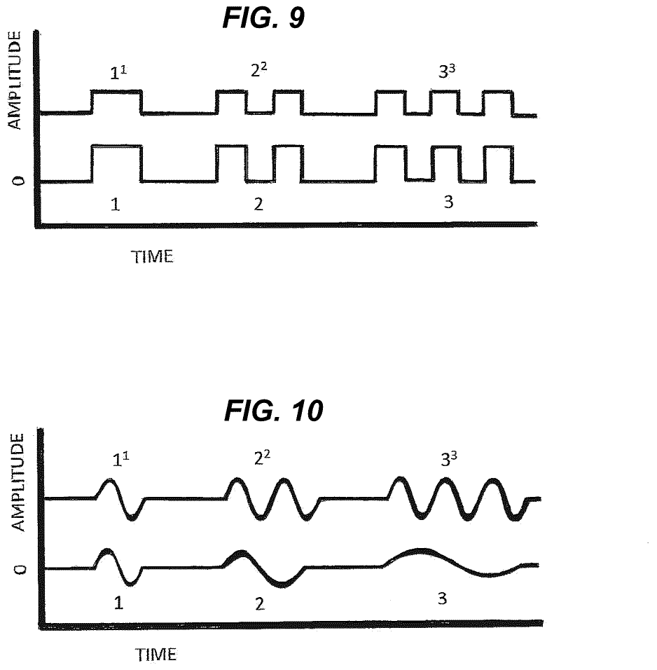

FIG. 9 shows a representation of the screen of an oscilloscope showing multiple square waves representing the base portion of numbers 1, 2, and 3, and also small square waves representing the exponent portion of the numbers. In this case, the number of cycles of the base portion of the number represent the value of the base number, and the number of cycles of the exponent representing the exponent portion of the number represent the value of the exponent. The base and exponent sine waves are nearly or actually coincident in time, and: 1¹=1, and 2²=4, and 3³=27. If and when desired, the sum of these three numbers would be 32.

FIG. 10 shows a representation of the screen of an oscilloscope showing sine waves representing the base portion of numbers 1, 2, and 3, and also small sine waves representing the exponent portion of the numbers. In this case, the number of cycles of the exponent represent the value of the exponent and the base and exponent sine waves are also nearly or actually coincident in time: 1¹=1, and 2²=4, and 3³=27. If and when desired, the sum of these three numbers would be 32.

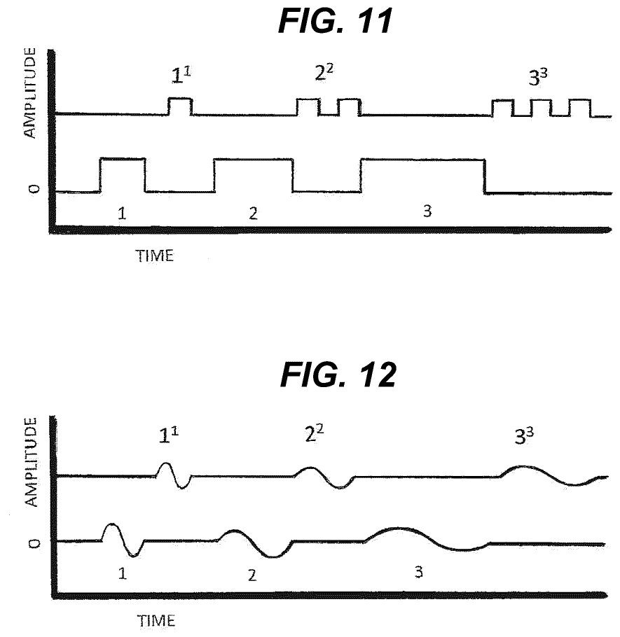

FIG. 11 shows a representation of the screen of an oscilloscope showing a first line including large square waves representing the base portion of numbers 1, 2, and 3, and a second line at a different amplitude including small square waves representing the exponent portion of the base numbers and which are offset in time. In this case, the wavelength of the base portion of the number represents the value of the base number, and the number of cycles of the exponent represents the value of the exponent: 1¹=1, and 2²=4, and 3³=27. If and when desired, the sum of these three numbers would be 32.

FIG. 12 shows a representation of the screen of an oscilloscope showing a first line including large sine waves representing the base portion of numbers 1, 2, and 3, and a second line at a different amplitude including small sine waves representing the exponent portion of the base numbers and which are offset in time. In this case, the wavelength of the base portion of the number represents the value of the base number, and the number of cycles of the exponent represents the value of the exponent: 1¹=1, and 2²=4, and 3³=27. If and when desired, the sum of these three numbers would be 32.

FIG. 13 shows a representation of the screen of an oscilloscope showing large sine waves having greater amplitude representing the base portion of the numbers or values 1 and 2, and also small sine waves having lesser amplitude representing the exponent portion of the number disposed on and about the same 0 axis and reference line: 1¹=1, and 1⁰=1, and 2¹=2, and 2²=4. If and when desired, the sum of these four numbers would be 8. Alternatively, large square waves could be used to represent the base portion of the numbers 1 and 2, and small square waves could be used to represent their corresponding exponents. It can be readily understood that the possible overlapping and summation of a plurality sine waves on a single reference line or graph can derive and result in one or more resultant waves being created in which the individual contributing sine wave forms may or may not be discernable to the human eye, but nevertheless be detectible using the Fast Fourier Transform Algorithm which is discussed in greater detail below.

FIG. 14 shows a representation of the screen of an oscilloscope showing three large sine waves having greater amplitude representing the base portion of number 3, and also two small sine waves having lesser amplitude representing 2 which is the exponent portion of the number 3 disposed on the same 0 axis: 3²=9. Alternatively, large square waves could be used to represent the base portion of the number 3, and two small square waves could be used to represent its exponent 2. Again, it can be readily understood that the possible overlapping and summation of a plurality sine waves on a single reference line or graph can derive and result in one or more resultant waves being created in which the individual contributing sine wave forms may or may not be discernable to the human eye, but nevertheless be detectible using the Fast Fourier Transform Algorithm which is discussed in greater detail below.

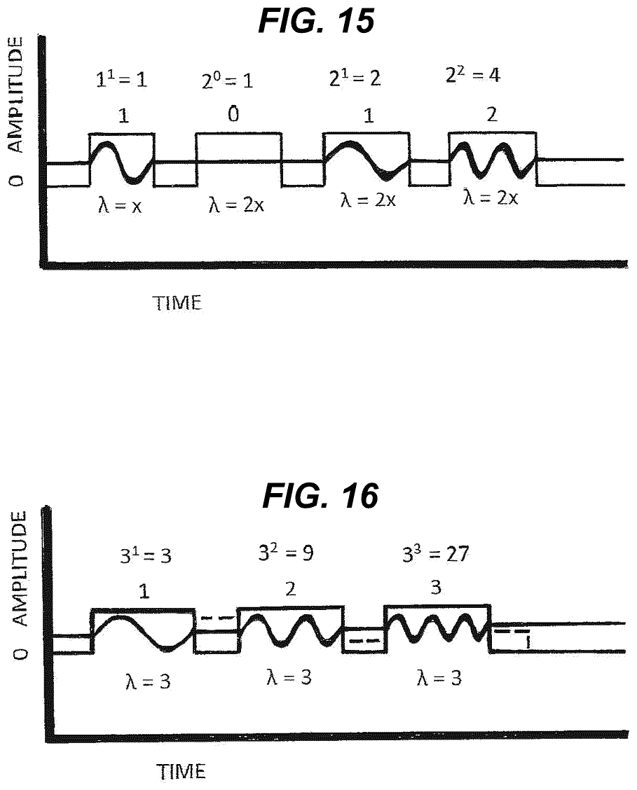

FIG. 15 shows a representation of the screen of an oscilloscope showing large square waves representing the base portion of numbers 1 and 2, and small sine waves disposed on nearly the same axis representing the exponent portion of the numbers. It can be seen the 1¹=1, and 2⁰=1 and so it can be used to represent 1, and 2¹=2, and 2²=4. If and when desired, the sum of these four numbers would be 8. However, it would not typically be the case that a digital square wave would be used to communicate one portion of the value of a number, and then a sine wave be used to represent another portion of the value of a number, at least not unless the information was being processed in series or parallel and then possibly by hybrid chip or processor device that would be capable of both a digital and optical processing capability.

FIG. 16 shows a representation of the screen of an oscilloscope showing large square waves representing the base portion of number 3, and small sine waves disposed on nearly the same axis representing the exponent portion of the numbers. 3¹=3, and 3²=9, and 3³=27. If and when desired, the sum of these three numbers would be 39. Also shown in FIG. 16 using dashed phantom lines, the space between the number 3¹=3 and 3²=9 can have a positive amplitude elevated above the 0 axis and this can be used to represent addition, and the space between the number 3²=9 and 3³=27 can have a different positive amplitude above the 0 axis and this can be used to represent subtraction, and the space after the square wave representing the number 3³=27 can have a different positive amplitude above the 0 axis and this can be used to represent division. Other structures, forms, and ways of representing and communicating mathematical calculations and operations can be used. Again, it would not typically be the case that a digital square wave would be used to represent and communicate one portion of the value of a number, and then a sine wave be used to represent another portion of the value of a number, at least not unless the information was being processed in series or parallel and then possibly by hybrid chip or processor device that would be capable of both a digital and optical processing capability. FIG. 15 and FIG. 16 have shown square waves being used to represent the base portion of the numbers, and sine waves to represent the exponent portions. Alternatively, the base portion of the numbers included in FIGS. 15 and 16 could be represented in sine waves, as has been shown in FIG. 10, FIG. 13, and FIG. 14.

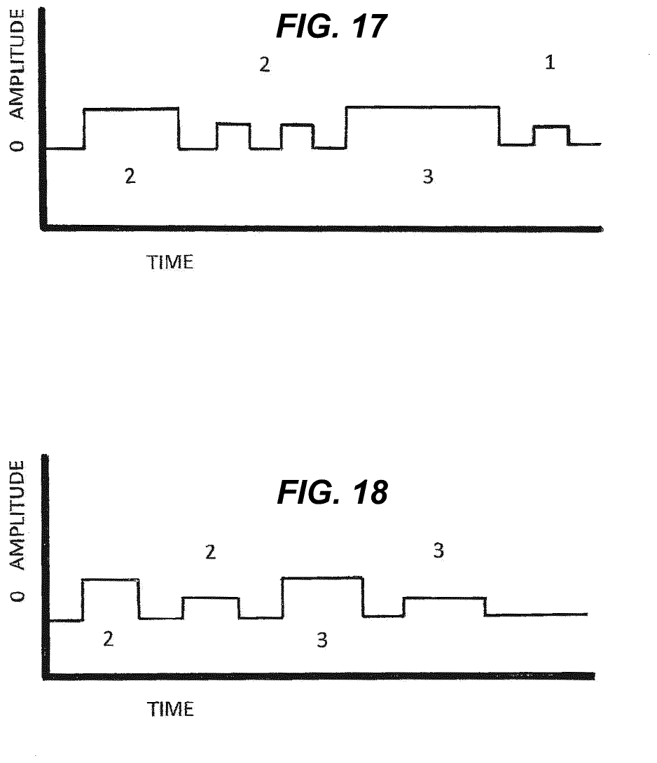

FIG. 17 shows a representation of the screen of an oscilloscope showing large square waves representing the base portion of the numbers 2 and 3, and small and sometimes multiple square waves having about half the amplitude representing the exponent portion following the base portion of the numbers and disposed on the same axis. In this way, the information concerning the value of the base number and exponent can be communicated in a digital signal having a single data stream.

FIG. 18 shows a representation of the screen of an oscilloscope showing large square waves representing the base portion of the numbers 2 and 3, and also small single square waves having about half the amplitude representing the exponent portion following the base portion of the numbers which are disposed on the same axis. In this way, the information concerning the value of the base number and exponent can be communicated in a digital signal having a single data stream, and only single square waves are used to represent the exponents of the base numbers.

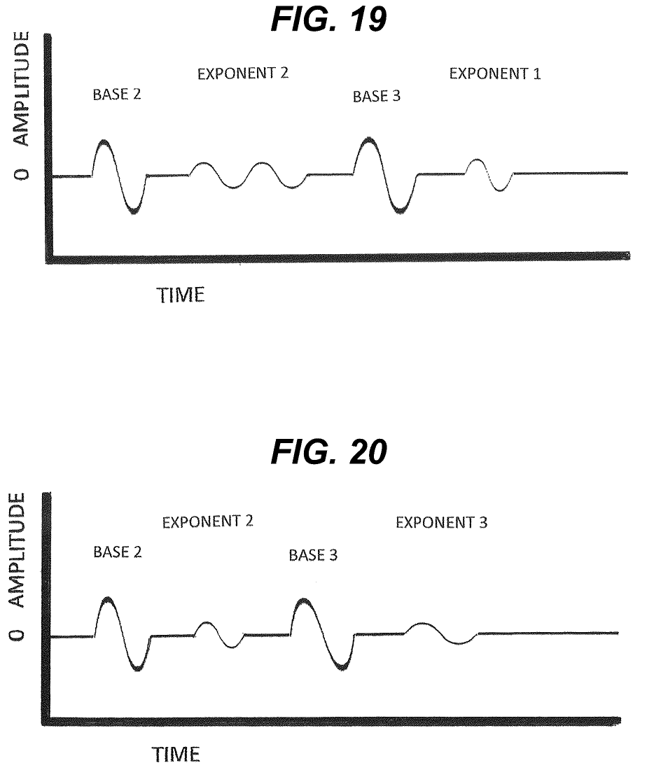

FIG. 19 shows a representation of the screen of an oscilloscope showing large sine waves representing the base portion of the numbers 2 and 3, and small and sometimes multiple sine waves having less than half the amplitude representing the exponent portion following the base portion of the numbers which are disposed on the same axis. In this way, the information concerning the value of the base number and exponent can be communicated in an analog signal having a single data stream.

FIG. 20 shows a representation of the screen of an oscilloscope showing large sine waves representing the base portion of the numbers 2 and 3, and small single sine waves having less than half the amplitude representing the exponent portion following the base portion of the numbers which are disposed on the same axis. In this way, the information concerning the value of the base number and exponent can be communicated in an analog signal having a single data stream, and only single sine waves are used to represent the exponents of the base numbers.

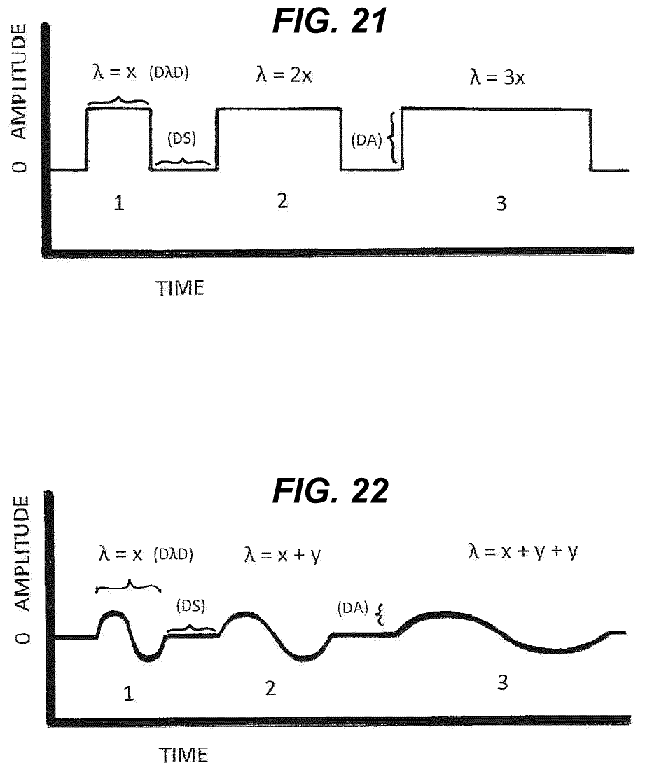

FIG. 21 shows a representation of the screen of an oscilloscope showing a series of single large square waves representing the base portion and exponent portion of the numbers 1, 2, and 3, which could also be used to represent other numbers or values such as 1, 2² and 3², and which are disposed on the same axis. The square waves are spaced apart in time by a desired detectable separation in time for accuracy indicated as (DS), and have a desired detectable amplitude (DA), and a desired detectable wavelength (λ) difference (DAD)=x, and/or multiples thereof.

FIG. 22 shows a representation of the screen of an oscilloscope showing a series of single large sine waves representing the base portion and exponent portion of the numbers 1, 2, and 3, which could also be used to represent other numbers or values such as 1, 2² and 3², and which are disposed on the same axis. The sine waves are spaced apart in time by a desired separation in time for accuracy (DS). Further, the length of the wavelengths of the sine waves are different from one another by a desired detectable wavelength difference (DAD)=x. As shown, if the number 1 is represented by a sine wave having length x, then the number 2 can be represented by a sine wave having length x+y, that is, which exceeds the desired detectable wavelength difference x by a detectable difference y, and the number 3 can be represented by x+y+y. Other desired separations in time (DS) and desired detectable wavelength differences (DAD), and desired detectable differences in amplitude (DA) can be used. It can be readily understood that various desired separations in time (DS) and desired detectable wavelength differences (DAD), and also desired detectable differences in amplitude (DA) can be used and applied to all of the drawing figures and examples discussed in this disclosure, and that a computer including a software application which includes suitable programs which can include codes, commands, and algorithms can read, write, and communicate such data and information and execute commands and run programs to perform calculations and operations using this information.

Algorithms, data structures, and other methods and techniques used in computer science include but are not limited to the following: Aho Corasick String Matching; Algebraic-Group Factorization Algorithms; Algorithm to Detect Cycle; Amplitude Amplification Algorithm, Articulation Points in a Graph; AKS Primality Test; Bach's Algorithm; Backpropagation Through A Neural Network; Beam Search Algorithm; Bell Ford Algorithm; Big O Notation; Binary Search Algorithm; Binary Indexed Tree or Fenwick Tree; Binary Search Trees; Boyer-Moore Majority Vote Algorithm; Brassard-Hoyer-Tapp algorithm (BHT) Algorithm; Breadth First Search Algorithm; Bridges in a Graph; Bubble Sort Algorithm; Bucket Sort Algorithm; Buchberger's Algorithm; Canonical Representation OF A Positive Number; Catalan Numbers; Convex Hull/Jarvis's Algorithm; Compression; Continued Fraction Factorization (CFRAC); Counting Inversions; Counting Sort Algorithm; Data Compression; Depth First Search Algorithm; Diffie-Hellman Key Exchange; Dijkstra's Algorithm; Dinic's Algorithm; Discrete Differentiation; Disjoint-Set Data Structure; Distance-Vector Routine Protocol Algorithm (DVRPA); Dixon's Algorithm; Dynamic Programming; Euclid's Algorithm; Euler's Factorization Method; Euler's Totient Function; Expectation-Maximization Algorithm; Factorial Calculation; Factorization; Fermat's Factorization Method; Ferrers Diagrams; Finite Automata Algorithm for Pattern Searching; Flood Fill Algorithm; Fast Fourier Transform (FFT) Algorithm; Floyd's Cycle Detection Algorithm; Floyd Warshall Algorithm; Ford-Fulkerson Algorithm; Gaussian Elimination to Solve Linear Equations; General Number Field Sieve (GNFS); Graham Scan; Gradient Decent Algorithm; Graphs; Graph Search Algorithm; Grover's Algorithm; Hashing; Heap Sort Algorithm; Hopcroft-Karp Algorithm for Maximum Matching; Huffman Coding Compression Algorithm; Hungarian Algorithm; Insertion Sort Algorithm; Interval Tree; Introsort Algorithm; Johnson's Algorithm; Kadane's Algorithm; Karatsuba Multiplication; Kahn's Topological Sort Algorithm; K Dimensional Tree; Key Exchange Encryption Algorithm; KMP Algorithm; Kraitchik Family Algorithm; Kruskal's Algorithm; Lee Algorithm; Lenstra Elliptical Curve Factorization; Link Cut; Linked List; Link-State Routing Protocol Algorithm (LSRPA); Logarithmic Exponentiation; Lowest Common Ancestor; LLL Algorithm; Matrix Exponentiation; Matrix Rank; Merge Sort Algorithm; Minimum Spanning Tree Algorithms; Modular Exponentiation; Modular Multiplicative Inverse; Mo's Algorithm; Multiplicative Partition; Newton's Method; Order Statistics; PageRank Algorithm, P-ADIC Order; Partition In Number Theory; Pollard's P—1 Algorithm; Pollard's Rho Algorithm; Primality Testing Algorithms such as the Sieve of Eratosthenes, the Fermat Primality Test and the Miller-Rabin Primality Test; Prime Factorization; Q Learning; Quadratic Sieve Algorithm; Quantum Walk Search; Queues; Quick Select Algorithm; Quick Sort Algorithm; Rabin Karp Algorithm; Random Sample Consensus Algorithm; Range Minimum Query; Rational Sieve; Recursion Functions; Regular Expression; RSA Algorithm; Schonhage-Strassen Algorithm; Segmented Sieve; Segment Tree; Selection Sort Algorithm; Shank's Square Forms Factorization (SQUFOF); Shor's Algorithm; Simplex Algorithm; Singular Value Decomposition (SVD); Solving a System of Linear Equations; Square Root of an Integer; Stacks; String Matching and Parsing; Transmission Control Protocol/Internet Protocol (TCP/IP) Algorithms; Trial Division Factorization Method; Trie; Trees; Topological Sort Algorithm; Union Find Algorithm; Viterbi Algorithm; Wheel Factorization; William's p+1 Algorithm; Wilson's Theorem; Young Diagrams; Variational Quantum Eigensolver, Quantum Optimization Algorithms, and, Z's Algorithm, and these and other algorithms, data structures, and methods and techniques used in computer science can be used in the development of software applications which can represent and communicate alphabetical letters, words, numbers, symbols, operations, and other processes including the communication of data and information and the use of computers and other devices for processing, manipulating, and storing data and information.

### Representation of Numbers in Base 10

It is also possible to use and represent the common values and numbers associated with base 10, namely, 0, 1, 2, 3, 4, 5, 6, 7, 8, 9, 10, by representing the base portion of these value or numbers with a square or sine wave, and also the exponent portion of these and other numbers with another square or sine wave. For example, it is possible to represent the base portion of values or numbers and the exponent portion of those values or numbers using photons and sine waves in the visible light spectrum and/or visible or invisible portion of the infrared light spectrum, or other invisible portion of the electromagnetic spectrum. For example, given the number 124: 4×10⁰=4 which is in the ones column; 2×10¹=20 which is in the tens column; and, 1×10²=100 which is in the hundreds column. The number 124 in base 10 can be thought of as being a compressed expression with there being 1 of 10 in the hundreds column, 2 of 10 in the tens column, and 4 of 10 in the ones column, which are added together to represent and provide the value and number 124. In order to represent 124, a first sine wave having a specific frequency and a wavelength to communicate the base number 1 can be communicated nearly or actually simultaneously with a second sine wave having a specific frequency and wavelength to communicate the exponent for representing 10² to represent the value and number 100, a third sine wave having a different specific frequency and wavelength can communicate the base number 2 nearly or actually simultaneously with a fourth sine wave having a different frequency and wavelength to communicate the exponent 10¹ and represent the value and number 20, and a fifth sine wave having a different frequency and wavelength to communicate the base number 4=2² nearly or actually simultaneously can be communicated with a sixth sine wave having a different frequency and wavelength to communicate the exponent 10⁰ to represent the value and number 4. All of the sine waves to represent the number 124 can be communicated nearly or actually simultaneously when photons and sine waves in the visible spectrum and/or infrared electromagnetic light spectrum are used. With the use of optical means of communication, logic and memory chips, or other photonic devices, the number 124 can only require 3 or 6 waves, vibes, quwaves, quvibes, or qubits and be communicated and processed nearly or actually simultaneously instead of using the binary representation of 124 which is 1111100 and requires 7 bits of information which are processed sequentially and also considerably slower by electrons moving in wire and conventional silicon CPU and memory chips. In this regard, it is possible for a conductive wire and also optical fiber cable to communicate hundreds or thousands of signals, but optical fiber cable can communicate faster at THz speeds without a significant amount of impedance, and also uses less energy. In contrast, the use of the binary system and its relatively narrow and slow stream of digital 0's and 1's can be like trying to drink a river with a straw.

Again, one of the ways to communicate and process more information at higher speeds is to decrease the number of bits, waves, vibes, or qubits that are required to communicate a phrase like “Run Tag Run” from 72 bits to 3 waves, vibes, or qubits, or depending on the software application can program being run, perhaps it would be 5 waves, vibes, or qubits counting the spaces between the words. In this regard, fiber optic cable can be used to carry photons and sine waves in the visible light spectrum, and the visible and/or invisible portion of the infrared electromagnetic light spectrum to communicate alphabetical letters, words, symbols, and the base portion and also the exponent portion of a value or number in base 10, or any other number system. If desired, optical fiber cable can communicate a plurality of alphabetical letters, words, paragraphs, and documents nearly or actually simultaneously in the range of THz speeds. Accordingly, optical fiber cable and optical computing can potentially provide faster communication and processing speeds than can conventional electronic digital communication and computing because of its ability to nearly or actually simultaneously communicate data and information and also because photons and light can typically travel about 20 times faster in optical cable and optical chips than digital electronic signals can travel in metal wire and conventional computer chips made of silicon. Once again, the number 3,486,784,401 expressed in binary form is 0110011111110101000001101110010001 which is 34 bits. However, the above discussion shows that 3,486,784,401 could be represented in base 10 in 10-20 waves, vibes, or qubits that could be communicated nearly or actually simultaneously as though only one bit was somehow alternatively being communicated digitally. The previous discussion also shows that 3,486,784,401 can be represented as 3²⁰ which could require the use of only one or two waves, vibes, or qubits. While the introduction of abbreviations and specialized vocabulary can make computer languages harder for individuals to learn and communicate in different spoken languages, the abbreviation or representation of 3,486,784,401 by using 3²⁰ is not problematic because the use of base 10 is widely accepted and understood. Accordingly, the use of photons and sine waves to communicate data and information and optical computers which can facilitate quantum computing has the potential to surpass the performance of conventional electronic computers for many tasks and purposes.

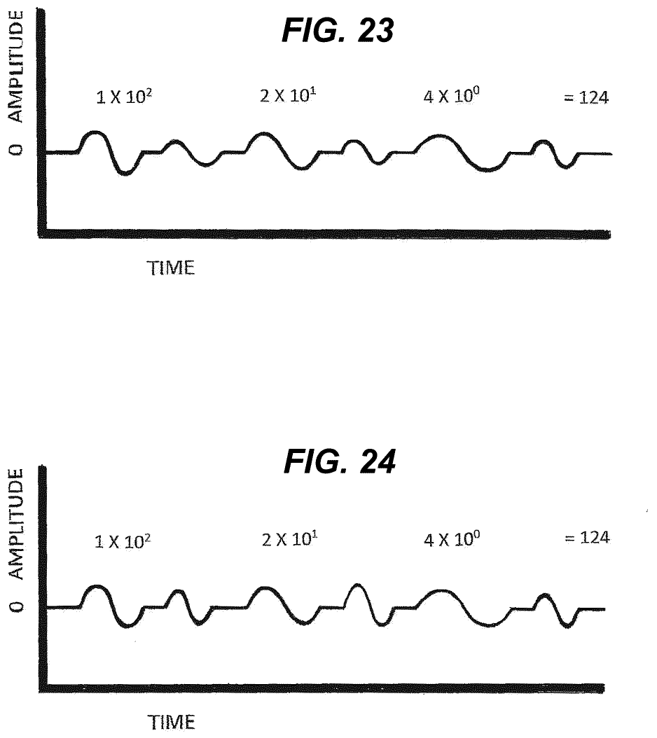

FIG. 23 shows a representation of the screen of an oscilloscope showing a series of sine waves representing the base portions and also the exponent portions of the individual numbers which can be used to represent and communicate the numbers 124. In this regard, 1×10²+2×10¹+4×10⁰=124. The base numbers 1, 2, and 4 are represented by sine waves having the same amplitude, but different frequencies and wavelengths. The exponent portions 10², 10¹, and 10⁰ are represented using sine waves having smaller amplitude than the base portion, and also different frequencies and wavelengths. As shown, for the sake of clarity in this disclosure, there is a short separation in time as between the base portion of each number and its corresponding exponent, but this need not be the case.

FIG. 24 shows a representation of the screen of an oscilloscope showing a series of sine waves representing the base portions and also the exponent portions of the individual numbers which can be used to represent and communicate the number 124. In this regard, 1×10²+2×10¹+4×10⁰=124. The base numbers 1, 2, and 4 are represented by sine waves having the same amplitude, but different frequencies and wavelengths. The exponent portions 10², 10¹, and 10⁰ are represented using sine waves having different amplitudes from one another, but the same frequencies and wavelengths. As shown, for the sake of clarity in this disclosure, there is a short separation in time as between the base portion of each number and its corresponding exponent, but this need not be the case.

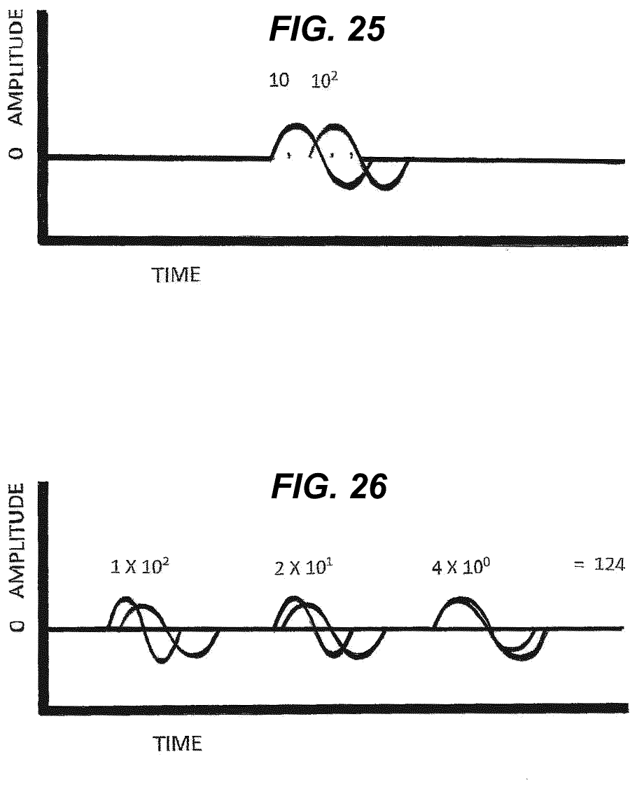

FIG. 25 shows a representation of the screen of an oscilloscope showing two sine waves which are phase shifted relative to one another. The first sine wave on the left represents the base portion of a number and has the value 10, and the second sine wave on the right which can have the same amplitude and general shape can represent the exponent portion of the number and has the value 2, and so the base portion and exponent portion can represent and communicate 10² which is the number 100. In this regard, a portion of the center reference line which rests at 0 has been deleted in order to better illustrate four points in time. In this example, each point indicates and represents a potential phase shift of the second sine wave and represents a corresponding change in its numerical value. The first point to the right of the first sign wave corresponds to the exponent 1 and represents 10¹, the second point to the exponent 2 and represents 10², and so the second sign wave begins on that second point in this example. The amount of phase shifting can possibly be made very small and even be in picoseconds (ps) which is 0.000000000001/second, or femtoseconds (fs) which is 0.000000000000001/second. This example shows how different numbers or other values can be represented by sine waves which are phase shifted and then used to communicate data and information to optical, hybrid electro-optical, and/or quantum computers. A software application including a compilation of programs, commands, and algorithms can be configured to identify and communicate the value 100 which is being represented and communicated in FIG. 25. It can be readily understood that the possible overlapping and summation of a plurality sine waves on a single reference line or graph can be used to derive and result in one or more resultant waves being created in which the individual contributing sine wave forms may or may not be discernable to the human eye, but they can nevertheless be detectible using the Fast Fourier Transform Algorithm which is discussed in greater detail below.

Moreover, it is possible for many different values and numbers to be represented and communicated by using the base 10 number system or a different base number system as the base portion of a number and using values or numbers derived from a logarithm table as the exponent portion of the number. For example, the first sine wave shown on the left in FIG. 25 can once again be used to represent and communicate the base portion of a number in base 10 having the value 10, but instead of the position of the second sine wave shown on the right in FIG. 25 being used to represent an exponent having the value 2, the amount to which the second sine wave is phase shifted can be used to represent a different exponent taken from a logarithm table such as 0.301029996, thus the value of the number which could be represented by log₁₀ x=0.301029996 would be 2. In FIG. 25, the value 0.301029996 would then be located between the start of the first sine wave and the first indicated point to the right of the start of the first sine wave, and the second sine wave representing the exponent would then start in that location. Alternatively, if the value of the exponent taken from a logarithm table would be 0.698970004 the number which could be represented by log₁₀ x=0.698970004 would be 5. In FIG. 25, the value 0.698970004 would then be also be located between the start of the first sine wave and the first indicated point to the right of the start of the first sine wave, and the second sine wave representing the exponent would then start in that location. Alternatively, if the value of the exponent taken from a logarithm table would be 2.093411685, the value of the number which could be represented by log₁₀ x=2.093411685 would be 124. In FIG. 25, the value 2.093411685 would then be located between the second and third points indicated to the right of the start of the first sine wave, and the second sine wave representing the exponent would then start in that location. In this regard, a base portion of a number and an exponent portion can be used to represent and communicate positive numbers, and also other kinds of numbers. The values of the exponents provided in some logarithm tables can be on the order of 1×10⁻¹², but since the amount of phase shifting can possibly be made very small and even be in picoseconds (ps) which is 0.000000000001/second, or femtoseconds (fs) which is 0.000000000000001/second, and visible light wavelengths as well as ultraviolet and infrared wavelengths are on the order of about 2 femtoseconds (fs), it is possible to represent and communicate exponents which are on the order of 1×10⁻¹² by using phase shifting, and other forms of modulation. Alternatively, the described methods and techniques including phase shifting could be used with at least two square waves, or other wave forms to represent and communicate data and information.

FIG. 26 shows a representation of the screen of an oscilloscope showing a plurality of sine waves which are phase shifted relative to one another and which represent the base portion and also the exponent portion of three numbers which can be used to represent and communicate the number 124. The first sine wave on the left represents the base portion of the number 1, and the second sine wave which can possibly have a different amplitude and general shape can represent its exponent 2 in base 10 and be phase shifted as previously discussed to represent and communicate 10². The third sine wave from the left represents the base portion of the number 2, and the fourth sine wave which represents its exponent 1 in base 10 is phase shifted in time to represent and communicate 10¹. The fifth sine wave from the left represents the base portion of the number 4, and the sixth sine wave which represents its exponent 0 in base 10 is phase shifted in time by 0 to represent and communicate 10⁰. Accordingly, a software application including a compilation of programs, commands, and algorithms can be configured to add the three numbers, that is, 100+20+4=124, to yield the sum 124 which is then being represented and communicated in FIG. 26. As shown, for the sake of clarity in this disclosure, the three pairs of sine waves are separated by breaks as would occur when the numbers would be entered and communicated using a keyboard, but this would not need to be the case if and when the numbers would be part of a data and information communication or stream that would be communicated, e.g., over fiber optical cables, and also possibly then be processed using an optical CPU and memory chip in an optical and/or quantum computer. In this regard, the individual sine waves associated with the values and numbers 1×10², 2×10¹, and 4×10⁰ which indicate and represent the sum and number 124 could also be nearly or actually communicated simultaneously, and then near or at the speed of light. Again, when a series of numbers is entered using a keyboard or other device, a software application can include programs, commands, and algorithms which cause those numbers to be added to derive and represent a number or value in base 10. Alternatively, mathematic operators such as add +, minus −, multiply ×, divide /, and other operations and functions can be indicated and represented by using corresponding sine waves having individually coded and assigned frequencies and wavelengths which indicate and represent desired operations and/or functions. Other number systems besides the binary and decimal number systems can be similarly represented and encoded, and so can other types of numbers such as real numbers which can include rational numbers, irrational numbers, integers, whole numbers, natural numbers, positive numbers, negative numbers, and imaginary numbers, and complex numbers. Moreover, the methods and processes disclosed with reference to drawing FIGS. 25 and 26 and their discussion can also be applied to the use of electrons and square waves or other wave forms to represent and communicate data and information in electronic communication, e.g., a first square wave can be used to represent the base portion of a number in base 10, or other base number system, and a second square wave of the same or different amplitude and/or wave form can be phase shifted or otherwise be modulated to represent the exponent portion of the number.

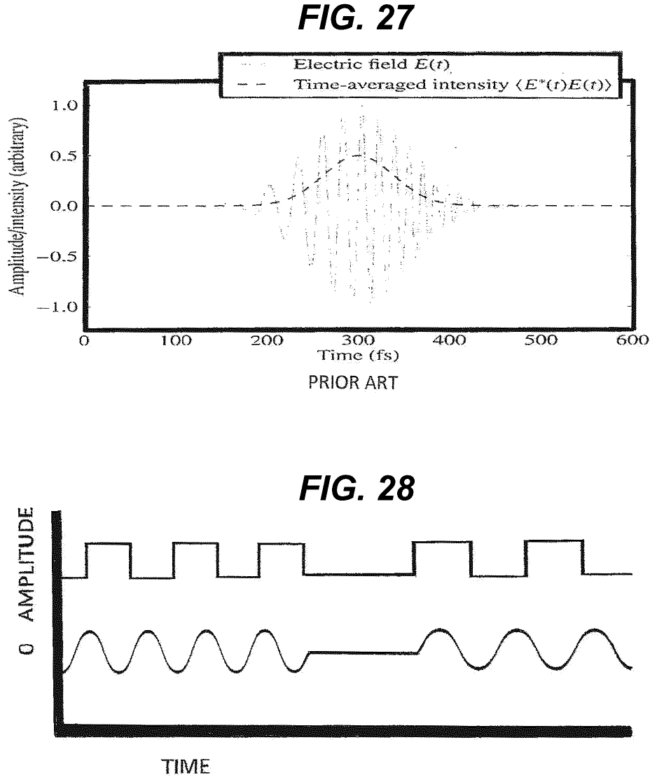

FIG. 27 is a prior art representation of an ultra short pulse which can be used to communicate information which has been reproduced from the website: https://wikipedia.org/wiki/Ultrashort_pulse. Shown is an ultra short pulse which corresponds to an electrical pulse which has a duration of about 200 femoseconds (fs). As previously discussed, the frequency and wavelength of visible light corresponds to only about 2 femtoseconds. Accordingly, this drawing figure can be used to show how much faster photons and light can potentially communicate data and information relative to forms of electronic communication which use electrons in wires. In this regard, in FIG. 28 and also in other drawing figures such as FIGS. 7, 8, 15, and 16, where photonic sine waves and electronic square waves are represented together for illustrative purposes, the caveat here being made in this disclosure is that sine wave forms associated with photons and light would typically be so small and their frequency would also be so fast that they would typically not be easily seen when represented on the same amplitude and time scale as electronically generated square waves. For this reason, the representation of sine waves corresponding to photons and visible and/or invisible light have sometimes been enlarged and/or simplified so that individuals will be able to follow and understand the key points and teachings made in this disclosure. In addition, for the sake of clarity, many of the drawing figures associated with this disclosure have represented one cycle of a sine wave or square wave and/or a series of different individual sine waves or square waves having only one cycle, but this need not be the case. While it is possible to generate and detect a single photon and optical sine wave, in view of the high frequency and speed of light and also the possible need or desire for a certain redundancy in order to ensure accurate detection and communication, the generation and detection of multiple cycles of a given sinusoidal wave form, sine wave, wavelet, pulse, or square wave can sometimes be desired. In this regard, the production and transmission of a signal including a plurality of photons in optical computing or electrons in electronic computing having a characteristic frequency and wavelength can in some circumstances provide for a more robust signal and enhance the ability to detect and accurately interpret the communication of data and information.

FIG. 28 is a representation showing two different sine waves and also two different square waves which are each separated by break. This image has been provided to represent how data and information which is communicated by a keyboard could look when being communicated digitally using square waves, or optically with the use of sine waves. For example, when an individual depresses a key on a computer keyboard a continuous square or sine wave signal which communicates that keystroke can be generated, but when the keystroke ends the signal is discontinued. The pushing of a space bar after entering at least one letter or a series of alphabetical letters to indicate and represent a word, or a symbol to indicate and represent a command, function, or operation, or a number or a series of numbers to indicate and represent a larger number, can then communicate with the use of a software application including programs including suitable codes, commands and algorithms that a completed piece of data and information has been communicated which can and should be read and persisted by a computer or other data communication, storage, and manipulation device.

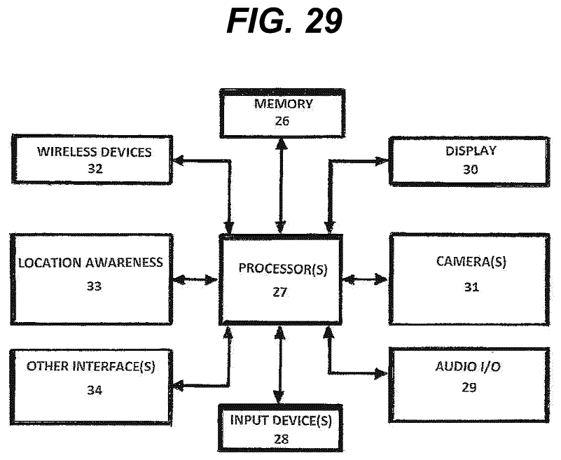

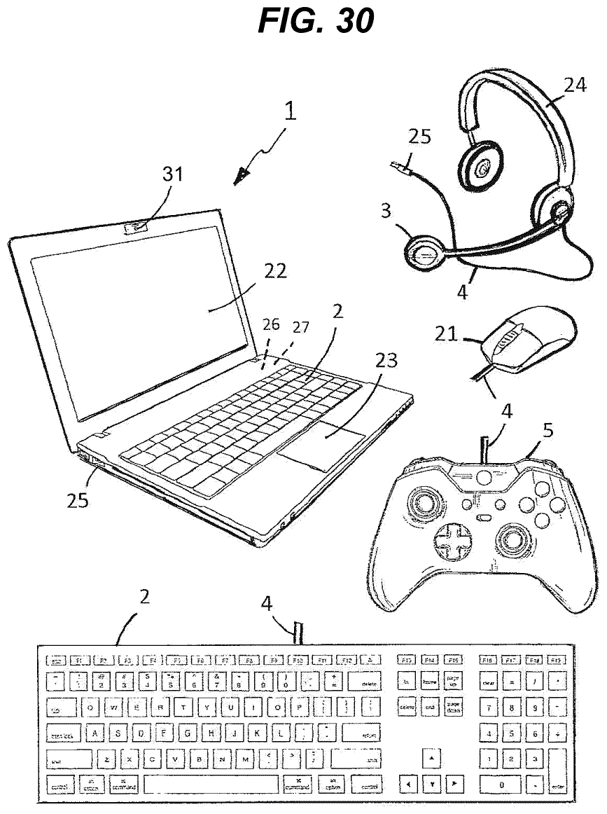

FIG. 29 shows a flow chart which relates to a conventional computer, an optical computer, electro-optical hybrid computer, and/or a quantum computer which is generally similar to that shown in FIG. 30. The processor(s) can include one or more conventional silicon CPUs and/or optical microprocessor chips and other photonic devices which can enable quantum computing. The input devices and/or output devices 28 or other interfaces 34 can include a keyboard 2, a game controller 5, a camera 31, a mouse 21, a headset 24 including a microphone 3, a voice recognition device or voice command, an optical detector device, a photodetector, a photodetector array, a CMOS device, a video camera, a CD disk, a DVD disk, an optical disk, a holographic optical disk, a magnetic tape, an optical tape, an optical film, an analog to digital converter, a digital to analog converter, a multiplexer, a demultiplexer, a wave division demultiplexer, a transponder, a transceiver, a computer monitor, a computer touchscreen monitor, an oscilloscope, a spectrum analyzer, a Solid State Drive (SSD), a removable Flash drive, a wire, waveguide, a fiber optic cable, a wireless device, a computer printer, and other devices. The display 30 can include an integral monitor and display screen 22 and/or external display screen. The camera 31 can include an integral camera 31 of the computer 1 and/or an external camera. The audio I/O 29 can include speakers which are integral or external to the computer 1, and microphones 3 which are integral to the computer 1 and/or other audio devices which are external to the computer 1. This could include interfaces for recording musical instruments and mixing and editing music such as the Universal Audio Apollo x8p. The wireless devices 32 can include wireless devices such as cell phones, wireless communication systems, printers, Bluetooth and internet or other wi-fi connections which can communicate with the computer 1. The location awareness 33 can include any means or device which can provide the computer 1 and a user with the location of the computer and/or communicate the location of the computer 1 to an external GPS or other location tracking system or third party. The other interface(s) 34 can include any other interface which can be integral or external to the computer 1 for communication with external devices, networks, the internet, and other sources of data and information and communication.

With reference to FIGS. 29 and 30, and regarding a pure or complete optical computer, a signal including data and information can be produced and communicated using a keyboard 2, a mouse 21, a microphone or other voice recognition device 3, or a camera 31 which can use an electronic digital system and be connected by a wire cable 4 or a wireless system to the optical computer 1. Alternatively, the data and information can be provided or converted to photonic and optical form by one or more of the aforementioned devices and communicated to the optical computer 1 using a fiber optic cable 4. The photonic data and information can then be directed to an optical processor 27 located inside the computer 1 which is shown in FIG. 30 with dashed lines, which can send the data and information through logic gates which can be part of a neural network which can permit quantum entanglement and/or a quantum superposition capability. At least some of the data and information being processed can be sent to an optical memory chip or device 26 which is located inside the computer 1 and so is shown in FIG. 30 with dashed lines, or alternatively, to a different data and information storage means, where it can be saved and persisted. After the information is saved and if the program needs to use it, the program can then send a command to the optical processor chip or device 27 which can send a command to receive the information. The program can then receive the information and also sent a signal back to the optical processor chip or device 27 to tell it that the task is complete.

The detailed structures, methods, and processes associated with making and operating optical computers, hybrid electro-optical computers, and quantum computers are recited in the prior art patents that are incorporated by reference herein, and the recited documents speak for themselves. A brief discussion of just a few of the structures and methods recited in some of these patents is provided here for those individuals who may not be familiar with or have time to review the prior art. Lasers from Ill and V groups on the periodic table using indium phosphide and silicon nitride, or LED's can be used as light sources. One or more optical microresonators can be included on or near an optical chip to generate at least one microcomb which can squeeze photons into small circular loops about the size of a millimeter in order convert the photons from a single wavelength to many different wavelengths or modes and so facilitate multiplexing, quantum entanglement, superposition, and quantum computing. In order to make an optical computer chip, transistors which utilize constructive or destructive light interference can be used to create optical or digital/optical logic gates. In this regard, liquid crystal structures, or nano-crystals made, e.g., from diamond, germanium, quartz, ruby, salt, sapphire, silicon, or other crystalline materials which have desired lattice structures and other physical properties can be used to make logic gates which can be connected to neural networks. Components of photonic devices and optical computers, electro-optical computers and/or quantum computers based thereupon can include: a power supply, a monitor, a keyboard, a mouse, a camera, a microphone, a touch screen, a wired connection, a wireless connection, multiplexers, wave guide demultiplexers, transceivers, transponders, digital to analogy converters, analog to digital converters, fiber optic cables, optical connections, active electrical modulators, amplifiers, dielectric waveguides, shutters, lenses, optical detector devices, photodetectors, photodetector arrays, beam splitters, beam shapers, spatial light modulators, light condensers, diffraction gratings, epitaxy on silicon structures, filters, channel drop filters, Mach-Zehnder filters, integrated heaters, heat sinks, lasers, tunable lasers, Femtolasers, hybrid silicon on chip lasers, LEDs, micro-LEDs, laser diodes, liquid crystals, silicon waveguides, optical buffer memory, optical transistors, optical chiplets, micro-electronic mechanical systems (MEMS), mirrors, modulators, phase velocity devices, photodiodes, prisms, ring resonators, micro-rings, spectrometers, splitters, 2 by 2 couplers, holographic memory devices, optical processor devices, holographic discs and disc drives, crystal memory, flash memory, RAM memory, ROM memory, silicon chip processor devices, silicon chip memory devices, other input and output devices, and other structures which can be used to manipulate, process, and store in memory photonic data and information. Some crystalline materials such a lithium niobate can be placed in communication with a laser, LED, or other light source and be used to make holographic optical memory devices. The following articles provide information on optical CPU's and/or memory chips: “Light-Based Memory Chip Is the First To Permanently Store Data, by Robert F. Service, published on Sep. 25, 2015 on the website: https://www.science.org/content/article/light-based-memory-chip-first-permanently-store-data; “Optical RAM And Integrated Optical Memories: A Survey/Light: Science & Applications,” by Theoni Alexoudi, George Theodore Kanellos & Nikos Pleros, published on May 25, 2020 on the website: https://www.google.com/url?sa=t&source-web&rct=j&url=https://www.nature.com/articles/s41377-020-0325-9&ved=2ahUKEwjOx46w9af1AhUdk4kEHaxyBewQFnoECAUQAQ&usg=AOvVaw3AP8OD47MCuabOpvB2_Kkgr; and, “New Optical Memory Cell Achieves Record Data-Storage Density,” published by the Oxford News Blog on Dec. 21, 2018 on the website: https://www.ox.ac.uk/news/science-blog/new-optical-memory-cell-achieves-record-data-storage-density-0. Optical computers can send and receive photonic and optical sine waves in multiple frequencies and wavelengths in order to communicate data and information in series or parallel and near or at the speed of light. Hybrid electro-optical computers can include one or more structures which require the conversion of information in an optical form to binary and digital form and/or vice-versa, and this requirement can reduce processing speeds and require more energy.

FIG. 30 shows a keyboard 2, a game controller 5, a mouse 21, and a headset 24 including a microphone 3 for communicating data and information to a computer 1 which has an integral keyboard 2 and touch pad 23 and can be an optical, hybrid electro-optical, and/or quantum computer. Many different types of keyboards exist, but most existing keyboards use mechanical switches. Capacitive keyboards also exist, as do virtual laser keyboards. Wireless keyboards exist. All of these and other types of keyboards can be adapted to communicate letters, words, symbols, numbers and operations using frequency modulation and/or amplitude modulation of electronic signals and/or optical signals. Some of the methods of representing letters of the alphabet, words, symbols, and numbers discussed herein can also be used with conventional computers which use the digital binary number system and wires connected to conventional silicon based CPUs and memory storage systems. In this regard, an oscillator such as a 555 or 955 timer circuit can be used to send a carrier or baseline square wave signal. Alternatively, an oscillating quartz crystal circuit, a vacuum tube oscillator circuit, or other oscillator can be used to send a carrier baseline square wave or sine wave signal, but the wave form can then be changed in frequency and wavelength by individual keystrokes on a keyboard, or by using voice recognition equipment in order to communicate specific information. For example, when using a 555 or 955 timer circuit, changing the value of the main capacitor will change the oscillation rate of the circuit, and so can changing one or both of the two main resistors. Accordingly, each key on a keyboard can be linked to a capacitor having a different value that can be placed in a parallel with the main capacitor on the 555 or 955 timer circuit by a keystroke and the resulting output value of the two capacitors in combination will then change the frequency and wavelength of the baseline oscillation to one that specifically indicates and represents the letter, number, symbol, or operation associated with the particular keystroke. In this way, letters, words, symbols, numbers and operations can be communicated by what will here be called a string of different digital square waves having different specific and identifying frequencies and wavelengths.

Alternatively, synthetic quartz crystals can be used to make oscillators or resonators having a frequency between 800 KHz and 300 MHz in a crystal oscillator circuit. Mode locked oscillators can produce short pulses in the range of picoseconds (ps) and femtoseconds (fs). The Seiko Epson 56-8003 series provides an example of a modern programmable quartz crystal oscillator, e.g., the Epson SG-8003CG.

Keyboards and vocal means of data and information input are relatively slow processes, and so when these means would be used to input data and information using conventional digital devices and the binary number system, it would not greatly affect the processing speed of an optical computer, a hybrid electro-optical computer and/or quantum computer. However, somewhere in the chain of equipment and data and information flow those digital signals would need to be converted into analog photonic or optical signals. Digital to optical and also optical to digital converters exist, but converting data and information back and forth takes time, and it is also associated with the production of heat and use of energy.

An optical keyboard, microphone or other voice recognition device which can use fiber optical cables to communicate photons and sine waves in the visible light spectrum and/or invisible portion of the infrared electromagnetic light spectrum to an optical computer which uses an optical CPU and memory chip or other means of persisting data and information can be used to enable and facilitate quantum computing. Whether using a keyboard with mechanical switches or a capacitive keyboard, a keystroke can be linked to a circuit associated with a light source and which changes the light output from either no output or from a baseline output to a different output by changing, e.g., the resistance or capacitance of the relevant portion of the associated integrated circuit and/or by changing, e.g., the transmittance, absorbance, filtering, reflection, scattering and/or dispersion of the light source so that the frequency and wavelength of the photonic output can be selectively changed. Instead of using electrons and the binary digital number system to make and communicate a signal, a source of light photons such as one or more LEDs, liquid crystals, or lasers can be used to generate the optical signal. In this regard, light sources which can generate photons and light in the visible light spectrum and/or invisible portion of the infrared electromagnetic spectrum can be used.

A conventional keyboard having mechanical switches or a capacitive keyboard will typically have an integrated circuit including a character map which identifies each individual keystroke. These keyboards send the information, e.g., that the letter “a” has been actuated, by sending the data and information using the binary system of 0's and 1's which is then communicated digitally using a conductive metal wire to a computer. The following discussion will address how to make a keyboard which can be used to communicate information in the form of photons and sine waves having frequencies and wavelengths in the visible light spectrum and/or invisible portion of the infrared electromagnetic spectrum. In this regard, a discussion will be provided regarding how television screens produce and represent different colors.

Computer keyboard commands, functions, operations and/or shortcuts typically include, but are not limited to: Alt, Backspace, Caps Lock, Ctrl, Delete, End, Enter, Esc, Fn, Home, Insert, Num LK, Pgdn, Pgup, Pause Break, Prt SC SYSRQ, Scr Lk, Shift, Spacebar, Tab, Windows, Ctrl+A, Ctrl+C (or Ctrl+Insert), Ctrl+X, Ctrl+V (or Shift+Insert), Ctrl+Z, Ctrl+Y, Ctrl+Shift+N, Alt+F4, Ctrl+D (Del), Shift+Delete, Alt+Tab, PrtScn, Windows key+I, Windows key+E, Windows key+A, Windows key+D, Windows key+L, Windows key+V, Windows key+Period (.) or semicolon (;), Windows key+PrtScn, Windows key+Shift+S, Windows key+Left arrow key, Windows key+Right arrow key, Keyboard shortcut, Windows key (or Ctrl+Esc), Ctrl+Arrow keys, Ctrl+Shift+Esc, Ctrl+Shift, Alt+F4, Ctrl+F5 (or Ctrl+R), Ctrl+Alt+Tab, Ctrl+Arrow keys (to select)+Spacebar, Alt+Underlined letter, Alt+Tab, Alt+Left arrow key, Alt+Right arrow key, Alt+Page Up, Alt+Page Down, Alt+Esc, Alt+Spacebar, Alt+F8, Shift+Click app button, Ctrl+Shift+Click app button, Shift+Right-click app button, Ctrl+Click a grouped app button, Shift+Right-click grouped app button, Ctrl+Left arrow key, Ctrl+Right arrow key, Ctrl+Up arrow key, Ctrl+Down arrow key, Ctrl+Shift+Arrow key, Ctrl+Spacebar, Shift+F10, Shift+Arrow keys, Windows key+X, Windows key+Number (0-9), Windows key+T, Windows key+Alt+Number (0-9), Windows key+D, Windows key+M, Windows key+Shift+M, Windows key+Home, Windows key+Shift+Up arrow key, Windows key+Shift+Down arrow key, Windows key+Shift+Left arrow key, Windows key+Shift+Right arrow key, Windows key+Left arrow key, Windows key+Right arrow key, Windows key+S (or Q), Windows key+Alt+D, Windows key+Tab, Windows key+Ctrl+D, Windows key+Ctrl+F4, Windows key+Ctrl+Right arrow, Windows key+Ctrl+Left arrow, Windows key+P, Windows key+A, Windows key+I, Windows key+E, Alt+D, Ctrl+E (or F), Ctrl+N, Ctrl+W, Ctrl+F (or F3), Ctrl+Mouse scroll wheel, Ctrl+Shift+E, Ctrl+Shift+N, Ctrl+L, Ctrl+Shift+Number (1-8), Alt+P, Alt+Enter, Alt+Right arrow key, Alt+Left arrow key (or Backspace), Alt+Up arrow, F1, F2, F3, F4, F5, F6, F7, F8, F9, F10, F11, F12, Ctrl+Tab, Ctrl+Shift+Tab, Ctrl+number of tab, Tab, Shift+Tab, Alt+underline letter, Spacebar, Arrow keys, Ctrl+A, Ctrl+C (or Ctrl+Insert), Ctrl+V (or Shift+Insert), Ctrl+M, Ctrl+Up arrow key, Ctrl+Down arrow key, Ctrl+F, Left or right arrow keys, Up or down arrow keys, Page Up, Page Down, Ctrl+Home, Ctrl+End, Windows key, Windows key+A, Windows key+S (or Q), Windows key+D, Windows key+L, Windows key+M, Windows key+B, Windows key+C, Windows key+F, Windows key+G, Windows key+Y, Windows key+O, Windows key+T, Windows key+Z, Windows key+J, Windows key+H, Windows key+E, Windows key+I, Windows key+R, Windows key+K, Windows key+X, Windows key+V, Windows key+W, Windows key+U, Windows key+P, Windows key+Ctrl+Enter, Windows key+Plus (+), Windows key+Minus (−), Windows key+Esc, Windows key+Forward-slash (/), Windows key+Comma (,), Windows key+Up arrow key, Windows key+Down arrow key, Windows key+Home, Windows key+Shift+M, Windows key+Shift+Up arrow key, Windows key+Shift+Down arrow key, Windows key+Shift+Left arrow key, Windows key+Shift+Right arrow key, Windows key+Left arrow key, Windows key+Right arrow key, Windows key+Number (0-9), Windows key+Shift+Number (0-9), Windows key+Ctrl+Number (0-9), Windows key+Alt+Number (0-9), Windows key+Ctrl+Shift+Number (0-9), Windows key+Ctrl+Spacebar, Windows key+Spacebar, Windows key+Tab, Windows key+Ctrl+D, Windows key+Ctrl+F4, Windows key+Ctrl+Right arrow, Windows key+Ctrl+Left arrow, Windows key+Ctrl+Shift+B, Windows key+PrtScn, Windows key+Shift+S, Windows key+Shift+V, Windows key+Ctrl+F, Windows key+Ctrl+Q, Windows key+Alt+D, Windows key+Period (.) or semicolon (;), Windows key+Pause. All of these different commands, functions, operations, and/or shortcuts can be communicated using visible light and/or infrared light in the invisible portion of the electromagnetic spectrum.

Modern television screens include only blue, green, and red pixels. Depending on whether one or more of these three blue, green, and red color pixels are being provided with power, or how much relative electrical energy is being provided to the individual pixels, that is, the amplitude of the color pixels, it is possible to reproduce or render all of the colors in the visible light spectrum. A television set does not require thousands of individual pixels having different unique colors in order to provide color rendering. The human eye also has cones which can see blue, green, and red light, but we can nevertheless see thousands of different unique colors. Likewise, it is possible to use relatively few values and numbers to represent and communicate data whether the data consists of words, numbers, symbols, or operations. In this regard, here is one example how different values and numbers can be represented using light. Number 0 can represent and be analogous to black on a television screen. In modern television screens, black is typically rendered with the use of a controllable second polarizer which absorbs all light. Number 1 can represent and be analogous to white on a television screen. In modern television screens, white is typically rendered by all three red, green, and blue light pixels being on. Number 2 can represent and be analogous to the color blue on a television screen. Number 3 can represent and be analogous to the color green on a television screen. Number 5 can represent and be analogous to the color red on a television screen. As previously discussed, using the values and numbers 0, 1, 2, 2ⁿ, 3, 3ⁿ, 5, and 5ⁿ we can represent all positive numbers just as the modern television set can represent all colors by using only blue, green, and red pixels. Other types of numbers such as negative numbers, fractions, imaginary numbers, complex numbers, and mathematical operations besides addition, such as subtraction, multiplication, and division can be represented using a relatively small collection of colors. The caveat with respect to this discussion being that while old cathode ray tube televisions use the excitement of different colored phosphors to generate blue, green, and red colors, the rendering of other colors was done using the RGB color model which is an additive process. For example, the RGB white point was often rendered by combining 464 nm blue with 549 nm green with 612 nm red. Many modern LED, liquid crystal, and plasma screens still use a generally similar RGB color model and additive process. As a result, humans may perceive, e.g., the color violet because of the addition of red and blue, but the screen may not be emitting light having the specific frequency and wavelength associated with the color violet. The web-safe color palette used with many early computer screens only included 6³=216 colors, but now millions of colors are being supported by modern computers. However, when the desire is to communicate information using the visible light spectrum or invisible portion of the infrared light spectrum using a wide bandwidth it can be necessary to actually generate and use the frequencies and wavelengths of light in the desired bandwidth and not rely upon an additive process. As previously discussed, the different colors used to indicate and represent or encode data and information, that is, the different frequencies and wavelength can correspond to a portion of the visible light spectrum, and/or invisible portion of the infrared light spectrum, or other invisible portion of the electromagnetic spectrum. FIG. 30 shows an optical, hybrid electro-optical, and/or quantum computer 1 which includes an integral keyboard 2, camera 31, screen 22, touch pad 23, and also a plurality of connectors and/or ports 25 for coupling with a wire or fiber optical cable 4 which can be used to removably secure an accessory device. Also shown is an accessory keyboard 2, a game controller 5, a mouse 21, and a headset 24 including a microphone 3 and wire or fiber optical cable 4. The wire or fiber optical cables 4 on the mouse 21, game controller 5, and accessory keyboard 2 are shown with parts broken away in order to simply the drawing figure. One or more of the integral computer keyboard 2, the accessory keyboard 2, the game controller 5, the mouse 21, the headset 24 including a microphone 3, and the optical, hybrid electro-optical, and/or quantum computer 1 can include a light source for generating and communicating data and information using the visible light spectrum and/or invisible portion of the infrared light spectrum, or other invisible portion of the electromagnetic spectrum.

For example, a light source can be used to produce different colors of light for generating photons and sine waves in the visible and/or invisible portion of the electromagnetic light spectrum. The different colors and associated frequencies and wavelengths of light can be produced by LED's, liquid crystals, lasers, or other light sources. The keyboard(s) or other input devices and/or the computer can possibly include an integrated circuit, a character map, a linear or circular light accelerator, a microcomb, a prism, a filter, a diffraction grating, an optical CPU, an optical memory chip or device, or other means of data storage, a neural network, an interface, a compiler, and connections for coupling with fiber optical cable. In this regard, a laser or other light source can be scattered or dispersed with the use of a prism, a diffraction grating, a filter, a microcomb, and/or other photonic or optical devices. When a keystroke is made on a keyboard which either includes or is connected to the light source a specific frequency and wavelength of light can then be generated and communicated using fiber optical cable to an optical CPU and optical memory chip or other device which is capable of persisting data and information. In this regard, fiber optical cable can transmit about 100 terabytes (tb)/second in C and L bands: the C band is between 1530-1565 nm; the L band is between 1565-1625 nm; the O band is between 1260-1360 nm, the E band is between 1360-1460 nm, the S band is between 1460-1530 nm, and the rarely used U band is between 1625-1675 nm. These wavelengths fall into the invisible portion of the electromagnetic light spectrum. The visible portion of the light spectrum is between 380-740 nm or about 400-700 nm. Lasers which use sapphire can render between 670-1100 nm and are very efficient at around 800 nm, but other materials can be used in the making of lasers to generate other frequencies and wavelengths. Alternatively, the other semiconductor materials which are typically used to make light emitting diodes (LEDs) are recited in the article: “Light-Emitting Diode Physics” on the website: https://en.wikipedia.org/wiki/Light-emitting_diode_physics.

When a prism is made from a crystalline material such as germanium, ruby, sapphire, diamond, quartz, salt, silicon, or other crystalline material, and in particular when the crystalline material is sensitive to a piezoelectric effect or can otherwise be caused to vibrate and change modes and so its optical and/or electrical properties, the prism can be adapted or tuned to communicate data using the electromagnetic light spectrum, that is, it is possible to make a tunable prism. Sapphire lasers are capable of providing between 670 nm-1100 nm, and is most efficient at about 800 nm in this range, and such lasers are sometimes used in spectroscopy. U.S. Pat. No. 2,212,845 by Alexander M. Nicolson discloses piezoelectric effects using Rochelle salt crystals. U.S. Pat. Nos. 1,450,246 and 1,472,583 by Walter Guyton Cady disclose crystal controlled oscillators, and these U.S. patents are hereby incorporated by reference herein. Quartz is silicon dioxide, and so-called AT cut quartz crystals can be used to make oscillators or resonators having a frequency between 800 KHz and 300 MHz. Synthetic quartz is made for this purpose, and it can be used in a crystal oscillator circuit. Mode locked oscillators can produce short pulses in the range of picoseconds and femtoseconds. The Seiko Epson 56-8003 series provides an example of a modern programmable quartz crystal oscillator, e.g., the Epson SG-8003CG. The aforementioned structures, devices, and methods of communicating data and information can be included in or used with one or more of the devices shown in FIG. 30.

FIG. 30 shows a game controller 5 which can possibly include a light source for communicating data to a computer or gaming platform using the visible light spectrum and/or invisible portion of the infrared light spectrum, and an optical fiber cable 4, as discussed above. Further, the game controller 5 can include the structures and features disclosed in U.S. Pat. No. 10,507,385 B2, U.S. Pat. No. 11,202,960 B2, and U.S. patent application Ser. No. 17/524,373 by Kieran S. Lyden, and all of these patents and the patent application are hereby incorporated by reference herein.

When information is sent wirelessly from a remote keyboard, mouse, game controller, or microphone to a computer using the binary system and digital communication, the electromagnetic signal can be received by the computer and processed by a digital to analog converter and then sent to an optical CPU and be stored in an optical memory device, or alternatively, using other means of data storage such as ROM, RAM, Flash, Solid State Drive (SSD) memory, spintronics memory or DNA coding memory. Conversely, data and information that is processed and stored optically can be communicated by using an optical analog to digital converter to external devices which use electronic means and digital communication. For information on the subject of spintronics memory, see, e.g., the articles “Highly Efficient Spintronics Memory Offer High Speeds at Low Power,” published Dec. 7, 2020, on the website: https://www.hpcwire.com/off-the-wire/jighly-efficient-spintronics-memory-offersohigh-speeds-at-low-power/; and, “Spintronic Devices: A Promising Alternative to CMOS Devices,” by Prashanth Barla, Vinod Kumar Joshi, and Somashekara Bhat, published on Jan. 21, 2021 on the website: https://www.google.com/url?sa=t&source=web&rct=j&url=https://link.springer.com/article/10.1007/s1_0825-020-01648-6&ved=2ahUKEwj375bakKr1AhVxk4EHVgfDtoQx7wDegQIBhAB&usg=AOvVaw0jCGYZC-CUXQ7cgBTSQsVO. For information on DNA coding memory, see, e.g., the articles “DNA Digital Data Storage” published on the Wikipedia website: https://g.co/kgs/sna3Fj; “DNA: The Ultimate Data-Storage Solution—Scientific American,” by Latchesar Lonkov and Bradley Settlemyer, published on May 28, 2021 on the website: https://www.scientificamerican.com/article/dna-the-ultimate-data-storage-solution/?amp-true.

When a microphone 3 or one or more of the other devices shown in FIG. 30 include means for recording vocal and audio information, the words, sounds, or music can be recorded and placed into a digital or analog format and be stored in RAM, ROM, flash memory, Solid State Drive (SSD) or other memory on magnetic tape, CD, DVD, laser disc, or using means for persisting data and information. In this regard, vocal, sound, and music information can also be processed by a digital to analog optical converter or by other mechanical and/or electronic to photonic or optical conversion devices, and be stored in an optical memory chip or device, or other data storage device. Again, the sound tracks of feature films are typically optically embedded in the film substrate and in the past the images and sound track were synchronized using a movieola device. The sound track(s) present on feature films are then later converted into audio output with the use of optical-electrical converters included in the film projectors used in movie theaters. Further, audio frequencies and wavelengths can also be used to communicate data and information not directly associated with vocal communication or music. In this regard, the audible portion of the sound spectrum is typically between 20-20,000 Hz. However, elephants can use and hear lower frequencies, and dogs can hear higher frequencies hence the use of a dog whistle. Whales and dolphins use sonar or bi-sonar. Bats use ultrasound and echo-location. Sound waves are typically sinusoidal and can be communicated using analog equipment, and they can also be readily converted to a photonic or optical form of data and information, and vice-versa, a photonic or optical form of data and information can be converted into sound and an audio form of communication.

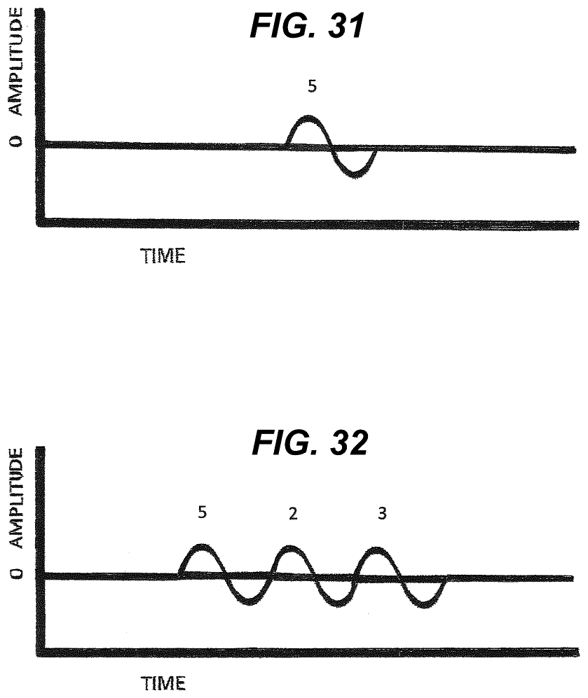

As shown in FIG. 31, a single sine wave can be used to represent and communicate a number having a base portion which has a value of “m” which equals 10 in the base ten number system, or a different value in a different base number system, and also an exponent portion of the number having a value of “n” which can be derived from a logarithm table. For example, log₁₀ x=0.698970004 can be expressed as 10^{0.698970004} (“mⁿ”) and this can represent and communicate the number x=5. The base portion value “m” and exponent portion value “n” can be configured to be manipulated by a mathematical function and/or algorithm by which a resultant wave form having a specific frequency and wavelength is derived to represent and communicate the value of the number “mⁿ” in a single sine wave. The resultant wavelength form which is assigned and coded to represent the value or number “m” “in a single sine wave can be derived by a mathematical function and/or algorithm which can possibly include other operations, e.g., addition, subtraction, multiplication, division, and/or taking a square root. In this regard, when integer factorization and prime factorization is made possible on a routine basis with the use of quantum computers which could then possibly use Shor's Algorithm, there will be a need for other means and methods besides the presently widely used Rivest-Shamir-Adleman (RSA) public-key cryptosystem for providing security to data communication. The RSA public-key cryptosytem is disclosed in U.S. Pat. No. 4,405,829 which was granted to Ronald L. Rivest, Adi Shamir, and Leonard M. Adleman of the Massachusetts Institute of Technology on Sep. 20, 1983, and this patent is hereby incorporated by reference herein. When using “mⁿ” to represent and communicate a number such as 5 in the base 10 number system, the exponent “n” which in this case has the value 0.698970004 is a relatively small nine-digit number. If and when a frequency and wavelength of light which is in the THz range is to be encoded to represent the number 5, it is possible to take the value “n” which is equal to 0.698970004 and use it as a first factor, and then multiply it by a second factor in order to derive the value of the frequency of the photonic sine wave which is to be encoded to represent the number 5. Alternatively, three or more factors could be used in order to derive the value of the frequency of the sine wave which would be encoded to represent the number 5. In this way, the ability to perform integer factorization and prime factorization would be flipped and instead of being used to break a code, it can be used to help create a code and then derive one or more factors which can serve as the key to arriving at a known numerical solution, and which in this case would correspond to the frequency of a sine wave. If and when the value of one or more of the factors would also be randomized then it would be even more difficult for a hacker or other unauthorized party or form of artificial intelligence to interpret and understand the data and information which would be contained in a communication.

The assignment and encoding of specific wavelengths to represent and communicate specific values, numbers, mathematical functions and operations can be stored in computer memory or other data and information, communication, manipulation and storage system. Other numerical values which are often used in the field of science, e.g., the speed of light which is 299,792,458 meters per second, Avogadro's number which is 6.022140857×10²³, and Planck's constant which is 6.62607004×10⁻³⁴ joule seconds can each be represented and communicated by different wave forms each having a different specific frequency and wavelength. As previously discussed, a software application can be used to access lists, tables, or arrays of numbers and other information which in the past have typically been included in hard copy tables of algorithms, but which can instead be stored in computer memory, and the software application can then execute and run programs which have been compiled which can include commands and algorithms to perform mathematical computations and other processes.

Visible light falls in the range of the electromagnetic spectrum between ultraviolet and infrared light. Visible light wavelengths have frequencies between approximately 4×10¹⁴ and 8×10¹⁴ cycles per second (Hz) which corresponds to frequencies in the range approximately between 405-790 THz and wavelengths in the range between approximately 380-740 nanometers (nm), and one cycle then has a period of about 2 femtoseconds (fs). The ultraviolet light spectrum includes wavelengths in the range between approximately 10 nm and 400 nm which corresponds to frequencies in the range between approximately 30 PHz-750 THz. The infrared light spectrum includes wavelengths in the range between approximately 700 nm-1 mm and corresponds to frequencies in the range between approximately 430 THz-300 GHz. In this regard, it is known that there can be some overlap as between the visible light spectrum and the infrared and ultraviolet light spectrums. Accordingly, in order to represent and communicate the number 5 shown in FIG. 3 and also the numbers 5, 2, and 3 shown in FIG. 32 and FIG. 33 using photons and visible and/or invisible light, the mathematical variables or numbers “m,” “n,” 5, 2, 3, or other mathematical variables or numbers can be manipulated by a mathematical function and/or algorithm which can derive a resultant frequency and wavelength which falls within the frequency and wavelength range associated with visible and/or invisible light. In this regard, the combined C, L, O, E and S bands used in optical fiber cable transmission are associated with infrared light in the range between approximately 1260-1625 nm. Subtracting 1260 nm from 1625 nm yields a difference of 365 nm which is about the same difference and result obtained when 380 nm is subtracted from 740 nm which yields 360 nm and this generally corresponds to the range of wavelengths associated with visible light.

FIG. 32 shows a representation of the screen of an oscilloscope showing three different resultant wave forms which are each derived from a base number portion in a known base number system and also an exponent portion and which have been manipulated by a mathematical function and/or algorithm to derive the three different resultant wave forms each having a specific wavelength which can represent and communicate a value or number. In FIG. 32, the three different resultant wave forms are shown to directly follow one another in a series and the changes between the three different resultant wave forms take place on the reference line and/or zero. Alternatively, the three resultant wave forms could be separated by a break or a different wave form which could be used to indicate a desired mathematical function and operation therebetween, e.g., addition, multiplication, subtraction, division. Alternatively, the changes in the resultant wave forms which each have a specific wavelength can take place at a position which is off the reference line and/or zero, e.g., the changes in the resultant wave forms could take place at the one quarter, one half, three quarter, or other portion of the cycle of one or more of the three resultant wave forms. In this regard, the various forms of detection used in frequency modulation which have been previously discussed, such as slope detection, can be used to read and identify a specific frequency and wavelength from a portion of wave form.

In FIG. 32, the base portion “m” of all three of the different resultant wave forms could have the value 10 in the base 10 number system. However, the first resultant wave form could be associated with a base 10 number having an exponent portion “n” equal to 0.698970004 and log₁₀ x=0.698970004 can be expressed as 10^{0.698970004} which yields the value and number x=5, and the first resultant wave form can be suitably manipulated by a mathematical function and/or algorithm using the values or numbers associated with the variables “m” and “n”, e.g., by addition, multiplication, subtraction, division, or other function, to derive a specific wavelength which can be used to represent and communicate the number 5. The second resultant wave form could be associated with a base 10 number having an exponent portion “n” equal to 0.301029996 and log₁₀ x=0.301029996 can be expressed as 10^{0.301029996} which yields the value and number x=2, and the second resultant wave form can be suitably manipulated by a mathematical function and/or algorithm using the values or numbers associated with the variables “m” and “n”, e.g., by addition, multiplication, subtraction, division, or other function, to derive a specific wavelength which can be used to represent and communicate the number 2. The third resultant wave form could be associated with a base 10 number having an exponent portion “n” equal to 0.477121255 and log₁₀ x=0.477121255 can be expressed as 10^{0.477121255} which yields the value and number x=3, and the third resultant wave form can be suitably manipulated by a mathematical function and/or algorithm using the values or numbers associated with the variables “m” and “n”, e.g., by addition, multiplication, subtraction, division, or other function, to derive a specific wavelength which can be used to represent and communicate the number 3. Accordingly, the three resultant wave forms can represent and communicate the numbers 5, 2, and 3. Depending upon the software application being used and its included and compiled programs, commands and algorithms, the numbers 5, 2, 3 could be read and understood as simply being 5, 2, 3, or alternatively, e.g., the numbers could be used in a mathematical function such as addition and/or subtraction and then 5+2+3=10, or alternatively, e.g., the numbers could be used in a mathematical function such as multiplication and then 5×2×3=30. In order to represent and communicate the number 523, the exponent “n” associated with the first resultant wave form could be changed from 0.698970004 to 2.698970004 and log₁₀ x=2.698970004 can be expressed as 10^{2.698970004} which yields the value and number x=500, the exponent “n” associated with the second resultant wave form could be changed from 0.301029996 to 1.301029996 and log₁₀ x=1.301029996 can be expressed as 10^{1.301029996} which yields the value and number x=20, and the exponent “n” associated with the third resultant wave form could remain the same 0.477121255 and log₁₀ x=0.477121255 can be expressed as 10^{0.477121255} which yields the value and number x=3, and so this can be used represent and communicate the three numbers 500, 20, and 3. A software application including a compilation of programs including commands and algorithms can then use these numbers in a mathematic function, such as addition to derive and represent and communicate the number 523. Alternatively, the number 523 can be represented by a plurality of wave forms which represent 5×10²=500, 2×10¹=20, and 3¹=3, and a software application including a compilation of programs including commands and algorithms can use these numbers in a mathematic function such as addition to derive and represent and communicate the number 523. Alternatively, other ways and means of using mathematical operations to derive and code wave forms having a specific frequency and wavelength to represent and communicate numbers can be used.

FIG. 33 shows a representation of the screen of an oscilloscope showing two cycles of each of the three different resultant wave forms which are each derived from a base number portion in a known base number system and an exponent portion and which have been manipulated by a mathematical function and/or algorithm to derive the three different resultant wave forms each having a specific wavelength which can be used to represent and communicate a value or number. In this regard, the base portion “m” of all three of the three different resultant wave forms could have the value 10 in the base 10 number system. However, the first resultant wave form could be associated with a number in base 10 having an exponent portion “n” equal to 0.698970004 and log₁₀ x=0.698970004 can be expressed as 10^{0.698970004} which yields the value and number x=5, and the first wave form can be suitably manipulated by a mathematical function and/or algorithm using the values or numbers associated with the variables “m” and “n”, e.g., by addition, multiplication, subtraction, division, or other function, to derive a specific wavelength which can be used to represent and communicate the number 5. The second resultant wave form could be associated with a number in base 10 having an exponent portion “n” equal to 0.301029996 and log₁₀ x=0.301029996 can be expressed as 10^{0.301029996} which yields the value and number x=2, and the second wave form can be suitably manipulated by a mathematical function and/or algorithm using the values or numbers associated with the variables “m” and “n”, e.g., by addition, multiplication, subtraction, division, or other function, to derive a specific wavelength which can be used to represent and communicate the number 2. The third resultant wave form could be associated with a number I base 10 having an exponent portion “n” equal to 0.477121255 and log₁₀ x=0.477121255 can be expressed as 10^{0.4771212}ss which yields the value and number x=3, and the third wave form can be suitably manipulated by a mathematical function and/or algorithm using the values or numbers associated with the variables “m” and “n”, e.g., by addition, multiplication, subtraction, division, or other function, to derive a specific wavelength which can be used to represent and communicate the number 3. Accordingly, the three resultant wave forms can represent and communicate the numbers 5, 2, and 3. Depending upon the software application and its compilation of programs, commands, and algorithms, the numbers 5, 2, 3 could be read and understood as simply being 5, 2, 3, or alternatively, e.g., the numbers could be used in a mathematic function such as addition and/or subtraction and then 5+2+3=10, or alternatively, e.g., the numbers could be used in a mathematic function such as multiplication and then 5×2×3=30. In order to represent and communicate the number 523, the exponent “n” associated with the first resultant wave form could be changed from 0.698970004 to 2.698970004 and log₁₀ x=2.698970004 can be expressed as 10^{2.698970004} which yields the value and number x=500, the exponent “n” associated with the second resultant wave form could be changed from 0.301029996 to 1.301029996 and log₁₀ x=1.301029996 can be expressed as 10^{1.301029996} which yields the value and number x=20, and the exponent “n” associated with the third resultant wave form could remain the same 0.477121255 and log₁₀ x=0.477121255 can be expressed as 10^{0.477121255} which yields the value and number x=3, and so this can be used to represent and communicate the three numbers 500, 20, and 3, and a software application including a compilation of programs including commands and algorithms can use these numbers in a mathematic function such as addition to derive and represent and communicate the number 523. Alternatively, the number 523 can be represented by a plurality of wave forms which represent 5×10²=500, 2×10¹=20, and 3¹=3, and a software application including a compilation of programs including commands and algorithms can use these numbers in a mathematic function such as addition to derive and represent and communicate the number 523. Alternatively, other ways and means of using mathematical operations to derive and code wave forms having a specific frequency and wavelength to represent and communicate numbers can be used.

In FIG. 33, the two cycles of each of the three different resultant wave forms are shown to follow one another in a series after a break and the changes in their different respective wave forms take place on the reference line and/or zero. Alternatively, the three resultant wave forms could be separated by break or other wave form which could be used to indicate a mathematical function and/or operation therebetween. Alternatively, the changes in the resultant wave forms could take place at a position which is off the reference line and/or zero, e.g., the changes in the resultant wave forms could take place at the one quarter, one half, three quarter, or other portion of the cycle of one or more of the three resultant wave forms. In this regard, the various forms of detection which have been used in frequency modulation and discussed previously, such as slope detection, can be used to read and identify a specific frequency and wavelength from a portion of wave form.

FIG. 34 shows a representation of the screen of an oscilloscope showing two cycles of three different sine waves corresponding to visible and/or invisible light having different frequencies and wavelengths. For example: the sine wave having the shortest wavelength could correspond to the color violet in the visible light spectrum and have a wavelength of 450 nanometers (nm) which takes 1.5 femtoseconds (fs) to complete one cycle; the sine wave having the second shortest wavelength could correspond to the color yellow in the visible light spectrum and have a wavelength of 590 nm which takes 2.0 fs to complete one cycle; and the since wave having the longest wavelength could correspond to the color red in the visible light spectrum and have a wavelength of 700 nm which takes 2.3 fs to complete one cycle. Alternatively, the three different sine waves could correspond to three different frequencies in the visible and/or invisible light spectrum such as the invisible portion of the infrared light spectrum. In this regard, the combined C, L, O, E and S bands used in optical fiber cable transmission are associated with infrared light in the range between approximately 1260-1625 nm. Subtracting 1260 nm from 1625 nm yields a difference of 365 nm which is about the same difference and result obtained when 380 nm is subtracted from 740 nm which yields 360 nm and this corresponds to the range of wavelengths associated with visible light.

When is possible to detect differences in the frequency and wavelength of sine waves corresponding to 1 nanometer (nm) with desired accuracy, then there would be about 360 different possible frequencies and wavelengths in the visible light spectrum, and at least 360 more in the infrared spectrum to work with in order to perform encoding. Some of the following methods and techniques can be used in order to provide for more possible code points when using wave forms to represent and communicate data and information. A first wave form having a first specific frequency and wavelength can be combined with a second wave form having a different and second specific frequency and wavelength. In this regard, the first wave form can be followed by the second in a series. Alternatively, the first wave form and second wave form can be communicated in parallel simultaneously and share the same point of origin, and could then create a single resultant wave form. Alternatively, the first wave form and second wave form can be offset and phase shifted relative to one another. Further, the many different positions to which the two wave forms can be phase shifted can each provide for different code points. The amplitude of one, the other, or both of the first wave form and the second wave form can also be changed and otherwise manipulated. Moreover, there are other methods and techniques which can be used to provide a multiplicity of possible code points, as discussed below.

Human DNA is a long molecule held together in two strands known as polynucleotides which form a double helix coil around a plurality of base pairs which are each made of two of four possible nucleobases, namely, cytosine (C), guanine (G), adenine (A), and thymine (T). In this regard, cytosine always pairs with guanine and adenine always pairs with thymine, and the human genome is made of about 3.2 billion of these base pairs which are disposed in a series in a DNA molecule. Selecting two colors from the red, blue, and green portions of the visible light spectrum, or from the red, blue, green, and yellow portions of the visible light spectrum, or selecting other specific frequencies and wavelengths in a different portion of the visible or invisible light spectrum, and then combining them as pairs and placing them in series or in parallel is one method and technique which can emulate and approximate the data and information coding and storage ability of the DNA molecule. This method, technique, and process for representing, configuring and communicating data and information will here be referred to as color coding, and/or color coded. For example, if four colors are selected from the red, blue, green, and yellow portions of the visible light spectrum, and they can all be combined with one another, that is, unlike cytosine, guanine, adenine, and thymine in human DNA, then the potential for data and information coding and storage is possibly even greater than DNA. Furthermore, there are many more combinations and permutations which are possible using approximately 360 different frequencies and wavelengths of visible light, and at least that many more different frequencies and wavelengths of invisible light in the infrared spectrum. For example, the possible number of combinations and permutations of one color having a specific frequency and wavelength being combined with another color having a different specific frequency and wavelength selected from a list or group including at least 360 members can be calculated: Permutations nPr=360!/(360−2)!=129,240, and Combinations nCr=360!/2!×(360−2)!=64,620. The possible number of combinations and permutations of four colors which each have a different specific frequency and wavelength which can be combined with one another selected from a list or group including at least 360 members can be calculated as follows: Permutations nPr=360!/(360−4)!=16,517,647,440, and Combinations nCr=360!/4!×(360−4)!=688,235,310. While it may not be possible or practical to encode infinite numbers with a finite number of coding points, this method and technique can nevertheless provide for a substantial number of coding points. Moreover, if, e.g., eight colors having different frequencies and wavelengths are selected for use then the result would be: Permutations nPr=360!/(360−8)!=260,858,210,442,628,246,400, and Combinations nCr=360!/8!×(360−8)!=6,469,697,679,132,645. As a point of reference, Unicode and ISO/IEC 10646 provide for about 1.1 million possible coding points.

As previously discussed, the current Webster's dictionary includes about 470,000 words, and the concise Oxford dictionary includes between about 171,476 words. However, it has been estimated that most individuals only have knowledge of about 15,000-20,000 word families which are called lemmas in their native language, and individuals seldom have knowledge of more than 2,000-3,000 word families in a foreign language. Accordingly, a concise dictionary for use with a computer language can include less than 20,000 lemmas, and even less than 5,000 lemmas. If even only 1,000 or 2,000 and certainly less than 3,000-5,000 alphabetical letters, words, symbols, and numbers are each individually assigned and coded in order to be represented and communicated in the form of a square wave or a sine wave having a specific frequency and wavelength, then the amount of data in bits, waves, vibes, quwaves, quvibes, qubits, or whatever name would be given to the data and information, can be decreased by over 75%. The following websites having 1000 and 3000 word lists include the most commonly used words in English: https://gonaturalenglish.com; and, http://basicenglishspeaking.com. According to the website http://basicenglishspeaking.com: “If you know these 3000 most common words, you can understand at least 95% of all conversations, e-mails, newspapers, and books.” This is one way to create faster computers which do not consume as much time and energy as they do today, that is, if the desire is to make computers 20 times faster, then one way to accomplish this is to make a new computer language which uses a lot less data in order to communicate the same information. In view of the number of coding points which can be provided by using combinations of different wave forms in the visible light spectrum, and/or invisible portion of the infrared light spectrum, or other portion of the electromagnetic spectrum, it is be possible to encode all of the words, symbols, and functions which are presently being used, and to also encode those numbers which are used by a typical user population, or a specific target population of scientists, or other users of computers or other data and information communication, manipulation, and storage devices.

As previously discussed, a number of different models such as OSI and TCP/IP are being used to communicate data and information in telecommunications and computer network environments. The method and process of combining two or more colors in the visible light spectrum or invisible portion of the infrared light spectrum associated with specific frequencies and wavelengths to configure and make a set, and further configuring and making a plurality of sets which can then be configured in series and/or parallel, can be further configured to include and/or be communicated with one or more other specific frequencies and wavelengths associated with the configuration and making of a packet which can include control information typically included in a header or footer, and also information for the possible purpose of synchronization and error detection and correction. In order to provide a visual aid by making reference to the structure of a DNA molecule, one can imagine the control information as being mostly contained in the double helix portion of the molecule or signal, but perhaps with a few breaks and/or portions in the plurality of sets being used to include control information and also the purpose of synchronization and error detection and correction, but most or all of the sets including different combinations of specific wavelengths and frequencies then being used like the cytosine (C), guanine (G), adenine (A), and thymine (T) nucleobases in the DNA molecule to deliver the payload of data and information. In this regard, various means for persisting data and information such as the use of conventional electronic silicon memory chips, ROM, RAM which can include different types of RAM such as PRAM, RRAM, SRAM, DRAM, Flash-memory, Solid State Drive (SSD) memory, optical memory chip or device, and/or other forms of photonic memory, spintronics memory, DNA memory, and what will here be referred to as a DNA color coded memory which is configured to process and store data and information which has been configured in various combinations and permutations of different frequencies and wavelengths of visible and/or invisible light. In this regard, the method, technique, and process of configuring data and information using various combinations and permutations of different frequencies and wavelengths of visible and/or invisible light has been discussed in the preceding paragraphs using the DNA molecule as a visual aid and this method or process can be referred to as color coding, or color coded, and DNA color coded data and information, or memory.

Again, one or more of the different models, methods, and processes which are being used to communicate data and information in various telecommunication and computer network environments can be configured and adapted to be used with one or more of the structures, methods, and processes discussed and shown in the present disclosure, and vice-versa, that is, the structures, methods, and processes relating to making a computer language and code for software application development, data compression, and use with conventional, optical, hybrid electro-optical and quantum computers can be configured and adapted to be used with one or more of the different models, methods, and processes which are being used to communicate data and information in various telecommunication and computer network environments.

FIG. 35 shows a representation of a resultant wave form derived from the summation and combination of the three different sine waves shown in FIG. 34. In this regard, the amplitude and time scales shown on the vertical and horizontal axis in FIG. 35 are approximately twice as large as those used in FIG. 34. The representation shown in FIG. 35 was not derived using mathematical data which was processed and graphed by a computer program, but rather is merely a rough approximation which is intended to show that the resultant wave created by a plurality of different sine waves can be very different looking than the individual sine waves, and the individual sine waves can then be either partially or completely unrecognizable in the resultant wave. Nevertheless, the data and information associated with the three individual sine waves is still present and can be effectively communicated by the resultant wave form.

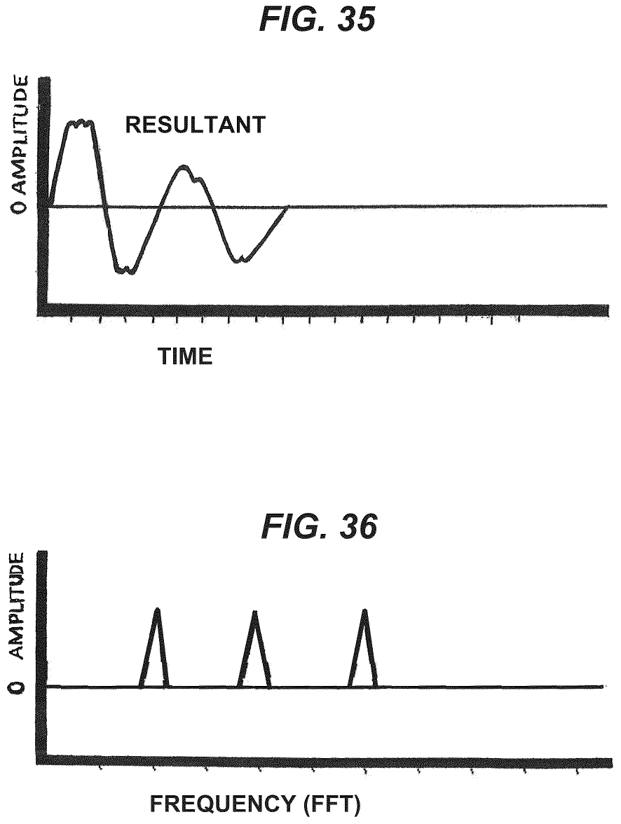

FIG. 36 shows the result of a Fast Fourier Transform (FFT) of the data and information associated with the resultant wave shown in FIG. 35. The use of the Fast Fourier Transform (FFT) can dramatically reduce the complexity and time required to compute a discrete Fourier transform (DFT) or its inverse (IDFT) by an attempt to calculate O (N²), and instead enables O (N log N) to be calculated where N is the size of the data. Some FFT algorithms depend on the factorization of N, but others exist which can also be used with prime N. In FIG. 36, the graph shows amplitude on the vertical axis, and frequency on the horizontal axis, whereas FIGS. 34-35 show amplitude on the vertical axis, and time on the horizontal axis. The FFT indicates and communicates the three different frequencies of the three different sine waves corresponding to visible and/or invisible light shown in FIG. 34 which make up the single resultant wave form shown in FIG. 35. For example: the sine wave having the shortest wavelength could correspond to the color violet in the visible light spectrum and have a wavelength of 450 nanometers (nm) which takes 1.5 femtoseconds (fs) to complete one cycle, and because wavelength times frequency equals the speed of light, and frequency equals the speed of light divided by the wavelength, the frequency corresponding to the wavelength of 450 nm would be 666,205,462,222,222 Hz. This frequency would then be indicated and communicated by the peak shown in FIG. 36 on the far right side. The sine wave having the second shortest wavelength could correspond to the color yellow in the visible light spectrum and have a wavelength of 590 nm which takes 2.0 fs to complete one cycle, and because wavelength times frequency equals the speed of light, and frequency equals the speed of light divided by the wavelength, the frequency corresponding to a wavelength of 590 nm would be 508,122,810,169,492 Hz, or approximately 508 THz. This frequency would then be indicated and communicated by the peak shown in FIG. 36 in the middle. The sine wave having the longest wavelength could correspond to the color red in the visible light spectrum and have a wavelength of 700 nm which takes 2.3 fs to complete one cycle, and because wavelength times frequency equals the speed of light, and frequency equals the speed of light divided by the wavelength, the frequency corresponding to a wavelength of 700 nm would be 428,274,940,000,000 Hz, or approximately 428 THz. This frequency would then be indicated and communicated by the peak shown in FIG. 36 on the far left side. When these three different frequencies and wavelengths of visible light are coded so as to represent specific data and information, whether it be a single letter of the alphabet, a word, a symbol, a number, a command, a function, or an operation, the data and information can be communicated using light waves, and be read and understood by a user of a computer or other data storage and processing device which includes a software application which includes a compilation of programs, codes, lists, tables, arrays, algorithms, commands, and other methods for processing, manipulating, and storing data and information.

Alternatively, the three different FFT wave forms could correspond to three different sine waves having the different frequencies and wavelengths in the visible and/or invisible light spectrum, such as the invisible portion of the infrared light spectrum. Accordingly, whether data and information is communicated using visible light, invisible light, or a different portion of the electromagnetic spectrum, and whether the data and information is communicated in a series of wave forms, or a plurality of wave forms communicated in parallel, or a plurality of wave forms which are being communicated nearly or actually simultaneously, and then whether using electronic means and wires and/or photonic means using visible or invisible light and optical fiber cable or other photonic or optical communication structures, devices and methods, the data and information associated with a plurality of wave forms and signals can be communicated, identified, read and understood by a user of a computer or other data storage and processing device which includes a software application which includes a suitable compilation of programs, codes, lists, and algorithms including but not limited to the Fast Fourier Transform (FFT), and other possible commands, methods, and techniques for processing, manipulating, and storing data and information.

### Optical, Electro-Optical and Quantum Computers

Classical or conventional computers which use the digital system have and will continue to be with us for a long time, but the introduction of optical, electro-optical, and quantum computers based upon them will make classical computers obsolete for performing certain tasks. As previously discussed, a single bit interval on a conventional digital computer typically corresponds to about 10×10⁻¹² or 10 picoseconds which is 0.000000000001 seconds, whereas the duration of one complete cycle of a sine wave period in the visible or invisible light spectrum is between approximately 1-4 femtoseconds (fs), and one femtosecond is a unit of time equal to 1×10⁻¹⁵=0.000,000,000,000,001 seconds. A light source such as a femtosecond laser, also known as a femtolaser, is able to communicate a sinusoidal wave form, sine wave, wavelet, or pulse associated with visible or invisible light in equal to or less than 10 fs, and even less than 5 fs. For the sake of simplicity, the round number 2 fs will be sometimes be used in this specification for the duration of one complete cycle or period of a sinusoidal wave form, sine wave, cosine wave, but also regarding a wavelet, or pulse when later making comparisons regarding the relative speed of visible and invisible light when being transmitted versus the electronic signals which are being used in classical or conventional computers today. These comparisons do not take into consideration the time it would take to read, write, or process data and information, but merely compare the approximate time it would take for these signals to be transmitted or communicated. While these comparisons can help individuals to appreciate the difference in communication speeds, these examples and comparisons should not be construed in a manner as to limit the scope of the present invention.

### Representing Letters, Words, and Symbols

In order to communicate Alexander Graham Bell's instruction “Mr. Watson, come here.” the binary number digital system would likely take the 22 letters and symbols×8 bits each=176 bits, and they would be transmitted as ones and zeros. Given a classical or conventional computer having a bit interval of 0.000000000001 it would take about 0.000000000176 seconds to communicate the sentence “Mr. Watson, come here.” By comparison, an optical computer or hybrid electro-optical computer which communicates visible and/or invisible light signals having a wave period of 2 fs can send the same message in series in about 44 fs which is 0.000000000000044 seconds. Further, using visible or invisible light in this manner requires fewer signals to be communicated and stored in memory, that is, 22 sine waves versus 176 bits, and so 22/176=X/100 and X=12.5 percent which represents an 88.5 percent reduction in data signals. Moreover, unlike the digital system in which a string of ones and zeros are communicated in series and a sequence, it is possible to send sinusoidal waves, and/or sine waves, and/or wavelets, and/or pulses associated with visible or invisible light signals in parallel, that is, all at the same time. Accordingly, the message of Alexander Graham Bell can potentially be communicated in about 2 fs by an optical computer or electro-optical computer versus 176,000 fs for a classical or conventional digital computer.

Further, there are only 9 different word classes in the English Language: noun, verb, adjective, adverb, pronoun, preposition, conjunction, determiner, and exclamation. In this regard, alphabetical letters and/or words can be encoded with a prefix, suffix, or other identifier to indicate and signal their corresponding word class. Because of the grammatical and punctuation rules which exist in the English language, e.g., a noun is typically placed before a verb and an adverb typically follows a verb, the possible and/or proper relative order of the alphabetical letters and words belonging to these 9 different word classes can be determined in a communication even when the individual words are being sent in parallel. The inclusion of information corresponding to various word classes can then be used to determine the order of the words used in a sentence ending in a period, or a group of words or an equation which ends with some other form of punctuation. Alternatively, a numerical number and related signal can be added to each letter, word, or symbol to indicate their correct order in a sentence. In this case, related pairs of signals can be communicated to indicate what the letter, word, number or symbol is that has been encoded, but also its correct order in a sequence of signals that make up a sentence, or an equation.

In addition, when using the English language, the average word size is 5 letters, and the average sentence size is 14 words. In this regard, the punctuation which terminates a phrase or sentence can also serve as a command and/or instruction in a software program for it to then determine and provide the correct word order of the phrase or sentence. Adding a prefix or suffix to a word would only add about 2 fs to the communication of each word when communicated in series, but would add little or no time when the word or another of piece of data and information is being communicated in parallel. In this regard, when the use of a prefix, suffix, a number, a symbol, a superscript, a subscript, an exponent, a wave form, a pulse, a tag, a map, a link, an association with a particular one of a plurality of optical channels in a multiplexer or demultiplexer, or other designator or numerical identifier is attached, transmitted, or correlated with each of the individual wavelengths and corresponding frequencies of visible and/or invisible light which are being used to represent and encode data and information in order to create, establish, or encode and/or to determine, decode or decipher an identifiable sequence, then data and information can be transmitted in parallel and/or in series or a sequence, and also be read, written, persisted or stored in parallel and/or in series or a sequence, and the data and information can be accessed and retrieved in parallel and/or in series or a sequence, and the data and information can be manipulated and computed in parallel and/or in series or a sequence. Further, it is also possible to directly represent and encode a dictionary of words such that a single sinusoidal wave, sine wave, wavelet, pulse, or square wave signal having a specific frequency and wavelength represents an entire word, e.g., the word elephant could be represented by a single encoded sine wave. As discussed earlier, a dictionary including between 1,000-5,000 common words that would each be directly represented and encoded by a specific signal can easily cover over 95% of the words which are used in typical communications. Moreover, it is also possible to represent and encode a group of words, sentence, paragraph, or other form of text using a single signal.

Once again, when using the English language, the average word size is 5 letters, and the average sentence size is 14 words. If one has a light source e.g., the 16-lambda DFB laser array made by Sivers Photonics of Glascow, Scotland, https://www.sivers-semiconductors.com/sivers-photonics/, which includes and can communicate 16 individual infrared light signal channels that are separated by 2 nanometers in wavelength which can each communicate 16 signals for a total of 256, and/or a communication device such a multiplexer and/or demultiplexer which includes a plurality of channels that can communicate individual sinusoidal wave, sine wave, wavelet, or pulse signals, and/or the compact and tunable laser which can generate hundreds of different colors which has been developed by Xscape Photonics, Inc., see the interview with Xscape Photonics CEO Vivek Raghunathan on Escape Bandwidth, of Xscape Photonics, Inc., by EE Times, Oct. 16, 2024, https://youtu.be/EjJ2Y5snTBk?si=kfvuoAHODUdWSoVD, or other spatial light modulators, then it is possible to communicate the alphabetical letters, and/or words, and/or symbols contained in a sentence in parallel because the first light source or channel can be configured by computer hardware and/or a software program to communicate the first word of a sentence, and the second light source or channel can be configured to communicate the second word, and so on. Accordingly, a 14 word sentence in which each word is represented and encoded by a plurality of visible and/or invisible light signals, and which uses another encoded signal, or no signal to indicate the presence of spaces or breaks between the adjoining words, and another encoded signal to indicate a period at the end of the sentence can then be communicated using 28 signals, or even less. When using the digital system, 8 bits or 1 byte is typically required in order to represent a letter of the alphabet, or a single digit number, or a symbol.

When using the QAM modulation system, the first step is to select and begin with a carrier wave, the second step is to modulate the carrier wave with a series of digital square waves representing 1's and 0's, the third step is to transmit this product which is the modulated signal out, the fourth step is to demodulate the signal out which has been received, and the fifth step is to filter the demodulated signal to recover the series of digital square waves representing 1's and 0's that was used to modulate the carrier wave. In contrast, the parent U.S. Pat. No. 11,809,839 and present application teaches and discloses, e.g., that wavelengths and corresponding frequencies of visible and/or invisible light which can be in the form of a sinusoidal wave, a sine wave, a cosine wave, a square wave, a wavelet, or a pulse can be directly used as the encoded signal, and that it can represent an alphabetical letter, word, sentence, number, symbol, formula, or equation. Accordingly, the sinusoidal wave, sine wave, cosine wave, wavelet, or pulse signal does not necessarily need to be modulated and demodulated, but can simply be transmitted and then detected on the receiving end which it can provides at least as much data and information as 8 digital bits. As a result, an alphabetical letter, word, a sentence of written text, a number, a symbol, or an equation can be communicated almost instantaneously, that is, in about 2 fs, and the data and information can then be placed into short, medium, or long term memory using, e.g., flash memory, or an optical memory device such as a holographic memory device, an optical or holographic disc memory device, or a glass or crystal memory device, and the correct sequence of the visible and/or invisible light signals can also be known or determined using one or more of the methods and techniques described herein.

### Representing Numbers

Before the introduction of computer calculators in the 1970's, slide rules, exponents and logarithms were used by individuals in the sciences to represent and manipulate large numbers. These devices and methods helped to make people faster and better at solving math problems. As previously discussed, by directly encoding and representing the base portion of a number with a first signal, and its place holder value or exponent with a second signal, and doing likewise with any other exponents or logarithms, it is also possible to make computers faster and more efficient. For example, using the current digital system, it takes 34 digits to represent the number 3,486,784,401=0110011111110101000001101110010001. The number 3,486,784,401 is also 3²⁰ in exponential form which can be communicated using less than 6 sine waves. Obviously, it is not always possible to represent a large number by using a single numerator raised to an exponential power. However, it is always possible to represent each individual base number which is present in 3,486,784,401 using a first signal in the visible or invisible light spectrum, and then also represent that base number's place holder value using a second signal in the visible or invisible light spectrum corresponding to its exponential power:

$$1 = {10}^{0}$$

$$10 = 1 {0}^{1}$$

$$100 = 1 {0}^{2}$$

$$1000 = 1 {0}^{3}$$

For example, let's consider the number 144, which is 1×10²=100+4×10¹=40+4×10⁰=4. These components can alternatively be arranged vertically as shown below.

$$1 \times {10}^{2} = 100$$

$$4 \times {10}^{1} = 40$$

$$4 \times {10}^{0} = 4$$

It is also possible to simply this notation and example. In this regard, when using scientific notation a carrot exponent symbol \hat{ } is sometimes used to indicate the exponential power of a number. If we know that we are using base 10, then the use of base 10 does not have to be represented and communicated. What we then need to know is the value of the base of the number, and also its place holder value or exponential power. The essential information can then be coded, represented and communicated as show below.

$${1}^{⋀} 2 = 1 \times {10}^{2} = 100$$

$${4}^{⋀} 1 = 4 \times {10}^{1} = 40$$

$${4}^{⋀} 0 = 4 \times {10}^{0} = 4$$

This enables any base number to be represented using 2 numbers, that is, one to indicate the base, and the other to indicate its index, place holder value, or exponential value, and one carrot \hat{ } symbol, thus 3 sinusoidal waves, sine waves, wavelets, or pulses. However, if we know that the first number of a pair indicates the value of the base portion of a number, and that the second number represents its place holder or exponential value this information can be simplified even more. In this regard, we don't really need to use a carrot symbol \hat{ } or some other designator to indicate that the second number in a pair of numbers represents the place holder value or exponential value. Accordingly, 144 can be represented and communicated in three pairs 12 41 40.

$$12 = {1}^{⋀} 2 = 1 \times {10}^{2} = 100$$

$$41 = {4}^{⋀} 1 = 4 \times {10}^{1} = 40$$

$$40 = {4}^{⋀} 0 = 4 \times {10}^{0} = 4$$

### Vertically.

12
41
40

### Horizontally.

12 41 40

Given the availability and use of a light communication device which can communicate 6 or more individual frequencies and wavelengths simultaneously on a single channel and/or on separate channels, the numbers 12 41 40 can be sent simultaneously. Alternatively, each pair can be sent simultaneously, but with a phase shift delay in communicating the second number of each pair.

Again, using the current digital system, it takes 34 digits to represent the number 3,486,784,401=0110011111110101000001101110010001. This number can alternatively be represented by number pairs in which the first number indicates the value of the base portion of the number, and the second number represents its place holder or exponential value.

3,486,784,401
39 48 87 66 75 84 43 42 01 10

The creation of these number pairs and their possible simultaneous communication in parallel using sine and cosine functions which are 90 degrees out of phase is well suited for digital and/or optical communication using the QPSK and/or QAM modulation methods, and the like.

It is possible to perform addition, subtraction, multiplication, and division on paper and using a keyboard and computer using the above Base\hat{ }Place Holder or exponent notation. In this regard, the writing of programs, algorithms, and the performance of many calculations is relatively easy because the number of intermediate sums to be carried over and placed into memory are relatively few. Here are some examples:

### Addition:

$$144 + 23 = 167$$

$${1}^{⋀} 2 + \{ {4}^{⋀} 1 + {2}^{⋀} 1 = {6}^{⋀} 1 ) + ( {4}^{⋀} 0 + {3}^{⋀} 0 = {7}^{⋀} 0 ) = 167$$

### Subtraction:

$$144 - 23 = 121$$

$${1}^{⋀} 2 + \{ {4}^{⋀} 1 - {2}^{⋀} 1 = {2}^{⋀} 1 ) + \{ {4}^{⋀} 0 - {3}^{⋀} 0 = {1}^{⋀} 0 ) = 121$$

### Addition:

$$144 + 26 = 170$$

Here you would normally carry over 1 to the tens column. There are ways to show this and write algorithms and programs that will perform the required calculation.

$${1}^{⋀} 2 + \{ {4}^{⋀} 1 + {2}^{⋀} 1 = {6}^{⋀} 1 ) + \{ {4}^{⋀} 0 + {6}^{⋀} 0 = {1}^{⋀} 1 ) = 170$$

### Subtraction:

$$144 - 26 = 118$$

Here you would normally subtract and borrow one from the tens column. There are ways to show this and write algorithms and programs that will perform the required calculation.

$${1}^{⋀} 2 + \{ {4}^{⋀} 1 - {2}^{⋀} 1 = {2}^{⋀} 1 ) + \{ {4}^{⋀} 0 - {6}^{⋀} 0 = - {1}^{⋀} 1 + {8}^{⋀} 0 ) = 118$$

### Multiplication:

$$3 \times 144 = 432$$

$$\{ 3 \times {1}^{⋀} 2 = {3}^{⋀} 2 = 300 ) + \{ 3 \times {4}^{⋀} 1 = {1}^{⋀} 2 + {2}^{⋀} 1 = 120 ) + \{ 3 \times {4}^{⋀} 0 = {1}^{⋀} 1 + {2}^{⋀} 0 = 12 ) = 432$$

$$144 / 3 = 48$$

$$100 = {1}^{⋀} 2 ) / 3 = ( {3}^{⋀} 1 = 30 ) + ( {3}^{⋀} 0 = 3 ) = 33 + {1}^{⋀} 0 = 1 Remainder ) ,$$

$$( 40 = {4}^{⋀} 1 ) / 3 = ( {1}^{⋀} 1 = 10 ) + ( {3}^{⋀} 0 = 3 ) = 33 + {1}^{⋀} 0 = 1 Remainder ) ,$$

$$4 = {4}^{⋀} 0 ) / 3 = \{ {1}^{⋀} 0 = 1 ) + {1}^{⋀} 0 = 1 Remainder ) .$$

$$Adding the Non - Remainders 33 + 13 + 1 = 47$$

$$Adding the 3 Remainders = 3 and 3 / 3 = 1 which added to 47 = 48 .$$

### Division:

Alternatively, it is possible to use the same kind of notation and method when using logarithms to represent numbers and to perform calculations. Moreover, if one has a light source e.g., the 16-lambda DFB laser array made by Sivers Photonics of Glascow, Scotland, https://www.sivers-semiconductors.com/sivers-photonics/, which can transmit 16 signals on each of its 16 channels for a total of 256, and/or a communication device such a multiplexer and/or demultiplexer which includes a at least 16 channels that can communicate individual sinusoidal wave, sine wave, wavelet, or pulse signals which can be separated by only 1 or 2 nanometers in wavelength, then it is possible to directly communicate a number having at least 16 base number portions, that is, a value or number in the range between 0 and 9,000,000,000,000,000 in about 2 fs because each individual base portion of the larger number can be directly communicated simultaneously using one of the channels. Alternatively, all of the 16 different individual channels can be used and by configuring the computer hardware and software, the associated individual place holder values of each of those 16 base number portions can be known by virtue of which laser channel, or other light source, was used to communicate each one of the signals. In this regard, light source channel 1 can be configured and designated by hardware and/or a software program to represent the ones column and its base number value, light source channel 2 the tens column and its base number value, light source channel 3 the hundreds column and its corresponding base number value, and so on. Alternatively, channel 1 can be designated by hardware and/or software to represent the first base number in a sequence of numbers and/or the first symbol of an equation, and channel 2 can be designed to represent the second number or symbol, and so on. Few individuals will ever have the need to communicate a number having more than 16 digits, but those working in the sciences sometimes do work with large numbers.

If and when a number would exceed in length the available number of individual light communication channels and/or their signal capacity, then the larger number can be broken down into 2 or more parts or factors, and/or possibly into one or more base portion(s) including an exponent in order to represent and communicate the larger number more efficiently. If an additional mathematical operation including addition, multiplication, and/or the use of an exponent or logarithm would then be required, a software program including the required algorithms can be configured to automatically perform such operations. Alternatively, exponents equal to or greater than 10 can be directly encoded, as well as certain numbers which are often used in math and the sciences such as the speed of light, Euler's number, and Avagadro's number. However, such methods and techniques will not typically be required when using a device having 16 or more optical channels. Accordingly, with the use of a computer and relevant computer software, it is possible for the aforementioned devices and others like them to be configured and used to represent and communicate numbers having at least 256 base number portions, that is, a number which could be as large as 9.0×10²⁵⁵, and for those signals to be communicated in parallel in about 2 fs and the correct number sequence can also be determined or known.

### Light Sources and Manipulating Light

When using nanometers (nm) for measurement purposes and to discriminate differences in wavelength, there are over a thousand different frequencies and wavelengths of light present in the visible and invisible light spectrums which can be used to represent and encode the letters of the alphabet, words, symbols, and numbers. Once again, there are four broad categories or methods of manipulating and/or modulating light: birefringence or double refraction methods as can be produced by a prism or diffraction grating, magneto-optic methods, electro-optical methods, and acousto-optical methods.

White light can contain all of the frequencies and wavelengths in the visible light spectrum. Some of the light sources potentially available for use in providing white light include liquid crystal displays (LCDs) which can provide red, green, and blue (RGB) colors which can be manipulated to provide white light, and there is also the M+ version LCD which adds white. LCDs typically use what is called twisted nematic and/or super in-plane switching in order to provide color rendering, but even when operating in blue phase mode LCDs have a switching time of about one millisecond, and this is relatively slow given the speeds desired and required for modern computing, but not for visual displays such a computer monitors and televisions, e.g., see Liquid Crystal Display—Wikipedia, https://en.wikipedia.org/wiki/Liquid-crystal_display.

Light emitting diodes (LEDs) can use the RGB method and/or add a yellow phosphor component to the magnesium doped gallium nitride that is typically used to make commercial blue LED's in order to provide white light. Organic LEDs or OLEDS are economical to make, and the response time of OLEDS can approach 200 kHz. Perovskite LEDs or PeLEDs can provide narrow bandwidths and also have the ability to provide an adjustable spectrum. Micro LEDs can be made very small, e.g., 5 μm, and provide light in the visible and infrared light spectrums, but also sub-nanosecond response times.

Lasers, dye lasers, laser diodes, micro laser diodes, masers (microwave amplification by stimulated emission of radiation), Femtolasers, and photonic crystal lasers can also provide light in the visible and invisible light spectrums. In particular, micro LEDs, micro laser diodes, femtosecond lasers, and photonic crystal lasers can be made very small, and also have fast response times, e.g., see Visible Light Communication: A System Perspective-Overview and Challenges, by Rehman et al., Mar. 7, 2019, https://www.ncbi.nlm.nih.gov/pmc/articles/pmid/30866473/.

It is possible to take a single light source such as the sun, or a different source of light which to the naked eye may appear to be white and then separate it by using birefringence or double refraction into a plurality of different wavelengths and frequencies of light which in the visible light spectrum then appear as different colors. This can be done using refraction and a prism. It can also be done using diffraction and a diffraction grating having slits or an irregular surface including peaks and valleys. In this regard, there are reflection gratings and also transmission diffraction gratings.

A multiplexer device can be used at the transmitter in order to combine and/or to send invisible infrared light signals over fiber optical cables and then a demultiplexer device such as a wave division multiplexer device can be used at the receiver to separate or split the them apart. In this regard, a multiplexer device which can perform course wavelength division multiplexing (CWDM), or dense wavelength division multiplexing (DWDM), and other devices such as an Optical Add Drop Multiplexer (OADM), a Reconfigurable Add Drop Multiplexer (ROADM), transceivers, transponders, repeaters, and optical amplifiers such as Erbium doped fiber amplifiers, and/or Raman amplifiers can be used in order to provide what can be over 100 different channels which can transmit different frequencies and wavelengths of visible and/or invisible light and a plurality of signals, e.g., see: Multiplexing, Wikipedia, https://en.wikipedia.org/wiki/Multiplexing; Multiplexor, Wikipedia, https://en.wikipedia.org/wiki/Multiplexer; and, What is Multiplexer and Types of Multiplexing Techniques, by admin, Jan. 5, 2021, https://www.watelectronics.com/what-is-multiplexer-and-types/.

An input device such as a keyboard, a mouse, a microphone, a voice recognition device or voice command, a camera, an analog to digital converter, a digital to analog converter, a transceiver, a transponder, a computer monitor including a touchscreen, an oscilloscope, a spectrum analyzer, a wire, a wireless device, a computer printer, or other input device can be linked to a multiplexer device on the transmitting end, and on the receiving end a wave division multiplexer device can communicate the data and information to and/or inside of an optical computer, electro-optical computer, or like quantum computer which can perform calculations or other computer functions using an optical processor and an optical memory device, or a hybrid combination of an optical processor and memory device.

Again, a prism or diffraction grating can be used to separate light into a plurality of wavelengths and frequencies, and in the visible light spectrum into different visible colors. However, mechanically changing the angle of the incident light relative to a prism and/or changing the orientation of a prism can be relatively slow, and so is mechanically changing the width of the slits or uneven surface of a diffraction grating. Accordingly, in order to be fast enough and energy efficient, the desired refraction, diffraction, or other modulation of light can be done using magneto-optic, electro-optic, and acousto-optical methods. In this regard, visible and invisible light are part of the electromagnetic spectrum and are thereby associated with electrical and magnetic fields, and typically the fastest way to control or modulate light at or near the speed of light, is with the use of light. In this regard, scientists have created PLASMONS devices, e.g., see, Tim Davis—All optical modulation of light, by NanoFabTV, Jul. 14, 2014, https://youtu.be/bUDDEiCIOAo?si=Ndv5WRe9DMG8WaeL. This method involves the use of a prism and a reflection grating. In brief, one can take a prism and use a relatively high energy source of light such as a laser and the incident light beam enters from a first side and then strikes the second side of the prism which includes a thin coating of metal which is typically made of gold or silver. Some of the light gets through the metal on the second side, but most of the rest is reflected at the SPR angle and exits from the third side. The frequency and wavelength of light which has passed through the second side will then be missing in spectral band which is reflected from the third side. Changing the composition of the metal, and/or the size, and/or shape of the surface roughness, and/or the holes, and/or the peaks and valleys, and/or the level of the electric and/or magnetic field being applied to the metal changes the frequency and wavelength and hence the color of the light which gets through the second side, but also the light that gets reflected and exits from the third side. This structure is known as the Kretchmann configuration. There is also an Otto Configuration in which the metal reflector and/or refractor is located very close too, but not quite on the surface of the prism. The Otto Configuration has been difficult to configure in the past with precision, but the present application here discloses that a single layer or multiple layers of graphene or graphene oxide can be used to create the desired separation and offset. In brief, it is possible to change the electrical and magnetic field(s) being applied to the metal coating on or near the second side of a prism to change and thereby tune the PLASMON to emit and reflect different frequencies and wavelengths of light. At this time, the practical problem with this method has to do with the use of high intensity lasers and/or high electrical and magnetic fields to create a tunable PLASMON. As a result, this technology has not lent itself to the creation of a desktop or laptop computer for a mass market.

For this reason, instead of using metals like gold or silver which have relatively high melting points and require a lot of energy to excite their atomic and physical structure in order to tune them, the present application here teaches and discloses that metals or other forms of matter with lower melting points and/or which can be excited with less energy at or near room temperature can alternatively be used to make a tunable PLASMON device for a computer application. In this regard, mercury, or gallium may instead be used, but mercury is very toxic. However, gallium is not toxic and it melts at 30 Celsius/86 degrees Fahrenheit. Gallium is also transparent in the visible light range. Germanium has a higher melt temperature than gallium, but is transparent in the infrared light range and it has been used for many years on optics, but also to make phase change optical storage disks such as CDs and DVDs.

As previously discussed, one of the alternative methods to using a prism for dividing white light into a plurality of frequencies and wavelength is the use a grating surface such as a reflective grating surface, or a transmission grating surface. The present application here teaches and discloses that these grating surfaces can be tuned using relatively low levels of electric and magnetic fields, and/or light, and/or sound and then also at or near room temperature, and so these methods can lend themselves to the creation of a practical desktop or laptop computer for the mass market. In support of this method and technique, it is known that two beams from ruby lasers inclined at an angle to one another striking germanium can create a diffraction grating having spacings between 2-20 um which is temporary and causes no permanent deformation, e.g., see Temporary Gratings On Germanium, by Wiggins et al., Oct. 15, 1974, https://www.semanticscholar.org/paper/Temporary-gratings-on-germanium-Wiggins-Salik/d9bd905c8f986895ab4f62aa64372ab21d879b09. Sound waves can do the same thing and this would include ultrasound and forms of modal vibration, e.g., see the articles provided in the section on Sound And Other Modulation Techniques including those relating to Cymatics and Brillouin scattering listed below. Just as tossing a stone can cause waves to form on a lake, fluctuating or changing electric and/or magnetic fields and/or light, and/or sound can create different wave patterns in a solid, liquid, gas, or plasma. As discussed above, when directing a beam of light through solid crystalline matter such as a prism, the refractive index of the crystalline material can then be manipulated. Lithium Niobate, which is a crystalline material can be doped with metals such as iron (Fe), and it has been used in the past as a storage medium to make holographic memory devices. Accordingly, a holographic crystalline medium and holographic memory device can also be similarly manipulated and visible and invisible light signals which are being used to represent and encode data and information can be communicated and also modulated in response to an electric field, a magnetic field, visible or invisible light, or acoustic stimulation. By reducing the number of light sources which are required, it is possible to simplify the design and operation of an optical computer, electro-optical computer, and/or quantum computer, and to lower its production cost, but also the energy which is required to communicate, process, and store data and information in memory. The recent introduction of the 16-lambda DFB laser array made by Sivers Photonics of Glascow, Scotland, website: https://www.sivers-semiconductors.com/sivers-photonics/, which includes and can transmit and communicate using 16 individual infrared light signal channels that are separated by 2 nanometers in wavelength with each channel having the capacity to communicate 16 signals for a total of 256, and/or the compact and tunable laser which can generate hundreds of different colors which has been developed by Xscape Photonics, Inc., see the interview with Xscape Photonics CEO Vivek Raghunathan on Escape Bandwidth, of Xscape Photonics, Inc., by EE Times, Oct. 16, 2024, https://youtu.be/EjJ2Y5snTBk?si=kfvuoAHODUdWSoVD can provide the level of communication using visible and/or invisible light required to support and implement and use the computer language and code and other teachings disclosed in the present application.

### Error Detection and Correction

When using a classical computer and binary number digital system, the use of error detection and correction methods can require that the individual digital signals need to be repeated, e.g., at least three times, and so the repetition of the 8 digital bits which are typically used to represent an alphabetical letter, number, or symbol×3=24 digital bits, and given a bit interval of about 10×10⁻¹² or 10 picoseconds (ps) which is 0.000000000001 seconds, the resulting duration=24,000 fs. In contrast, the repetition of 1 complete sine wave cycle or period of visible or invisible light having a period of about 2 fs×3=6 fs. Accordingly, the use of the conventional digital system and eight ones and zeros with classical computers to represent and encode letters, numbers, and symbols becomes even more inefficient when error detection and correction is also considered. When communicating a sine wave form or other visible and/or visible light signal that represents and is being used to encode, e.g., an alphabetical letter, word, number, or symbol, the signal can be repeated in order to ensure that it can be communicated, read, and decoded correctly. In the abstract, it can then be repeated a 1000 or more times, but repeating a visible and/or invisible light signal between 3-100 times, or even only between 3-10 times can provide for satisfactory error detection and correction. It is possible for the sensitivity and/or desired accuracy of the error detection to be selected as desired using computer hardware and computer software, e.g., a computer user and/or software program can select 2 out of 3 signals being readable and correct as being acceptable, or alternatively 7 out of 10, 9 out of 10, 10 out of 10, or in the range between 95-100 out of 100 signals as being acceptable.

Further, because visible and invisible light can be transmitted in sinusoidal wave forms, such as sine waves and cosine waves, this makes it possible for a different kind of error detection and correction to be used that will here be named and called sum of sine and cosine squares error detection and correction. In this regard, the sum of the squares of the sine function and the cosine function is equal to 1, that is, cos² x+sin² x=1, e.g., see the article entitled: Sum of Squares of Sine and Cosine—ProofWiki, Feb. 8, 2024, https://proofwiki.org/wiki/Sum_of_Squares_of_Sine_and_Cosine, and also the animation by OpenMathCircle, Oct. 17, 2024, entitled: What is the Sum of Squares of Sine & Cosine Functions?, https://www.facebook.com/openmathcircle/videos/1970302120085404/. In brief, if and when the sum of the squares of the sine function and the cosine function corresponding to a sine wave associated with visible or invisible light which is used to communicate, manipulate, and/or store into memory data and information does not add up to 1, then you can know that there is an error and/or noise and this method can also be used to identify when and where it is located in the communication and/or related data and information. In this regard, a scan of the signals and data can be conducted in order to detect errors, but also to correct errors and/or to eliminate noise by manipulating and smoothing the wave forms, e.g., by using filters, and/or to block, reject, and effectively remove those portions having errors.

It is also possible to use other known methods and techniques with visible and/or invisible light signals or portions thereof and/or digital signals in order facilitate error detection and correction including, but not limited to error correction code (ECC) which can include block codes or convolutional codes, forward error control (FEC) or channel coding, and/or one or more of the following codes: An codes, Algebraic geometry code, BCH code, Barker code, Berger code, Burst error-correcting code, Constant-weight code, Convolutional code, Expander codes, Group codes, Golay codes, Binary Golay code, Goppa code, Hadamard code, Hagelbarger code, Hamming code, Latin square based code Lexicographic code, Linear Network coding, Long code, Low-density partity-check code also known as Gallager code, LT code which is a near-optimal rateless erasure correcting code or Fountain code, M of N codes, Nordstrom-Robinson code, Online code which is a near-optimal rateless erasure correcting code, Polar code, Raptor code which is a near-optimal rateless erasure correcting code, Reed-Solomon error correction, Reed-Muller code, Repeat-accumulate code, Repetition codes such as Triple modular redundancy, Spinal code which is a rateless nonlinear code based on pseudo-random hash functions, Tornado code which is a near-optimal erasure correcting code, Turbo code, Walsh-Hadamard code, and Cyclic redundancy checks.

Accordingly, the use of directly encoded sinusoidal wave forms, sine waves, cosine waves, wavelets, or pulses in the visible or invisible light spectrum to represent and communicate alphabetical letters, words, numbers, and symbols can result in higher processing and communication speeds, but also a substantial reduction in the amount of data that needs to be manipulated, processed and stored in memory. In this regard, the time required to send data and information to and from memory can be potentially reduced to about 1-4 fs when using holographic memory devices, and crystal memory devices.

### Partial Sine Wave Signals

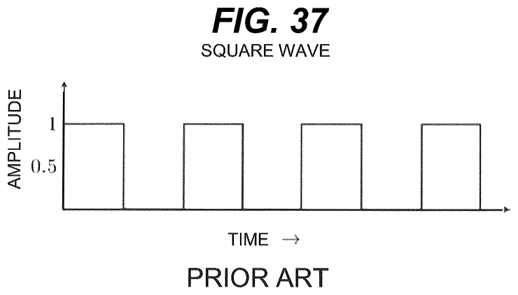

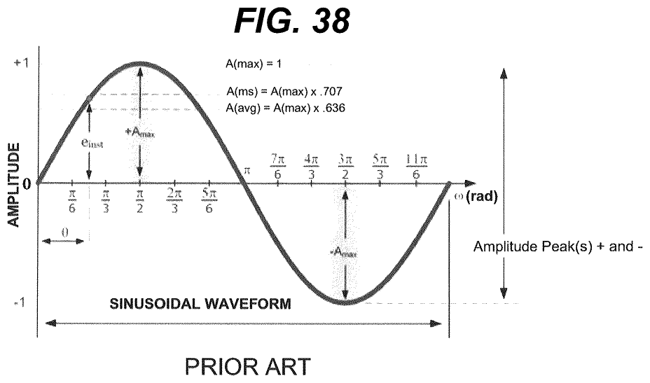

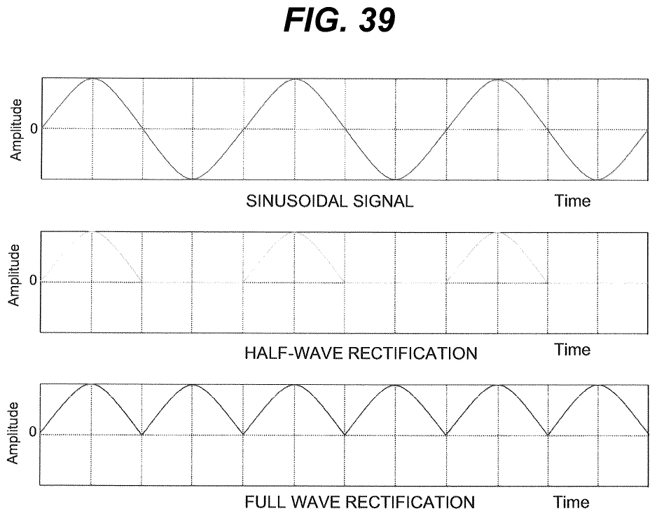

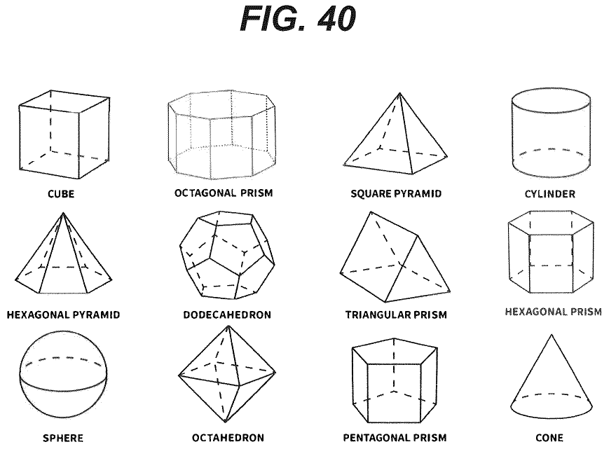

In order to improve efficiency and/or error detection and correction, it is also possible to use less than complete wave cycles or periods in order to transmit and communicate data and information. For reference purposes, an illustration of prior art square waves is shown in FIG. 37, and an illustration of a prior art sine wave is shown in FIG. 38. When sending data and information which represents or includes visible light waves or sound waves such as a video recording, audio recording, a computer game, or a feature film, it can sometimes be advantageous to use both the positive and negative portions of a sinusoidal wave form to communicate data and information, and therefore use full sine wave cycles and periods. However, this is not necessarily required in order to represent and communicate letters, words, numbers, or symbols. In this regard, the positive or negative half wave portion of a sine wave can alternatively be used. In this regard, one possible option is to use half-wave rectification to provide and use only the positive portion of a sine wave, as shown in the middle of FIG. 39. This can provide relatively wide gaps between succeeding positive sine wave portions, and depending on the circumstances this can possibly contribute to detection and accuracy. Another possible option is to use full-wave rectification to provide and use both of the positive and the negative portions of a sine wave which is manipulated so that the negative portion is inverted and also appears on the positive axis as shown on the bottom of FIG. 39. The generation of a single sine wave using full wave rectification then results in a double tap, that is, two identical and consecutive positive sine waves. In some circumstances, this can possibly contribute to detection and accuracy. When using conventional computers and the digital system, the ones and zeros which are used to communicate data and information in square wave form will sometimes be repeated 3 or more times in order to enable or enhance error detection and error correction. Of course, this slows down the effective rate of communication. However, if a sine wave is being used to represent an alphabetical letter, word, symbol, or number and it is repeated 3 times, and possibly while also being manipulated by full wave rectification the result will be 6 repetitions on the positive axis, that is, 3 double taps as shown at the bottom in FIG. 39, and this takes much less time than does repeating a conventional digital square wave three times. In the abstract, instead communicating data in a single complete sine wave cycle or period in about 2 Fs, this way of providing 3 double-taps for the sake of error detection and correction would require 6 fs.

The associated computer hardware and software can then be configured to enable and/or require, e.g., 2 out of 2 to be free of error, 5 out of 6 to be free of error, or require all 6 out of 6 to be detectable and accurate. If a higher level of certainty and accuracy would be desired or required, then, e.g., 5 sine waves could be used with full wave rectification to provide 10 positive sine waves to be checked for the existence of possible errors. In this regard, it would be possible to require 10 out of 10, 9 out of 10, or a different margin of error. If a full sine wave period was repeated 100 times which would only take around 200 fs, then one could require 90 of 100, 99 of 100, or a different margin of error to be acceptable and used.

Because of the dramatic increase in speed when using the photons associated with visible or invisible light instead of conventional electronic digital signals, repeating a sine wave in the visible or invisible light spectrum 10 times, 100 times, or even 1,000 times would not significantly undermine the considerable relative difference in processing, memory, and communication speeds. In this regard, even if the sinusoidal waves associated with optical communication using visible or invisible light were being sent in a series and not in parallel, it would then still only take about 20, 200, or 2,000 fs.

Moreover, it is also possible to use a wavelets, Morlet wavelets, pulses, and Gaussian pulses in order to transmit and communicate data and information. A wavelet can be compressed and its mean frequency and wavelength can be known and by conducting wavelet analysis the time and sequence of a plurality of wavelets can also be known. Further, the present application has taught and disclosed that if one wants to create one or more pulses, it is possible to use half or full wave rectification of a sinusoidal wave to do so, or alternatively to use a different method to configure one or more pulses as shown in FIG. 39. In this regard, see, e.g., Optical Rectification by Rachet Transport In an Asymmetric Grating, by Moroshkin et al., Nov. 2, 2021, https://doi.org/10.1063/5.0062816. Furthermore, it is possible to take a sinusoidal wave form and to apply a high pass, low pass, or other filter to effectively block or stop the communication and transmission of most of the sinusoidal wave form or other signal and to instead only leave, e.g., the portion which is equal to and greater than 0, and the result could then look like the example of half wave rectification shown in the middle of FIG. 39. Alternatively, the filter could be applied to not pass and/or to remove the portion of a signal which is below the −3 dB level and this can sometimes be half of the amplitude of the original sinusoidal wave form, wavelet, or pulse.

### Data Packets

At this time, different models exist and are being used to communicate data in various telecommunications and computer networking environments. The Open Systems Interconnection Model (OSI model) includes seven layers and characterizes and attempts to standardize the communication of data and information. The OSI model was defined in ISO/IED 7498 which includes the following parts: ISO/IED 7498-1 which is the basic model; ISO/IED 7498-2 which relates to security architecture; ISO/IEC 7498-3 which relates to naming and addressing; and, ISO/IEC 7498-4 relating to management framework. However, various other designs and models for data and information communication have been developed such as the Internet Protocol Suite which includes four layers and is commonly known as the Transmission Control Protocol (TCP) and Internet Protocol (IP), or more simply, the TCP/IP protocols which are being widely used today. Lists of existing network protocols can be found on the website: https://wikipedia.org/wiki/Lists_of_network_protocols. When data is being communicated in telecommunications and computer networking, the data and other related information is typically configured in what is called a packet which is a formatted unit of data. A packet is sometimes also called a block, a cell, a datagram, or a frame, that is, depending on the data communication protocol which is being used. In this regard, the packet typically contains control information, and also user data and information which is called the payload. The control information is typically located in headers and footers or trailers and these portions can contain, e.g., the source and destination network addresses, error detection codes, and sequencing information. In this regard, error detection and correction can be performed at different layers of a protocol stack, and the packets can contain checksum, parity bits or cyclic redundance checks to detect for errors. One or more of the different models, methods, and processes which are being used to communicate data and information in various telecommunication and computer network environments can be configured and adapted to be used with one or more of the structures, methods, and processes discussed and shown in the present disclosure, and vice-versa, that is, the structures, methods, and processes relating to making a computer language and code for software application development, data compression, and use with conventional, optical, hybrid electro-optical and quantum computers can be configured and adapted to be used with one or more of the different models, methods, and processes which are being used to communicate data and information in various telecommunication and computer network environments. When communicating a lot of data and information in the form of sinusoidal wave forms and/or sine wave forms, and/or wavelets, and/or pulses, and/or square waves, or other signals in the visible or invisible light spectrum, an encoded signal having a specific frequency and wavelength can be used to indicate the start and end of the segment, or what is sometimes called the header and footer. Alternatively, in the visible or infrared light spectrum the color black or the absence of a signal can be used to indicate a break, and/or the start and end of the visible and/or invisible light communication data packet. A data packet can be relatively small and only include a single sinusoidal wave form or other signal type which may be repeated X number of times, or alternatively, it can include two or more different signals, and possibly a very large number of different signals. The length of the packet and/or the number of sinusoidal waves or other signals contained therein can be compared with the original communication for accuracy and/or one or more of the methods and techniques of error detection and error correction which have been previously disclosed can then be used.

### Neural Networks, Machine Learning, and Quantum Computing

A brief discussion will be provided here concerning how the existing digital system processes data and information, and also stores it in memory. Conventional digital logic gates include the following different types: OR, AND, XOR, NOR, NAND, XNOR, and NOT. Here is the flow chart of an OR logic gate in which 1 is true and 0 is false: 0+0=>0, 0+1=>1, 1+0=>1, 1+1=>1. Here is the flow chart of an AND logic gate in which 1 is true and 0 is false: 0+0=>0, 0+1=>0, 1+0=>0, 1+1=>1. Here is the flow chart of a XOR logic gate in which 1 is true and 0 is false: 0+0=>0, 0+1=>1, 1+0=>1, 1+1=>0. Here is the flow chart of a NOR logic gate in which 1 is true and 0 is false: 0+0=>1, 0+1=>0, 1+0=>0, 1+1=>0. Here is the flow chart of a NAND logic gate in which 1 is true and 0 is false: 0+0=>1, 0+1=>1, 1+0=>1, 1+1=>0. Here is the flow chart of a XNOR logic gate in which 1 is true and 0 is false: 0+0=>1, 0+1=>0, 1+0=>0, 1+1=>1. Here is the flow chart of a NOT logic gate in which 1 is true and 0 is false: 0=>1, 1=>1. For more information, e.g., see How Logic Gates Work: OR, AND, XOR, NOR, NAND, XNOR, and NOT, by HTG Staff, May 27, 2021, https://www.howtogeek.com/devops/how-logic-gates-work-or-and-xor-nor-nand-xnor-and-not/, and Logic Gates Explained: AND, OR, NOT, XOR, NAND, NOR, XNOR, Logic Gates—The Foundation of Digital Circuits, by Amansour Blog, Sep. 23, 2024, https://amansour.me/blog/logic-gates-explained-and-or-not-xor-nand-nor-xnor/. Further, the following articles discuss and show how conventional digital memory devices are configured and operate: Semiconductor memory, https://en.wikipedia.org/wiki/Semiconductor_memory, Semiconductor Memory Design, Chapter 8 from Analysis and Design of Digital Integrated Circuits, 3rd Edition, 2024, by Hodges et al., McGraw Hill, https://highered.mheducation.com/sites/dl/free/0070593752/303325/Chapter_08.pdf, Memory Design—Duke University, by James Morizio, Adapted from J. M. Rabaey, A. Chandrakasan and B. Nikolic, Digital Integrated Circuits, 2nd ed. 2003, https://people.ee.duke.edu/~jmorizio/ece261/classlectures/Memory_design.pdf. In a nutshell, the digital system uses transistors which are tiny switches that are either on or off, that is, in one position or the other, and which are used to represent a one (1) or a zero (0), and therein lies the appeal and expediency of using the binary number system in classical computers. However, if one has a different way of processing and storing information that does not rely upon transistors, then it is not necessary to use and/or be limited to the use of the binary number and digital system. When you look beyond the buzzwords “entanglement,” “superposition,” “quantum,” “quibit,” and the marketing hype associated with current efforts to perform quantum computing it largely boils down to this: 1) They want to make a computer that can input, output, and in particular, process and store data and information in parallel, that is, instead of being stuck with classical computers which can only do so in series or a sequence; and, 2) They want to do this using the conventional digital system which represents data and information using the binary number system and ones (1s) or zeros (0s) because most of the existing computer hardware and software has been configured in this manner and so it can be supported by their present manufacturing facilities. Accordingly, they now strive to create an entangled and superposition crafted qubit which can also be called a “Wonder 1 and/or 0.” Most of these approaches require pieces of equipment which are large, expensive, and consume a lot of electrical energy.

The following example shows that when large numbers, and/or when many numbers and computations are being calculated, the time and energy required by a classical computer using the conventional digital system can increase dramatically relative to the use of an optical computer, electro-optical computer, or a quantum computer which uses visible or invisible light signals to communicate data and information using the methods and techniques disclosed herein. For example, the BITCOIN blockchain size is now about 500 Gb and when using a conventional computer and the digital system 500,000,000,000 bytes×8 bits each=4,000,000,000,000 bits which given a bit interval of 0.000000000001 seconds=4 seconds. What about the speed of neural networks which are commonly being using in machine learning, deep learning, and AI, e.g., the number of computations associated with a neural network having 8 inputs, 2 hidden layers each having 16 nodes, and 1 output is 8,528 computations. Here is an approximate “ballpark” calculation of how long the transmission and communication of 8,528 calculations would take using the conventional digital system, that is, without considering the additional time which is typically required to move data in and out of memory, and to perform calculations and error detection and correction. If each of the 8,528 computations includes one multiplication of two whole numbers and also adding a number, e.g., 1×2+3=5, then at least 7 bytes will be used. 7 bytes×8 bits each=56 bits. 56 bits for one computation×8,528 computations=477,568 bits. 477,568 bits×(the bit interval 0.000000000001)=0.000000477568 seconds which is 477,568,000 fs.

In contrast, here's about how long it would take with an optical or electro-optical computer using visible and/or invisible light and the methods of representing and coding data and information disclosed herein: 8,528 computations×(7 numbers and/or symbols×2 fs each=14 fs)=0.000000000119392 seconds which is 119,392 fs, and so the difference is 119,392 fs versus 477,568,000 fs when these calculations are performed in a series. Again, this is only an approximate estimate of the communication time, and it does not include the time which may be required for error detection and correction, processing, and storage. In this regard, if each of the individual signals would need to be repeated 3 times for the sake of error detection and correction, the difference would be about 358,176 fs using the methods taught and disclosed in this application, versus 1,432,704,000 fs when using the conventional digital system. Once again, this is without even considered the ability of optical communications to perform these tasks in parallel, that is, instead of in series or a sequence like classical computers which use the digital system.

The teachings and disclosure contained in U.S. Pat. No. 11,809,839 and the present application can be used to represent, encode, and communicate data and information, but also to configure, manipulate and use optical neural networks, hybrid electro-optical neural networks, and related quantum computing neural networks and to perform calculations and other computer functions. When performing calculations or computations using an optical neural network and only looking for simple answers or solutions such as zero (0) or one (1), then one option is to have both the 0 and 1 inputs have the same wave form and also the same wavelength and corresponding frequency of visible and/or invisible light, but then represent and encode the 0 and 1 inputs by using two different amplitudes. A second method is to use two different wavelengths and corresponding frequencies of the same type of wave form in the visible and/or invisible light spectrum to represent and encode the 0 and 1 inputs. A third method is to use two different types of wave forms, which may or may not also have two different wavelengths and frequencies of visible and/or invisible light to represent and encode the 0 and 1 inputs.

Further, if one uses a sine wave unit circle, the value +1 can be represented and communicated using the sine wave's positive peak amplitude point, and the value 0 can be represented and communicated and by using a point having no amplitude, and the value −1 can be represented and communicated and using the sine wave's negative peak amplitude point. In addition, it is also possible to create sine wave or other wave forms which can be manipulated by half or full wave rectification, and/or to otherwise create waves, or pulses with can be Gaussian or non-Gaussian, as shown in FIG. 39. When a wave form or pulse having a specific wavelength, frequency, and amplitude is in superposition with one that is identical and in the same phase, but which is inverted the result is wave or pulse cancellation. When two identical sine wave forms overlap and are out of phase, a resultant sine wave form which has a peak amplitude which is located right between the two is then created by additive superposition and this can effectively result in phase shifting.

If one is looking for answers or solutions such as zero (0) which can be represented using a dark color, or black, or no signal, and one (1), which can be represented by white, but also everything in between zero (0) and one (1) then is possible to use a gray scale rendering of data and information and to observe the resulting white, black, or gray scale, and then get an answer or resultant solution. Alternatively, one can use a portion of the visible and/or invisible infrared light spectrums and zero (0) can be represented using a dark color, or black, or no signal, and one (1) can be represented by white and the range between zero (0) and one (1) can represented by a portion of the visible and/or invisible light spectrum, e.g., the visible color light spectrum between 400-700 nm. If and when different wavelengths and frequencies corresponding to different colors in the visible light spectrum would be used in a neural network and/or to perform calculations, then some of the phenomenon relating to color mixing and rendering can also be used when performing computations or other operations. For example, given the three primary colors red, blue and green, mixing red and green produces yellow, mixing red and blue produces magenta, and mixing blue and green produces cyan. Primary colors reflect light having the same color. Secondary colors will reflect the two primary colors which were used to produce them, and also their secondary color. It is possible to manipulate and use different wavelengths and frequencies of color in the visible light spectrum, and also its associated hue, intensity, saturation, and value to perform calculations and other computer operations.

Further, if one wishes to represent the probably of an outcome then one method is to use different amplitudes of a sine wave within the boundaries defined by a unit circle, e.g., a sine wave unit circle, and then have no amplitude represent and correspond to 0 probability and an amplitude of 1 correspond to 100 percent probability, or alternatively to have −1 represent no or 0 probability and 0 to represent 50 percent and +1 to represent 100 percent probability. Another method which can be used to represent probability is to use two wave forms having the same wavelength and corresponding frequency, and one represents an event or outcome, and the other represents the probability of the outcome, and they can be added or multiplied together to provide an answer or resultant. If and when the desire is to conduct a form of analysis such as decision analysis which typically weighs the probability and also the risks or costs associated various outcomes, and/or the desire is to simply calculate multiple interdependent variables, then phase shifting can also be used and scaled so as to indicate the percentage or probability of an outcome, e.g., as between 0-100 percent, and the weighted outcome and solution can be provided for an individual calculation, and also for a series of calculations and/or events. For example, when viewed or measured in a two-dimensional format as on a piece of paper or computer screen, when two sine waves overlap one another, the common area of intersection and/or the maximum positive or negative amplitude at the area of intersection between a first sine wave which represents an event or outcome and a second sine wave which represents the probability of that outcome can be used to represent the resulting probability product or outcome. With regards to the chain rule and subject of probability see, e.g., Chain rule (probability), https://en.wikipedia.org/wiki/Chain_rule_%28probability%29, and Probability and Decision Analysis: Principles and Network Representation, Ross D. Shachter, Reed College, Jul. 31, 1996, https://web.stanford.edu/~shachter/pubs/UAI96Tut.pdf. Decision trees which include a plurality of alternative branches, decision nodes, chance nodes, and at least one end or outcome node have been used for years in decision analysis, and they closely resemble those structures and configurations which are used in neural networks and machine learning, e.g., see Machine Learning—Wikipedia, https://en.wikipedia.org/wiki/Machine_learning. Neural networks and/or decision trees can also be configured in a fractal form, e.g. see, Fractal—Wikipedia, https://en.wikipedia.org/wiki/Fractal, and with regards to the use of fractal antennas, see, e.g., U.S. U.S. Pat. No. 11,588,421 B1 and U.S. Pat. No. 12,136,824 B2 by the Applicant Robert M. Lyden, and these patents are hereby incorporated by reference herein. For information on the subject decision analysis, see the book entitled: Quick Analysis for Busy Decision Makers, by Robert D. Behn & James W. Vaupel, published in 1984, which is available on amazon.com, https://www.amazon.com/Quick-Analysis-Busy-Decision-Makers/dp/0465067883. For information on neural networks, see the following articles relating to neural networks and also the use of visible and/or invisible light: Selection of Proper Neural Network Sizes and Architectures a comparative study, by Yu et al., Feb. 14, 2012, https://ieeexplore.ieee.org/document/6152147; Optical neural network, Wikipedia, https://en.wikipedia.org/wiki/Optical_neural_network; An optical neural chip for implementing complex-valued neural network, by Zhang et al., Jan. 19, 2021, https://www.nature.com/articles/s41467-020-20719-7; The Diamond Mesh, A Phase-Error-And Loss-Tolerant Field-Programmable MZI-Based Optical Processor For Optical Neural Networks, by Shokraneh, et al., Aug. 3, 2020, https://pubmed.ncbi.nlm.nih.gov/32752345/; Running Neural Networks On Meshes Of Light, by Asianometry, Aug. 11, 2022, https://youtu.be/tyj4hBDUsc?si=lgb4MxlnSvXw_GK7; Localization of Light in Photonics Lattices for All-Optical Representation of Binaries, by Nguyen et al., Aug. 17, 2021, https://www.frontiersin.org/journals/physics/articles/10.3389/fphy.2021.709428/full; and, Optical Memory and Neural Networks, Springer Link, Co-Editors-in-Chief Boris V. Kryzhanovsky, Victor A. Soifer, 03-xx-2024, https://link.springer.com/journal/12005.

### The Conventional Digital System can be Limiting

One of the problems associated with the digital system is that it reduces various things, problems, and natural phenomenon to ones and zeros, but in nature and many fields of study things are not simply black or white or easily reduced to ones and zeros. Sometimes there is also everything in between black and white, and/or ones and zeros, and this can be better represented by using a plurality of different wavelengths and frequencies or colors in the visible and/or invisible light spectrum to encode data and information. Analog computing using visible or invisible light signals can be especially suitable for solving problems which involve many complex and rapid changes in physical and/or non-physical phenomenon. In this regard, the field of quantum mechanics fits this description and therefore so does quantum computing. The phenomenon of superposition including wave addition and cancellation can be configured and used to perform calculations or otherwise to provide answers or solutions to various questions or problems, and optical neural networks, optical processor devices and/or optical memory devices can then be configured to make use of entanglement and superposition phenomenon. When this is done, the calculating or computing time is then performed at or near the speed of light.

Again, the data and information communicated using sinusoidal waves, sine waves, cosine waves, wavelets, or pulses in the visible and/or invisible light spectrum can be stored in flash memory, an optical memory device, e.g., a holographic memory device, a holographic disk device, an optical disk device, or a crystal memory device and the transmission and communication of data and information can be performed in parallel and then in a few femtoseconds. Further, the parent patent application which matured as U.S. Pat. No. 11,809,839 and present application teaches a DNA color coded method of coding and a type of memory in which wave forms can be combined, e.g., visualize the 4 nucleotides in human DNA being colorized, and the possibility of using between 2-8 sine wave forms like nucleotides to create a set, and then adding numerous sets in a series to create hundreds of trillions of possible coding points. By comparison, the binary digital system associated with the Universal Coded Character Set (USC) Unicode standard only has about 1.1 million possible code points available for use. Moreover, a recent publication suggests that space-time may have a form resembling or which can be conceptualized visibly as colorized DNA, e.g., see the article: DNA-Like Geometric Structure Discovered In Space Time, by Carvajal, Oct. 14, 2024, https://Inkd.in/gaqxq298, and the research article: From Colored Gravity to Electromagnetism, by Monjo, et al., Oct. 10, 2024, Gen Relativ Gravit 56, 117 (2024). doi.org/10.1007/s10714-024-03307-8, https://arxiv.org/pdf/1012.4730.

Moreover, in order to send digital data and information from a classical or conventional computer through optical fiber to another one at a remote location at the present time, the data and information first has to be converted from digital to analog, and after being received then be converted back from analog to digital. This process consumes time and energy, e.g., see the following discussion of digital to analog and analog to digital conversion: https://www.analog.com/media/en/training-seminars/design-handbooks/Basic-Linear-Design/Introduction.pdf. This conventional digital method and process introduces a bottleneck. In contrast, an optical computer or hybrid electro-optical computer, and/or a quantum computer based thereupon, does not need to use analog to digital or digital to analog conversions to send data and information to another optical computer, electro-optical computer, and/or quantum computer.

### Entanglement

The word and concept of entanglement is presently being used in connection with quantum computing. In brief, when two particles such as a pair of electrons, or photons which only have an imaginary rest mass become entangled they will remain connected in their quantum state even when separated by vast distances. In order to entangle electrons in connection with the operation of what can be called a conventional quantum computer which uses the digital system, electrons, and metal wires, a lot of energy is required in order to produce extremely low temperatures. However, a plurality of sinusoidal wave forms of visible and/or invisible light which can be used in one or more signal channels which are derived from a common light source in space and time are ALREADY entangled. Whether they originate from a single light source or beam of light and are produced by a beam of light being separated and scattered into a plurality of different wavelengths and corresponding frequencies by an optical device such as a prism, a diffraction grating, or other optical device such as a beam splitter, or a polarized filter the resulting plurality of different wavelengths and corresponding frequencies of light are related to one another and entangled. The resulting plurality of sinusoidal wave forms provide for many different possible points in space and time where they will be in different states and conditions of superposition. For example, when a sine wave having a maximum amplitude of +1 is plotted symmetrically on a graph over time half of it will be above and the other half will be below the reference or x axis. The sine wave will repeatedly intersect the x axis at 0, and the maximum amplitude will alternate between +1 and −1. This can be represented and illustrated using a sine wave unit circle. Looking at the sine wave and/or its corresponding unit circle an individual can observe and measure its wavelength and frequency. In this regard, if 16 different wavelengths and frequencies of light originate from the same light source at the same time and have an amplitude of 1 there will be a plurality of points in space and time where and when the wavelength and corresponding frequency associated with a first signal of a first light channel or beam are at sine +1, 0, or −1, and there will also be a plurality of different points in space and time where and when the wavelength and corresponding frequency associated with a second signal of a second light channel or beam will be at sine +1, 0, or −1. In this regard, there will also be a plurality of points in time and space where the wavelength and frequency of the first signal associated with the first channel is at sine +1, when the second signal of the second channel is at sine 0, or −1, but also when the first signal of the first channel and the second signal of the second channels will coincide and both be at sine +1, 0, or sine −1, and for other relationships and correlations in time and space to occur and which are knowable and predictable. In this regard, it is possible to calculate using the linear equations for sine waves and cosine waves and to also visualize using a sine wave unit circle when and where various superposition conditions will occur.

Many of those who are using conventional quantum computers seek to manipulate electrons in order to create what are being called positive or negative spins which can be associated with ones (1s) and zeros (0) in order to have entanglement and superposition, but this is not the only way in which it can be done. The visible and invisible light spectrums provide a plurality of different wavelengths and frequencies or colors in which can be used represent not only a zero (0) or a one (1), that is, black which is or can be represented as a dark color, or the absence of color, or no signal, and white which includes all colors, and also everything else in the range between 0 and 1. This range can be rendered using, e.g., the colors and visible light spectrum between 400-700 nm and/or the infrared light spectrum between 700 nm and 1625 nm. In some sense, people in the computer industry have painted themselves into a corner by thinking, using, and relying upon the digital system, whereas the entire floor can be made available once you open up the possibilities associated with using visible and invisible light to represent, encode, and communicate data and information. Accordingly, if and when more individuals in the computer industry can get away from the limiting idea and fixation about using only the existing digital system, then perhaps we will indeed see a quantum leap forward.

### Superposition

The word and concept of superposition is also presently being used in connection with quantum computing. In this regard, some calculations can be performed faster and more efficiently if one digital bit of information can be not just a 1 or a 0, but both 1 and 0. According to quantum theory and some individuals who advocate quantum computing: Schrodinger's Cat is both alive and dead in the box. However, Sir Roger Penrose and other individuals believe that Quantum Theory is incomplete and dead wrong about a lot of things, e.g., see Roger Penrose Thinks Quantum Mechanics Is Dead Wrong, Oct. 4, 2024, https://youtu.be/HPH-SzWF46w?si=rNJb9KFw540NTakRsee; Roger Penrose On Quantum Mechanics And Consciousness, Mar. 24, 2024, https://youtu.be/YnXUuyfPK2A?si=TMNnJ9d4uB9IEUXf; The Quantum World: Dreams and Delusions I Roger Penrose, Sabine Hossenfelder, Michio Kaku, And More!, https://youtu.be/dvVBNaZc_WE?si=uvhlkj6ILd8eDdZS; The Future Of Quantum Computing With Michio Kaku, Neil deGrasse Tyson & More, Jun. 4, 2024, https://youtu.be/lum6rdKr4To?si=7CgfLLG3-QD6fMqn, and, Michio Kaku: Quantum Computing Is The Next Revolution, Aug. 13, 2023, https://youtu.be/qQvil1d_hFA?si=pagvdKcaU7nUZ4pg. Once again, advocates of quantum computing want to make a computer that can input, output, and in particular, also process and store data and information in parallel, that is, instead of being stuck with classical computers which can only do so in series or a sequence. Further, many wish to do so using the conventional digital system which represents data and information using the binary number system and ones (1s) or zeros (0s) because most of the existing computer hardware and software has been made and configured in this manner. Accordingly, they now strive to create an entangled and superposition crafted qubit which can also be called a “Wonder 1 and/or 0.” Most of these approaches require equipment that is expensive and consumes a lot of electrical energy. At the present time, many quantum computer companies are trying to create qubits and perform calculations by manipulating electrons using metal wires, transistors, and the conventional digital system. This is like trying get a river to flow through a fire hose or a drinking straw.

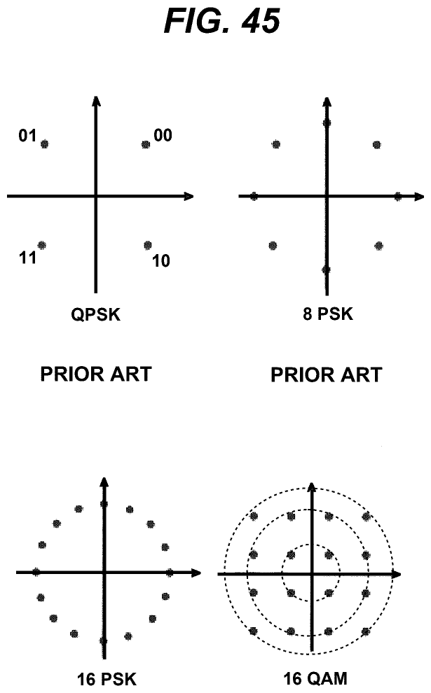

In contrast, the parent application U.S. Pat. No. 11,809,839 and present application teach directly using a plurality of wavelengths and corresponding frequencies in the visible and/or invisible light spectrums to represent and encode data and information including alphabetical letters, word, symbols, numbers, and/or images. In this regard, there is plenty of entanglement, superposition, computing power available for use when more than zero (0) or a one (1) can be used as signals. As shown and discussed in FIGS. 45-50, the present application also discloses how to represent and encode the binary number system in optical patterns and constellation configurations so that numbers can be manipulated, computed and communicated in parallel and/or in series or a sequence.

Once again, a plurality of sinusoidal wave forms or other visible or invisible light signals which can be used in one or more signal channels which are derived from a common light source in space and time are entangled, e.g., a single light source or beam of light can be separated or scattered into various different wavelengths and corresponding frequencies by a prism, a diffraction grating, or otherwise be manipulated by a beam splitter, a polarized filter, or other optical device. For example, when visible light passes through a prism, a plurality of different wavelengths and frequencies will be separated and dispersed, and they will all be entangled and in various different superposition conditions or states. However, there will not be any two of the resulting plurality of wavelengths and frequencies of visible and/or invisible light which are identical in wavelength and frequency, amplitude, and phase.

There are four broad categories or methods of manipulating and/or modulating light: birefringence or double refraction methods as can be produced by a prism or diffraction grating, magneto-optic methods, electro-optical methods, and acousto-optical methods. In order to produce or generate two or more identical wavelengths and frequencies of visible and/or invisible light that are identical in wavelength and frequency, amplitude, and phase, and which are entangled and in matching superposition conditions or states, a collimated light source can be used and simultaneously refracted using at least two prisms, or alternatively be diffracted using two diffraction gratings, or by using other magneto-optic, or electro-optic methods, and other optical devices. For example, a light source can provide a beam of collimated beam of light that can directly strike at least two prisms, or alternatively, the light source can indirectly strike at least two prisms with the use of at least one beam splitter or mirror and this will generate at least two sets of a plurality of wavelengths and frequencies. In these at least two sets there will be at least one first individual wavelength and corresponding frequency in a first set and also a second individual wavelength and corresponding frequency in a second set which are identical, entangled, and in superposition. Further, these two identical wavelengths and frequencies can be phase shifted relative to one another, and one or both of their amplitudes can be changed, and one or both of them can be inverted, or rectified, or otherwise be manipulated using a lens, a signal manipulation device, or other optical or electro-optical device. In this regard, a lens can have many different configurations, e.g. see, Lens—Wikipedia, https://en.wikipedia.org/wiki/Lens.

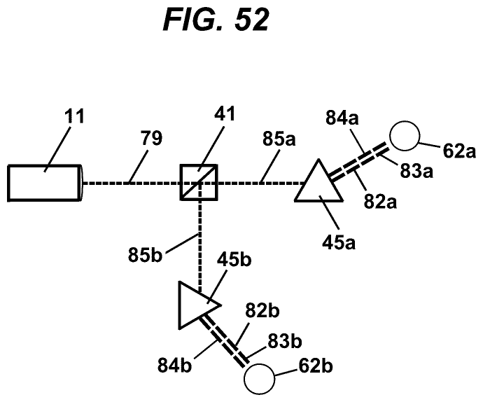

FIG. 52 shows a light source 11 which can be used to produce a collimated light beam 79 that is divided by a beam splitter 41 and the two light beams 85a and 85b which are produced are directed to two prisms 45a and 45b and the resulting diffraction causes a two sets 84a and 84b of resulting light beams each including a plurality of wavelengths and corresponding frequencies in the visible light spectrum 82a and 82b which include a plurality of spectral colors 83a and 83b, which can then be transmitted via at least one optical connection 62a and 62b which can include a waveguide, or fiber optic cable. In this regard, a plurality of beam splitters 41 can be used with a plurality of prisms, e.g., 45a, and 45b, or alternatively a plurality of diffraction gratings to product a plurality of sets 84a and 84b of a plurality of wavelengths and corresponding frequencies 82a and 82b which are entangled and in matching superposition states or conditions. Other optical devices, e.g., amplifiers, lenses, loops, and phase shifters can be used to further manipulate the light beams and/or the plurality of sets of wavelengths and corresponding frequencies which are being produced. As a result, it is possible to generate a plurality of wavelengths and corresponding frequencies of visible and/or invisible light which are entangled and in matching superposition conditions or states, and it is also possible to phase shift at least two matching wavelengths and corresponding frequencies of visible and/or invisible light such that they are in quadrature and the amplitude of one corresponds to 1 while the other corresponds to 0 as can be shown on graph and/or sine wave unit circle. For more information on prisms, and beam splitters, e.g., see Prism (optics)—Wikipedia, https://en.wikipedia.org/wiki/Prism_(optics), and Beam Splitter—Wikipedia, https://en.wikipedia.org/wiki/Beam_splitter, and in particular the discussion therein entitled “Diffractive Beam Splitter,” “Reflection Beam Splitters,” “Application for Quantum Computing” and the “Knill, Laflamme and Milburn (KLM) protocol,” and KLM Protocol—Wikipedia, https://en.wikipedia.org/wiki/KLM_protocol.

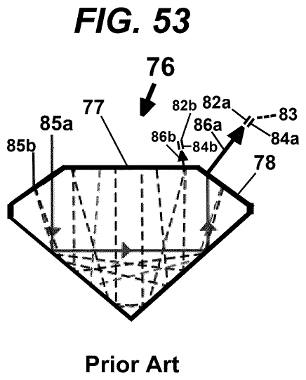

FIG. 53 shows a prior art illustration of a gem cut diamond 76 which has a prismatic form and is configured so that it takes advantage of its total internal reflection and refraction to exhibit dispersion and what is called fire which is caused by a plurality of sets, e.g., sets 84a and 84b which each include a plurality of wavelengths and frequencies 82a and 82b which can be seen as colors associated with the visible light spectrum being projected from the top table 77 and/or other facets 78 of the diamond 76. As shown, an incident light beam 85a enters the diamond 76 and is reflected and diffracted and exits as resultant light beam 86a, and an incident light beam 85b enters the diamond 76 and is reflected and diffracted and exits as resultant light beam 86b, and plurality of other possible light paths in the diamond 76 are also shown using dashed lines. A round brilliant cut diamond has 58 facets, and a radiant cut has 70 facets, and an ideal cut diamond has a table which is between 53-57 percent of the girdle diameter, and a depth which is between 57.5-63 percent of the girdle diameter. For more information, see, e.g., Diamond Cut—Wikipedia, https://en.wikipedia.org/wiki/Diamond_cut?wprov=srpw1_0. Because of the density of the carbon atoms and molecules which make up a crystalline diamond 76, the refractive index of a diamond is approximately in the range between 2.417-2.219 and the speed of light in a diamond is reduced to approximately 1.24×10⁸ meters/second versus the speed of light in air which is approximately 3×10⁸ meters/second. There have been efforts to use diamond to make interconnects, memory devices, and quantum computers, e.g., see Will Diamonds Revolutionize Quantum Computing? by William G. Wong, Nov. 26, 2024, https://www.electronicdesign.com/technologies/embedded/quantum-computing/article/55246096/electronic-design-will-diamonds-revolutionize-quantum-computing; Lightsynq makes diamond photonic quantum interconnects, e.g., see Why We Founded Lightsynq, https://www.lightsynq.com/; Quantum Brilliance, Room Temperature Diamond Quantum Accelerators, https://quantumbrilliance.com/ and WO 2023097361 A1, by Doherty et al, Jun. 8, 2023; MIT's Diamond Qubits Redefine the Future of Quantum Computing, by Adam Zewe, Jun. 28, 2024, https://scitechdaily.com/mits-diamond-qubits-redefine-the-future-of-quantum-computing/; Long-term data storage in diamond, by Dhomkar et al., Oct. 26, 2016, https://www.science.org/journal/sciadv; Major development successes in diamond spin photon quantum computers, by Fraunhofer Institute for Applied Solid State Physics, Oct. 28, 2024, https://www.sciencedaily.com/releases/2024/10/241028132358.htm; Record Breaking Diamond Storage Can Save Data For Millions of Years, by Jemery Hsu, Nov. 27, 2024, https://modern-science.net/record-breaking-diamond-storage-can-save-data-for-millions-of-years/: 5 Companies Working With Diamond NV Quantum Computing Technology, by James Dargen, Mar. 31, 2022, https://thequantuminsider.com/2022/03/31/5-quantum-computing-companies-working-with-nv-centre-in-diamond-technology/.

However, these efforts have for the most part focused on using or creating imperfections in a diamond in order to use the ones (1s) and zeros (0) associated with the digital system to represent and encode data and information and to perform computing operations. When a beam of visible light is directed towards and passes through a triangular prism a resulting beam of light is produced which is diffracted such that its wavelengths and corresponding frequencies are separated and they will display the red, yellow, green, blue, indigo, and violet color spectrums. This is how a gem cut diamond which is a prismatic structure produces what is called fire. In this regard, a gem cut diamond in some sense is and will here be referred to as a super prism. When a beam a light is directed through the table or one of the other plurality of facets of a gem cut diamond, it will be reflected and refracted multiple times before exiting the diamond, and given the angle and orientation of the incident beam of light the exit point can also be known.

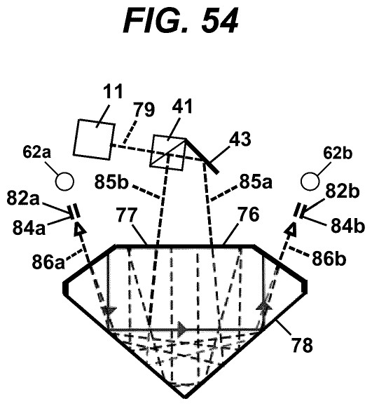

FIG. 54 shows a plurality of incident light beams 85a and 85b entering a diamond 76 and a plurality of resultant light beams 86a and 86b which have been diffracted exiting the diamond 76 which can then be transmitted via at least one optical connection 62a and 62b which can include a waveguide, or fiber optic cable. In this regard, a plurality of light beams 85a and 85b, and also others derived from a single light source 11 which are thereby also entangled can be produced and directed through the table 77 and/or other facets 78 of a gem cut diamond 76. The internal reflection which then takes places between the facets 78, and the internal refraction which takes place within the diamond 76 will result in a plurality of resulting diffracted light beams 86a and 86b that will exit the surface of the diamond and then be substantially similar and/or identical in their provided and exhibited light spectrums. In this regard, a plurality of sets 84a and 84b of resulting light spectrums each including a plurality of wavelengths and corresponding frequencies 82a and 82b containing substantially similar and/or identical wave forms can thereby be produced which are in superposition. If and when slight imperfections or discrepancies exist, the amplitude and/or phase of one or more of the sets and/or plurality of individual wave forms can be manipulated in order to make them substantially or completely identical in their form and properties. Alternatively, the amplitude and/or phase of at least one of the wave forms in at least one set can be manipulated to make the wave form differ from a corresponding one having approximately or exactly the same wavelength and frequency in another set, e.g., one wave form or set of wave forms can be phase changed to a cosine configuration relative to a different wave form or set of wave forms having the same wavelengths and frequencies to produce quadrature, and this can be used to provide ones (1s) and zeros (0) if and when the desire is to use the binary number and decimal system. However, the key point here is that a diamond 76 can be configured to be a super prism and then serve as a multiplexer, or demultiplexer, and perhaps most importantly to generate a plurality of light beams which are entangled and which can provide a plurality of resulting sets including a plurality of wavelengths and frequencies of light which are superposition. Again, a typical gem cut diamond includes over 50 facets which can possibly be used to receive at least one light beam, and merely changing the orientation and angle of the incident light beams on the table or other facet will produce corresponding resultant light beams which are diffracted. Each one of the individual incident and/or resulting light beams which exit the diamond can be used and manipulated to process computations in parallel or perform other operations, and persist or store data and information in memory. At the same time, each of the incident light beams and/or resulting light beams which exit the diamond are identifiable and so such computations or other operations can alternatively also be manipulated, performed, observed, and persisted or stored in series or a sequence if this is desired. Accordingly, it is possible to create a plurality of sets of wavelengths and corresponding frequencies of visible and/or invisible light which are entangled and also in superposition, and these wavelengths and corresponding frequencies can be encoded to represent different alphabetical letters, words, symbols, numbers, and images, and the data and information can be processed and placed into memory in parallel, but also be manipulated in parallel and/or in series or a sequence. As a result, it is thereby possible to perform a multitude of computations at or near the speed of light. If desired, this structure and method can be also used to represent, encode, and communicate the binary number system in an optical pattern, and/or in a constellation configuration, e.g., see the discussion of FIGS. 45-50. Accordingly, the kinds of quantum computers which many companies are now trying to build and use may not be the most optimal and efficient types which can be created. The present application suggests that optical computers, electro-optical computers, and quantum computers based upon them which use the methods and techniques disclosed herein can be manufactured less expensively, perform calculations more efficiently, and require less energy to operate.

### Holographic Memory Devices

Instead of creating and storing data and information and performing calculations and operations using only ones and zeros as if nature and all problems can or should be reduced to black or white, or 0's and 1's, optical computers, electro-optical computers and quantum computers based upon them can instead use many different wavelengths and frequencies that can be seen by humans in the visible light spectrum as different colors. Further, the same phenomenon exists in the invisible light spectrum, but it is simply that humans cannot see the differences in the wavelengths and frequencies while being unaided. This kind of data and information representation and coding using visible and/or invisible light has been previously identified and called color coded data, and it can be stored in holographic memory. For information on holographic memory and other forms of optical memory, see the articles provided under the subheadings Holographic And Optical Memory Storage, Glass And Crystal Memory Storage, and also the patents assigned to InPhase Technologies, Inc. recited below. The storage medium used in a holographic device can be made, e.g., of silica, glass, a crystalline material, diamond, lithium niobate, and this material can also possibly include at least one dopant and/or metal, e.g., such as boron, copper, erbium, iron, gadolinium, gold, hafnium, manganese, magnesium oxide, silver, yttrium, zinc, or other element(s), a reflective material, and/or a thermoplastics material, for manipulating or effecting the physical characteristics and/or performance characteristics of the optical storage medium and the associated holographic memory device.

As shown in FIG. 40, a holographic storage medium such as silica, glass, lithium niobate, or other crystalline material for use with holographic memory device can be configured in many differ geometric shapes, e.g., a cube shape, an octagonal prism shape or octahedron shape, a square pyramid shape, a cylinder or cylindrical shape, a hexagonal pyramid shape, a dodecahedron shape, a triangular prism shape, a hexagonal prism shape, a sphere shape, a half-sphere or lens shape, a pentagonal prism shape, a cone shape, a double cone shape having two cones having either their peaks or bases in conjunction, or other polyhedron or geometric shapes. The presence of multiple sides or facets on a holographic storage medium can permit the possible use of one or more light sources which can provide a plurality of data beams and reference beams which can be used to store data and information in a holographic form which can be seen using at least one optical detector device, such as a camera, photodetector, or photodetector array. The dodecahedron shape is an interesting one in the field of science because the size and configuration of its facets have an association with phi the golden ratio, and the dodecahedron shape was used by Philo T. Farnsworth as the seed nucleus in his early experiments with nuclear fusion. For more information, e.g., see Fusor—Wikipedia, https://en.wikipedia.org/wiki/Fusor.

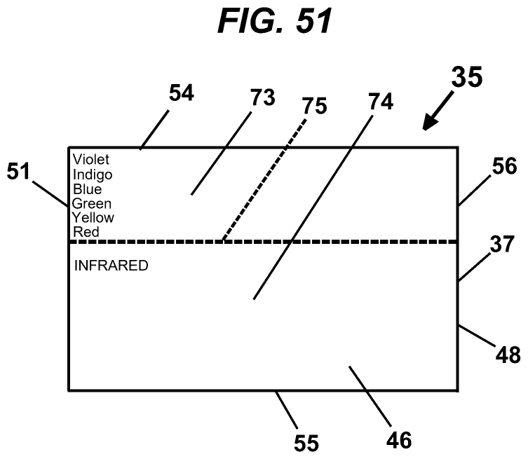

As shown and discussed in FIG. 51, the present application discusses and shows a special kind of holographic memory device 35 for persisting and storing data and information which has been represented and coded in different wavelengths and frequencies in the visible and/or invisible light spectrum. Again, this kind of data and information can be referred to as color coded data and be stored in a structure, object, medium, device and/or format resembling a Red, Green, Blue cube, RGB cylinder, RGB cone, or other geometric form, or a different RGB format such as sRGB, or a different color format such as Pantone Matching System (PMS), Cyan, Magenta, Yellow, Black (CMYK), or Hexadecimal Color (HEX), or alternatively, in some cases using grayscale. In the form of a piece of hardware and a memory device, it can be called or referred to as a RGB Holographic Memory Device. Alternatively, when a memory device is similarly configured for use with invisible light in the infrared spectrum it can be referred to as an Infrared Holograph Memory Device. When a processor device such as an optical processor device, or optical logic processor device is similarly configured for use with the visible and/or invisible light spectrum and is structured or formatted such that a plurality of wavelengths and frequencies of visible and/or invisible light are specifically configured or arranged to be manipulated in portion or space within the processor device it can be referred to as a RGB Processor Device.

The data and information stored and retrieved on and/or in a holograph memory device can be configured for the sake of facilitating organization and efficiency with regards to storing and retrieving data and information. For example, numbers can be represented and coded in a specific range of frequencies and wavelengths of the visible and/or invisible light spectrum, and this specific range can then be recorded and retrieved from a specific portion of a RGB and/or IR Holograph Memory Device. This can serve to enhance speed and efficiency relative to how conventional memory devices, and in particular, computer cache, RAM, ROM, Flash, and hard drive memory devices typically operate when using the conventional digital system and metal wires. Further, the computer processor, and/or the optical computer processor portion of a combined optical processor and optical memory device, and also data and information including but not limited to algorithms and compiled programs which are typically stored in ROM in conventional computers and used when manipulating numbers and performing calculations or other operations, can also be configured to be in close proximity and/or to be easily manipulated in parallel in optical memory for the same purposes. In order to learn more about the origins and history of color representation in the computer environment, see the following video entitled “RGB to XYZ: The Science and History of Color” by John Austin published on thestrangeloop.com on Sep. 13-14, 2019 which discloses that sRGB is mathematically accurate: https://youtu.be/AS1OHMW873s?si=AqedPUZMtl0-Or6I. Again, a certain type of RGB known as sRGB which has been used with digital information in the past is known to be mathematically accurate, and can possibly be used or adapted when representing, manipulating, and or storing color coded or other form of data and information relating to numbers and mathematical operations. For more information, e.g., see, sRGB—Wikipedia, https://en.wikipedia.org/wiki/SRGB. Further, see following video entitled “The Amazing Math Behind Colors” by Kuvina Saydaki @kuvina discusses RGB cubes, columns and HSV (Hue, Saturation, and Value) cones: https://youtu.be/gnUYoQ1pwes?si=J9j_yyJflvw46L0c; and also see U.S. Pat. No. 4,694,286 and the following discussion of other color rendering configurations including HSV, HSL (Hue, Saturation, Lightness) and HSI (Hue, Saturation, and Intensity: https://en.wikipedia.org/wiki/HSL_and_HSV. For disk shaped holographic storage devices resembling CD's and DVD's, and related computer drives, see the patents and patent applications listed below that were granted or assigned to InPhase Technologies, Inc., and later acquired by Apple, Inc. in 2018, and also the recent article: Quantum CD’ could hold up to 1,000 times more data than today's optical disks, by Allison, Oct. 25, 2024, https://www.livescience.com/technology/computing/quantum-cd-could-hold-up-to-1-000-times-more-data-than-todays-optical-discs.

Optical Processor and/or Memory Devices

The present application here teaches and discloses several different embodiments, structures, methods, functions and operations relating to optical, electro-optical and/or quantum computers. The different types, structure and performance characteristics of fiber optical cables will first be discussed. At the present time, a typical single mode fiber optic cable designated OM1 is made up of a small glass or plastic core surrounded by cladding which has a reflective layer. The small core will typically have a diameter around 9 microns, a maximum attenuation of 0.4 dB/km, an operating wavelength of 1550 nm at 0.3 dB/km and/or 1310 nm at 0.4 dB/km, and a range of 10 km at 10 Gbps and a bandwidth of 200 MHz km; and a typical single model fiber optic cable designated OS2 has a core with a diameter around 9 microns, a maximum attenuation of 0.3 dB/km, an operating wavelength of 1550 nm at 0.3 dB/km and/or 1320 nm at 0.3 dB/km, and a range of 40 km at 10 Gbps and a bandwidth of 500 MHz km. The small core allows a narrow beam of light to pass in one mode, that is one direction and it is generally more suitable for long range transmission than multimode fiber optic cable which has a larger core diameter. A single mode fiber optic cable can include, e.g., 36 ribbons which each contain 24 fiber strands, and such a fiber optic cable will include a total of 864 individual fiber strands. However, there are many different fiber optical cables made which include different numbers of fibers, e.g., there are so-called microcables and also high fiber count cables, and some of these can include over 3000 fibers.

Multimode fiber optic cable has a larger diameter core, typically 50 or 62.5 microns in diameter which allows a wider beam of light and multiple modes of light to pass through and while being less expensive, it is not as suitable for long range transmission as single mode fiber optical cable. A typical OM1 multimode fiber optic cable has a core with a diameter around 62.5 microns, a maximum attenuation of 3.5 dB/km, an operating wavelength of 850 nm at 200 MHz, a range of 300 m at 10 Gbps, and a bandwidth of 200 MHz km; a typical OM2 multimode fiber optic cable has a core with a diameter around 50 microns, a maximum attenuation of 3.0 dB/km, an operating wavelength of 850 nm at 500 MHz, a range of 550 m at 10 Gbps, and a bandwidth of 500 MHz km; a typical OM3 multimode fiber optic cable has a core with a diameter around 50 microns, a maximum attenuation of 3.0 dB/km, an operating wavelength of 850 nm at 2000 MHz, a range of 1000 m at 10 Gbps and/or 400 m at 40 Gbps, and a bandwidth of 2000 MHz km; a typical OM4 multimode fiber optic cable has a core with a diameter around 50 microns, a maximum attenuation of 3.0 dB/km, an operating wavelength of 850 nm at 4700 MHz, a range of 550 m at 40 Gbps and/or 150 m at 100 Gbps, and a bandwidth of 4700 MHz km; and, a typical OM5 multimode fiber optic cable has a core with a diameter around 50 microns, a maximum attenuation of 3.0 dB/km, an operating wavelength of 850 nm at 4700 MHz, a range of 1000 m at 40 Gbps and/or 150 m at 100 Gbps, and a bandwidth of 4700 MHz km, e.g., see the websites: Fiber Cables Direct.com https://fibercablesdirect.com/ and, RF Industries https://rfindustries.com/pdfs/articles/Fiber-Optic-Cable-Types.pdf. While fiber optic cable which can transmit 100 Gbps is currently being used, the movement is towards cables which can provide faster transmission speeds around 200 Gbps. There are three types of modes in fiber optic cable: single mode fiber optic cable can typically only be used to transmit in one direction; half duplex mode makes it possible to transmit and also receive data and information, but not at the same time; and, full duplex mode makes it possible to transmit and also receive data and information at the same time.

However, as concerns the design and operation of an optical, electro-optical and/or quantum computer one of the important things to recognize is that the above specifications and performance characteristics pertain to the transmission of data and information over relatively long distances. Given an optical, electro-optical, and/or quantum computer operating in a large data center, the length of the fiber optic cables will not be 1 km in length, and they may be less than 10 meters, or even 1 meter. Further, an optical, electro-optical, and/or quantum computer for use in a business, a personal computer, or a cell phone could include fiber optic cables which are less than 10 cm, or less than 1 cm, or even less than 1 mm in length. In this regard, signal strength and quality is typically improved, and the related signal to noise ratio be more favorable, the shorter is the transmission distance over fiber optic cables. Accordingly, the performance characteristics of fiber optic cable and related photonic connections for use with distances in the range between 0-10 cm is more relevant to the design and performance of optical, electro-optical, and/or quantum computers.

The data and information which is inputted into an optical computer, electro-optical computer, and/or a quantum computer which is based upon them will typically be in either a digital form, or an analog and/or optical form. If the data and information is in a digital form, it will either have to be read, written, processed and placed into memory using a classical or conventional electronic co-computer which can be the electro portion of an electro-optical computer, and/or the data and information will have to be converted into an analog form using an digital to analog converter or transceiver device so that the optical computer, or optical portion of an electro-optical computer, and/or an optical quantum computer can read, write, and manipulate the data and information, store it into memory, and perform calculations or other computing operations. If the data and information is in an analog form, it will typically be communicated by a first computer or other source which has a multiplexer device, and the analog signal will typically be transmitted in a sinusoidal wave form, sine wave, cosine wave, wavelet, or pulse over at least one fiber optical cable which is connected on the receiving end to a wavelength division demultiplexer that is associated with or contained in a second computer which is an optical computer, electro-optical computer, and/or an optical quantum computer. The wavelength division demultiplexer will then communicate the analog sinusoidal, wavelet, or pulse signals to an optical processor device, an optical memory device, and/or a combined optical processor and memory device in the second computer. In this regard, typically, the shorter the fiber optical cable or other photonic cables which are used to connect the demultiplexer to the optical processor device, optical memory device, or combined optical processor and memory device, and the more perfect are the associated connections the better will be the resulting transmission or communication speed, quality, and computer performance.

For this reason, the present application teaches and disclosed certain structures and configurations in which the connections between a wave division demultiplexer device and the optical processor device, or optical memory device, or a combined optical processor and memory device are either direct and/or the wave division demultiplexer device is combined with an optical processor device, or an optical memory device, or a combined optical processor and memory device. Alternatively, the wave division demultiplexer device can be located in close proximity to the optical processor device, optical memory device, or combined optical processor and memory device. Again, a single mode fiber optic cable can include 36 ribbons which each contain 24 fiber strands, and so a fiber optic cable can include a total of 864 individual fiber strands, and there are many other different fiber optical cables being manufactured which include a different number of fibers, e.g., there are so-called microcables and also high fiber count cables, and some of the latter can include over 3000 fibers. Accordingly, a multiplexer device, wave division multiplexer device, transceiver, or transponder can potentially include a plurality of optical or photonic connections. As previously discussed, a portion of the invisible infrared light spectrum is being used today by members of the telecom industry to transmit signals through fiber optical cable. Fiber optical cable can transmit about 100 terabytes (Tb)/second in C and L bands: the C band is between 1530-1565 nm; the L band is between 1565-1625 nm; the O band is between 1260-1360 nm, the E band is between 1360-1460 nm, the S band is between 1460-1530 nm, and the U band is between 1625-1675 nm. Visible light frequencies are between about 4×10¹⁴ and 8×10¹⁴ cycles per second (Hz) which is about 430-750 trillion Hz (THz) and have wavelengths in the range between approximately 380-740 nanometers (nm). For the sake of simplicity, and because the following range is often recited by others the present application will sometimes refer to the visible light range as being between 400-700 nm. The ultraviolet light spectrum includes wavelengths in the range between approximately 10 nm and 400 nm which corresponds to frequencies in the range between approximately 30 PHz-750 THz. The infrared light spectrum includes wavelengths in the range between approximately 740, and for the sake of simplicity here, between 700 nm-1 mm and corresponds to frequencies in the range between approximately 430 THz-300 GHz.

For practical purposes, the present discussion will here focus on the visible light spectrum between 400-700 nm and the invisible light spectrum between 700-1675 nm. However, ultraviolet light is also of interest and important because it has the ability to erase and/or delete data and information which is being persisted and stored in a holograph memory device which can include, e.g., a crystalline material such as lithium niobate. Accordingly, it can be useful for an optical computer, electro-optical computer, and/or optical quantum computer to also include a source and be able to generate and use ultraviolet light. In this application, data and information which can be communicated in the visible and/or invisible light spectrum is sometimes more simply referred to color coded data. In this regard, color coded data can be stored in a structure, object, medium, and/or in a format resembling a Red, Green, Blue (RGB) cube, a RGB cylinder, a RGB cone, or other geometric form. In the form of a piece of hardware and a memory device, it can be referred to as a RGB Holographic Memory Device 35, as shown in FIG. 51. When a memory device is specifically configured for use with invisible light in the infrared spectrum it can be referred to as an Infrared Holograph Memory Device. As previously discussed, an optical computer, electro-optical computer, and/or optical quantum computer can include an optical processor device, an optical memory device, or a combined optical processor and memory device. Accordingly, an optical processor device can also be configured to manipulate data and information in a structure, medium, and/or format resembling a RGB cube, RGB cylinder, RGB cone, or other RGB geometric form, and can then be referred to as a RGB processor device. In this regard, it is possible for an optical computer, electro-optical computer, and/or quantum computer to include one or more optical processor devices, one or more optical memory devices, or one or more combined optical processor and memory devices. With respect to an RGB processor device and/or RGB memory device, the range of colors in the visible light spectrum can include white light, which is and/or can be used to represent the presence of all visible colors, and the range can then extend through the red, yellow, green, blue, and into the purple color spectrums, and then go to black which is and/or can be used to represent the presence of no color, and no data and information, or no signal, and then be rendered and communicated by using a very dark color, or no color, or no signal.

In this regard, it is important to recognize that written text, but also numbers and many mathematical computations have typically been rendered in the past in black and white. Accordingly, the present application teaches and discloses that a RGB processor and/or RGB memory device can be configured such that its sub-portions which are configured or assigned to process and/or store data and information relating to numbers, and also its connections to a wave division multiplexer device can include those signals which communicate in white and black, and/or in white, gray semitones, and black and/or signals which are contained in the infrared spectrum. This can be done by tapping one portion of an RGB processor and/or optical memory device for white and another portion for a dark color, or black, or simply using no signal for black, or otherwise tapping into one portion of an RGB processor and/or optical memory device in order to communicate, process, and/or store in memory data and information which can be rendered in white, gray semitones, and black. As previously discussed, it is possible to represent and communicate the values and numbers 0, 1, 2, 3, 4, 5, 6, 7, 8, and 9, and all of the possible combinations thereof by representing the base portion of a larger number, and also its index, place holder value, or exponential value in base 10, that is, 10ⁿ. Alternatively, the present application also discloses how to represent each base portion of a number, and also the entire number such that it can be communicated in parallel, but also be read, written, and processed with the base portions of the larger number being configured and/or rendered in the correct sequence. The present application has also suggested encoding certain often used and large numbers which are often used in the sciences, e.g., the speed of light, Euler's number, and Avagadro's number. When numbers are looked at in the described manner, one can recognize that there is not an infinite sized group of different numbers which need to be encoded, but only infinite combinations of a relatively few numbers or symbols which can then be used to create and communicate infinite numbers. Accordingly, unless one is performing a lot of computations using numbers and mathematical formulas, a large portion of a RGB processor device and/or optical memory device will typically not be required and used in this capacity. Because human beings do not typically need or use color rendering when communicating written text or when performing computations using numbers, their representation and encoding can for the most part be done and communicated by wavelengths and corresponding frequencies which are in the invisible light spectrum, such as the infrared spectrum, but the ability to use color rendering with words and numbers can nevertheless still be provided. In this regard, when attempting to represent things like multiple dimensions in time and space, the orientation of atoms and molecules in chemistry, or complex biological structures such as DNA, the use of multiple colors, and the x, y, z axis and three dimensions can be helpful. Further, the introduction and use of a fourth dimension relating to time can also sometimes be useful, as discussed and shown in FIG. 50. Just as conventional computers presently have and use ordinary CPUs, but can also include what are called GPUs like those of NVIDIA which are specially adapted to process video and color information, the same specialization is possible with respect to RGB optical processors and/or optical memory devices, and this is discussed and shown in FIG. 51. However, when the desire is to make a relatively inexpensive computing device which consumes less energy than classical computers, a computer design that is simple and includes less, rather than more, can be advantageous. For this reason, it can be beneficial to save the use of the visible light spectrum and its color rendering ability for when it is really needed. In terms of size and volume, over 90 percent of the data and information which is being transmitted, communicated and used by members of the general public in computers today is in the form of photos, color photos, videos, video games, audio, music, and films, and is visual in nature. Accordingly, using visible and/or invisible light and waves to provide for the transmission and communication of data and information which is originally by nature in a wave form such as images, video, or audio by using sinusoidal wave forms, wavelets, or pulses and fiber optical cable or other waveguides can potentially provide for greater efficiency than using classical computers and conventional use of the digital system, and it also lends itself to modulation for wireless communication in the 4-5 G microwave spectrum and larger radio frequency spectrum.

Accordingly, one question concerns how to design and configure an optical memory device such as holographic or crystal memory device, an optical processor device, and/or a combined optical processor and memory device. In the past, holographic memory devices have been made in relatively simple geometric shapes such as a cube shape, or to resemble a removable CD or DVD disk, e.g., like those made by InPhase, Technologies, Inc., see, the patents assigned to this company below, and also the following video which was made by the company which took over its assets before they were purchased by Apple Inc.: Akonia Holographic Data Storage (HDS) Demonstration, Jan. 28, 2019, https://youtu.be/W6wAuOiiGsM?si=gVWjSneuCoSi0S_h. The computer industry typically focuses on making computers and their components very small, but it is also possible to make a crystalline material for use as a holographic storage medium or use in a data center which is relatively large, e.g., in the range between 5 mm-300 mm, and even the size of a silicon wafer. It is also possible to use optical fiber cables having larger fiber cores, and/or to use a larger number of optical fibers than what has been customary in the past. As some individuals with experience in the audio and music industry know, sometimes, size matters, and the quality of the sound, and in particular with reference to the transmission of lower frequencies or bass, which comes from using a guitar cable and/or speaker cable having a thicker gauge and/or more pure chemical elements can be noticeable and dramatic.

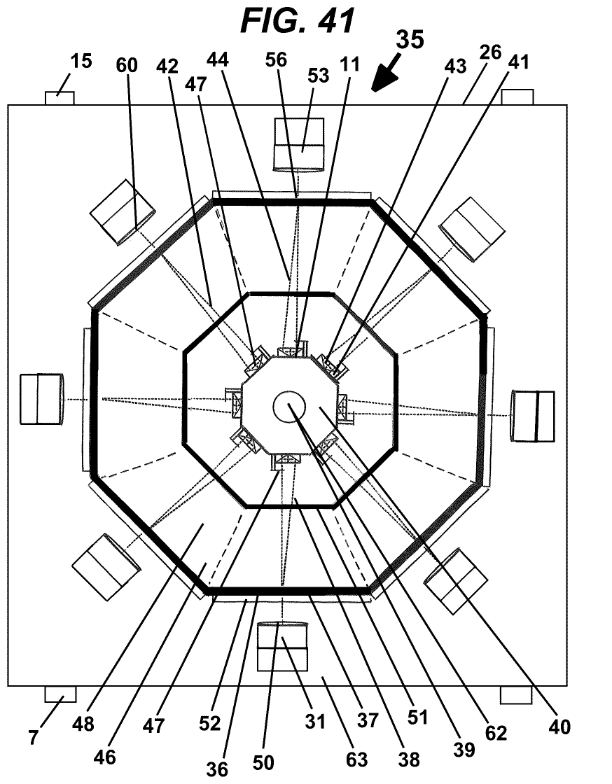

As shown in FIG. 40, a plurality of different geometric shapes can possibly be used to make a photonic, optical, or holographic processor device, a holographic memory device, and/or a combined photonic, optical, holographic processor and memory device. The cylinder and cone shapes generally correspond to the configuration of RGB columns and cones which have previously been discussed in the literature and videos relating to color representation which have been cited in this application, and the cube, pentagonal prism, hexagonal prism, octagonal prism, and dodecahedron shapes can lend themselves to the kind of configuration and structure of a holographic memory device 35 that is shown and discussed in FIG. 41. Some of these geometric shapes can be used in the configuration of optical processor devices and/or optical memory devices which can enable and permit a plurality of tasks and operations to be performed in parallel and/or in series or a sequence.

FIG. 41 is a top view of an optical memory device 26, and in particular holographic memory device 35. As shown in FIG. 41, a holographic memory device 35 can include eight sides and then have the general shape of an octagonal prism 36, but other geometric shapes can be used. The holographic memory device 35 includes a holographic storage medium 46, e.g., a glass, a silicon, or a doped lithium niobate crystalline material which has an inside surface 51, an outside surface 56, a top side 54, a bottom side 55, an open space 38, a center or middle 39, and also multiple lateral sides or facets 37 which can define different conceptual or actual sections or portions 48. In this regard, the holographic storage medium 46 used in the holograph device 35 can be made in a single piece and be divided conceptually or functionally into different working sections or portions 48, or alternatively it can be configured, arranged, or assembled in a plurality of different sections or portions 48. These different sections or portions 48 can be in direct communication with one another, isolated from one another, and/or be placed into photonic and/or electrical communication with one another as desired. A base 63 upon which the various components of the holographic memory device 35 is mounted, a positive lead 15 and/or electrical connection for providing electrical power, and a negative electrical lead 7 and/or ground connection is also shown in FIG. 41. In addition, the memory device 26 can include a plurality of other leads, waveguides, and/or optical connections on its top side, bottom side, and lateral sides or facets for electronic and/or optical communication with an output device, input device, processor device, or other memory device.

A turret 40 is located in the open space 38 and center or middle 39 of the holograph storage medium 46, and faces the inside surface(s) 51 of the holograph storage medium 46. Alternatively, at least one turret 40, light source 11, beam spitter, reference beam mirror 43, shutter 47, and other photonic devices can be located in a position that is above, below, or otherwise not in the same horizonal plane as the holographic storage medium 46. The turret 40 can contain at least one light source 11 such as a laser, laser diode, LED, and/or serve to direct a beam of light which has been transmitted or communicated from a remote light source 11. The turret 40 and/or open spaced 38 of the holographic memory device 35 can include a beam splitter 41, a reference beam mirror 43, a shutter 47, and other photonic devices possibly including, but not limited to, e.g., an optical and/or signal modulation device 52, a lens 50, a beam shaper, a filter, and a spatial light modulator. The data light beam 42 is shown with a dashed line extending from the turret 40 and through the beam splitter 41 to the inside surface 51 of the holograph storage medium 46, and the reference light beam 44 is shown with a dashed line extending from the beam splitter 41 and also possibly through a shutter 47 to the reference beam mirror 43 and then to the inside surface 51 of the holograph storage medium 46, but also beyond it in order to illustrate the possible retrieval of stored data and information. In this regard, when storing data and information using a holograph memory device 35 both of the data light beam 42 and the reference light beam 44 are used, but only the reference light beam 44 is required when retrieving stored data and information. The shutter 47 can be actuated to either permit the passage of the data light beam 42, or to block it when it is desired to retrieve data and information which has been stored on and/or within the holograph storage medium 46. At least one of the turret 40, the beam splitter 41, and the reference beam mirror 43 can rotate or otherwise be caused to change position and/or orientation so as to be able to direct visible and/or invisible light such a infrared light towards the holographic storage medium 46 and to store and/or retrieve data and information. As shown, the turret 40 can include a plurality of light sources 11 which are associated with a plurality of data light beams 42, reference light beams 44, beam splitters 41, reference beam mirrors 43, and shutters 47 on each of its eight lateral sides or facets 37, and this can make it possible for multiple sections or portions 48 of the holographic storage medium 46 to be used simultaneously in parallel and/or in series to store and/or retrieve data and information which is being communicated using different encoded wavelengths and corresponding frequencies of visible and/or invisible light using, e.g., sinusoidal wave forms, sine wave, cosine waves, wavelets, or pulses. In this regard, some of the sections or portions 48 of the holographic storage medium 46 can be used for cache memory, and/or Read Only Memory (ROM) memory, and/or Random Access Memory (RAM) memory. Alternatively, a plurality of holographic memory devices 35 like the one shown in FIG. 41, or other optical memory devices 26 can be configured to perform some of these different memory tasks. In this regard, a plurality of holographic memory devices 35 can be stacked vertically above or on top of one another. Alternatively, the open space 38 of at least one holographic storage medium 46 can be configured to include multiple levels, and each level can include a turret 40 and/or other structures for directing a data beam and a reference beam towards the holographic storage medium 46 for recording and retrieving data and information. An optical detector device 53 such as a photodetector, photodetector array, or camera 31, and possibly at least one photonic or optical manipulation device 52, e.g., a lens 50, a beam shaper, a mirror 43, a shutter 47, a filter, a spatial light modulator, a beam collimator, can be located inside, that is, in the open space 38 defined by the inside surface 51 of the holographic storage medium 46, or outside, that is, beyond the outside surface 56 of the holographic storage medium 46. In this regard, an optical modulation device 52 can possibly include, e.g., a signal modulator, an intensity modulator, a phase modulator, a spatial light modulator, an acousto-optic modulator, an electro-optic modulator, plasmonic modulator, an electroabsorption modulator, an interferometric modulator such as a Mach-Zehnder modulator, and/or a liquid crystal modulator. Alternatively, at least one turret 40, light source 11, beam spitter, reference beam mirror 43, shutter 47, optical detector device 53 and other photonic devices can be located in a position that is above, below, or otherwise not in the same horizonal plane as the holographic storage medium 46.

In FIG. 41, eight different data light beams 42 are shown extending from the turret 40, and this is in part to keep the drawing relatively simple and easy to comprehend. However, the number of data beams 42 and/or associated signals channels could potentially be equal to the number of different wavelengths and frequencies in the visible and/or invisible light spectrum. In the visible light spectrum there are 300 different wavelengths and frequencies in the range between 400-700 nm, that is, when they are being differentiated by a 1 nm separation, and in the invisible infrared light spectrum between 700-1675 nm there are 975 different wavelengths and frequencies which are differentiated by a 1 nm separation, the sum of which comes to a total of 1275 different wavelengths and frequencies. As previously discussed, there are fiber optic cables available on the market which include between 800 and 4000 individual fibers. Accordingly, a holographic memory device 35 can be configured to be in communication with a plurality of individual fibers and/or to a multiplexer device 49 which can communicate encoded data and information signals in parallel and then potentially be using over 1000 different wavelengths and frequencies of visible and invisible to communicate signals. In this regard, the turret 40 can include an optical connection 62 which enables it to be in communication with at least one fiber optic cable 4 which comes from an external computer or internal source, e.g., from a multiplexer and/or demultiplexer device 49, and/or an optical processor device 27. Alternatively, the turret 40 can include a multiplexer and/or demultiplexer device 49, such as a wave division demultiplexer. Moreover, the presence and use of at least 8 data light beams 42 as shown in FIG. 41, makes it possible for an optical representation and encoding of 8 digital bits or other signals to be simultaneously communicated and also stored in parallel by being directed into the 8 different sections or portions 48 of the holographic storage medium 46, but at the same time this structure and configuration can be used to facilitate the data and information being read, written, retrieved and communicated in a sequence, if desired. Again, the structure of the holograph memory device shown in FIG. 41 can be extended vertically and then essentially be duplicated and/or stacked upon itself one or more times, and so the 8 sections or portions 48 which are shown in FIG. 41 can then potentially become 16, and two 16's can become 32, and so on.

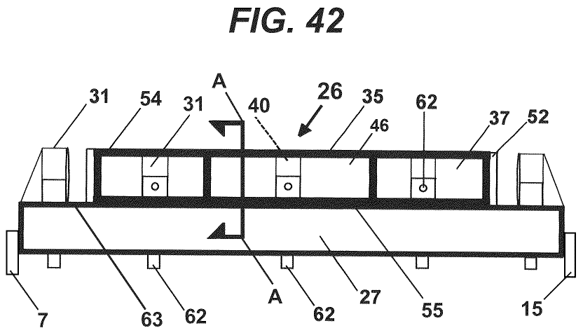

The quality of optical communication using visible and/or invisible light can be adversely affected and will typically degrade due to the introduction of noise and other factors given long transmission distances and/or the existence of more numerous optical connections. Accordingly, inside an optical computer, an electro-optical computer, and/or optical quantum computer it is typically desirable to minimize transmission lengths and to keep the number of optical connections few. For this reason, the turret 40 can include, or be directly connected to a multiplexer device 49. In addition, an optical memory device 26 such as a holographic memory device 35 can be in direct communication with at least one optical processor device 27 as shown in FIG. 42.

FIG. 42 shows a side view of an optical memory device 26, and in particular, a holographic memory device 35 which resembles the one shown in FIG. 41 being located and disposed above and in close proximity to an optical processing device 27. If desired, the optical processing device 27 can be configured to include, e.g., photonic logic gates, a photonic transceiver, a transponder, a muxponder, a multiplexer, or a demultiplexer. Alternatively, an optical processor device 27 can be an integral part and a hybrid combination of an optical processor device 27 and an optical memory device 26 such as a holographic memory device 35. As shown, the holographic memory device 35 can be in direct contact with the optical processor device 27, and there can then be direct and/or very short optical connections 62 between these two devices and/or within a hybrid combination of an optical memory device 26 and an optical processor device 27. A positive lead 15 for providing an electrical power connection, and a negative lead 7 for providing an electrical ground connection is also shown in FIG. 42. An optical processor device 27 can be configured as an optical logic processor device which can also be used to manipulate data and information and perform computations and other computer functions using representations and encoding of the binary number system, as discussed and shown in FIGS. 45-50. Further, the structure shown in FIG. 42 can be duplicated and stacked vertically or horizontally if and when this is desired, and one or more heat sinks can possibly be added in order to help control the operating temperature. Again, the optical memory device 26, optical processor device 27, or combined optical memory device 26 and optical processor device 27 can include a plurality of other leads, waveguides, and/or optical connections for electronic and/or optical communication with an output device, input device, processor device, or other memory device.

FIG. 51 shows a cross-sectional view of the holographic memory device 35 and holographic storage medium 46 shown in FIGS. 41 and 42, taken along Line A-A in FIG. 42. The holographic device 35 has an octagonal prism configuration and shape and includes a holographic storage medium 46 which has a top side 54, a bottom side 55, a plurality of lateral sides and facets 37, a plurality of sections or portions 48, at least one inside surface 51, and at least one outside surface 56. The holographic storage medium 46 is configured and/or formatted to persist or store data and information using wavelengths and frequencies of visible and/or invisible light. In this regard, the visible light spectrum which is typically considered to be in the range between 400-700 nm can be used, persisted or stored in the top or upper portion 73 beginning from the dashed demarcation line 75 which is used to indicate the position of 700 nm data and information and then extending to the top side 54. In this regard, the visible light spectrum range and associated colors would then begin with red at 700 nm and then transition to yellow, green, and blue, and indigo and then violet at 400 nm. From the dashed demarcation line at 700 nm and extending downwards to the bottom side 55 the space and volume can be used to persist or store data and information that is sent or transmitted and communicated using a portion of the invisible infrared light spectrum which is typically considered to be in the range between 700 nm and 1 mm, and is commonly used in the range between 700 nm and 1625 nm. This configuration and relative use of space and volume can be suitable for applications where a substantial amount of the persisted or stored data and information does not require that it be in the visible light range. In this regard, other different configurations and demarcations are possible, e.g., it is possible for nearly all or completely all of the holographic storage medium 46 to be dedicated for persisting or storing data and information which would use the visible range between 400-700 nm in order to support the functions which are currently performed using conventional GPU devices, and vice versa, that is, alternatively, in order to support the functions currently performed by CPU devices. Alternatively, the holographic device 35 can be made and take the form of a combined optical processor device and optical memory device. In any case, the wavelengths and corresponding frequencies of visible and/or invisible light and related data and information can be configured and organized on and/or within the holographic medium 46 of a holographic memory device 35 such that it resembles a Red, Green, Blue (RGB) configuration, or what can be called and Infrared, Red, Green, Blue (IRGB) configuration. Accordingly, such a memory device and/or processor device can be referred to as a RGB memory device, RGB Holographic memory device. RGB processor device, or a combined RGB processor and memory device. Alternatively, a glass or other crystal holographic memory device can be similarly configured to persist or store data and information.

### Sending and Receiving Ultra Fast Signals

One of the devices which can be used to generate and send sinusoidal wave forms, and/or wavelets, and/or pulses very quickly is an ultrafast mode locked femtosecond laser. In this regard, a femtosecond laser can send a sinusoidal wave form in less than 10 fs, and some passively mode-locked titanium-sapphire lasers can do about 5 fs. However, it is possible to generate even faster signals. As previously discussed, the duration of a single sine wave period in the visible light spectrum is in the range between approximately 1.3 and 2.3 fs and in the infrared light spectrum a bit slower, e.g. about 3.3 fs at 1000 HZ. As previously discussed in connection with FIG. 35 and FIG. 36, when a plurality of sinusoidal waves are being sent in parallel simultaneously using fiber optic cable it is possible to use the Fourier Transform Algorithm (FFT) to see what different wavelength and frequencies of sinusoidal waves are present. Again, see Fourier Transform, https://en.wikipedia.org/wiki/Fourier_transform. When the wavelength and frequencies of the sinusoidal waves associated with visible and/or invisible light are not being used to carry a signal, such as a binary digital signal, but instead they are themselves the signal and have been directly encoded to represent a letter of the alphabet, a word, a symbol, or a number, this can make it simpler and easier to decode signals which are transmitted in parallel in a communication of data and information and to know what the corresponding signals are. However, one of the limitations of Fourier analysis is that while it can tell us which sinusoidal frequencies are present and their amplitude in a communication, it can't tell us what their relationship is in time and so we don't know the order or sequence of the signals when they being transmitted in parallel.

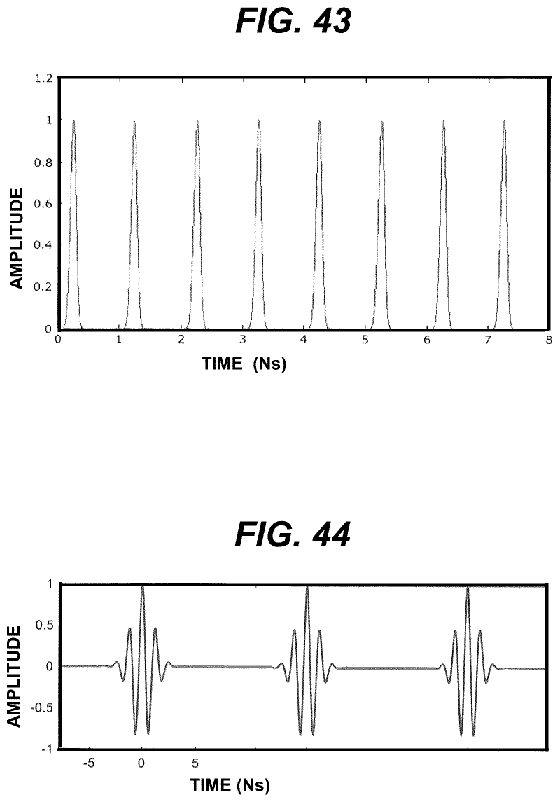

One of the ways to send a sinusoidal wave form, or other form of signal very fast is to use an ultra-short pulse and/or a chirped pulse, and such a pulse can take the form of what is called a wavelet and/or a burst, and/or a pulse train, and/or a Gaussian pulse. As previously discussed, FIG. 27 is a prior art representation of an ultra-short electronic pulse having a duration of about 200 Fs which can be used to communicate information which has been reproduced from the website: https://en.wikipedia.org/wiki/Ultrashort_pulse. However, this drawing figure also shows what is called a wavelet, and this particular wavelet form is known as a Morlet Wavelet, e.g., see Wavelet, https://en.wikipedia.org/wiki/Wavelet; Morlet Wavelet, https://en.wikipedia.org/wiki/Morlet_wavelet; and Chirped Pulse Amplification, https://en.wikipedia.org/wiki/Chirped_pulse_amplification. As shown in FIGS. 43 and 44, a similar Morlet wavelet, a series of wavelets, and a burst of several wavelets or train of pulses can also be generated in the visible and/or invisible light spectrum, and the associated center frequencies and wavelengths will then be in the PHz and THz range.

FIG. 44 shows a plurality of wavelets, and in particular three Morlet wavelets which together form a train of wavelets. In this regard, wavelet transform analysis makes it possible to know the center or main frequency of an ultra-short pulse wavelet, but also its position in time and as a result it is possible to know the sequence of the sinusoidal waves, and/or ultra-short pulses and/or wavelets which are present in a parallel communication, e.g., see Wavelet Transform, https://en.wikipedia.org/wiki/Wavelet_transform, and What is Wavelet and How We Use It for Data Science, by Ryan, May 31, 2019, https://towardsdatascience.com/what-is-wavelet-and-how-we-use-it-for-data-science-d19427699cef. Accordingly, a combination of Fourier analysis and wavelet analysis can provide more information about visible and/or invisible light signals than either of them can provide alone, and so there can be good reasons to send at least some optical or photonic communications very fast and in the form of wavelets, and to then perform wavelet analysis. Ultra-fast light pulses can be produced by femtosecond lasers or flash lamps. In this regard, they be used to create single shot pulses, or pulse bursts using burst mode lasers, or alternatively they can make repetitive pulses or pulse trains which can be spaced very close together, e.g., about 1 nm apart, and the train of pulses can then also be varied in length and duration, as desired or required. Moreover, a technique known as Q switching can be used to create ultra-fast light pulses, and there are microchip lasers which can produce pulse durations which are less than 1 nanosecond. A good website and resource on the internet relating to the field of photonics and optical communication and related equipment is the RF Photonics Encyclopedia, by Dr. Rüdiger Paschotta of RF Photonics AG who is located in Frauenfeld, Switzerland, see https://www.rp-photonics.com/encyclopedia.html, and https://www.rp-photonics.com.

One of the issues which can possibly be associated with creating and sending ultra-short and fast signals is that doing so can possibly consume a lot of bandwidth, as will be discussed below in connection with the Shannon-Hartley Theorem. However, a different way of quickly generating optical signals and to then not consume so much bandwidth and also possibly introduce as much noise is to not attempt to start as from a starting line and then to stop a short while later in making and communicating an optical signal, but to be continuously generating and potentially transmitting an optical signal, but to then block or cancel it out unless or until you wish to send that particular signal, and/or a plurality of signals. For example, let's say that we have 10 laser light sources that are generating different sinusoidal signals having specific wavelengths and frequencies which we are using to represent and encode 0, 1, 2, 3, 4, 5, 6, 7, 8, 9. They can be blocked, or shuttered, or directed elsewhere unless and until we want to send a particular signal which represents and encodes a specific number. In this regard, the same thing can be done when we desire to communicate letters of the alphabet, words, and symbols, but in this case only 10 signals are needed, and they can be generated, e.g., by a single laser or other light source with the use of a multiplexer and/or demultiplexer. In this regard, an optical add-drop multiplexer device can effectively stop or drop the communication of various signals, e.g., see Add-Drop Multiplexer, https://en.wikipedia.org/wiki/Add-drop_multiplexer, and Optical Add-Drop Multiplexer, https://en.wikipedia.org/wiki/Optical_add-drop_multiplexer.

Another way to essentially block the transmission and/or cancel a sinusoidal wave, sine wave, wavelet, or pulse is to simultaneously cause the same signal to be inverted 180 degrees and in the same phase so that superposition takes place and the superimposed wave forms cancel themselves out due to destructive interference. It is possible to do this by sending a second sinusoidal signal from the same origin, or from the opposite direction, or to have the source signal precisely reflected back on itself by using a mirror or diffraction grating so that the intended destructive interference takes place. When the second sinusoidal signal which is being used to product destructive interference is blocked, filtered, or otherwise stopped, then the first signal will not be cancelled.

### Detecting Ultra Fast Signals

One of the ways in which look at sinusoidal wave forms which are very small and fast is with the use of a streak camera which have a time resolution of about 180 fs, but in 2020 individuals at CALTECH used a pulsed laser with a streak camera in order to simulate a movie frame rate of 70 trillion frames per second. e.g., see Streak Camera, https://en.wikipedia.org/wiki/Streak_camera. Other methods include: Frequency-Resolved Optical Gating (FROG), https://en.wikipedia.org/wiki/Frequency-resolved_optical_gating; Multiphoton Intrapulse Interference Phase Scan, https://en.wikipedia.org/wiki/Multiphoton_intrapulse_interference_phase_scan; Spectral Phase Interferometry For Direct Electric-Field Reconstruction, https://en.wikipedia.org/wiki/Spectral_phase_interferometry_for_direct_electric-field_reconstruction; and Optical Autocorrelation, https://en.wikipedia.org/wiki/Optical_autocorrelation. In addition, optical devices and equipment such as cameras, photodetectors, photodetector arrays, infrared detectors, optical spectrum analyzers, Fourier transform spectroscopy, heterodyne detection, spectrometers, autocorrelators, and related methods and techniques can be used. Moreover, if and when speed and the use of the digital system is not an issue, the CCD and CMOS digital sensors which are now being used in the cameras found in cell phones can be used.

In the abstract, it is possible to generate and send different individual sinusoidal wave forms, and/or sine wave forms, and/or wavelets, and/or pulses, and/or Gaussian pulses in the visible and/or invisible infrared light spectrums in equal to or less than 5 fs. However, it is not necessary to do this in order to dramatically beat the speed and performance of the relatively slow square wave signals that are being used in the digital system and by classical or conventional computers. Accordingly, for most commercial and home computer applications there is no need to send only one encoded sinusoidal wave form having only one complete period, or a single wavelet or pulse of visible and/or invisible infrared light, nor are speeds equal to or less than 5 fs normally required for business and home computing. In this regard, there are several good reasons why it can be advantageous to repeat an individual signal more than once. In this regard, it is typically easier to send multiple complete sinusoidal wave form cycles and periods, and/or sine waves, and/or wavelets, and/or pulses, and it is less expensive to do so, and it is also easier to detect the signals which decreases the probability of error and then serves to increase accuracy and facilitate error detection and correction, and it can also decrease the amount of bandwidth which is used or required to transmit and receive the signals. Again, a 1 bit interval typically corresponds to about 10×10⁻¹² or 10 Picoseconds (ps) which is 0.000000000001 seconds, whereas one sinusoidal wave form cycle or period in the visible and/or invisible infrared light spectrum is about 2×10⁻¹⁵ or 2 fs, and so one could potentially fit about 50,000 sinusoidal wave periods into the bit interval of a classical or conventional computer which is using the digital system. Further, some of the error detection methods being used with conventional computers will now repeat a bit and therefore the associated bit interval at least 3 times which is 30 ps, and this would correspond to about 150,0000 sinusoidal wave periods. Accordingly, using 5, 10, 100, 1000, or even 10,000 repeated sinusoidal wave periods and/or wavelets and/or pulses in the visible and/or invisible light spectrum would not significantly compromise the relative efficiency of optical communication as compared with a digital version using classical computers and wires.

### Bandwidth and the Shannon-Hartley Theorum

As previously discussed, there can be a significant difference between the bandwidth that is available when sending data and information between two computers using fiber optical cable over long distances, versus when transmitting data and information inside of a data center, or inside an individual computer. However, there is a limit to the amount of data and information which is possible to encode in a phase space even in the absence of noise, and this phenomenon is disclosed in the Shannon-Hartley theorem. e.g., see Wikipedia, https://en.wikipedia.org/wiki/Shannon%E2%80%93Hartley_theorem. In brief, it can take more bandwidth to correctly identify a single complete sinusoidal wave form period, than it does when the sinusoidal wave is repeated multiple times, and so there can be a practical compromise to be made as between how many times a sinusoidal wave is repeated versus how much bandwidth is then required and will be used, e.g., see, How are Data Rate and Bandwidth Related? (“a super clear explanation!”) by Ian Collins, Feb. 26, 2020, https://youtu.be/ZBSvMbOOmPQ?si=oSEt-ko4tDscl8T_, and, What is the Maximum Bandwidth?—Sixty Symbols, by Mike Merrifield, Oct. 3, 2013, https://youtu.be/0OOmSyaoAt0?si=T_2Nre7syQyN67lh. For example, a sinusoidal wave form having a wavelength 1000 nm which is in the infrared light spectrum has a corresponding frequency=299.7925 THz and a period duration of 3.3 Fs. A wavelength bandwidth converter and also a time-bandwidth product calculator can be found online on at https://lasercalculator.com/spectral-bandwidth-converter/. There are many bandwidth calculators available online. In this regard, the following source includes many other links to different subjects relating to photonics and also the various types of equipment which can be used to manipulate signals, e.g., see Bandwidth—Optical Spectrum, Telecom Fiber—RP Photonics, https://www.rp-photonics.com/bandwidth.html.

When transmitting and communication sine wave form or other signals, it is recognized that a plurality of wavelengths and corresponding frequencies can be generated and present or otherwise associated with sudden and abrupt starting and/or stopping points, and this can consume and/or require more bandwidth. In the case of wireless communication, a plurality of sine waves are typically combined together in order to generate a square wave that is used to represent and encode digital ones (1s) and zeros (0s). With this being said, the representation of the sine wave signals shown in the drawing figures, e.g., FIGS. 3-4, 6-7, 10, 12-16, 19-20, 22-26, and 31-34 which appear to show large breaks and/or sudden starts and stops have been represented in this manner for the sake of visual clarity and to facilitate comprehension and understanding of the main points being discussed and disclosed. Likewise, sine waves have sometimes been shown on the same scale as square waves. In reality, the transitions between different wavelengths and corresponding frequencies of visible and/or invisible light can be continuous and relatively subtle, and a sign wave in the visible light spectrum used in an optical computer which has wave interval or period of about 2 femtoseconds or 0.000000000000002 is very much smaller than a typical square wave being used in the digital system in a classical computer which has a bit interval of 1 picosecond or 0.000000000001.

As previously discussed, the present application has disclosed that one of the ways to get around the problem which can be encountered when transmitting ultra-fast signals is to not suddenly start and stop creating and potentially transmitting them, but to instead block them with a shutter and/or to effectively cancel them using a similar waveform which is inverted and superimposed 180 degrees that will result in wave cancellation, that is, until such time that you want to transmit a visible and/or invisible light signal. Further, just as a compression technique can be used to derive the center frequency of a sinusoidal ultra-short pulse and/or wavelet, an expansion technique can be used to derive the frequency and wavelength of an ultra-short and/or compressed sinusoidal wave form. The present application has also discussed the possible use of half wave and full wave rectification, as shown in FIG. 39.

As shown in FIG. 43, a pulse can also take the form of a Gaussian and/or Gaussian-like pulse, and a plurality of such pulses are shown which each have an individual duration of about 1 nanosecond and together they correspond to a train of signals. In this regard, a single pulse or train of pulses can be generated and communicated by taking a sinusoidal wave, or wavelet, and using a filter, e.g., high pass and/or low pass filter, to essentially cutoff and block most of the complete wave form and then only leave a series of pulses. Again, the cutoff can be at the −3 dB level or at half of the amplitude of the sinusoidal wave form, or alternatively can be made at a different level of amplitude. In this regard, the frequency and wavelength of the wave form from which the pulse signals are generated can then be known, and the transmitted pulses can be relatively noiseless and provide a cleaner signal characterized by a favorable signal to noise ratio. Moreover, the previously discussed methods and techniques of using a shutter to block a pulse, burst, or train of signals, and wave cancellation can also be used to cancel out a pulse, burst, or train of signals until such time it is desired to communicate and transmit the associated signal.

Sine Wave Unit Circle(S) and their Relationship to Euler'S Number and Logarithms

The following video is an animation which shows a sine wave unit circle: https://youtu.be/Q55T6LeTvsA?si=xH_1_ChhrzhKve1-. These two videos show and/or discuss Euler's Number and sine wave representations: https://youtu.be/znwuFjJs_44?si=DCtk7lQcdqfPnx1Y, https://youtu.be/f8CXG7dS-D0?si=JbacRvLsL2yaCZHO, and the following two videos show and discuss domain coloring: https://youtu.be/MpxA1YloEyA?si=MiH2Uxj1Q_2BbpoW, https://youtu.be/EbanExb75mc?si=Nb-D8wzgT2khDMTN. In this regard, many mathematical and scientific phenomenon are associated with or can be represented using sinusoidal wave forms and unit circles such as a sine wave unit circle.

### Mathematics, Music and Light

The German poet Johann Wolfgang von Goethe once said that “Music is liquid architecture; architecture is frozen music.” Vibration, mass, time, space, mathematics and geometry are intimately related to sound and music. In this regard, music can be regarded as the product of mathematics and physics being communicated to the ears, and the different colors of visible light can be regarded as musical notes and pitch for the eyes. For more information, see the following videos: Robert Edward Grant Documentary, by Robert Edward Grant, Dec. 3, 2020, https://youtu.be/cntQTIYoE4c?si=ZEdiUo_3yBIVPdWm; The Universal Language of Mathematics and Music, by Gaia, Dec. 8, 2023, https://youtu.be/tlz-nrurlf4?si=8b7TOPbue9pEgobl; The Geometry of Music, by the Harmonagom Project, May 23, 2017, https://youtu.be/ZWzwb4Bumlk?si=4liXkvvWS7gTJumd; The Simple Math of Music Theory, by Why These Notes—Adventures in Music Theory, May 30, 2021, https://youtu.be/AbfnDSplg0U?si=G5htJ1oJAUVluAlt; The Circle of Fifths: Everything You Need to Know, by Brad Harrison Music, Sep. 10, 2020, https://youtu.be/AbfnDSplg0U?si=HN5U2wbOBNuH31QS; Color Wheel Theory, The Circle of Fifths (5ths), and Sight Reading Music, by Color Wheel Music Theory, Jan. 7, 2013, https://youtu.be/Viue81moXis?si=0RLz67poE3YhAwHq; The Math Behind Music and Sound Synthesis, by Gonkee, Mar. 21, 2021, https://youtu.be/Y7TesKMSE74?si=o7xQbuT4zM_2yWdt. In brief, there is a direct relationship between mathematics and sound. Sound is often communicated in sinusoidal wave forms, but it which can also be produced in square wave, triangle wave, and sawtooth wave forms which are used in musical synthesizers. The Circle of Fifths which was invented by Nikolay Diletsky in the 1670's is a learning tool which arranges 12 major and minor chromatic pitches which are each one perfect fifth and which corresponds to 7 semitones away from one another in a circle. The Circle of Fifths has sometimes been colorized as a visual aid and also for entertainment purposes.

### Different Signal Types

Signal types fall into two broad categories and are either continuous, or discontinuous. For example, analog sine wave and cosine wave signals are continuous, whereas wavelets and ultra short pulses are examples of signals which are typically discontinuous.

### Methods of Modulation

Analog modulation of visible and invisible light can be done by using frequency and wavelength modulation, phase modulation, amplitude modulation, but also various combinations and permutations thereof. With discontinuous signals or pulses, there are several other ways in which to perform modulation and these include pulse modulation, pulse amplitude modulation, pulse width modulation, pulse position modulation, and pulse code modulation, e.g., see Pulse-Amplitude Modulation, https://en.wikipedia.org/wiki/Pulse-amplitude_modulation; Pulse-Width Modulation, https://en.wikipedia.org/wiki/Pulse-width_modulation; Pulse-Position Modulation, https://en.wikipedia.org/wiki/Pulse-position_modulation; and, Pulse-Code Modulation, https://en.wikipedia.org/wiki/Pulse-code_modulation. There are four broad categories or methods and techniques of manipulating and/or modulating light: birefringence or double refraction as can be produced by a prism or diffraction grating, magneto-optic, electro-optic, and acousto-optical. While many different combinations and permutations of these methods and techniques are possible, the following categories and things will be discussed here.

### Amplitude Modulation

Amplitude modulation can be performed by changing the amplitude of a signal. For example, it is possible to communicate a binary digital zero (0) or a binary digital (1) by creating two different amplitudes with the use of square waves, sinusoidal waves, wavelets, or pulses. It is also possible to communicate a digital zero (0), or a one (1), and/or maybe both zero (0) and one (1) signals by creating three different amplitudes with the use of square waves, sinusoidal waves, wavelets, or pulses. In this regard, see Hackaday 10th Anniversary: Non-Binary Computing, Oct. 7, 2014, https://youtu.be/TFTK074nG_M?si=DRwZwCgBrq0VO4jT; Ternary Computing Testbed 3-Trit Computer Architecture, by Jeff Connelly, Aug. 29, 2008, http://xyzzy.freeshell.org/trinary/CPE%20Report%20-%20Ternary%20Computing%20Testbed%20-%20RC6a.pdf; Computing Science: Third Base, by Brian Hayes, 12-XX-2001, https://www.jstor.org/stable/27857554.

FIG. 37 shows a representation of a digital signal including zeros (0s) and ones (1s) which can be created by using amplitude modulation. When using two similar or dissimilar sinusoidal wave forms, sine waves, cosine waves, wavelets, or pulses, the phenomenon of superposition can be introduced. In the case of two similar wave forms being superimposed, this can result in a wave addition that results in a single wave having twice the amplitude, or alternatively it can result in a wave subtraction and complete wave cancellation, but also everything in between depending upon the degree to which the two waves overlap. In this regard, a unit reference wave can be created and used in order to perform mathematical calculations, or other desired functions. Further, combining two proximate sinusoidal wave forms can result in a superposition that results in a phase shift. In this regard, when the frequency and wavelength, and also the amplitude of two proximate sine waves are the same, then their combination due to wave superposition can result in an effective phase shift to a position that is located between their two proximate peak amplitudes. Moreover, a plurality of sinusoidal wave forms, sine waves, cosine waves, wavelets, or pulses can be combined and then be associated with a plurality of combinations and permutations and a plurality of wave superpositions which can result in a plurality of resulting wave forms.

Once again, there are three basic ways of modulating binary data including ones (1's) and zeros (0's), namely, amplitude shift keying (ASK), frequency shift keying (FSK), and phase shift keying (PSK). As discussed in the article entitled “Understanding Modern Digital Modulation Techniques,” by Lou Frenzel, published Jul. 14, 2021 on the ElectronicDesign website: https://www.electronicdesign.com/technologies/communications/article/21798737/understanding-modern-digital-modulation-techniques, and also the article “Coherent Binary Modulation techniques” published online by an unknown author, date unknown, on the website: https://ee.engusm.my/eeacad/mandeep/EEE436/Chp%204.pdf, with reference to wireless and radio frequency digital communication, there are two types of amplitude modulation, namely on-off keying (OOK) which is like turning a flashlight on and off to communicate morse code, and in this case ones (1's) and zeros (0's) associated with the binary system, and amplitude shift keying (ASK) which resembles sending digital information using two flashlights with one being noticeably brighter than the other or using one flashlight which has two different brightness settings. The latter kind of modulation is sometimes called intensity modulation. When a digital square wave is embedded in a sinusoidal carrier wave having a higher frequency for wireless communication in the microwave and/or radio frequency spectrums, the carrier wave will then be modulated to have corresponding higher and lower amplitudes in different portions of the resulting signal out.

Amplitude modulation can also be used change the amplitude of visible and/or invisible light channels and their associated signals. Moreover, amplitude modulation can also be combined with one or more of the other methods and techniques of modulation disclosed herein. For example, wavelets, and/or ultra-short Gaussian-like pulses can possibly be used to represent and encode the spaces between alphabetical letters, words, numbers, symbols, and/or different types of punctuation, and these signals could then be given a high amplitude. Alternatively, amplitude modulation can possibly be used to represent and encode a capital letter version of an alphabetical letter, and/or to help represent and encode and communicate symbols or functions which a usually accessed using the shift key on a computer keyboard. Amplitude modulation can also be used to help separate different wavelength and frequencies of visible and/or invisible light and signals and as is done when making a digital QAM constellation in order to stay within a desired Error Vector Magnitude parameter or EVM box. Moreover, amplitude modulation can also be used to help perform certain forms of optical imaging, but also computations using neural networks and/or optical processor devices, but also storage of data and information in optical memory devices.

### Frequency and Wavelength Modulation

The parent U.S. Pat. No. 11,809,839 and present application disclose using different wavelengths and frequencies of visible and/or invisible light to directly represent and encode data and information. This can be done with the use of sinusoidal wave forms, sine waves, cosine waves, wavelets, or pulses associated with the visible and/or invisible light spectrum. In this regard, selecting and using different frequencies and wavelengths in this way is a form of frequency and wavelength manipulation or modulation in broad strokes. However, frequency and wavelength modulation can be further performed with respect to the sinusoidal wave forms, sine waves, cosine waves, square waves, wavelets, pulses, or other wave forms or signals which are being used to communicate data and information. When different sinusoidal frequencies and wavelengths of visible and/or invisible light are sent in parallel it is possible to decipher the communication of alphabetical letters, words, numbers and/or symbols using a Fast Fourier Transform (FFT) algorithm, and other methods and techniques can also be used. Once again, when encoded wavelets are being used to communicate data and information, then wavelet analysis can be performed and the mean frequency and also the relative timing and sequence of the wavelets can be determined.

In order to wirelessly communicate digital information using the microwave and/or radio frequency spectrums, lower frequency digital square waves are typically used to modulate higher frequency carrier microwave and/or radio waves. In this regard, a digital bit zero (0) is typically communicated using a lower frequency associated with a longer wavelength relative to a digital bit one (1) which uses a higher frequency associated with a shorter wavelength. When using the conventional digital system and 8 bit ASCI II Code with classical computers, ASCII code 49 which is 00110001 is then used to represent and communicate the number one (1), and ASCII code 48 which is 00110000 is used to represent and communicate the number or value zero (0). Accordingly, the modulated signal out will have 8 possible segments, and in the case of ASCII code 49 which is 00110001 and used to represent and communicate the number one (1), there will be at least four different portions characterized by lower and higher frequencies and wavelengths, and in the case of ASCII code 48 which is 00110000 and used to represent and communicate the number or value zero (0), there will be at least three different portions characterized by lower and higher frequencies and wavelengths. This form of digital communication is sometimes called frequency shift keying (FSK) and a popular version of this is called minimum shift keying (MSK) in which a higher frequency is used to indicate and represent what is called a mark which could identify a one (1), and another lower frequency is used to indicate and represent what is called a space which can be used to identify a zero (0). The use of Gaussian low pass filters with (MSK) which is sometimes indicated as (GMSK) has been used to improve the spectral efficiency of communication on cell phones.

The speed of operation of classical computers which is indicated by their switching or flop rate and/or bit rate is relatively uniform and currently typically corresponds to about 1 picosecond Ps or 0.000000000001 second in consumer laptops and desktop computers, that is, depending upon the particular demands then being placed on the computer. Unlike a classical computer which uses a series and sequence of square waves to represent and encode digital bits including ones (1s) and zero (0s) which are then processed by conventional electronic silicon CPUs, GPU's, and stored in logic based memory chips and other device, an operating optical, electro-optical, and/or quantum computer based thereupon, can utilize frequency and wavelength modulation, amplitude modulation, phase modulation, and signal type modulation not only to externally transmit signals wirelessly in the microwave and/or radio frequency spectrum, but also to manipulate optical signals internally in order to process data and information and perform computations and other computer operations. Further, when a plurality of different encoded wavelengths and frequencies of visible and/or invisible light which have the same start position in time are used to communicate data and information, there is inherently also a kind of inherent relative phase shifting which can take place. In this regard, if the plurality of different encoded wavelengths and frequencies of light are plotted on a sine wave unit circle, their first amplitude peaks will be moving clockwise or counter-clockwise, and this phenomenon while not constituting a phase shift from the start position can have some similar effects which can resemble this kind of phase shifting.

### Phase Shift Modulation

BPSK: Binary phase shifting keying (BPSK) is phase modulation method of digital modulation which shifts the carrier wave 180 degrees for each change in the binary state when indicating ones (1's) and zeros (0's) so that the starting and ending points of the different values begin and end at zero on the reference line. In particular, when using a constellation diagram which has a horizontal X axis that intersects a vertical Y axis and forms a Latin cross having point x=0, y=0 as its center, with Binary Phase Shift Keying (BPSK), the digital 1's and 0's are normally represented and communicated by their being shifted 180 degrees out of phase and typically to opposite poles of the X axis. Differential (BPSK) or (DPSK) is another related form which compares the phase of the received bit of information with the phase of the previously received one.

QPSK: A variation of BPSK known as quadrature PSK (QPSK) produces two carrier signals orientated 90 degrees apart, and the binary data then modulates each phase to produce four sinusoidal signals, shifted by 45 degrees from one another. In this regard, shifting a sine wave by 45 degrees corresponds to its cosine wave function. This permits twice as much data to be transmitted, and a 4 QPSK configuration is shown in the upper left of FIG. 45. There are also some other variations known as offset QPSK (OPSK), and differential QPSK (DPSK) modulation. The most commonly used form of QPSK is 8 QPSK, with 16 and 32 being less common because of their higher error rates. Offset QPSK (OPSK) and/or Differential QPSK (DPSK) are sometimes used for Bluetooth and were configured to better avoid signal changes which would cross close to the X=0, Y=0 center or origin as represented in a constellation diagram in order to lower the error rate when using QPSK modulation, e.g., see Understanding APSK and QAM, by Rhode Schwarz, Feb. 19, 2021, https://youtu.be/1xGncBvWv6U?si=3KZNS5R7YqHk64oN, Different types of 802.11 Modulating Schemes, by Wireless LAN Professionals, Oct. 17, 2017, https://youtu.be/W5DMfEuY2Vg?si=vTns-rybisOzOo8-, #171: IQ Signals Part II: AM and FM phasor diagrams, SSB phasing method, by W2aeu, Sep. 14, 2014, https://youtu.be/5GGD99Qi1PA?si=crgHqalk7EG8HF46, and Visualizing Digital Modulation: ASK, FSK, BPSK, DPSK, QPSK and QAM, by Ian Collins, Sep. 2, 2024, https://youtu.be/8e4Sf6rL3zk?si=FxATGBD0mXrhpCWs. When representing quadrature phase shift modulation, it is common to use a sine wave unit circle and to make a constellation configuration or drawing and to plot the sine wave which is then called the quadrature component (Q) on the vertical Y axis, and the cosine wave which is called the in-phase component (I) on the horizontal X axis. In this regard, a positive sine wave is typically represented above an inverted and negative sine wave, and a corresponding positive cosine wave is typically also represented above an inverted and negative cosine wave and this results in the 4 QPSK configuration shown in the upper left portion of FIG. 45. As shown in FIG. 45, two bits are shown in each of the four quadrants in the 4 QPSK configuration. When using the conventional digital system and an 8 PSK configuration, there would be 3 bits in each of its eight positions, and when using a 16 PSK configuration there would be 4 bits in each of its sixteen positions.

QAM: Quadrature amplitude modulation (QAM) uses four carrier phases and at least two amplitude levels, and there exist 16 QAM, 32 QAM, 64 QAM, 128 QAM, 256 QAM, 1024 QAM, and 4096 QAM variations which can transmit more bits per symbol by using a mix of different amplitudes and phases. In this regard, see the document entitled: Lesson 21, Digital Modulation U.S. Naval Academy, published by an unknown author, date unknown, on the website: https://www.usna.edu/ECE/ec312/Lessons/wireless/EC312_Lesson_21_Digital_Modulation_Course_Notes.pdf, which provides a discussion and illustrations showing the different basic ways of modulating binary data including ones (1's) and zeros (0's) in modern digital communication. The QAM method has been used with regards to cable television, and also with wireless communication such as cell phones. A hybrid form of PSK and QAM known as amplitude phase shift keying (APSK) which uses two different amplitudes and 16 different phase positions has been used in satellite communication. Orthogonal frequency division multiplexing (OFDM) is a combination of modulation and also multiplexing which creates many different sub-channels which are orientated in an orthogonal configuration within a given transmission channel, and this is one of the most widely used forms of digital communication being used today in digital subscriber line (DSL) and 4G cellular systems. Using the conventional digital system, a QAM 16 configuration can carry and transmit 4 digital bits consisting of 1's and/or 0's in each of the 16 constellation locations which are shown in the lower right portion of FIG. 45. In the 16 QAM configuration shown in FIG. 45, three different amplitude levels are also shown using dashed lines. Accordingly, it takes a combination of 2 such constellation points in 16 QUAM to provide a total of 8 bits or 1 byte. When using the conventional digital system, it takes having a 256 QAM configuration in order to carry and transmit 8 digital bits in each of its constellation positions. For reference, see What Is QAM? by Huawei IP Encyclopedia, No Date, https://community.fs.com/encyclopedia/qam.html, and Quadrature Amplitude Modulation (QAM): Explained, by Dave's Space, Aug. 31, 2022, https://youtu.be/1asY7-NZ93g?si=gdyn3MF60yiZMKvp, #171: IQ Signals Part II: AM and FM phasor diagrams, SSB phasing method, by W2aeu, Sep. 14, 2014, https://youtu.be/5GGD99Qi1PA?si=crgHqalk7EG8HF46, and the related prior art constellation diagrams shown in FIG. 45. Orthagonal Time Frequency Space Modulation (OTFS) is another kind of modulation, e.g., see What is OTFS? Orthogonal Time Frequency Space Modulation (“Best video in youtube for OTFS”), by Ian Explains Signals, Systems, and Digital Comms, Sep. 26, 2024, https://youtu.be/MvK3zhPrGkk?si=Dk8VdfXEka5iwSMc. Again, when representing quadrature phase shift modulation, it is common to use a sine wave unit circle and to make a constellation configuration or drawing and to plot the sine wave which is then called the quadrature component (Q) on the vertical Y axis, and the cosine wave which is called the in-phase component (I) on the horizontal X axis.

The parent U.S. Pat. No. 11,809,839 and present application teach and disclose that it is possible to use different specific frequencies and wavelengths of visible and invisible light to directly represent and encode data and information which can include letters, words, numbers, or symbols, and has referred to such encoded data and information as waves or vibes, and as color coded data and information, that is, instead of using the words bits or bytes which have been associated with the digital system and classical computers. Further, the method of directly encoding visible and/or invisible light which is taught and disclosed in the parent and present application can also use amplitude, wavelength and frequency, and phase modulation methods and techniques like BPSK, QPSK and QAM to communicate data and information. In order to show this possibility, the 8 QPSK, 16 QPSK and 16 QAM constellations do not have digital bits indicated on their constellation points like the 4 QPSK constellation which is shown on the upper left side of FIG. 45.

Moreover, it is possible to configure a pattern and/or constellation configuration or diagram 68 for use with different encoded wavelengths and frequencies of visible and/or invisible light which can then be distributed between 0-360 degrees in various circular configurations with each constellation point being separated by 1 degree, or other different measure of separation. However, one of the things which is different here as compared to conventional digital communication, is that you are not waiting for a series or sequence of modulated digital signals representing 1's and 0's to be transmitted and pour out in a relatively narrow stream, but rather a plurality of different directly encoded wavelengths and frequencies of visible and/or invisible light can be transmitted in parallel and correspond to a plurality of different constellation points. Further, each light channel and beam of a multiplexer device can transmit a plurality of signals in parallel. Accordingly, instead of having 16 constellation points each being associated with 4 digital bits which equals 64 bits or 8 bytes and typically corresponds to 8 complete encoded pieces of data and information when using a conventional digital 16 QPSK or 16 QAM constellation, you instead have 16 constellation points which are each associated with at least one visible and/or invisible light signal which represents and encodes a complete piece of data and information and is then at least the equivalent of 8 digital bits or one byte of digitally communicated data and information. Further, each of those constellation points associated with visible and/or invisible light would also be capable of transmitting a plurality of such directly encoded light signals in parallel, e.g., you could have 16 constellation points each providing 16 encoded light signals at the same time, that is, 16×16=256 complete encoded wave or vibe pieces of data and information, versus only 8 complete encoded digital pieces of the same data and information using the conventional digital system. In this regard, the 8 PSK, 16 PSK and 16 QAM configurations shown in FIG. 45 are not labeled with digital numbers in order to show that they could be used with this method and technique, as could other constellation configurations, e.g., 4 PSK, and 32, 64, 128, 256, 1024, or 4096 QAM.

### Different Wave Forms or Pulse(S) Type Modulation

The different types of wave forms and pulses which have been described above, e.g., sinusoidal wave forms, sine wave forms, cosine wave forms, wavelet forms, and pulse forms can be mixed and/or matched together in different combinations and permutations. Accordingly, you can then have different types of encoded wave forms and/or pulse signals being used and transmitted in a communication of data and information, and this can be performed in series and/or parallel. Moreover, it is possible to create square, triangular, sawtooth, or other wave forms by combining multiple wave forms and/or different types of wave forms. Moreover, the different modulation methods disclosed herein can be combined in different combinations and permutations.

### Carrier Wave Signals and the Microwave and Radio Spectrums

In conventional forms of wireless digital communication in the microwave and/or radio frequency spectrums, it is typically the case that digital signals representing ones and zeros are communicated at a relatively low frequency using square waves and this baseband frequency will then be embedded in a carrier wave having a higher frequency to create a modulated carrier wave which is then used and transmitted as the signal out to communicate data and information. However, within the logic processor devices and memory devices of a classical computer, the binary digital signals are communicated without the use of a carrier frequency, but rather the square waves representing digital zeros (0s) and ones (1s) are communicated electronically using wires or other electrical conductors. When using a classical computer and the digital system, the binary 1's and 0's or bits are typically communicated in series and a sequence of square waves, and not in parallel. It is possible to have a number of different digital processes which are characterized by different streams and series of 1's and 0's going on at the same time, and this is sometimes referred to a parallel processing, but the different bit streams are still being communicated in a series and sequence.

Signals in the visible and/or invisible light spectrum can also be embedded into and communicated via higher frequency carrier waves in the microwave and/or radio spectrums. In this regard, the radio frequency spectrum is that part of the electromagnetic spectrum between 3-3,000 GHz, and the microwave spectrum is between 300 MHz to 300 GHz. The current 5G frequency range 1 is between 410 MHz to 7125 MHz, 5G frequency range 2 is from 24.25 GHz to 71 GHz, and the proposed 5G frequency range 3 is between 7.125 to 24.25 GHz, e.g., see 5G NR Frequency Bands, Wikipedia, https://en.wikipedia.org/wiki/5G_NR_frequency_bands. Some of the teachings and disclosure which is provided in the parent application U.S. Pat. No. 11,809,839, and also the present application relating to the representation, encoding, and communication of data and information can be at least in part, and/or in whole applied to and used with wavelengths and corresponding frequencies which are outside of the visible and/or invisible light spectrum. Within the optical processor devices and optical memory devices of an optical computer, electro-optical computer, or a quantum computer based thereupon, the different wavelengths and frequencies of visible and/or invisible light which can be directly or indirectly encoded to represent and communicate data and information will typically be communicated over fiber optic cables, waveguides, and/or with the use of other photonic and optical devices. As disclosed in the parent U.S. Pat. No. 11,809,839 and the present application, different frequencies and wavelengths of visible and/or invisible light can be directly encoded to represent and communicate data and information. An optical, electro-optical, or quantum computer based thereupon can internally use a carrier wave, or a reference wave, or other wave form in combination with another sinusoidal wave, sine wave, cosine wave, square wave, wavelet or pulse, such as a Gaussian pulse, to perform modulation and to manipulate superposition in order to communicate data and information and/or to perform computations or other computer functions. Moreover, an optical, electro-optical, or quantum computer based thereupon can internally combine a plurality of sinusoidal waves, sine waves, cosine waves, square waves, wavelets and/or pulses and transmit and communicate them in parallel and in various different states of entanglement and superposition in order to communicate data and information and/or to perform computations or other computer functions.

Accordingly, the methods of amplitude modulation, frequency and wavelength modulation, phase modulation, and use of different wave forms or pulse(s) types discussed herein can also be used in various combinations and permutations with the use of one or more internal carrier waves, or reference unit waves, or other wave forms. The possible effects of having entanglement and superposition phenomenon and possible reflection taking place then needs to be taken in and considered. When working with electronic signals, a Smith Chart is typically used for this purpose. However, when using optical computers, electro-optical computers, and/or quantum computers, entanglement and superposition of the kind which is engineered and configured for the purpose of manipulating data and information can be desired for enabling computations and processing speeds which either cannot be done, or not be done as quickly or accurately when using a classical or conventional computer.

### Performing Computations and Other Operations and Functions

A number of different structures, methods, and techniques can be used by classical computers, optical computers, electro-optical computers and/or quantum computers to perform calculations and computations. In this regard, conventional silicon RAM, ROM, and logic processor and memory chips, and other conventional devices can be used. Optical RAM, ROM, and optical logic or other optical processors, optical neural networks, and/or other devices can be used, e.g., see the articles and videos on these subjects provided below in the list of reference articles and videos. Conventional silicon RAM, ROM, and logic based processor chips or devices, and memory chips or devices can also be used in various combinations with Optical RAM, ROM, and optical logic chips, or other optical processors, optical neural networks, and optical memory devices. Many common and often used mathematical constants, formulas, equations, and computations can be stored in ROM memory, and then whether it be a conventional silicon ROM memory, or an optical ROM memory such a holographic memory device, glass, or crystal memory device.

When using visible and/or invisible light, the superposition of wave forms is another method and technique which can be used to perform calculations and computations. For example, if one uses a single sine wave having a specific frequency and wavelength to represent the base portion of a number 0 or 1, the amplitude can be then changed to represent the numbers between 0-9, or 1-9. When two or more of these unit reference sine waves are used in addition, the product will be with the sum of their combined amplitudes and this result will correspond to another known number which is the solution. Likewise, when one or more of these numbers is subtracted from another starting number, then it's starting amplitude can be diminished to provide a resulting sine wave having an amplitude which corresponds to the solution and another number. Multiplication can be seen as a shortcut and a fast way to perform addition. When division is performed using numbers between 0-9, the resulting products will often range between 0 and 9, and some of the solutions will be in the form of fractions which can be represented, e.g., on a sine wave unit circle or other circular configuration. In this regard, a circle has 360 degrees and this corresponds to 2π radians. One radian has 57.3 degrees. 90 degrees corresponds to π/2 radians. 180 degrees corresponds to n radians. If one wishes to create a unit circle for representing base ten, then a circle can be divided into 10 sections each having a radian of π/5. One complete revolution can start at 0 and sweep through numbers 1-9 and will then end at the starting point 0 which can be counted as 10. If desired, a similar method can be used to represent other base number systems. The preceding discussion of light, sound, music, the Circle of Fifths, and also amplitude modulation, wavelength and frequency modulation, and phase modulation including QSPK and QAM can help individuals to understand the following method of performing mathematical calculations and/or transmitting and communicating mathematical data and information.

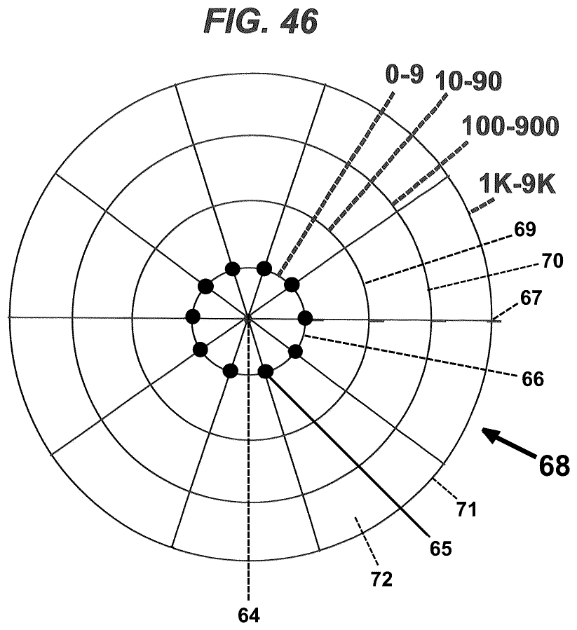

FIG. 46 shows a pattern 68, optical pattern and/or constellation configuration or diagram for use in representing numbers and/or symbols and also performing mathematical calculations or other operations. However, a similar pattern and/or constellation configuration or diagram can also be configured and used to represent alphabetical letters, symbols, words, and images. The recovered Greek Antikythua Mechanism is believed to have been an astronomical calculator, and it includes a plurality of gears. Mechanical watches also typically include a plurality of gears, and a face which includes 12 hour positions, and also two hands to indicate minutes and hours. In the following discussion, it may be helpful to think of the pattern and/or constellation configuration or diagram 68 shown in FIG. 46 as being somewhat like the face of a mechanical watch. With this being said, the circles or rings 66, 69, 70, and 71, and center point 64, and also the plurality of lines which extend therefrom indicating ten sections 72 corresponding to radians of π/5, and the hash marks shown at or near the 3 o'clock position 67 which are shown in FIG. 46 would not appear in an actual optical communication in the visible or invisible light spectrum or another portion of the electromagnetic spectrum such as the microwave and/or radio frequency spectrums, but have simply been provided in FIG. 46 as a visual aid reference and comprehension purposes. The possibility of a plurality of positions or points 65 located at the intersection of the plurality of lines that extend from the center 64 which correspond to ten radians of π/5 is also shown for illustrative purposes, and it can be readily understood that all of the other intersection points could also be used in order to configure and locate other positions or points 65, and that other alternative point positions which do not coincide with the illustrated intersection points and related configurations can also be made and used. Further, the number of circles or rings can also be changed, and others can be added in order to represent and communicate other numbers when using a positional number system.

If one wishes to create a unit circle for representing base ten, then a circular pattern or constellation configuration or diagram 68 and its corresponding circles or rings, e.g., 66, 69, 70, and 71, can be divided into 10 parts each corresponding to a radian of π/5 which then define 10 sections 72, as shown in FIG. 46. One complete revolution can start at 0 in the 3 o'clock position 67 and sweep counter-clockwise through numbers 1-9 and will then end at the starting point 0 which can be counted as 10. Alternatively, the configuration and discussed movement could be just the opposite and clockwise. When the number 10 is equaled or exceeded, then a second concentric circle or ring 69 outside of the first circle or ring 66 can be used to represent the number of tens which would be in the tens column in a positional number system. When 100 is equaled or exceeded, then a third concentric circle or ring 70 outside of the second circle or ring 69 can be used to represent the number of hundreds which would be in the hundred's column in a positional number system. When 1000 is equaled or exceeded, then a fourth concentric circle or ring 71 outside of the third circle or ring 70 can be used to represent the number of thousands which would be in the thousand's column in a positional number system, and this process and technique of adding concentric circles or rings can be continued to represent tens of thousands, hundreds of thousands, millions, and so on. From a practical standpoint, and with a mind to energy efficiency it typically makes sense to start with representing and/or communicating the numbers 0-9, or 1-9 close to the center 64 as this can be associated with lower amplitudes with respect to a pattern and/or constellation configuration or diagram 68 which represents and includes visible and/or invisible light signals, or other signals in the electromagnetic spectrum such as in the microwave and radio frequency spectrums. As the radius of the concentric circles or rings increases, it is then possible to for more individual constellation points 65 to be added to a larger pattern and/or constellation configuration or diagram 68 while maintaining a desired Error Vector Magnitude (EVM) box and/or area. In this regard, the example shown in FIG. 46 is a simple representation which is intended to teach and illustrate the general principle, structure, method, and technique which is being disclosed. In lieu of providing additional circles or rings, it is possible to include a hand or two like a clock or other indicator. Moreover, a single point or light signal can be used to indicate a particular base number and its index, place holder value, and/or exponential value and expression in base 10, e.g., 1×10²=100.

In brief, this disclosed structure, method, and technique can be used to represent and create a circular abacus, a virtual abacus, a pattern, optical pattern and/or a constellation configuration or diagram 68 for representing, communicating, and performing mathematical calculations and computations. The pattern or optical pattern can be in a two-dimensional form like on a piece of paper, or alternatively be configured in a three-dimensional form, or in a four-dimensional form as later discussed in FIG. 50. For example, if one wishes to represent and/or communicate the number 144, a visible and/or invisible light signal and point 65 representing 100 would be represented and/or transmitted in the appropriate position in the 100's circle or ring 70, another representing 40 would be represented and/or transmitted in the 10's circle or ring 69, and another representing 4 would be represented and/or transmitted in the inner 1's circle or ring 66. Looking directly at this pattern and/or constellation configuration or diagram using a fiber optic cable or fiber, or a portion of a neural network, or an oscilloscope, or a spectrum analyzer, or an optical detector device such as a camera, a photodetector, or a photodetector array, one would then see or detect three beams of light. Given knowledge of the structure and configuration of the associated pattern and/or constellation configuration or diagram 68, one would then know the identity of any given number which is being represented and communicated using visible and/or invisible light, or another portion of the electromagnetic spectrum. If addition is represented and performed by a clockwise movement and progression, then subtraction can be represented and performed by a counter clockwise movement, and vice-versa. When on the inner circle or ring 66 representing the 1's column in a positional number system, the number 9 is exceeded in an addition computation by 2 to yield the number 11, then the relevant position or point 65 on next outer circle or ring 69 indicating the ten's column in a position number system would register a 1 for 10, and the position or point 65 on the inner circle or ring 66 in a position number system would indicate a 1. If one desires to represent the range between 0-1 and/or fractions, then another circle or ring would be added inside of the one for the range between 0-9, and it would be in the range between 0-0.9999 repetend 9 and the 0-9 circle or ring would then be changed to the range between 1-9. In this regard, it may be helpful to add to a pattern and/or constellation configuration or drawing 68 and to think of visible or invisible hands being present, but instead the positions or points 65 and pattern and/or constellation configuration or diagram 68 can simply be generated, illuminated, and communicated by the configuration of visible and/or invisible light points, channels, beams or other light sources.

In this regard, it would not be necessary to use many different specific frequencies and wavelengths of visible and/or visible light which have been encoded in order to directly represent and communicate specific numbers using this method because it is the pattern or constellation configuration 68 which has been encoded. However, if and when many different specific frequencies and wavelengths of visible and/or visible light which have been directed encoded to represent and communicate specific numbers and/or symbols are being used in the specific locations of the pattern and/or constellation configuration which have been also been designated and configured to represent and encode those same numbers, then a certain redundancy can be created, and a higher level of error detection and correction can then be introduced and effected. On the subject of artificial intelligence (AI), quantum computers, and current methods of error detection, e.g., see, AI Meets Quantum: New Breakthrough Will Change Everything, by Anastasi in Tech, Dec. 10, 2024, https://youtu.be/elNcrZGDQD0?si=4ScoP-2jyG5Wz8Pp.

Further, when using and manipulating numbers, they can possibly be divided into odd and even numbers, and if desired one or the other group can be represented by the cosine functions corresponding to the wavelengths and frequencies which are being used to represent and encode the individual numbers, or alternatively, a different method of further differentiating a plurality of numbers can be used. The visible and/or invisible light signal can be in the form of a sinusoidal wave, a sine wave, a cosine wave, a wavelet, or a pulse, and it can be being further manipulated by using amplitude modulation, phase shifting, or a combination of both techniques in order to represent the positions or points 65, pattern, optical pattern, and/or constellation configuration or diagram 68, and the encoded numerical values which are then being represented and communicated. In this regard, some or all of the same methods and techniques which are used in QPSK and QAM modulation and communication can also be used here.

In addition, the visible and/or invisible light signals and points 65, pattern and/or constellation configuration or diagram 68 can be observed and captured by using, e.g., an optical detector device such as a camera, a photodetector, a photodetector array, or an image sensor such as a CCD or CMOS device. For more information, see, Image Sensor, https://en.wikipedia.org/wiki/image_sensor. The detected and captured light signals can then be communicated to an optical processor device and/or be saved in an optical memory device such as a holograph memory device, or a glass or crystal memory device. The representation and communication of numbers can then be performed using this encoded pattern and/or constellation configuration or diagram structure, method, technique, and form of pattern recognition. In this regard, visible and/or invisible light signals and patterns and/or constellation configurations or diagrams can then be used to represent, encode, and communicate mathematical numbers and symbols, and these patterns and/or constellation configurations or diagrams can be manipulated with the use of hardware and/or software in order to perform mathematical computations and operations and to provide solutions which can be communicated and stored in optical memory devices, and/or other memory devices.

The circular pattern 68 shown in FIG. 46 somewhat resembles the 8 PSK constellation pattern shown on the upper right in FIG. 45. In this regard, the methods and techniques which are typically used to create PSK, QPSK, and QAM constellation configurations for communication of data and information can be adapted and used to transmit optical patterns which can be used and manipulated by optical computers, electro-optical computers, and related quantum computers to perform calculations and other computer operations. For more information on to how this and other patterns can be used, also see the discussion of FIGS. 47-50.

FIG. 47 shows a linear pattern 68, optical pattern, and configuration including eight circle portions for use in representing numbers, symbols, alphabetical letters, words, or images. In this regard, it is possible to represent and encode the individual zeros (0s) and ones (1s) used in the binary number system and, e.g., expanded ASCI II Code as an optical pattern, and instead of reading each bit of a given sequence in a series, it is possible to instead capture, communicate, read, and write the entire sequence as a whole by using the encoded pattern and using optical pattern recognition. For example, instead of reading in serial the individual bits in the sequence 00110001 which is used to represent and communicate the number forty-nine (49) in expanded ASCII code, the pattern of two less bright or dark or no signals, and then two bright signals, and then three less bright or dark or no signals, and then one bright visible and/or invisible light signal can be directly captured and communicated. Alternatively, a pattern of two bright signals, and then two less bright or dark or no signals, and then three bright signals, and then one less bright or dark or no visible and/or invisible light signal can be used to communicate the same digital code sequence 00110001. Further, instead of using circular shapes as shown in FIG. 47, other geometric shapes, patterns or symbols can be used. In FIG. 47, the zeros (0s) in the digital code sequence 00110001 are represented using the circles which appear to be empty and/or white, and the ones (1s) are represented using the circles which appear to be full and/or black. Alternatively, two different colors and corresponding wavelengths and frequencies of light in the visible light spectrum and/or two different wavelengths and frequencies in the invisible light spectrum can be used to represent and encode the digital ones (1s) and zeros (0s). Given a linear or other pattern including at least two portions, and in particular eight portions, and/or multiples of eight portions such as 16, 32, 64, 128, 256, 1024, or 4096, and so on, and the disclosed method and technique of representing data and information in a binary form which can be optically encoded in a pattern, it is possible to perform mathematical calculations such as addition, subtraction, multiplication, and division by following the rules and using algorithms which are associated with manipulating and performing computations using the binary number system and that can be written into software programs that can be compiled and stored in a computer memory device, and/or a combined computer processor and memory device. For example, if the pattern and/or optical pattern shown in FIG. 47 which represents and encodes the number 49 when using the binary number system would be added to itself, the result would be 0110010 which represents the number 98, and it would appear from left to right as one empty or white, two black, two empty or white, one black, and one empty or white circle when represented in a linear manner like the example which is shown in FIG. 47. With regards to linear and non-linear optical patterns which have been used to represent and encode binary numbers, Barcodes, Matrix Codes and Universal Product Codes (UPC), see, e.g., U.S. Pat. No. 2,612,994 by Woodland et al., and Barcode—Wikipedia, https://en.wikipedia.org/wiki/Barcode; Universal Product Code—Wikipedia, https://en.wikipedia.org/wiki/Universal_Product_Code; Code 39—Wikipedia, https://en.wikipedia.org/wiki/Code_39; Anoto—Wikipedia, https://en.wikipedia.org/wiki/Anoto.

With regards to binary number representation in a linear geometric form to configure photonic lattices and/or neural networks, e.g., see Localization of Light in Photonics Lattices for All-Optical Representation of Binaries, by Nguyen et al., Aug. 17, 2021, https://www.frontiersin.org/journals/physics/articles/10.3389/fphy.2021.709428/full, and for general information about how classic computers perform computations, e.g., see How Computers Perform Mathematical Calculations I Using adders, binary and logic gates, by Adam Reynoldson, May 10, 2019, https://youtu.be/MR42kVQ434g?si=AMPo4AUyPef24Jxa.

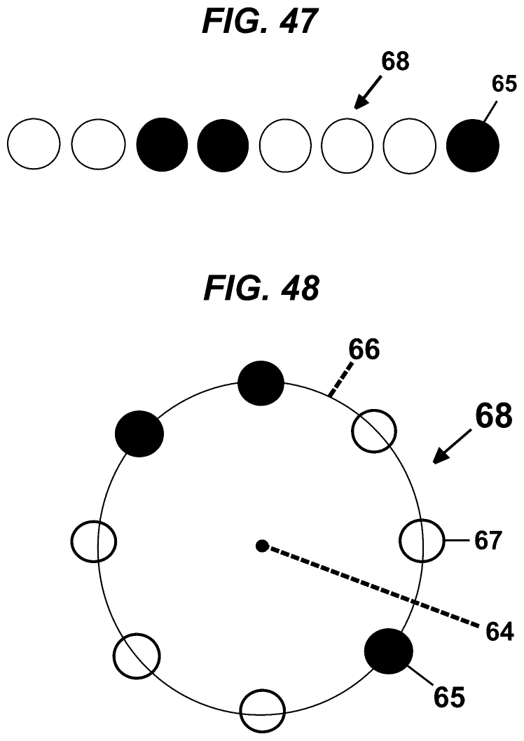

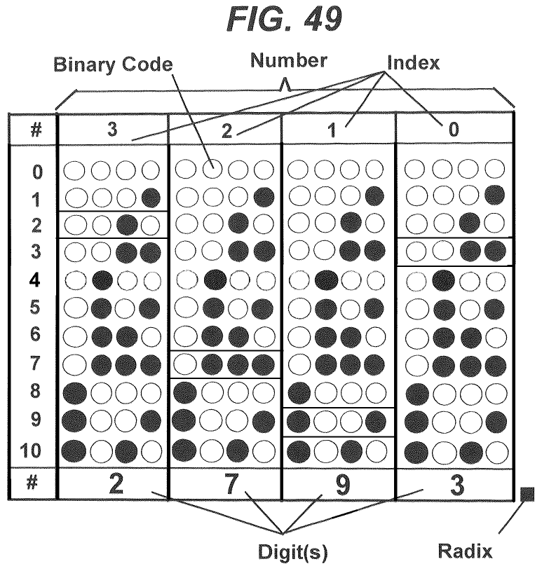

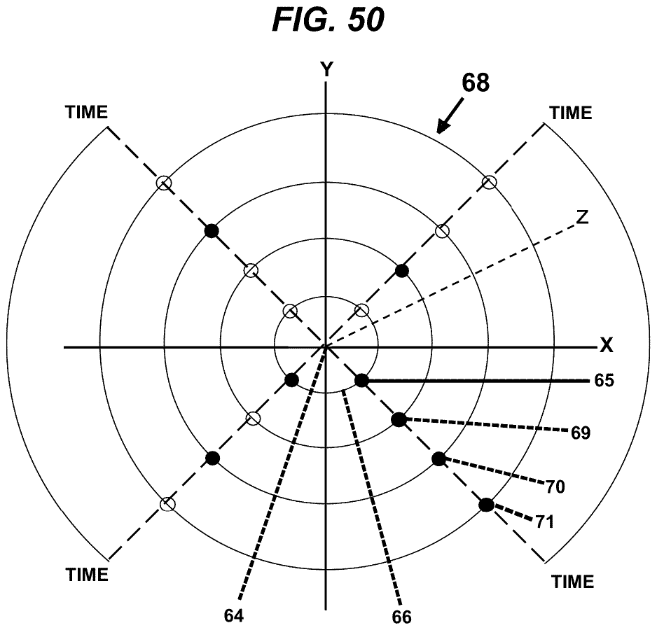

The discussed linear pattern shown in FIG. 47 can be used to represent and encode binary number system digits. However, it is important to recognize that when each of the 8 positions or points 65 in the linear configuration and pattern 68 represented in FIG. 47 are instead used to represent and show a configuration of different wavelengths and frequencies of visible and/or invisible light or other portions of the electromagnetic spectrum which have each been directly encoded to represent an entire alphabetical letter, a word, a symbol, or a number, then the amount of data and information which can be communicated, and the mathematical calculations and operations which can be performed can be dramatically increased in number and speed as compared to a classical computer using the conventional digital system. The linear pattern shown in FIG. 47 can be easily scanned or otherwise optically captured using, e.g., a camera, video, a photodetector, or photodetector array. However, it does not so directly lend itself to being used as constellation configuration and then being transmitted and communicated through fiber optical cable or waveguides as well as the circular patterns shown and discussed in FIG. 48 and FIG. 50.

FIG. 48 shows a circular pattern 68, optical pattern and/or constellation configuration or diagram for use in representing numbers, symbols, alphabetical letters, words, or images. As shown in FIG. 48, the representation of the first 0 in 00110001 which is used to represent and communicate the number forty-nine (49) in expanded ASCII code, starts at the 3 o'clock position 67, and the other digital representations follow in counter clockwise order. In FIG. 48, the zeros (0s) in the digital code sequence 00110001 are represented using the circles which appear to be empty and/or white, and the ones (1s) are represented using the circles which appear to be black. Alternatively, one or more colors and corresponding wavelengths and frequencies of light in the visible light and/or invisible light spectrum can be used to represent and encode the digital ones (1s) and zeros (0s). Further, instead of using circular shapes, other geometric shapes, patterns or symbols can be used. In addition, the direction of the sequence could instead be clockwise, and other alternative constellation configurations or patterns can be used. In any case, what had once been a relatively slow serial process with respect to communicating and manipulating data and information using the binary system is now turned into a parallel and nearly instantaneous process. As a result, the associated 8 bit intervals which would each take about 1 Ps when communicated in serial and a sequence therefore about 8 Ps in total when using a classical computer and the conventional digital system can instead be turned into eight wave periods which can each take in the range approximately between 1-4 Fs and a total of about 8-32 Fs, that is, when each of the 8 portions of the constellation or pattern would be communicated and detected in serial and as a sequence, but only a single wave period in the range approximately between 1-4 Fs when they are communicated and detected in parallel at the same time. Again, the circular pattern 68 shown in FIG. 48 can be in a two-dimensional form like on a piece of paper, or alternatively be configured in a three-dimensional form, or even be configured in a four-dimensional form as discussed in FIG. 50. The circular pattern 68 shown in FIG. 48 resembles the 8 PSK constellation pattern shown on the upper right in FIG. 45, and it can be communicated using an 8 PSK configuration. In this regard, the methods and techniques which are typically used to create PSK, QPSK, and QAM constellation configurations for communication of data and information can be adapted and used to transmit optical patterns which can be used and manipulated by optical computers, electro-optical computers, and related quantum computers to perform calculations and other computer operations. By creating and using a pattern including at least two portions, and in particular four or eight portions, and/or multiples of eight portions such as 16, 32, 64, 128, 256, 1024, or 4096, and so on, which also correspond to PSK and/or QAM constellations and patterns, it is possible to use the disclosed method of representing and encoding the binary number system to transmit and communicate data and information over fiber optic cable, waveguides, and wirelessly. Further, it is also possible to perform mathematical calculations such as addition, subtraction, multiplication, and division by following the rules and using the algorithms which are associated with manipulating and performing computations using the binary number system which can be written into software programs that can be compiled and stored in a computer memory device, and/or a combined computer processor and memory device. For example, if the pattern shown in FIG. 48 which represents the number 49 would be added to itself, the result would be 0110010 which represents the number 98, and it would appear starting from the 3 o'clock position and rotating counter-clockwise as one empty or white, two black, two empty or white, one black, and one empty or white circle when represented in a circular manner like the example which is shown in FIG. 48. The center 64 and circle or ring 66 shown in FIG. 48 would not appear in an actual optical communication, but has been provided here as a visual aid for reference and comprehension purposes. For information on optical character and pattern recognition, see Optical Character Recognition, https://en.wikipedia.org/wiki/Optical_character_recognition, and What is Pattern Recognition? A Gentle Introduction (2025), by Viso.ai, Oct. 11, 2024, https://viso.ai/deep-learning/pattern-recognition/. For tactile pattern recognition, see Braille, https://en.wikipedia.org/wiki/Braille. For information on the binary number system, and how computations are typically performed using the binary number system and digital system, e.g., see Binary Number, Wikipedia, https://en.wikipedia.org/wiki/Binary_number, and How Computers Perform Mathematical Calculations|Using adders, binary and logic gates, by Adam Reynoldson, May 10, 2019, https://youtu.be/MR42kVQ434g?si=AMPo4AUyPef24Jxa.

The discussed circular pattern shown in FIG. 48 can be used to represent and encode binary number system digits. However, it is important to recognize that when each of the 8 positions or points 65 in the linear configuration and pattern 68 represented in FIG. 48 are instead used to represent and show a configuration of different wavelengths and frequencies of visible and/or invisible light or other portions of the electromagnetic spectrum which have each been directly encoded to represent an entire alphabetical letter, a word, a symbol, or a number, then the amount of data and information which can be communicated, and the mathematical calculations and operations which can be performed can be dramatically increased in number and speed as compared to a classical computer using the conventional digital system.

The circular pattern 68 shown and disclosed in FIG. 48 can be used to represent and encode binary number system digits. However, it is important to recognize that when each of the 8 positions or points 65 which are disposed on the circle or ring 66 shown in FIG. 50 are instead used to represent and show a configuration of different wavelengths and corresponding frequencies of visible and/or invisible light or other portions of the electromagnetic spectrum which have each been directly encoded to represent an entire alphabetical letter, a word, a symbol, a number, or an image, then the amount of data and information which can be communicated, and the mathematical calculations and operations which can be performed can be dramatically increased in number and speed as compared to a classical computer using the conventional digital system.

The use of cursive or cursive-like Arabic numerals 0, 1, 2, 3, 4, 5, 6, 7, 8, 9, 10 also known as Western digits may not always be the easiest and best representation of numbers to use with respect to the tasks of performing optical pattern recognition and/or character recognition and/or mathematical calculations or other operations, and in part, because they are abstract symbols and representations of different quantities of real or imaginary things. As a result, they do not lend themselves to being added, subtracted, multiplied or divided optically. In ancient China, rod numerals were configured to resemble the following: 1=I, 2=II, 3=III, 4=IIII, 5=IIIII, 6=T, 7=TT, 8=TTT, and 9=TTTT. The Roman numeral system of counting and representing the numbers 1-10 is also less abstract, e.g., I, II, III, IV, V, VI, VII, VIII, IX, X, but it still requires three different symbols, namely, 1, V, and X, and also a combination of four of them to represent the number 8.

One of the potential advantages of the binary digital system is that the number of symbols is reduced to only two, namely, 1 and 0. However, one of the issues with the binary digital system is that it can become cumbersome and also introduce certain inaccuracies such as rounding errors when it is used to represent large numbers. In this regard, when using 8 binary number system digits, it is only possible to represent a total of 256 numbers in the range between and including 0-255. Dice which are used in board games and gambling use of form of pattern recognition in which round dots are used to represent a certain digit and/or number up to six. Alternatively, the number 5 can be represented by using a pattern and/or dots representing a pentagram and the number 6 can be represented by using a pattern and/or dots representing a pentagram, but having an additional dot in the center, or can be alternatively represented by using a pattern and/or dots representing a hexagram. Further, the number 7 can be represented by a pattern and/or dots representing hexagram, but having an additional dot in its center, and the number 8 can be represented by an octagon. The number 9 can be represented by a pattern and/or dots representing an octagon, but having an additional dot in its center. These kinds of representations are more literal or direct and less abstract than using cursive Arabic numerals, but one of the potential issues with this more literal and direct method of numerical representation is that when it would be continued the required number of dots and/or vertices associated with a geometric shape or symbol then become progressively ever greater in number, thus more complex and less easy to capture and communicate when using a an optical detector device such as a camera, photodetector, photodetector array, and performing optical pattern recognition.

In this regard, the use of a binary number system with 4 digits can provide certain advantages, and zero can then be represented, e.g., as black, or by no signal, or alternatively by white, or one specific wavelength and frequency of visible and/or invisible light, and one can be represented as white, or alternatively by black, and/or a different specific wavelength and frequency of visible and/or invisible light. In this case, there are only two different digits, bits, symbols, or indicators required, that is, one (1) and zero (0), and only four different digit positions: 1 is represented by 0000, 2 is represented by 0001, 3 is represented by 0011, 4 is represented by 0100, 5 is represented by 0101, 6 is represented by 0110, 7 is represented by 0111, 8 is represented by 1000, 9 is represented by 1001, and 10 can be represented by 1010, and these 4 binary digit and/or bit sequences can be represented by different corresponding patterns and/or constellation configurations 68 of circular dots or other symbols or positions and points 65 as shown in FIG. 49 and also FIG. 50 which provides examples of white or void rendering of 0's and black or filled rendering of 1's. It is possible to use 4 digits in this manner to represent the numbers between 0-15, but beyond this it is necessary to use more than 4 digits when using the binary number system. Once again, when using 8 digits or positions and the binary number system it is possible to represent a total of 256 numbers in the range between and including 0-255. When you wish to represent the number 99 the result is seven digits 1100011, and when you wish to represent the number 999 the result is 10 digits 1111100111, and when you wish to represent the number 9,999 the result is 14 digits 10011100001111, and when you wish to represent the number 99,999 the result is 17 digits 11000011010011111, and when you wish to represent a number over a million such as 1,234,567 using the binary digital system the result is 100101101011010000111 which is 21 digits. Alternatively, if one instead chooses to represent the ones column and position in a positional number system by using a first set or group of 4 binary digits or symbols which represent a number between 0-9, and likewise also use a second set or group of 4 binary digits or symbols to represent the tens column and position to represent a number between 0-9, and likewise also use a third set or group of 4 binary digits or symbols to represent the hundreds column and position to represent a number between 0-9, and likewise also use fourth set or group of 4 binary digits or symbols to represent the thousands column and position to represent a number between 0-9, and likewise also use a fifth set or group of 4 binary digits or symbols to represent the ten thousands column and position to represent a number between 1-9, and likewise also use sixth set or group of 4 binary digits or symbols to represent the 100 thousands column and position to represent a number between 1-9, and so on, then the number 99 would be represented by 8 binary digits, bits, or symbols instead of 7, the number 999 would be represented by 12 binary digits, bits, or symbols instead of 10, the number 9,999 would be represented by 16 binary digits, bits, or symbols instead of 14, the number 99,999 would be represented by 20 binary digits, bits, or signals instead of 17, and so on. The point here being that representing a number by a single binary digital sequence of ones and zeros moving positionally from right to left does not save, spare, or economize a great deal with regards to the number of digits or symbols which are required, that is, as compared with the alternative method of using sets or groups of 4 binary digits, bits, or symbols which is disclosed and shown in FIGS. 49 and 50. Alternatively, it is possible to use 8 binary digits, bits, or symbols instead of 4, and this would enable numbers between 0-255 to be represented in a single sequence. Once again, 4, 8, 16, 32, 64, 128, 256, 1024, or 4096 constellations can be represented and communicated using PSK and/or QAM configurations and related methods.

Further, another symbol or indicator can be added to the binary 4 digits representation of a number in order to indicate that is has a positive (+) or a negative (−) value. This can also the used to indicate the possible mathematical operations of addition or subtraction, and would be associated with a representation and code having 5 digits and/or symbols, that is, when added to a binary number representation which includes 4 digits. In this regard, adding a negative number to a positive one can result in subtraction. Multiplication can be viewed as a fast way of performing addition, and this operation can be covered and performed by simply using addition. Division is the inverse or opposite of multiplication, and it can also be performed and expressed using addition. For example, 12/4=X can also be algebraically represented as 12=4X, which is a way of asking what number added together 4 times=12, and the answer is the number 3. With regards to the use of addition in language models, see, e.g., Addition is All You Need For Energy-Efficient Language Models, by Luo et al., Oct. 2, 2024, https://arxiv.org/pdf/2410.00907. The possible use of exponents and logarithms to perform computations has also previously been discussed. It is possible to use optical detection to capture binary digital representations of ones (1s) and zeros (0s), e.g., their representation using white or black circles or other colors and/or symbols, and whether a number is then represented as a single sequence of binary digits in a linear configuration, or alternatively, has been represented using a one or more sets or groups of binary number digital sequences in a different geometric pattern and/or constellation configuration or diagram in order to represent each individual position and place holder of a given number, and the entire number. Once again, a sequence can be represented in a linear manner as shown in FIG. 47, or alternatively in a circular pattern and/or configuration or diagram 68 as shown and discussed in connection with FIGS. 45, 46, 48, 49, and 50.

FIG. 49 shows a table indicating numbers between 0-10 and a corresponding binary representation and code using 4 digits in connection with a positional number system. In this regard, the index is shown near the top of the table, the numbers 0-10 are shown on the left side under the #symbol and their corresponding representation and code using the binary system and 4 digits is shown in each of the columns or indexes numbered 0-3, the digits corresponding to the number 2,793 are shown near the bottom of the table and the corresponding binary 4 digit representation and code is indicated by rectangular boxes in the column above each of digits in the number 2,793, and a period or radix is shown to indicate and represent the number 2,793.0 in base 10. While the binary representation and code for the number 10 is shown in this table, it would not be required or typically be used when using the pattern and/or constellation diagram shown in FIG. 50 because the number 10 would be represented in the next outer ring(s) and corresponding position or points 65 associated with the next higher number position index.

FIG. 50 shows a circular pattern which can be an optical pattern and constellation configuration diagram for use in representing and communicating numbers, symbols, alphabetical letters, words, or images. It can be used for representing and encoding the binary number system, and in this example digital code which includes 4 digits. Alternatively, a different and larger number of digits can be used such as 8 or more digits. The circular optical pattern can be in a two-dimensional form like on a piece of paper, or alternatively be configured in a three-dimensional form, or even in a four-dimensional form. As shown in FIG. 50, a plurality of circles or rings 66, 69, 70, 71, can include a plurality of different positions or points 65 which can be used to represent and encode a set or group of 4 binary number digits which can be used as a pattern, optical pattern and/or constellation configuration diagram for communication purposes. Further, it can also be used to perform mathematical computations, and other computer operations or functions. In this regard, the 4 different positions or points 65 in the first set or group associated with the first circle or ring 66 closest to the center 64 can be used to represent a number between 0-9 and would then correspond the first index position corresponding to the one's column in a positional number system, as shown and discussed with reference to FIG. 49. The next 4 different positions or points 65 in the second set or group associated with the second circle or ring 69 further from the center 64 can be used to represent a number between 0-9 and correspond to the second index position and ten's column in a positional number system. The next 4 different points 65 in the third set or group associated with the third circle or ring 69 even further from the center 64 can be used to represent a number between 0-9 and correspond to the third index position and hundred's column in a position number system. The next 4 different points 65 in the fourth set or group associated with the fourth circle or ring 69 even further still from the center 64 can be used to represent a number between 0-9 and correspond to the fourth index position and thousand's column in a positional number system, and so on. Alternatively, it is possible to use 8 binary number digits in concentric circles, rings and positions and other patterns in order to represent, encode, and communicate numbers between 0-1, 0-9, 0-10, or between 0-255, or another range of numbers. Alternatively, a binary number representation using 4 digits can be configured and used closest to the center 64, a binary number representation using 8 digits can be configured and used further from the center 64, and a binary number representation using 16 digits can be configured and used even further from the center 64, that is, a greater number of positions or points 65 can be used in a circular configuration or in other configurations which are disposed at a greater distance from the center 64 of the pattern and/or constellation configuration or diagram 68 and then still maintain a desired Error Vector Magnitude parameter or EVM box. Alternatively, many different numbers of circles or rings and/or a different number of positions or points and can be used to create different configurations and patterns. For example, when using sine waves and cosine waves, the position or points 65 can be configured to coincide with and/or represent and encode the values 0 and 1 with the use of phase modulation and then also be configured for possible communication using a PSK and/or QAM constellation. Further, the number of circles or rings and positions or points can be created with the use of amplitude modulation. However, while many patterns can be detected and captured by optical devices, not every pattern may be conducive to being rendered and communicated using a constellation configuration typically associated with PSK and/or QAM over fiber optic cable. When representing quadrature phase shift modulation, it is common to use a sine wave unit circle and to make a constellation configuration or drawing and to plot the sine wave which is then called the quadrature component (Q) on the vertical Y axis, and the cosine wave which is called the in-phase component (I) on the horizontal X axis. For more information regarding QPSK and QAM, and how these optical patterns appear on an oscilloscope or other monitor device, see, e.g., Visualising Digital Communications: QAM with Real Signals, by Ian Explains, Signals, Systems, and Digital Communications, Sep. 30, 2024, https://youtu.be/8tAxhV3GeGc?si=yk7Kw6sTAsM6IMvW. Orthagonal Time Frequency Space Modulation (OTFS) is another kind of modulation, e.g., see What is OTFS?Orthogonal Time Frequency Space Modulation (“Best video in youtube for OTFS”), by Ian Explains Signals, Systems, and Digital Comms, Sep. 26, 2024, https://youtu.be/MvK3zhPrGkk?si=Dk8VdfXEka5iwSMc.

The circular pattern 68 shown and disclosed in FIG. 50 can be used to represent and encode binary number system digits. However, it is important to recognize that when each of the 4 positions or points 65 in each of the sets or groups which are disposed on each of the circles or rings 66, 69, 70, and 71 in the circular pattern 68 represented in FIG. 50 are instead used to represent and show a configuration of different wavelengths and corresponding frequencies of visible and/or invisible light or other portions of the electromagnetic spectrum which have each been directly encoded to represent an entire alphabetical letter, a word, a symbol, a number, or an image, then the amount of data and information which can be communicated, and the mathematical calculations and operations which can be performed can be dramatically increased in number and speed as compared to a classical computer using the conventional digital system.

In FIG. 50, the positions or points 65 on circles or rings 66, 69, 70, and 71 are all shown at 45, 135, 225, and 315 degrees when moving counter clockwise from the X axis, but they could be configured in a different manner in order to represent a different pattern and/or constellation configuration or diagram. The number 2793 which was discussed and shown in a binary number form and pattern in FIG. 49 is represented using the 3 o'clock position 67 and/or the quadrant located between the 12 and 3 o'clock position as the starting point for the first set and group of 4 positions or points 65 moving counter-clockwise when representing the value 3 in the one's column in the first circle or ring position 66. The second set and group of 4 positions or points 65 is similarly used to represent the value 9 in the ten's column in the second circle or ring position 69. The third set and group of 4 positions or points 65 is similarly used to represent the value 7 in the hundred's column in the third circle or ring position 70. The fourth set and group of 4 positions or points 65 is similarly used to represent the value 2 in the thousand's column in the fourth circle or ring position 69. However, the circles or rings 66, 69, 70, and 71, center point 64, X axis, Y axis and Z axis which extend therefrom, and indication of light cones and TIME shown in FIG. 50 would not appear in an actual optical pattern or communication, but have been provided as a visual aid for reference and comprehension purposes. As previously discussed in connection with FIGS. 45-48, it is possible to perform mathematic computations, and other computer operations and functions using the configuration which has been discussed and shown in FIG. 50.

In addition, FIG. 50 shows a X and a Y axis for representing two-dimensional space, but also a Z axis which can be used to represent a three-dimensional space, and also three-dimensional optical patterns. Three-dimensional optical patterns can be useful for recording, storing, manipulating, and computing data and information relating to many different subjects and phenomenon associated with the sciences, e.g., biology, chemistry, and physics. Moreover, a time cone has also been indicated and added to the right side using an arc between the words time in the upper and lower right quadrants in order to represent a future time in a fourth dimension, and another time cone has been indicated and added to the left side using an arc between the words time in the upper and lower left quadrants in order to represent a past time in the fourth dimension. A four-dimensional holographic optical pattern or image can represent a three-dimensional one that is changing and/or moving in time and can then be used to model or predict future events, e.g., such as the weather. When using a plurality of wavelengths and frequencies of visible and/or invisible light to represent and encode data and information and optical devices such as an optical processor and/or memory devices, and then making and using holographic optical patterns or other three-dimensional optical patterns or images, it is important to recognize that optical patterns can be represented and encoded not only in two dimensions, but also in three dimensions. Further, they can be persisted or stored in three dimensions, and can also be manipulated and processed in three dimensions, and if desired, the associated operations and functions can then be done in parallel and/or in series or a sequence. In this regard, the representation and encoding, manipulation, communication, processing, and persisting or storage of data and information in three-dimensional and/or four-dimensional forms is an area where analog computing and the use of what the Applicant has called “waves” or “vibs” using visible and/or invisible light can provide advantages over classical computers and the conventional digital system. Accordingly, the disclosure contained in U.S. Pat. No. 11,809,839 and the present application goes to teach and disclose how optical computers can perform computations and other computer operations and functions and provides solutions to what has been one of the challenges and outstanding questions associated with optical computers, electro-optical computers, and quantum computers.

### Encryption

The following information is provided in order to disclose how data and information that would be communicated in the frequency domain, such as in the visible or invisible light spectrum, and/or sound spectrum can be protected and made secure with the use of cryptography, and related methods. In 2001, the United States adopted the Advanced Encryption Standard (AES), also known as the Rijndael block cipher which is included in the international ISO/IEC 18033-3 standard. The two most common methods of encryption in cryptography are known as symmetric and asymmetric encryption. With symmetric encryption two or more parties share the same private password or key in order to communicated data and information. One example of symmetric encryption is the Substitution Cipher (Caesar Cipher) ROT 13 in which alphabetical letters are switched with those which appear 13 later in the alphabet. Some of the weaknesses of this cipher related to the existence of single letter words, and the frequency of use of certain letters. The size of the keys used in symmetric encryption are typically 128 bit or larger, and are typically communicated out of band, that is, privately. As a result, symmetric encryption is not an easy method of security to scale up, and it can also be vulnerable because if the key is compromised or lost then the data and information in not secure and a new key would be required. One Time Pad is another related cryptographic method, and it relies on the generation of random numbers which is something that is not easy as it sounds.

With asymmetric encryption two or more parties share their public password, phrase or key, and each of them also has a private password, phrase, or key. The RSA algorithm as disclosed in U.S. Pat. No. 4,405,829 is a common method of asymmetric encryption which is used to generate the public and private keys. For example, if an individual wished to send the message: “Run Tag Run” to a company the plain text of this message could be converted using the public key of the company into a cipher text. Upon receiving the cipher text, the company would then use its private key to decipher the message and read the plain text. The RSA algorithm makes use of a least two or more very large integers and prime numbers, and relies on the inability of ordinary classical and what we know as conventional computers to determine their factors in polynomial time, that is, for a very long time, and perhaps never ever. In this regard, the size of the keys commonly used in RSA encryption are 3,072 bits or larger.

There is also a different type of asymmetric cryptography known as Elliptic Curve Cryptography (ECC) which uses curves which are associated with mathematical equations. The Elliptic Curve Effie Hellman protocol is one form of ECC which is being used today. One of the advantages of the Elliptic Curve Cryptography method is that it can use smaller passwords, phrases, and keys, and it then has smaller storage and transmission requirements than RSA encryption. For example, ECC using only 256 bits can provide the same level of security as RSA using 3072 bits, and ECC using only 384 bits which is something commonly used by the U.S. government to secure Top Secret data and information can provide the same level of security as RSA using 7680 bits. For example, see Wikipedia: https://en.wikipedia.org/wiki/RSA_(cryptosystem), regarding the RSA Cryptography method, and https://en.wikipedia.org/wiki/Elliptic-curve_cryptography regarding Elliptic Curve Cryptography. The company Certicom was the original creator and owner of numerous patents directed to elliptic curve cryptography, e.g., see U.S. Pat. Nos. 6,563,928, and 6,704,870, and these patents are hereby incorporated by reference herein. In brief, ECC typically makes use of an elliptical curve which is symmetric about the x axis such that a line that is drawn from a point of origin A can only intersect the other parts of the curve at two points, a nearer point B, and further point C. Point C is then used to determine a point D on the other half of the curve, and a line drawn between this point and point A then determines a new point of intersection of the curve E. This process can continue for a very long time, but it is typically limited by a maximum value on the elliptical curve which serves to determine the size of a key in this public key and private key asymmetric when using this cryptography method. The National Institute of Standards and Technology (NIST) has several recommended elliptical curves for possible use, and the National Security Agency (NSA) also has some. The NSA has also provided SHA 1, 2, and 3 Secure Hashing Algorithms. However, SHA 1 has been broken, and some people believe at least one of the curves recommended by the NSA has a back door. Elliptical curve X25519 is well-regarded and presently being widely used. Elliptic Curve Diffie-Hellman Key Exchange (ECDH) is being used to secure key exchange, and Elliptic Curve Digital Signature Algorithm (ECDSA) is often used to secure and validate signatures and other transactions, e.g., see https://en.wikipedia.org/wiki/Elliptic-curve_Diffie%E2%80%93Hellman, and https://en.wikipedia.org/wiki/Elliptic_Curve_Digital_Signature_Algorithm. Accordingly, elliptic curve cryptography is commonly being used to provide security for certain block chain technologies such as Bitcoin, e.g., see https://en.wikipedia.org/wiki/Blockchain.

Visible and/or invisible light which is associated with sinusoidal wave forms, but also and other wave forms such as square waves, wavelets, triangle waves, and sawtooth waves, pulses, and Gaussian pulses can be used to communicate data and information. These wave forms and/or pulses can be used with the methods described above, and others such as quantum cryptography to provide security for data and information communications. In particular, the use of visible and/or invisible light can lend itself to a form of Ellipitic Curve Cryptography (ECC), and this will be described below. In brief, visible light frequencies are between about 4×10¹⁴and 8×10¹⁴cycles per second (Hz) or about 430-750 trillion Herz (THz), and have wavelengths in the range between approximately 380-740 nm. For the sake of simplicity, the present application will here refer to the visible light range as being between 400-700 nm. One cycle of visible light associated with wavelengths between 400-700 nm corresponds to durations in time in the range between about 1.3 and 2.3 fs. The ultraviolet light spectrum includes wavelengths in the range between approximately 10 nm and 400 nm which corresponds to frequencies in the range between approximately 30 PHz-750 THz. The infrared light spectrum includes wavelengths in the range between approximately 700 nm-1 mm and corresponds to frequencies in the range between approximately 430 THz-300 GHz. In order to make this large scale easier to both see and understand: One TeraHerz (THz) equals 1,000,000,000,000 cycles per second (12 zeros); One PicoHerz (PHz) is 10⁻¹² equals 0.000000000001 cycles per second (12 zeros); One picosecond is 10⁻¹² and 0.000000000001 second (12 zeros); and, One femtosecond (fs) is 10⁻¹⁵ and 0.000000000000001 second (15 zeros).

Here is one possible method of cryptography which can be used to provide security for data and information communications. Consider the logarithm notation M^{N} in which M is used to represent a numerator in the base 10 system (or other selected base system), and N is an exponent. Let's say you wish to represent and communicate the number 5. The number 5 can be represented in logarithmic form as: Log₁₀ X=0.69870004=10⁻⁶⁹⁸⁹⁷⁰⁰⁰⁴=5. If you select the number 5 and wish to represent it in base 10, or different selected base number system M, and it is represented as MN which in this case is 10⁻⁶⁹⁸⁹⁷⁰⁰⁰⁴. You can them multiply (or otherwise manipulate) the exponent N by a factor that we will here call X to determine or match the frequency and/or wavelength of the visible or invisible light that will be used in TeraHerz (THz) which equals 1,000,000,000,000 cycles per second, to encode and represent the number in the light spectrum. Accordingly, in this case you would take the nine-digit number N=0.69897004 and multiply it by X to determine or match the frequency and/or wavelength of the visible or invisible light used to encode and communicate the number 5. One side of the equation is then: 0.698970004(X)=Wavelength. For example, it we wish to use the color blue associated with 472 nanometers to represent the number 5, the corresponding frequency is about 635.14 THz, and more precisely, 635,153,512,711,864 Hz. Accordingly, the equation is then: 0.698970004(X)=635,153,512,711,864 (Hz), and we can then solve for X=908,699,241,851,677.0359903292.

If someone does not know what base system you are using or what number you are trying to represent then they are missing two variables of the equation, and if they do not know what color, frequency and wavelength you wish to use then they are also missing a third variable of the equation. As a result, they can't know the configuration of the elliptical curve associated with the sine wave form (or waveform) having a wavelength of 472 nanometers that could possibly be used in this example, if desired, in lieu of a standardized ECC curve, and so the data and information is already hard to decipher. In this regard, an elliptical curve can be generated from at least one of the sine function, cosine function, tangent function, and/or cotangent function associated with a sinusoidal wave, or wavelet, or alternatively a different standardized elliptical curve can be selected. This elliptical curve which is generated or selected can then be used to perform Ellipitic Curve Cryptography ECC. Further, in order to add another level of complexity, one or more additional factors and/or mathematical operations can be added to the equation in the exponent portion. In order to add another level of security and protection, one or more those added factors and/or operations could include the use of a randomly selected number, and possibly one or more very, very, large prime number(s) so that you have a “really, really, big number.” Moreover, with the use of a filter or optical prism such as a Fresnel rhomb it is possible to polarize visible and/or invisible light and then configure spherical and/or elliptical shapes and wave forms with the emerging light. Accordingly, it is possible to create, randomly or not, and to select an elliptical shape and then work backwards to determine the other factors associated with the equations described above. Likewise, a holograph can be used to generate at least one curve or three-dimensional form for the same purpose, and data and information can be stored in a holographic memory device. Analog devices and communications are typically less susceptible to hacking than digital devices and communications, and with the use of one or more of the aforementioned cryptography methods and standards and also the methods discussed above, a bad actor would likely die of old age before a secured communication of data and information could possibly be hacked. Optalysys of Leeds, England is a company that uses Fully Homomorphic Encryption (FHE) to secure photonic communications. The company has a website: https://www.optalysis.com, and is associated with the following patents and patent applications: U.S. Pat. No. 8,610,839 B2 by New et al., U.S. Pat. No. 10,289,151 B2 by New, U.S. Pat. No. 10,409,084 B2 by New et al., 11,062,101 B2 by New et al., U.S. Pat. No. 12,033,066 B2 by Macfaden, U.S. 20200387013 A1 by Palani, U.S. 20230076393 A1 by Cottle et al., U.S. 20230291552 A1 by Michel, U.S. 20230375784 A1 by Todd, WO 9931563 by Wilkinson, WO 2020245436 A1 by Palani, WO 2022053825 A2 by Kundu et al., WO 2023170406 A1 by Kundu, WO 2024184545 A1 by Todd et al., and all of the patents and patent applications recited in this paragraph are hereby incorporated by reference herein.

### Articles and Videos

For the same of providing easy access to information, the present application will provide a list of subjects and links to related articles or videos below which will also be provided in the Information Disclosure Statement(s) being submitted with the present application. Some of the subjects and topics overlap and could be organized differently, but this may helpful because readers will be able to copy and paste or click on the linked provided below.

Future of Analog, Optical, Electro-Optical and/or Quantum Computers

Articles or videos relating to the history and possible future of analog, optical, electro-optical and/or quantum computers include:
Professor's perceptron paved the way for AI—60 years too soon, by Melanie Lefkowitz, Sep. 25, 2019, https://news.cornell.edu/stories/2019/09/professors-perceptron-paved-way-ai-60-years-too-soon;
Vector Processor, https://en.wikipedia.org/wiki/Vector_processor;
Cray 1, https://en.wikipedia.org/wiki/Cray-1;
Array Processing, https://en.wikipedia.org/wiki/Array_processing;
The Analog Thing, https://the-analog-thing.org/;
Future Computers Will Be Radically Different, by Veritasium, https://youtu.be/GVsUOuSjvcg;
The Unbelievable Zombie Comeback of Analog Computing|WIRED, Mar. 30, 2023, by Charles Platt, https://www.wired.com/story/unbelievable-zombie-comeback-analog-computing/;
Research brings analog computers just one step from digital, by Brandie Jefferson, Dec. 8, 2021, https://source.wustl.edu/2021/12/pim-computing-neural-network/;
Hackaday 10th Anniversary: Non-Binary Computing, Oct. 7, 2014, https://youtu.be/TFTK074nG_M?si=DRwZwCgBrq0VO4jT;
Ternary Computing Testbed 3-Trit Computer Architecture, by Jeff Connelly, Aug. 29, 2008, http://xyzzy.freeshell.org/trinary/CPE%20Report%20-%20Ternary%20Computing%20Testbed%20-%20RC6a.pdf;
Computing Science: Third Base, by Brian Hayes, 12-XX-2001, https://www.jstor.org/stable/27857554;
Optical Computing—Wikipedia, https://en.wikipedia.org/wiki/Optical_computing;
Blueprint for a Scalable Photonic Fault-Tolerant Quantum Computer, by Bourassa et al., Oct. 6, 2020, https://arxiv.org/abs/2010.02905;
Optimal Encoding of Classical Information in a Quantum Medium, by Elron et al., May 30, 2006, https://arxiv.org/pdf/quant-ph/0601010.pdf;
Opening the Door to a Next-Generation Information Processing Platform, U.S. Department of Energy, by Xu Han, xx-xx-2023, https://science.osti.gov/bes/Highlights/2023/BES-2023-09-f;
Basic Linear Design, by Zumbahlen, https://www.analog.com/media/en/training-seminars/design-handbooks/Basic-Linear-Design/Introduction.pdf;
Analog computing will take over 30 billion devices by 2040. WTF does that mean?|Hard Reset, By Freethink on Youtube, Oct. 9, 2023, https://youtu.be/6AgkTdQXFTY?si=TNlywfKiXswPq0fL;
How Quantum Computers Work: Explaining Qubits to Quantum Superposition by New Scientist, Feb. 23, 2023, https://youtu.be/WW7DKcrQ-7E?si=_QNmiqpBViNlp6mn;
Roger Penrose Thinks Quantum Mechanics Is Dead Wrong, Oct. 4, 2024, https://youtu.be/HPH-SzWF46w?si=rNJb9KFw540NTakRsee;
Roger Penrose On Quantum Mechanics And Consciousness, Mar. 24, 2024, https://youtu.be/YnXUuyfPK2A?si=TMNnJ9d4uB91EUXf;
Roger Penrose On Quantum Mechanics And Consciousness, Mar. 24, 2024, https://youtu.be/YnXUuyfPK2A?si=TMNnJ9d4uB91EUXf;
The Quantum World: Dreams and Delusions|Roger Penrose, Sabine Hossenfelder, Michio Kaku, And More!, https://youtu.be/dvVBNaZc_WE?si=uvhlkj6lLd8eDdZS;
Quantum Entanglement Isn't All That Spooky After all, by Chris Ferrie, Feb. 13, 2023, https://www.scientificamerican.com/article/quantum-entanglement-isnt-all-that-spooky-after-all1/;
Quantum-centric supercomputing for materials science: A perspective on challenges and future directions, by Alexeev et al., May 31, 2024,
https://www.sciencedirect.com/science/article/pii/S0167739X24002012;
Optimal Pump Shaping For Entanglement Control In Any Countable Basis, by Bornman, et al., Aug. 21, 2021, https://onlinelibrary.wiley.com/doi/10.1002/qute.202100066;
The Future Of Quantum Computing With Michio Kaku, Neil deGrasse Tyson & More, Jun. 4, 2024, https://youtu.be/um6rdKr4To?si=7CgfLLG3-QD6fMqn;
Michio Kaku: Quantum Computing Is The Next Revolution, Aug. 13, 2023, https://youtu.be/qQvilld_hFA?si=pagvdKcaU7nUZ4pg;
DNA-Like Geometric Structure Discovered In Space Time, by Carvajal, Oct. 14, 2024, https://Inkd.in/gaqxq298;
From Colored Gravity to Electromagnetism, by Monjo, et al., Oct. 10, 2024, Gen Relativ Gravit 56, 117 (2024). doi.org/10.1007/s10714-024-03307-8, https://arxiv.org/pdf/1012.4730;
Quantum Computing Explained With A Deck Of Cards, by Dario Gil, IBM, Jun. 22, 2017, https://youtu.be/yy6TV9Dntlw?si=gfl3VGW4a5FkeW7x;
Quantum Entanglement, https://en.wikipedia.org/wiki/Quantum_entanglement;
Superposition Principle, https://en.wikipedia.org/wiki/Superposition_principle;
Wave Function, https://en.wikipedia.org/wiki/Wave_function;
Wave Interference—Wikipedia, https://en.wikipedia.org/wiki/Wave_interference;
Quantum Superposition, https://en.wikipedia.org/wiki/Quantum_superposition;
Fast digital methods for adiabatic state preparation, by Wan et al., Apr. 8, 2020, https://arxiv.org/pdf/2004.04164;
AI Meets Quantum: New Breakthrough Will Change Everything, by Anastasi in Tech, Dec. 10, 2024, https://youtu.be/elNcrZGDQD0?si=4ScoP-2jyG5Wz8Pp;
Exponentially faster implementations of Select(H) for fermionic Hamiltonians, by Kianna Wan, Apr. 8, 2020, https://arxiv.org/pdf/2004.04170;
A Jordan-Wigner gadget that reduces T count by more than 6× for quantum chemistry applications, by Sam Pallister, Apr. 10, 2020, https://arxiv.org/pdf/2004.05117;
Fault-tolerant resource estimate for quantum chemical simulations: Case study on
Li-ion battery electrolyte molecules, by Kim et al., May 9, 2023, https://arxiv.org/pdf/2104.10653;
Increasing error tolerance in quantum computers with dynamic bias arrangement, by Bombin et al., Mar. 28, 2023, https://arxiv.org/pdf/2303.16122;
Increasing error tolerance in quantum computers with dynamic bias arrangement, by Bombin et al., Mar. 28, 2023, https://arxiv.org/pdf/2303.16122;
Logical blocks for fault-tolerant topological quantum computation, by Bombin et al., Dec. 22, 2021, https://arxiv.org/pdf/2112.12160;
Fusion-based quantum computation, by Bartolucci et al., Jan. 22, 2021, https://arxiv.org/pdf/2101.09310;
Optical Quantum Computing, by Jeremy O'Brien, Mar. 11, 2008, https://www.science.org/doi/10.1126/science.1142892;
A variational eigenvalue solver on a photonic quantum processor, by Peruzzo et al., Jul. 23, 2014, https://www.nature.com/articles/ncomms5213.pdf;
Universal Linear Optics, by Carolan et al., Jul. 15, 2015, https://science.sciencemag.org/content/349/6249/711.abstract;
Chip-to-chip quantum photonic interconnect by path-polarization interconversion, by Wang et al., Sep. 26, 2026, https://www.osapublishing.org/optica/fulltext.cfm?id=338939&uri=optica-3-4-407;
Large-scale silicon quantum photonics implementing arbitrary two-qubit processing, by Qiang et al., Sep. 26, 2018, https://arxiv.org/abs/1809.09791;
Programmable four-photon graph states on a silicon chip, by Adcock et al., Aug. 6, 2019, https://www.nature.com/articles/s41467-019-11489-y.pdf;
Integrated photonic quantum technologies, by Wang et al., Oct. 21, 2029, https://arxiv.org/pdf/2005.0194;
Chip-to-chip quantum teleportation and multi-photon entanglement in silicon, by Llewellyn et al., Nov. 15, 2019, https://arxiv.org/pdf/1911.07839;
Error protected qubits in a silicon photonic chip, by Vigliar et al., Sep. 17, 2020, https://arxiv.org/pdf/2009.08339;
How to compute a 256-bit elliptic curve private key with only 50 million Toffoli gates, by Daniel Litinski, Jul. 14, 2023, https://arxiv.org/pdf/2306.08585;
Active volume: An architecture for efficient fault-tolerant quantum computers with limited non-local connections, by Litinski et al., https://arxiv.org/pdf/2211.15465;
Fusion-Based Quantum Computation, by Bartolucci et al., Feb. 17, 2023, https://www.nature.com/articles/s41467-023-36493-1.pdf;
A manufacturable platform for photonic quantum computing, by PsiQuantum team, Apr. 26, 2024, https://arxiv.org/pdf/2404.17570;
Fault-tolerant quantum computation of molecular observables, Steudtner, et al., Mar. 24, 2023, https://arxiv.org/pdf/2303.14118;
Logical Blocks for Fault-Tolerant Topological Quantum Computation, by Bombin et al., 04-07, 2023, https://journals.aps.org/prxquantum/pdf/10.1103/PRXQuantum.4.020303;
KLM Protocol—Wikipedia, https://en.wikipedia.org/wiki/KLM_protocol;
Grover's Search Algorithm—Wikipedia, https://en.wikipedia.org/wiki/Grover%27s_algorithm;
Amplitude Amplification, https://en.wikipedia.org/wiki/Amplitude_amplification;
Brassard-Hoyer-Tapp algorithm (BHT) Algorithm, https://en.wikipedia.org/wiki/BHT_algorithm;
Pollard's rho Algorithm, https://en.wikipedia.org/wiki/Pollard%27s_rho_algorithm;
Quantum Walk Search, https://en.wikipedia.org/wiki/Quantum_walk_search;
The AI Boom Could Use a Shocking Amount of Electricity, by Lauren Leffer, Oct. 13, 2023, Scientific American, https://www.scientificamerican.com/article/the-ai-boom-could-use-a-shocking-amount-of-electricity/, and
Projecting the Electricity Demand Growth of Generative AI Large Language Models in the US, by Jafari et al., Jul. 17, 2024, https://www.energypolicy.columbia.edu/projecting-the-electricity-demand-growth-of-generative-ai-large-language-models-in-the-us/.

### Barcodes, Matrix Codes, and UPC Codes

Barcode—Wikipedia, https://en.wikipedia.org/wiki/Barcode;
Universal Product Code—Wikipedia, https://en.wikipedia.org/wiki/Universal_Product_Code;
Code 39—Wikipedia, https://en.wikipedia.org/wiki/Code_39;
Anoto—Wikipedia, https://en.wikipedia.org/wiki/Anoto.

### Cryptography

Blockchain, https://en.wikipedia.org/wiki/Blockchain;
Huffman Coding, https://en.wikipedia.org/wiki/Huffman_coding;
Cryptosystem, https://en.wikipedia.org/wiki/RSA_(cryptosystem);
Elliptic-Curve Cryptography, https://en.wikipedia.org/wiki/Elliptic-curve_cryptography;
Elliptic Curve Digital Signature Algorithm, https://en.wikipedia.org/wiki/Elliptic_Curve_Digital_Signature_Algorithm; and,
Elliptic-Curve Diffie-Hellman, https://en.wikipedia.org/wiki/Elliptic-curve_Diffie%E2%80%93Hellman;
Coding Theory, Wikipedia, https://en.wikipedia.org/wiki/Coding_theory;
Cryptography, Wikipedia, https://en.wikipedia.org/wiki/Cryptography;
Quantum Algorithm Zoo, https://quantumalgorithmzoo.org/;
Blockchain, https://en.wikipedia.org/wiki/Blockchain;
Cryptosystem, https://en.wikipedia.org/wiki/RSA_(cryptosystem).

### Diamonds and Computers

Diamond Cut—Wikipedia, https://en.wikipedia.org/wiki/Diamond_cut?wprov=srpw1_0.
Will Diamonds Revolutionize Quantum Computing? by William G. Wong, Nov. 26, 2024, https://www.electronicdesign.com/technologies/embedded/quantum-computing/article/55246096/electronic-design-will-diamonds-revolutionize-quantum-computing;
Lightsynq makes diamond photonic quantum interconnects, e.g., see Why We Founded Lightsynq, https://www.lightsynq.com/;
Quantum Brilliance, Room Temperature Diamond Quantum Accelerators, https://quantumbrilliance.com/, and their WO 2023097361 A1, by Doherty et al, Jun. 8, 2023;
MIT's Diamond Qubits Redefine the Future of Quantum Computing, by Adam Zewe, Jun. 28, 2024, https://scitechdaily.com/mits-diamond-qubits-redefine-the-future-of-quantum-computing/;
Long-term data storage in diamond, by Dhomkar et al., Oct. 26, 2016, https://www.science.org/journal/sciadv;
Major development successes in diamond spin photon quantum computers, by Fraunhofer Institute for Applied Solid State Physics, Oct. 28, 2024, https://www.sciencedaily.com/releases/2024/10/241028132358.htm;
Record Breaking Diamond Storage Can Save Data For Millions of Years, by Jemery Hsu, Nov. 27, 2024, https://modern-science.net/record-breaking-diamond-storage-can-save-data-for-millions-of-years/; and,
5 Companies Working With Diamond NV Quantum Computing Technology, by James Dargen, Mar. 31, 2022, https://thequantuminsider.com/2022/03/31/5-quantum-computing-companies-working-with-nv-centre-in-diamond-technology/.

### Error Correction

Error Correction Code, Wikipedia, https://en.wikipedia.org/wiki/Error_correction_code;
Error Detection and Correction, Wikipedia, https://en.wikipedia.org/wiki/Error_detection_and_correction;
AI Meets Quantum: New Breakthrough Will Change Everything, by Anastasi in Tech, Dec. 10, 2024, https://youtu.be/eINcrZGDQD0?si=4ScoP-2jyG5Wz8Pp;
Hamming Code, Wikipedia, https://en.wikipedia.org/wiki/Hamming%27s_code;
List of Algorithms, Wikipedia, https://en.wikipedia.org/wiki/List_of_algorithms#Error_detection_and_correction;
Variational Quantum Eigensolver, https://en.wikipedia.org/wiki/Variational_quantum_eigensolver;
Quantum Optimization Algorithms, and, https://en.wikipedia.org/wiki/Quantum_optimization_algorithms.

### Fiber Optic Speed and Bandwidth

The following articles relate to the development and use of fiber optics, speed, and bandwidth in classical, optical, electro-optical, and/or quantum computers:
Shannon-Hartley theorem, Wikipedia, https://en.wikipedia.org/wiki/Shannon%E2%80%93Hartley_theorem;
René-Jean Essiambre, Gerhard Kramer, Peter J. Winzer, Gerard J. Foschini, and Bernhard Goebel, Capacity Limits of Optical Fiber Networks, J. LIGHTWAVE TECH., VOL. 28, NO. 4, https://opg.optica.org/JLT/abstract.cfm?uri=JLT-28-4-662;
Information—Maximum theoretical bandwidth of fibre-optics—Physics Stack Exchange, Answer by Selene Routley, Jul. 12, 2013, https://physics.stackexchange.com/questions/56240/maximum-theoretical-bandwidth-of-fibre-optics;
Engineers Shatter Fiber Optic Speed Record at 22.9 Petabits Per Second, Extremetech, by Ryan Witwam, https://www.extremetech.com/internet/engineers-shatter-fiber-optic-speed-record-at-229-petabits-per-second; and,
Ultrashort Pulse—Wikipedia, https://en.wikipedia.org/wiki/Ultrashort_pulse;
5G NR Frequency Bands, Wikipedia, https://en.wikipedia.org/wiki/5G_NR_frequency_bands;
Wavelength bandwidth converter—Lasercalculator, https://lasercalculator.com/spectral-bandwidth-converter/.
Bandwidth—Optical Spectrum, Telecom Fiber—RP Photonics, https://www.rp-photonics.com/bandwidth.html;
Time-Bandwidth Product, by Dr. Rüdiger Paschotta, Telecom Fiber—RP Photonics, https://www.rp-photonics.com/time_bandwidth_product.html;
Xscape Photonics CEO Vivek Raghunathan on Escape Bandwidth, by EE Times, Oct. 16, 2024, https://youtu.be/EjJ2Y5snTBk?si=kfvuoAHODUdWSoVD;
Wavelength bandwidth converter—Lasercalculator, https://lasercalculator.com/spectral-bandwidth-converter/;
Bandwidth—Optical Spectrum, by Dr. Rüdiger Paschotta, Telecom Fiber—RP Photonics, https://www.rp-photonics.com/bandwidth.html;
Noisy-Channel Coding Theorum, or Shannon's Theorum, Wikipedia, https://en.wikipedia.org/wiki/Shannon%27s_theorem;
How are Data Rate and Bandwidth Related?(“a super clear explanation!”) by Ian Collins, Feb. 26, 2020, https://youtu.be/ZBSvMbOOmPQ?si=oSEt-ko4tDscl8T;
What is the Maximum Bandwidth?—Sixty Symbols, by Mike Merrifield, Oct. 3, 2013, https://youtu.be/OOOmSyaoAtO?si=T_2Nre7syQyN67lh;
Fourier Series, https://en.wikipedia.org/wiki/Fourier_series;
Fourier Optics, https://en.wikipedia.org/wiki/Fourier_optics;
Fourier Transform, https://en.wikipedia.org/wiki/Fourier_transform;
Complex Logarithm, https://en.wikipedia.org/wiki/Complex_logarithm;
Intuitive Learning via Manim! Visualizing Euler formula and trigonometric functions, by QuantPi, Sep. 22, 2024, https://youtu.be/znwuFjJs_44?si=f2xU6Eb9qGpWeoAr;
The most beautiful equation in math, explained visually [Euler's Formula], by Welch Labs, Aug. 12, 2024, https://youtu.be/f8CXG7dS-D0?si=JbacRvLsL2yaCZHO;
Sum of Squares of Sine and Cosine—ProofWiki, Feb. 8, 2024, https://proofwiki.org/wiki/Sum_of_Squares_of_Sine_and_Cosine;
What Is The Sum of Squares of Sine & Cosine Functions?, Animation by OpenMathCircle, Oct. 17, 2024, https://www.facebook.com/openmathcircle/videos/1970302120085404/;
RF Photonics Encyclopedia, by Dr. Rüdiger Paschotta, https://www.rp-photonics.com/encyclopedia.html; and, https://www.rp-photonics.com.

### Glass and Crystal Memory Storage

Articles about the possible use of glass and crystal memory storage include:
Microsoft's Project Silica saves data on glass plates for 10,000 years, PCWorld, by Hans-Christian Dirscherl, Oct. 17, 2023, https://www.pcworld.com/article/2108839/microsoft-project-small-glass-pane-stores-terabytes-of-data.html;
Sealed In Glass, by Microsoft, https://go.redirectingat.com/?id=111346X1569483&url=https://unlocked.microsoft.com/sealed-in-glass/&xcust=2-1-2108839-1-0-0&sref=https://www.pcworld.com/article/2108839/microsoft-project-small-glass-pane-stores-terabytes-of-data.html; and,
5D Optical Data Storage—Wikipedia, https://en.wikipedia.org/wiki/5D_optical_data_storage.

### Graphene Oxide

The following articles relate to the possible use of graphene oxide in optical, electro-optical and/or quantum computers:
Graphene Oxide for Photonics, Electronics and Optoelectronics, Nature Reviews Chemistry 7(3), 01-xx-2023, by Wu et al., https://www.researchgate.net/profile/Jiayang-Wu-3/publication/367250154_Graphene_oxide_for_photonics_electronics_and_optoelectronics/links/63f5e5e00d98a97717ad2a7d/Graphene-oxide-for-photonics-electronics-and-optoelectronics.pdf?_tp=eyJjb250ZXh0ljp7mZpcnN0UGFnZSI6lnB1YmxpY2F0aW9uliwicGFnZSI6lnB1Ym xpY2F0aW9uln19;
A thermally photoreduced graphene oxides for three-dimensional holographic images, Nature Communications, 6, by Li et al., Apr. 22, 2015, https://www.nature.com/articles/ncomms7984.pdf;
Highly efficient and ultra-broadband graphene oxide ultrathin lenses with three-dimensional subwavelength focusing, Nature Communications, 6, by Zheng et al., Sep. 22, 2015, https://www.nature.com/articles/ncomms9433.pdf;
A spectrally tunable all-graphene-based flexible field-effect light-emitting device, by Wang et al., Nature Communications, 6, Jul. 16, 2015, https://www.nature.com/articles/ncomms8767.pdf;
Ultrafast All-Optical Graphene Modulator, Nano Letters, by Li et al., Jan. 17, 2014, https://pubs.acs.org/doi/10.1021/nl404356t;
Hybridization of graphene-gold plasmons for active control of mid-infrared radiation, Scientific Reports, by Feinstein et al., Mar. 20, 2024, https://www.nature.com/articles/s41598-024-57216-6;
Graphene plasmonics for tunable terahertz metamaterials, Nature Nanotechnology, by Ju et al., Sep. 4, 2011, https://www.nature.com/articles/nnano.2011.146;
Electro-optical switching of graphene oxide liquid crystals with an extremely large Kerr coefficient, Nature Materials, by Shen et al., Mar. 9, 2014, https://pubmed.ncbi.nlm.nih.gov/24608144/;
Graphene Metapixels for Dynamically Switchable Structural Color, ACS Nano, by Hu et al., May 21, 2021, https://testpubschina.acs.org/doi/10.1021/acsnano.1c01570;
Graphene photonics and optoelectronics, Nature Photonics, by Bonnoccorso et al., Aug. 31, 2010, https://www.nature.com/articles/nphoton.2010.186; and,
Graphene-Based Multilayered Metamaterials with Phototunable Architecture for on-Chip Photonic Devices, ACS Photonics, by Yang et al., Feb. 27, 2019, https://www.x-mol.com/paper/5577066.

### Holographic and Optical Memory Storage

Articles about the possible use of holographs and/or optical memory and storage include:
Optical RAM and integrated optical memories, a survey, by Alexoudi et al., May 25, 2020, https://www.nature.com/articles/s41377-020-0325-9;
Table 1 Summary of optical memory technologies, from Optical RAM and integrated optical memories, a survey, by Alexoudi et al., May 25, 2020, https://www.nature.com/articles/s41377-020-0325-9;
Collinear holographic data storage technologies, by Lin et al., Mar. 10, 2020, https://www.oejournal.org/oej-data/oea/2020/3/PDF/OEA-3-3-190004-1.pdf;
Project HSD: Holographic Storage Device for the Cloud, by Thomsen et al., Sep. 22, 2020, https://www.microsoft.com/en-us/research/project/hsd/;
Microsoft Sheds Some Light On Its Mysterious Holographic Processing Unit, Aug. 23, 2016, https://arstechnica.com/information-technology/2016/08/microsoft-sheds-some-light-on-its-mysterious-holographic-processing-unit/;
Optical Rectification by Rachet Transport In an Asymmetric Grating, by Moroshkin et al., Nov. 2, 2021, https://doi.org/10.1063/5.0062816;
Microsoft HoloLens, https://en.wikipedia.org/wiki/Microsoft_HoloLens;
Swave Photonics Developing World's First True Holographic Display Technology To Power Reality-First Spacial Computing, Apr. 25, 2024, https://swave.io/swave-photonics-developing-worlds-first-true-holographic-display-technology-to-power-reality-first-spatial-computing/;
In search for future of cloud storage, researchers look to holographic storage solutions—Microsoft Research, by Thomsen et al., Sep. 22, 2020, https://www.microsoft.com/en-us/research/blog/in-search-for-future-of-cloud-storage-researchers-look-to-holographic-storage-solutions/;
How Does Holographic Storage Work? by Microsoft Research, Sep. 12, 2020, https://youtu.be/4EADwGV5Gv8?si=fnd8VECkTguh4w9K;
Holographic Data Storage, Wikipedia, https://en.wikipedia.org/wiki/Holographic_data_storage,
Holographic Data Storage Technology, Bernal et al., May 2000, https://www.researchgate.net/publication/220498234_Holographic_data_storage_technology;
Full-color 3D holographic augmented-reality displays with metasurface waveguide, by Gopakumar et al., May 8, 2024, https://www.nature.com/articles/s41586-024-07386-0;
Multicolor 3D meta-holography by broadband plasmonic modulation, Science Advances, by Lee et al., Nov. 4, 2016, https://www.science.org/doi/10.1126/sciadv.1601102;
Optical Storage—Wikipedia, https://en.wikipedia.org/wiki/Optical_storage;
Using light for next-generation data storage—ScienceDaily, University of South Australia, Jul. 18, 2017, https://www.sciencedaily.com/releases/2018/07/180711093109.htm;
Revolutionizing 3D: New Holographic Technique Breaks Computational Barriers, By SPIE—INTERNATIONAL SOCIETY FOR OPTICS AND PHOTONICS, Apr. 16, 2024, https://scitechdaily.com/revolutionizing-3d-new-holographic-technique-breaks-computational-barriers/;
Multicolor 3D meta-holography by broadband plasmonic modulation, Science Advances, by Lee et al., Nov. 4, 2016, https://www.science.org/doi/10.1126/sciadv.1601102;
Harnessing the power of light: Advancements in photonic memory for faster optical computing, by Wei et al., Jul. 31, 2023, https://amp.spie.org/news/harnessing-the-power-of-light-advancements-in-photonic-memory-for-faster-optical-computing;
Quantum optical memory for entanglement distribution, by Lie et al., Optica Vol. 10, Issue 11, pp. 1511-1528 (2023), https://doi.org/10.1364/OPTICA.493732;
Is Holographic Data Storage the Next Big Thing, Discover Magazine, by Avery Hurt, Jan. 17, 2022, https://www.discovermagazine.com/technology/is-holographic-data-storage-the-next-big-thing;
Can Holographic Optical Storage Displace Hard Disk Drives? by Chu et al., Jun. 18, 2024, https://www.nature.com/articles/s44172-024-00225-0;
Time-Domain Holographic Digital Memory, Science, by Shen et al., Oct. 3, 1997, https://www.science.org/doi/10.1126/science.278.5335.96;
Can Holographic Optical Storage Displace Hard Disk Drives? by Chu et al., Jun. 18, 2024, https://www.nature.com/articles/s44172-024-00225-0;
Akonia Holographic Data Storage (HDS) Demonstration, Jan. 28, 2019, https://youtu.be/W6wAuOiiGsM?si=gVWjSneuCoSi0S_h;
Quantum CD’ could hold up to 1,000 times more data than today's optical disks, by Allison, Oct. 25, 2024, https://www.livescience.com/technology/computing/quantum-cd-could-hold-up-to-1-000-times-more-data-than-todays-optical-discs;
How Does Holographic Storage Work? by Microsoft Research, Sep. 12, 2020, https://youtu.be/4EADwGV5Gv8?si=fnd8VECkTguh4w9K;
InPhase Technologies, https://en.wikipedia.org/wiki/InPhase_Technologies;
Unveiling the Future: Holographic Data Storage Technology, by Julien Sudre, Nov. 25, 2023, https://medium.com/@julien.sudre/unveiling-the-future-holographic-data-storage-technology-419ae9913d67;
Optical storage arrays: a perspective for future big data storage, Light Science & Applications, by Gu et al., May 24, 2014, https://www.nature.com/articles/Isa201458;
True colors—a novel way of information storage using color lithography, Oct. 23, 2008, by Michael Berger, https://www.nanowerk.com/spotlight/spotid=7881.php;
Domain coloring: Visualizing #complex #functions, by Beauty in Math, Oct. 29, 2024, https://youtu.be/MpxA1YloEyA?si=MiH2UxjlQ_2BbpoW;
How to color complex functions [Domain Coloring], by Leios Labs, Jun. 27, 2020, https://youtu.be/EbanExb75mc?si=Nb-D8wzgT2khDMTN;
The Amazing Math behind Colors!—YouTube, by Kuvina Saydaki, Aug. 12, 2022, https://youtu.be/gnUYoQlpwes?si=diJnX9ew8UOk74Ky; and,
sRGB—Wikipedia, https://en.wikipedia.org/wiki/SRGB.
Photorefractive Effect—Wikipedia, https://en.wikipedia.org/wiki/Photorefractive_effect.
Static Random-Access Memory, https://en.wikipedia.org/wiki/Static_random-access_memory;
Dynamic Random-Access Memory, https://en.wikipedia.org/wiki/Dynamic_random-access_memory;
Resistive Random-Access Memory, https://en.wikipedia.org/wiki/Resistive_random-access_memory;
Phase-Change Memory, https://en.wikipedia.org/wiki/Phase-change_memory;
Parallel RAM, https://en.wikipedia.org/wiki/Parallel_RAM;
Flash Memory, https://en.wikipedia.org/wiki/Flash_memory;
Research Talk: Storing Data For Millennia, Oct. 27, 2022, https://youtu.be/V7L_wdEuQXs?si=DVBHylx_VSOTFDWt.

### Light Sources

The following articles relate to light sources for possible use in optical, electro-optical, and/or quantum computers:
Visible Light Communication: A System Perspective-Overview and Challenges, by Rehman et al., Mar. 7, 2019, https://www.ncbi.nlm.nih.gov/pmc/articles/pmid/30866473/;
Laser diode—Wikipedia, https://en.wikipedia.org/wiki/Laser_diode; Light-emitting diode—Wikipedia, https://en.wikipedia.org/wiki/Light-emitting_diode;
OLED—Wikipedia, https://en.wikipedia.org/wiki/OLED;
Liquid Crystal Display—Wikipedia, https://en.wikipedia.org/wiki/Liquid-crystal_display;
The future of photonic crystal surface-emitting lasers, Applied Physics Letters, AIP Publishing, Zhou et al., Oct. 4, 2023, https://pubs.aip.org/aip/apl/article/123/14/140501/2914636/The-future-of-photonic-crystal-surface-emitting;
Light Spectrum in Femtosecond—Wikipedia, https://en.wikipedia.org/wiki/Femtosecond;
Femtosecond Lasers, RP Photonics Encyclopedia, by Rüdiger Paschotta, no date, https://www.rp-photonics.com/femtosecond_lasers.html;
Tunable optical negative-index metamaterials employing anisotropic liquid crystals, by Wan et al., Oct. 4, 2007, https://engineering.purdue.edu/~shalaev/MURI/publications/Tunable_NIM_APL_91_(143122)_2007.pdf;
New nonlinear metamaterial is a million times better than traditional options, Research & Development World, by R&D editors, Jul. 2, 2014, https://www.rdworldonline.com/new-nonlinear-metamaterial-is-a-million-times-better-than-traditional-options/;
Materials For Infrared Optics, by Saaman, No date, https://wp.optics.arizona.edu/optomech/wpcontent/uploads/sites/53/2016/10/Saayman-521-Tutorial.pdf;
Prism (optics)—Wikipedia, https://en.wikipedia.org/wiki/Prism_(optics);
Beam Splitter—Wikipedia, https://en.wikipedia.org/wiki/Beam_splitter, and in particular the discussion therein entitled “Diffractive Beam Splitter,” “Reflection Beam Splitters,” “Application for Quantum Computing” and the “Knill, Laflamme and Milburn (KLM) protocol;” and,
Lens—Wikipedia, https://en.wikipedia.org/wiki/Lens.

### Mathematics, Music, and Light

Robert Edward Grant Documentary, by Robert Edward Grant, Dec. 3, 2020, https://youtu.be/cntQTIYoE4c?si=ZEdiUo_3yBIVPdWm;
The Universal Language of Mathematics and Music, by Gaia, Dec. 8, 2023, https://youtu.be/tlz-nrurlf4?si=8b7TOPbue9pEgobl;
The Geometry of Music, by the Harmonagom Project, May 23, 2017, https://youtu.be/ZWzwb4Bumk?si=4liXkvvWS7gTJumd;
The Simple Math of Music Theory, by Why These Notes—Adventures in Music Theory, May 30, 2021, https://youtu.be/AbfnDSplg0U?si=G5htJ1oJAUVluAlt;
The Circle of Fifths: Everything You Need to Know, by Brad Harrison Music, Sep. 10, 2020, https://youtu.be/AbfnDSplg0U?si=HN5U2wbOBNuH31QS;
Color Wheel Theory, The Circle of Fifths (5ths), and Sight Reading Music, by Color Wheel Music Theory, Jan. 7, 2013, https://youtu.be/Viue81moXis?si=0RLz67poE3YhAwHq;
The Math Behind Music and Sound Synthesis, by Gonkee, Mar. 21, 2021, https://youtu.be/Y7TesKMSE74?si=o7xQbuT4zM_2yWdt, and Binary Number, Wikipedia, https://en.wikipedia.org/wiki/Binary_number.

### Neural Networks

Articles about neural networks and classical, optical, electro-optical and/or quantum computers include:
Deep Learning With Coherent Nanophotonic Circuits, by Shen et al., Oct. 7, 2016, https://arxiv.org/pdf/1610.02365;
Design of optical neural networks with component imprecisions, by Fang et al., Dec. 13, 2019, https://arxiv.org/pdf/2001.01681;
Selection of Proper Neural Network Sizes and Architectures a comparative study, by Yu et al., Feb. 14, 2012, https://ieeexplore.ieee.org/document/6152147;
Optical neural network, Wikipedia, https://en.wikipedia.org/wiki/Optical_neural_network;
An optical neural chip for implementing complex-valued neural network, by Zhang et al., Jan. 19, 2021, https://www.nature.com/articles/s41467-020-20719-7;
The Diamond Mesh, A Phase-Error-And Loss-Tolerant Field-Programmable MZI-Based Optical Processor For Optical Neural Networks, by Shokraneh, et al., Aug. 3, 2020, https://pubmed.ncbi.nlm.nih.gov/32752345/;
Running Neural Networks On Meshes Of Light, by Asianometry, Aug. 11, 2022, https://youtu.be/t0yj4hBDUsc?si=lgb4MxlnSvXw_GK7;
Optical Memory and Neural Networks, Springer Link, Co-Editors-in-Chief Boris V. Kryzhanovsky, Victor A. Soifer, 03-xx-2024, https://link.springer.com/journal/12005;
Quantum Walks in Periodic and Quasiperiodic Fibonacci Fibers, by Nguyen et al., Feb. 28, 2020, https://doi.org/10.1038/s41598-020-64065-6;
Localization of Light in Photonics Lattices for All-Optical Representation of Binaries, by Nguyen et al., Aug. 17, 2021, https://www.frontiersin.org/journals/physics/articles/10.3389/fphy.2021.709428/full;
Computational Complexity of Mathematical Operations, Wikipedia, https://en.wikipedia.org/wiki/Computational_complexity_of_mathematical_operations; and
Addition is All You Need For Energy-Efficient Language Models, by Luo et al., Oct. 2, 2024, https://arxiv.org/pdf/2410.00907;
Chain rule (probability), https://en.wikipedia.org/wiki/Chain_rule_%28probability%29;
Probability and Decision Analysis: Principles and Network Representation, Ross D. Shachter, Reed College, Jul. 31, 1996, https://web.stanford.edu/~shachter/pubs/UAI96Tut.pdf;
Fractal—Wikipedia, https://en.wikipedia.org/wiki/Fractal; and,
Machine Learning—Wikipedia, https://en.wikipedia.org/wiki/Machine_learning.

### Optical Modulation Devices and Methods

The following articles relate to the development and possible use of optical modulator devices in optical, electro-optical, and/or quantum computers:
Understanding Modern Digital Modulation Techniques, Electronic Design, by Lou Frenzel, Jul. 14, 2021, https://www.electronicdesign.com/technologies/communications/article/21798737/electronic-design-understanding-modern-digital-modulation-techniques;
A full degree-of-freedom spatiotemporal light modulator, by Panuski et al., Nov. 28, 2022, https://www.nature.com/articles/s41566-022-01086-9;
Light Modulator, by Grand Illusions, Mar. 1, 2019, https://youtu.be/7bhlaeTFDzA?si=2_Nle7dx9Z6ymH2I;
The Light Modulator, by Make Science Run, Jun. 8, 2018, https://youtu.be/-rx779tOVrM?si=5Mf7SBZJk9CSIsmr;
Tim Davis—All optical modulation of light, by NanoFabTV, Jul. 14, 2014, https://youtu.be/bUDDEiCIOAo?si=Ndv5WRe9DMG8WaeL;
Visualizing Digital Modulation: ASK, FSK, BPSK, DPSK, QPSK and QAM, by Ian Collins, Sep. 2, 2024, https://youtu.be/8e4Sf6rL3zk?si=FxATGBD0mXrhpCWs;
Visualising Digital Communications: QAM with Real Signals, by Ian Explains, Signals, Systems, and Digital Communications, Sep. 30, 2024, https://youtu.be/8tAxhV3GeGc?si=yk7Kw6sTAsM6IMvW;
Understanding APSK and QAM, by Rhode Schwarz, Feb. 19, 2021, https://youtu.be/1xGncBvWv6U?si=3KZNS5R7YqHk64oN;
What Is QAM? by Huawei IP Encyclopedia, No Date, https://community.fs.com/encyclopedia/qam.html;
What is OTFS? Orthogonal Time Frequency Space Modulation (“Best video in youtube for OTFS”), by Ian Explains Signals, Systems, and Digital Comms, Sep. 26, 2024, https://youtu.be/MvK3zhPrGkk?si=Dk8VdfXEka5iwSMc;
Quadrature Amplitude Modulation (QAM): Explained, by Dave's Space, Aug. 31, 2022, https://youtu.be/1asY7-NZ93g?si=gdyn3MF60yiZMKvp;
Inside Wireless: QAM modulation (Quadrature Amplitude Modulation), by RF Elements S.R.O., May 12, 2020, https://youtu.be/lbUflaeJcU8?si=zRp65hYsAFy4BVaQ;
Inside Wireless: QAM modulation II—The Modulator, by RF Elements S.R.O., Mar. 21, 2021, https://youtu.be/YnWCRUoTEAI?si=u6QieUvO9qlno5Hx;
Different types of 802.11 Modulating Schemes, by Wireless LAN Professionals, Oct. 17, 2017, https://youtu.be/W5DMfEuY2Vg?si=vTns-rybisOzOo8-;
#171: IQ Signals Part II: AM and FM phasor diagrams, SSB phasing method, by W2aeu, Sep. 14, 2014, https://youtu.be/5GGD99Qi1PA?si=crgHqalk7EG8HF46;
Modulation, https://en.wikipedia.org/wiki/Modulation;
In-phase and quadrature components, https://en.wikipedia.org/wiki/In-phase_and_quadrature_components;
Mind your I's and Q's: The Basics of I/Q data, by Peter Barrett Bryan, Jan. 15, 2022, https://towardsdatascience.com/mind-your-is-and-q-s-the-basics-of-i-q-data-dlf2b0dd81f4;
Why is a Chirp Signal used in Radar? by Ian Explains, https://www.youtube.com/@iain_explains
New device can control light at unprecedented speeds, MIT News, Massachusetts Institute of Technology, by Adam Zewe, Nov. 28, 2022, https://news.mit.edu/2022/control-light-beam-holograms-1128;
RF Industries, https://rfindustries.com/pdfs/articles/Fiber-Optic-Cable-Types.pdf;
Dynamics of a liquid crystal-based modulator with germanium substrates for mid-infrared radiation, Liquid Crystals, Vol 48, No 7, by Resse et al., Nov. 3, 2020, https://www.tandfonline.com/doi/full/10.1080/02678292.2020.1839803;
Tiny spectral sensor handles 380-700 nm wavelength range, by WTWH editor, Sep. 25, 2015, https://www.sensortips.com/vision-systems/optics/tiny-spectral-sensor-handles-380-700-nm-wavelength-range/;
Optical Memory, Switching, and Neuromorphic Functionality in Metal Halide Perovskite Materials and Devices—Vats—2023—Advanced Materials—Wiley Online Library, by Vats et al., Sep. 19, 2022, https://onlinelibrary.wiley.com/doi/10.1002/adma.202205459;
Optical Modulator—Wikipedia, https://en.wikipedia.org/wiki/Optical_modulator;
Wavelength-Division Multiplexing, https://en.wikipedia.org/wiki/Wavelength-division_multiplexing;
Mutiwavelength Optical Networking, https://en.wikipedia.org/wiki/Multiwavelength_optical_networking;
Optical Transportation Network, https://en.m.wikipedia.org/w/index.php?title=Optical_transport_network&wprov=rarw1;
Spatial Light Modulator, https://en.wikipedia.org/wiki/Spatial_light_modulator;
Lithium Niobate, https://en.wikipedia.org/wiki/Lithium_niobate;
New device modulates visible light—without dimming it—with the smallest footprint and lowest power consumption, by Holly Evarts, Nov. 22, 2021, https://www.engineering.columbia.edu/news/new-device-modulates-visible-light-without-dimming-it-with-the-smallest-footprint-and-lowest-power-consumption;
Electro-optic modulator—Wikipedia, https://en.wikipedia.org/wiki/Electro-optic_modulator;
Electro-absorption modulator—Wikipedia, https://en.wikipedia.org/wiki/Electro-absorption_modulator;
Wavelength-division multiplexing—Wikipedia, https://en.wikipedia.org/wiki/Wavelength-division_multiplexing;
Multiplexing, Wikipedia, https://en.wikipedia.org/wiki/Multiplexing;
Multiplexor, Wikipedia, https://en.wikipedia.org/wiki/Multiplexer;
What is Multiplexer and Types of Multiplexing Techniques, by admin, Jan. 5, 2021, https://www.watelectronics.com/what-is-multiplexer-and-types/;
Optical Modulation (Chapter 10)—Principles of Photonics, by Jia Ming Lu, Aug. 5, 2016, https://www.cambridge.org/core/books/principles-of-photonics/optical-modulation/9BF9A9E46AD8106EF7E86D37A9E3FF51;
A full degree-of-freedom spatiotemporal light modulator, Nature Photonics, by Panuski et al., Nov. 28, 2022, https://www.nature.com/articles/s41566-022-01086-9;
Massively scalable Kerr comb-driven silicon photonic link, Nature Photonics (2023). DOI: 10.1038/s41566-023-01244-7, by Rizzo et al., Jun. 29, 2023, www.nature.com/articles/s41566-023-01244-7;
Refraction of light in gallium phosphide, Journal of Applied Spectroscopy, by Pikhtin et al., 08-xx-1977, https://link.springer.com/content/pdf/10.1007/bf00609497.pdf;
Temporary gratings on germanium, Semantic Scholar, by Wiggins et al., Oct. 15, 1974, https://www.semanticscholar.org/paper/Temporary-gratings-on-germanium-Wiggins-Salik/d9bd905c8f986895ab4f62aa64372ab21d879b09;
Tunable optical negative-index metamaterials employing anisotropic liquid crystals, by Wan et al., Oct. 4, 2007, https://engineering.purdue.edu/~shalaev/MURI/publications/Tunable_NIM_APL_91_(143122)_2007.pdf;
Picosecond transient orientational and concentration gratings in germanium, IEEE Journals & Magazine, by Smirl et al., 04-xx-1983, https://ieeexplore.ieee.org/abstract/document/1071920;
Gallium phosphide optical metasurfaces for visible light applications, Scientific Reports, by Melli et al., Nov. 26, 2020, https://www.nature.com/articles/s41598-020-77753-0;
Materials For Infrared Optics, by Saaman, No date, https://wp.optics.arizona.edu/optomech/wp-content/uploads/sites/53/2016/10/Saayman-521-Tutorial.pdf;
Temporary Gratings On Germanium, by Wiggins et al., Oct. 15, 1974, https://www.semanticscholar.org/paper/Temporary-gratings-on-germanium-Wiggins-Salik/d9bd905c8f986895ab4f62aa64372ab21d879b09;
Picosecond transient orientational and concentration gratings in germanium, IEEE Journals & Magazine, by Smirl et al., 04-xx-1983, https://ieeexplore.ieee.org/abstract/document/1071920; and
Gallium phosphide optical metasurfaces for visible light applications, Scientific Reports, by Melli et al., Nov. 26, 2020, https://www.nature.com/articles/s41598-020-77753-0;
Fiber Cables Direct.com, https://fibercablesdirect.com/;
Wavelet, https://en.wikipedia.org/wiki/Wavelet;
Wavelet Transform, https://en.wikipedia.org/wiki/Wavelet_transform;
Morlet Wavelet, https://en.wikipedia.org/wiki/Morlet_wavelet;
What is Wavelet and How We Use It for Data Science, by Ryan, May 31, 2019, https://towardsdatascience.com/what-is-wavelet-and-how-we-use-it-for-data-science-d19427699cef;
Optical Add-Drop Multiplexer, https://en.wikipedia.org/wiki/Optical_add-drop_multiplexer;
Add-Drop Multiplexer, https://en.wikipedia.org/wiki/Add-drop_multiplexer;
Streak Camera, https://en.wikipedia.org/wiki/Streak_camera;
Frequency-Resolved Optical Gating, https://en.wikipedia.org/wiki/Frequency-resolved_optical_gating;
Multiphoton Intrapulse Interference Phase Scan, https://en.wikipedia.org/wiki/Multiphoton_intrapulse_interference_phase_scan;
Real-space nanophotonic field manipulation using non-perturbative light-matter coupling, by Cortese et al., Dec. 23, 2022, https://opg.optica.org/optica/viewmedia.cfm?uri=optica-10-1-11&seq=0;
Recent Development of Tunable Optical Devices Based on Liquid, by Wu et al., Nov. 18, 2022, https://pmc.ncbi.nlm.nih.gov/articles/PMC9694320/pdf/molecules-27-08025.pdf;
Spectral Phase Interferometry For Direct Electric-Field Reconstruction, https://en.wikipedia.org/wiki/Spectral_phase_interferometry_for_direct_electric-field_reconstruction;
Optical Autocorrelation, https://en.wikipedia.org/wiki/Optical_autocorrelation;
Lens—Wikipedia, https://en.wikipedia.org/wiki/Lens;
Quantum Brilliance, Room Temperature Diamond Quantum Accelerators, https://quantumbrilliance.com/; and,
Lightsynq, Makes Diamond Photonic Quantum Interconnects, Why We Founded Lightsynq, https://www.lightsynq.com/;

### Optical Processors

Articles about optical and/or electro-optical processors or chips include:
IBM's Photonic Processor Shocks The Entire Industry, by Beyond, Feb. 10, 2023, https://youtu.be/pN26JY6tqso?si=mciAgkKmBW5RfYK1;
Quantum Computing With Light: The Breakthrough? by Sabine Hossenfelder, Oct. 7, 2023, https://youtu.be/7UkXJsF8_so?si=2S3iTllFxd7GhYSZ;
Analog Optical Computing For Sustainable AI and Beyond, by Microsoft Research, Sep. 3, 2024, https://youtu.be/gdJYMoZMKIY?si=U3095XDqyrqN-glM;
China's Rush Into Light-Based Semiconductors Threatens NVidia, CHIPS Act Fab Plants With Total Loss, by Inside China Business, Jun. 7, 2024, https://youtu.be/fk38BdJlujk?si=6g_RNUACDPHIjbKI;
China's Chip Revolution: Manufacturing Nightmare, by Anastasi in Tech, Aug. 29, 2024, https://youtu.be/D54gX9gTTzY?si=ylgMVLQSkHM8lvv6;
Novel Nanocomposisite-Superlattices for Low Energy And High Stability Nanoscale Phase Change Memory, by Wu et al., Jan. 22, 2024, https://www.nature.com/articles/s41467-023-42792-4;
Photonic chip enables faster and more energy-efficient artificial intelligence programs, by Columbia University School of Engineering and Applied Science, Jun. 29, 2023, https://phys.org/news/2023-06-photonic-chip-enables-faster-energy-efficient.html;
Optical RAM and integrated optical memories: a survey, Alexoudi et al., May 25, 2020, https://www.nature.com/articles/s41377-020-0325-9;
Optical Computing—Wikipedia, https://en.wikipedia.org/wiki/Optical_computing;
What is Optical Computing/Photonic Computing Explained (Light Speed Computing) By Futurology, Youtube, https://youtu.be/UWMEKex6nYA?si=hG8kew4W7DihC-B;
Quantum supremacy using a programmable superconducting processor, by Arute et al., Oct. 23, 2019, https://www.nature.com/articles/s41586-019-1666-5;
Copper Wires Have Already Failed Clustered AI Systems, by Timothy Prickett Morgan, Sep. 13, 2024, https://bit.ly/4esTYI1;
A Brain-Inspired Chip Can Run AI With Far Less Energy, Quanta Magazine, by Senor Salame, Nov. 10, 2022, https://nexth.city/news-technology/a-brain-inspired-chip-can-run-ai-with-far-less-energy-quanta-magazine;
Photonic ICs, Silicon Photonics & Programmable Photonics, by Wim Bogaerts, Gent University, Jan. 11, 2021, https://youtu.be/CBhdLTTbYoM?si=DDN0cY6c1Mlq396D;
Programmable Photonics—PhotonHUB Europe Course (September 2023), by Wim Bogaerts, Sep. 21, 2023, https://youtu.be/GmDFK7eyjuQ?si=cX7fCJ1T0wklZTDg;
A New Neuromorphic Chip for AI on the Edge, at a Small Fraction of the Energy and Size, by Patringenaru, Aug. 17, 2022, https://www.sciencedaily.com/releases/2022/08/220817114253.htm;
Akida Generations—BrainChip, https://brainchip.com/akida-generations/;
Electrochemical RAM, https://en.wikipedia.org/wiki/Electrochemical_RAM;
Time Crystal, https://en.wikipedia.org/wiki/Time_crystal;
Photonic Crystal, https://en.wikipedia.org/wiki/Photonic_crystal;
Sycamore Processor, https://en.wikipedia.org/wiki/Sycamore_processor;
New Photonic Chip Explained: Computing in Femtoseconds, Apr. 25, 2024, https://youtu.be/TJ8vywX9asU?si=Gbo32Si2Zm0p55ox;
China's Upgraded Light-Empowered ‘AGI Chip’ Is Now A Million Times More Efficient Than Before, Researchers Say, by Owen Hughes, Aug. 29, 2024, https://www.livescience.com/technology/computing/china-s-upgraded-light-powered-agi-chip-is-now-a-million-times-more-efficient-than-before-researchers-say;
Optical Transport Network—Wikipedia, https://en.wikipedia.org/wiki/Optical_transport_network;
Microchip Breakthrough: The Future is Glass, by Anastasi In Tech, Sep. 24, 2024, https://youtu.be/eOjmTExBWPE?si=t7ChK-OWHyn51smO; and,
Diamond-on-Chip-on-Glass Interposer for Efficient Thermal Management, by Zhong et al., Jan. 10, 2024, https://www.semanticscholar.org/paper/Heterogeneous-integration-of-interposer-for-Thermal-Zhong-Bao/5e5575fd62c1312e0457020e19fca0b795c05046/figure/0.

### Plasmonics

The following articles relate to the development and possible use of plasmonic devices in optical, electro-optical, and/or quantum computers:
Ten Years of Spasers and Plasmonic Nanolasers, by Azzam et al., Mar. 25, 2020, https://www.nature.com/articles/s41377-020-0319-7;
Plasmonic Properties of Individual Gallium Nanoparticles, The Journal of Physical Chemistry Letters, by Horak et al., https://pubs.acs.org/doi/10.1021/acs.jpclett.3c00094;
Plasmonic coupling in Close-Packed Ordered Gallium Nanoparticles, by Gomez et al, https://www.nature.com/articles/s41598-020-61090-3;
All-Color Plasmonic Nanolasers with Ultralow Thresholds: Autotuning Mechanism for Single-Mode Lasing, by Lu et al., Jul. 16, 2014, https://pubs.acs.org/doi/10.1021/nl501273u;
Excitation and propagation of surface plasmon polaritons on a non-structured surface with a permittivity gradient, by Wang et al., Jun. 8, 2016, https://www.nature.com/articles/Isa2016179;
Massive and massless plasmons in germanene nanosheets, Scientific Reports, by Pisarra et al., Nov. 3, 2022, https://www.nature.com/articles/s41598-022-23058-3;
Tunable plasmonic gallium nano liquid metal from facile and controllable synthesis, by Gao, 12-xx-2021, https://pubs.rsc.org/en/content/articlelanding/2021/mh/d1mh01101d#!;
Multicolor 3D meta-holography by broadband plasmonic modulation, Science Advances, by Lee et al., Nov. 4, 2016, https://www.science.org/doi/10.1126/sciadv.1601102;
Photonic metamaterial—Wikipedia, https://en.wikipedia.org/wiki/Photonic_metamaterial;
Review of Computer-Generated Hologram Algorithms for Color Dynamic Holographic Three-Dimensional Display, by Pi et al., Jul. 26, 2022, https://www.nature.com/articles/s41377-022-00916-3;
Multicolor 3D Meta-Holography By Broadband Plasmonic Modulation, by Li et al., Nov. 4, 2016, https://www.science.org/doi/10.1126/sciadv.1601102; and,
Jesse Rodriguez, Nov. 5, 2023, Optical Computing With Plasma: Stanford PHD Defense, https://youtu.be/Mdh2pLwsK8Y?si=CkKZsnSlaU36aoNC.

### Processor Development

‘World's purest silicon’ could lead to 1st million-qubit quantum computing chips, by Afifi-Sabet, May 7, 2024, https://www.livescience.com/technology/computing/worlds-purest-silicon-could-lead-to-1st-million-qubit-quantum-computing-chips;
Scalable on-chip multiplexing of silicon single and double quantum dots, by Bohyslavskyi et al., Oct. 7, 2024, https://www.nature.com/articles/s42005-024-01806-3;
In-Memory Processing, https://en.wikipedia.org/wiki/in-memory_processing;
MIT Engineers “Grow” Atomically Thin Transistors on Top of Computer Chips, by Zewe, Apr. 27, 2023, https://news.mit.edu/2023/mit-engineers-2d-materials-computer-chips-0427;
Diamond-on-Chip-on-Glass Interposer for Efficient Thermal Management, by Zhong et al., Jan. 10, 2024, https://www.semanticscholar.org/paper/Heterogeneous-integration-of-interposer-for-Thermal-Zhong-Bao/5e5575fd62c1312e0457020e19fca0b795c05046/figure/0;
AI Accelerator, (NPU), https://en.wikipedia.org/wiki/AI_accelerator;
Wafer (Electronics), https://en.wikipedia.org/wiki/Wafer_(electronics);
New Computing Breakthrough Achieves 100 Million Times GPU Performance, by Anastasi in Tech, Nov. 24, 2024, https://youtu.be/hJUHrrihzOQ?si=EM1iqUBMB17DRaCk;
Reducing Leakage of Single-Qubit Gates for Superconducting Quantum Processors Using Analytical Control Pulse Envelopes, by Eric Hyyppa et al., Sep. 19, 2024, https://journals.aps.org/prxquantum/abstract/10.1103/PRXQuantum.5.030353;
Combining quantum processors with real-time classical communication, by Vazquez, et al., Nov. 20, 2024, https://Inkd.in/emgiN_mS;
Semiconductor memory, https://en.wikipedia.org/wiki/Semiconductor_memory, Semiconductor Memory Design, Chapter 8 from Analysis and Design of Digital Integrated Circuits, 3rd Edition, 2024, by Hodges et al., McGraw Hill, https://highered.mheducation.com/sites/dl/free/0070593752/303325/Chapter_08.pdf,
Memory Design—Duke University, by James Morizio, Adapted from J. M. Rabaey, A. Chandrakasan and B. Nikolic, Digital Integrated Circuits, 2nd ed. 2003, https://people.ee.duke.edu/~jmorizio/ece261/classlectures/Memory_design.pdf.
How Logic Gates Work: OR, AND, XOR, NOR, NAND, XNOR, and NOT, by HTG Staff, May 27, 2021, https://www.howtogeek.com/devops/how-logic-gates-work-or-and-xor-nor-nand-xnor-and-not/; and,
Logic Gates Explained: AND, OR, NOT, XOR, NAND, NOR, XNOR, Logic Gates—The Foundation of Digital Circuits, by Amansour Blog, Sep. 23, 2024, https://amansour.me/blog/logic-gates-explained-and-or-not-xor-nand-nor-xnor/.

### Sound and Other Modulation Techniques

Cymatics, https://en.wikipedia.org/wiki/Cymatics;
Ultra-broadband optical detection from the visible to the terahertz range using a miniature quartz tuning fork, by Lui et al., 2022, https://opg.optica.org/ol/abstract.cfm?uri=ol-47-7-1875;
Brillouin Scattering—Wikipedia, https://en.wikipedia.org/wiki/Brillouin_scattering;
100 years of Brillouin scattering: Historical and future perspectives, by Merklein et al., Nov. 10, 2022, https://pubs.aip.org/aip/apr/article/9/4/041306/2835396/100-years-of-Brillouin-scattering-Historical-and;
Integrated microwave photonic notch filter using a heterogeneously integrated Brillouin and active-silicon photonic circuit, by Garrett et al., Nov. 20, 2023, https://www.nature.com/articles/s41467-023-43404-x; and,
Acousto-optic modulator—Wikipedia, https://en.wikipedia.org/wiki/Acousto-optic_modulator.
Pulse-Amplitude Modulation, https://en.wikipedia.org/wiki/Pulse-amplitude_modulation; Pulse-Width Modulation, https://en.wikipedia.org/wiki/Pulse-width_modulation;
Pulse-Position Modulation, https://en.wikipedia.org/wiki/Pulse-position_modulation; Pulse-Code Modulation, https://en.wikipedia.org/wiki/Pulse-code_modulation; and
Fusor—Wikipedia, https://en.wikipedia.org/wiki/Fusor.

### Companies Making Optical, Electro-Optical, Quantum Computers or Related Components

Articles, videos, or websites relating to some of the major universities and companies exploring the use of optical, electro-optical, and/or quantum computers include:
Amazon Q, a generative AI-powered assistant for businesses and developers, is now generally available, by Amazon Staff, Apr. 30, 2024, https://www.aboutamazon.com/news/aws/amazon-q-generative-ai-assistant-aws;
New AMD Patent Proposes Teleportation to Make Quantum Computing More Efficient, by Pires, Aug. 30, 2021, https://www.tomshardware.com/news/amd-teleportation-quantum-computing-patent;
AMD Instinct™ MI300X Accelerators, https://www.amd.com/en/products/accelerators/instinct/mi300/mi300x.html;
Introducing Apple Intelligence, the Person Intelligence System that Puts Powerful Generative Models at the Core of the iPhone, Jun. 10, 2024, https://www.apple.com/newsroom/2024/06/introducing-apple-intelligence-for-iphone-ipad-and-mac/;
Ayar Labs: Solving AI System Bandwidth Bottlenecks with Optical I/O, https://ayarlabs.com/;
Transforming AI with Optical IO Technology Ayar Labs, https://ayarlabs.com/;
AyarLabs Solution Brief, In-Package Optical IO for Generative AI Architectures, https://ayarlabs.com/; and, also relating to Ayar Labs see the following article:
Copper Wires Have Already Failed Clustered AI Systems, by Timothy Prickett Morgan, published Sep. 13, 2024, https://bit.ly/4esTYI1;
Sivers Website, https://www.sivers-semiconductors.com/;
About Us—Aspinity, https://www.aspinity.com/about-us/;
Cerebras, https://cerebras.ai/company/;
D-Wave Systems|The Practical Quantum Computing Company, https://www.dwavesys.com/;
Ushering in the Thermodynamic Future, by Fuillaume Verdon and Trevor McCort, Mar. 11, 2024, https://www.extropic.ai/;
Quantum Computer|Google Quantum AI, https://quantumai.google/quantumcomputer;
Google's Cloud TPU v4 Provides exaFLOPS-scale ML with Industry-leading Efficiency, bu Jouppi and Patterson, Apr. 5, 2023, https://cloud.google.com/blog/topics/systems/tpu-v4-enables-performance-energy-and-co2e-efficiency-gains;
Gemini, AI by Google, https://gemini.google.com/?hl=en-GB;
The AI Revolution: Google's Developers on The Future of Artificial Intelligence|60 Minutes, Apr. 15, 2023, https://youtu.be/880TBXMuzmk?si=jSV1Eo-zWzN2nLdB;
Quantum|Honeywell, https://www.honeywell.com/us/en/company/quantum;
Home|Hamamatsu Photonics, https://www.hamamatsu.com/;
Artificial Intelligence (AI) Solutions|IBM, https://www.ibm.com/artificial-intelligence;
Intel® Gaudi® 3 AI Accelerator, https://www.intel.com/content/www/us/en/products/details/processors/ai-accelerators/gaudi3.html;
We build quantum computers.|IQM, https://www.meetiqm.com/;
Integrated Photonics|Transitioning to End-to-End Optical I/O, Intel, https://www.intel.com/content/www/us/en/research/integrated-photonics.html;
Lightelligence, https://www.lightelligence.ai/;
Lightmatter®—The photonic (super)computer company, https://lightmatter.co/;
Optalysys—Fully Homomorphic Encryption (FHE), https://optalysys.com/;
Qubitekk—Quantum Components & Systems for Quantum Technology Markets, https://qubitekk.com/;
Intel Labs|The Future Begins Here, https://www.intel.com/content/www/us/en/research/overview.html;
Intel® Gaudi® 3 AI Accelerator, https://www.intel.com/content/www/us/en/products/details/processors/ai-accelerators/gaudi3.html;
Quantum Photonics Laboratory, RLE at MIT, Home, https://qp.mit.edu/;
Quantum Motion company, https://quantummotion.tech/;
Mythic, Inc. of Austin, Texas and Redwood City, California has a website: Power-efficient analog compute for edge AI—Mythic, https://www.mythic.ai/;
Who we are—STMicroelectronics, https://www.st.com/content/st_com/en/about/st_company_information/who-we-are.html;
LIGENTEC|Photonic Integrated Circuits Manufacturing—LIGENTEC, https://www.ligentec.com/;
IPG Photonics, https://www.ipgphotonics.com/;
CUDA, by NVIDIA, https://en.wikipedia.org/wiki/CUDA;
Nvidia reveals Blackwell B200 GPU, the ‘world's most powerful chip’ for AI, by Hollister, Mar. 18, 2024, https://www.theverge.com/2024/3/18/24105157/nvidia-blackwell-gpu-b200-ai;
NKT Photonics—NKT Photonics, https://www.nktphotonics.com/;
Sivers Photonics of Glascow, Scotland: https://www.sivers-semiconductors.com/sivers-photonics/;
Teem Photonics—Advanced Laser and Optical Waveguide Products, https://www.teemphotonics.com/;
Home—Photonic, https://photonic.com/;
NeoPhotonic is now part of Lumentum|Lumentum Operations LLC, https://www.lumentum.com/en/neophotonics-products;
Home|ORCA Computing, https://orcacomputing.com/;
Photons and quantum computing Santa Barbara, No Author, No Date, https://engineering.ucsb.edu/sites/engineering.ucsb.edu/files/images/Convergence-Spring2021/Photons_and_quantum_computing.pdf;
PsiQuantum, https://www.psiquantum.com/;
Tesla Dojo, https://en.wikipedia.org/wiki/Tesla_Dojo;
Xanadu|Welcome to Xanadu, https://www.xanadu.ai/;
Xanadu/From a state of light to state of the art, the photonic path to millions of qubits, by Tzitrin et al., Oct. 30, 2020, https://www.xanadu.ai/blog/from-a-state-of-light-to-state-of-the-art-the-photonic-path-to-millions-of-qubits.

Ayer Labs Inc. of San Jose, California has a website: https://ayerlabs.com and the following patents and patent applications: U.S. Pat. No. 10,630,393 B2 by Wade et al., U.S. Pat. No. 10,641,939 B2 by Fini et al., U.S. Pat. No. 10,670,807 B2 by Meade et al., U.S. Pat. No. 11,156,773 B2 by Lu et al., U.S. Pat. No. 11,209,597 B2 by Fini et al., U.S. Pat. No. 11,424,830 B2 by Sun et al., U.S. Pat. No. 11,569,914 by Sysak, U.S. Pat. No. 11,700,068 B2 by Sysak et al., U.S. Pat. No. 11,705,972 B2 by Meade et al., U.S. Pat. No. 11,762,154 B2 by Raval et al., U.S. Pat. No. 11,799,544 B2 by Sun et al., U.S. Pat. No. 11,822,128 B2 by Ardalan et al., U.S. Pat. No. 11,823,990 B2 by Meade, U.S. Pat. No. 11,867,944 B2 by Meade et al., U.S. Pat. No. 11,899,251 B2 by Zhang et al., U.S. Pat. No. 11,914,203 B2 by Davenport et al., U.S. Pat. No. 11,982,887 B2 by Buchbinder et al., U.S. Pat. No. 11,994,724 B2 by Wright et al., U.S. Pat. No. 12,019,269 B2 by Meade et al., U.S. Pat. No. 12,057,332 B2 by Sun et al., U.S. Pat. No. 12,072,532 B2 by Bhargava et al., U.S. 20190271819 A1 by Meade et al., U.S. 20190317288 A1 by Fini et al., U.S. 20200021079 A1 by Meade et al., U.S. 20200158961 A1 by Fini et al., U.S. 20220155538 A1 by Fini et al., U.S. 20200158950 A1 by Meade et al., U.S. 20220214502 A1 by Fini et al., U.S. 20220214509 A1 by Fini et al., U.S. 20220163723 A1 by Mead, U.S. 20220166533 A1 by Stojanovic et al., U.S. 20200264390 A1 by Wade et al., U.S. 20220045780 A1 by Stojanovic et al., U.S. 20220326441 A1 by Sapra et al., U.S. 20220328705 A1 by Vercruysse et al., U.S. 20230194782 A1 by Fini et al., U.S. 20230224047 A1 by Sysak et al., U.S. 20230275671 A1 by Raval et al., U.S. 20230291493 A1 by Raval et al., U.S. 20230296836 A1 by Raval, U.S. 20230345655 A1 by Meade et al., U.S. 20230352897 A1 by Popovic et al., U.S. 20230393424 A1 by Kita et al., U.S. 20230408767 A1 by Kita et al., U.S. 20240302609 A1 by Fini et al., WO 2020205556 A1 by Bhargava et al., and WO 2021016486 A1 by Wright et al., and all of the patents and patent applications recited in this paragraph are hereby incorporated by reference herein.

Robert Englund of MIT is associated with the following patents and patent applications: U.S. Pat. No. 7,778,296 B1 by Vuckovic et al., U.S. Pat. No. 9,588,416 B2 by Englund et al., U.S. Pat. No. 9,709,440 B2 Englund et al., U.S. Pat. No. 9,766,181 B2 by Englund et al., U.S. Pat. No. 10,126,509 B2 by Mower et al., U.S. Pat. No. 10,158,481 B2 by Bunandar et al., U.S. Pat. No. 10,261,389 B2 by Skirlo et al., U.S. Pat. No. 10,648,933 B2 by Clevenson et al., U.S. Pat. No. 10,648,934 B2 by Kim et al., U.S. Pat. No. 10,429,718 B2 by Pant et al., U.S. Pat. No. 10,522,326 B2 by Walsh et al., U.S. Pat. No. 10,648,933 B2 by Clevenson et al., U.S. Pat. No. 10,648,934 B2 by Kim et al., U.S. Pat. No. 10,649,306 B2 by Skirlo et al., U.S. Pat. No. 11,022,826 B2 by Panuski et al., U.S. Pat. No. 11,042,073 B2 by Peng et al., U.S. Pat. No. 11,054,590 B1, by Wan et al., U.S. Pat. No. 11,120,360 B2 by Kim et al., U.S. Pat. No. 11,373,089 B2 by Englund, U.S. Pat. No. 11,522,117 B2 Englund er al., U.S. Pat. No. 11,585,870 B2 by Kim et al., U.S. Pat. No. 11,604,978 B2 by Hamerly et al., U.S. Pat. No. 11,614,643 B2 by Peng et al., U.S. Pat. No. 11,790,221 B2 by Carolan et al., U.S. Pat. No. 11,853,847 B2 by Choi et al., U.S. Pat. No. 11,860,458 B2 by Panuski et al., U.S. Pat. No. 11,956,017 B2 by Bersin et al., U.S. 20170352538 A1 by Kim et al., U.S. 20180335574 A1 by Steinbrecker et al., U.S. 20200348579 A1 by Heuck et al., U.S. 20210057135 A1 by Choi et al., U.S. 20220091474 A1 by Choi et al., U.S. 20220137169 A1 by Englund et al., U.S. 20220146322 A1 by Fong et al., U.S. 20220146749 A1 by Bandyopadhyay et al., U.S. 20220197225 A1 by Trusheim et al., U.S. 20220215281 A1 by Englund et al., U.S. 20220236113 A1 by Goldstein et al., U.S. 20220269972 A1 by Bandyopadhyay et al., U.S. 20220337333 A1 by Bernstein et al., U.S. 20220397383 A1 by Hamerly et al., U.S. 20230208628 A1 by Krastanov et al., U.S. 20230274156 A1 by Hamerly et al., U.S. 20230281437 A1 by Davis et al., U.S. 20230288637 A1 by Hermans et al., U.S. 20230342650 A1 by Chen et al., U.S. 20230351168 A1 by Basani et al., U.S. 20240069368 A1 by Panuski et al., U.S. 20240118537 A1 by Dong et al., AU 2017273863 B2 by Harris et al., WO 2017143160 A1 by Englund, WO 2019164638 A2 by Ibrahim et al., WO 2021015839 A1 by Choi et al., WO 2022246197 A2 by Gobadi et al., WO 2024030690 A2 by Chen et al., WO 2020102160 A2 by Carolan et al., WO 2020149927 A1 by Goldstein, and all of the patents and patent applications recited in this paragraph are hereby incorporated by reference herein.

InPhase Technologies, Inc. was a company located in Longmont, Colorado that pioneered the development holographic memory storage devices which failed due to mismanagement, e.g., see https://en.wikipedia.org/wiki/InPhase_Technologies. The company was associated with the following patents and patent applications that were acquired by Akonia Holographics, LLC in 2012, and then by Apple, Inc. in 2018: U.S. Pat. No. 7,739,577 B2 by Earhart et al., U.S. Pat. No. 7,167,286 B2 by Anderson et al., U.S. Pat. No. 8,062,809 B2 by Trentler et al., U.S. Pat. No. 7,209,270 B2 by Curtis, U.S. Pat. No. 7,848,595 B2 by Ayres et al., U.S. Pat. No. 8,133,639 B2 by Cole et al., U.S. Pat. No. 8,053,147 B2 by Stockel et al., U.S. Pat. No. 8,323,854 B2 by Askham, U.S. Pat. No. 8,786,923 B2 by Chuang et al., U.S. Pat. No. 9,715,426 B2, by Curtis et al., U.S. Pat. No. 7,678,507 B2 by Cole et al., U.S. Pat. No. 7,879,509 B2 by Stockel et al., U.S. Pat. No. 9,190,803 B2 by Hunter et al., U.S. Pat. No. 8,311,067 B2 by Ensher et al., U.S. Pat. No. 7,633,662 B2 by Riley et al., U.S. Pat. No. 7,495,838 B2 by Krneta et al., U.S. Pat. No. 7,466,411 B2 by Riley et al., U.S. Pat. No. 7,397,571 B2 by Krneta et al., U.S. Pat. No. 8,199,388 B2 by Chuang et al., U.S. Pat. No. 7,742,211 B2 by Riley et al., U.S. Pat. No. 8,305,700 B2 by Riley et al., U.S. Pat. No. 7,548,358 B2 by Riley et al., U.S. Pat. No. 7,710,624 B2 by Fotheringham et al., U.S. Pat. No. 7,480,085 B2 by Riley et al., U.S. Pat. No. 7,173,744 B1 by Whiteside et al., U.S. Pat. No. 7,638,755 B2 by Ayres et al., U.S. 20080259421 A1 by Curtis et al., U.S. 20050270856 A1 by Earhart et al., U.S. Pat. No. 8,254,418 B2 by Smith et al., U.S. 20060280096 A1 by Riley et al., U.S. 20080239428 A1 by Bell et al., U.S. 20080059144 A1 by Earhart et al., U.S. 20060275670 A1 by Riley et al., U.S. 20060281021 A1 by Riley et al., U.S. 20120281514 A1 by Ayres et al., U.S. 20080102378 A1 by Cole et al., U.S. Pat. No. 7,623,279 B1 by Ayres, U.S. Pat. No. 7,483,189 B2 by Matsumura et al., U.S. Pat. No. 8,004,950 B2 by Ide et al., U.S. Pat. No. 7,981,987 B2 by Stockel et al., U.S. 20060279819 A1 by Krneta et al., U.S. 20060291022 A1 by Redmond et al., U.S. 20100020373 A1 by Askham, U.S. 20090207710 A1 by Ayres et al., U.S. Pat. No. 7,336,409 B2 by Sissom, U.S. 20070091399 A1 by lhas et al., U.S. Pat. No. 7,773,276 B2 by Hoskins et al., U.S. 20070127100 A1 by Wilson et al., U.S. 20070115523 A1 by Matsumura et al., U.S. 20070248890 A1 by Cole et al., U.S. 20060166104 A1 by Setthachayanon et al., U.S. 20070091768 A1 by Hori et al., U.S. 20080030826 A1 by Sissom et al., U.S. 20070160106 A1 by Hunter et al., U.S. Pat. No. 7,079,296 B2 by Anderson, U.S. Pat. No. 7,738,153 B2 by Harris et al., U.S. Pat. No. 7,471,429 B2 by Kogure et al., U.S. Pat. No. 7,649,661 B2 by Chuang et al., U.S. 20090018687 A1 by Harris et al., U.S. Pat. No. 7,990,830 B2 by Shimada et al., U.S. Pat. No. 8,023,549 B2 by Miyata et al., U.S. 20090103416 A1 by Smith et al., U.S. 20070242589 A1 by Redmond et al., U.S. 20070283369 A1 by Schoenfeld et al., U.S. Pat. No. 7,739,701 B1 by Hertrich et al., U.S. Pat. No. 8,120,832 B2 by Ernst et al., U.S. 20070171495 A1 by Kogure et al., U.S. 20070082179 A1 by Wade et al., U.S. 20070019692 A1 by Kogure et al., U.S. 20070019267 A1 by Kogure et al., U.S. 20100014133 A1 by Whiteside et al., U.S. 20090046334 A1 by Curtis et al., U.S. Pat. No. 6,482,551 B1 by Dhar et al., U.S. Pat. No. 6,765,061 B2 by Dhar et al., U.S. Pat. No. 6,780,546 B2 by Trentler et al., U.S. Pat. No. 6,721,076 B2 by King et al., U.S. Pat. No. 7,116,626 B1 by Woods et al., U.S. Pat. No. 6,788,443 B2 by Ayres et al, U.S. Pat. No. 7,295,356 B2 by King, U.S. Pat. No. 6,825,960 B2 by Curtis et al., U.S. Pat. No. 7,492,691 B2 by Earhart, U.S. Pat. No. 6,856,461 B2 by Curtis, U.S. 20030206320 A1 by Cole et al., U.S. Pat. No. 6,697,180 B1 by Wilson et al., U.S. Pat. No. 7,229,741 B2 by Setthachayanon et al., U.S. Pat. No. 5,892,601 by Curtis et al., U.S. Pat. No. 6,018,402 by Campbell et al., U.S. Pat. No. 6,700,686 B2 by King et al., U.S. Pat. No. 5,808,998 by Curtis et al., U.S. 20030128324 by Woods et al., U.S. 20050089795 A1 by Cole et al., U.S. 20050018316 A1 by Curtis et al., U.S. Pat. No. 7,112,359 B2 by Dhar et al., U.S. Pat. No. 7,184,383 B2 by Ayres et al., U.S. Pat. No. 7,001,541 B2 by Dhar, U.S. Pat. No. 6,735,002 B2 by Ayres, U.S. 20030189740 A1 by Hoogland et al., U.S. Pat. No. 7,474,413 B2 by Hertrich, U.S. Pat. No. 6,847,498 B2 by Curtis et al., U.S. Pat. No. 7,435,941 B2 by Ayres, U.S. 20050248817 A1 by Weaver et al., U.S. Pat. No. 6,695,213 B2 by Curtis, U.S. Pat. No. 6,914,704 B2 by Shuman, U.S. Pat. No. 7,020,885 B2 by Hertrich, U.S. Pat. No. 7,738,736 B2 by Pharris, U.S. Pat. No. 6,831,762 B2 by Schuck et al., U.S. Pat. No. 7,391,593 B2 by Hertrich, U.S. Pat. No. 6,798,547 B2 by Wilson et al., U.S. Pat. No. 6,061,154 by Campbell et al., U.S. Pat. No. 5,973,806 by Campbell et al., U.S. 20030151783 A1 by Schuman, U.S. 20050146762 A1 by Hoogland et al., U.S. 20030076765 A1 by Ayres et al., U.S. 20060082850 A1 by Weaver et al., U.S. Pat. No. 6,081,912 by Richardson, U.S. Pat. No. 5,943,145 by Curtis et al., WO 2008125201 A1 by Stoeckel, et al., WO 2008125202 A1 by Stoeckel et al., WO 03014178 A1 by Setthachayanon et al., WO 03102959 A1 by Setthachayanon et al., WO 2009009182 A1 by Harris et al., WO 2008027882 A2 by Sissom et al., WO 2006130391 A3 by Earhart et al., WO 2005047988 A1 by Curtis et al., WO 03019239 A2 by Dhar et al., WO 2005052926 A1 by Ayres et al., EP 2390731 B1 by Curtis et al., EP 0817201 B1 by Campbell et al., JP 2012-164412 A by Curtis, J P 2010-151907 A by Ishii et al., and all of the patents and patent applications recited in this paragraph are hereby incorporated by reference herein.

Lightelligence, Inc. of Boston, Massachusetts has a website: https://www.lightelligence.ai and the following patents and patent applications: U.S. Pat. No. 11,657,262 B2 by Khoury et al., U.S. Pat. No. 11,719,963 B2 by Lu et al., U.S. Pat. No. 11,734,556 B2 by Meng et al., U.S. Pat. No. 11,907,832 B2 by Shen et al., 12,025,862 B2 by Shen et al., U.S. 20200110992 A1 by Hosseinzadeh et al., U.S. 20220004029 A1 by Meng et al., U.S. 20220179159 A1 by Wu et al., WO 2020191217 A1 by Meng et al., and WO 2020149953 A1 by Hosseinzadeh et al., and all of the patents and patent applications recited in this paragraph are hereby incorporated by reference herein.

Lightmatter, Inc. of Boston, Massachusetts has a website: https://www.lightmatter.co and the following patents and patent applications: U.S. Pat. No. 10,359,272 B2 by Mower et al., U.S. Pat. No. 10,608,663 B2 by Gould et al., U.S. Pat. No. 10,884,313 B2 by Gould, U.S. Pat. No. 11,256,029 B2 by Kannan et al., U.S. Pat. No. 11,367,711 B2 by Harris et al., U.S. Pat. No. 11,686,902 B2 by Dora-Quinones et al., U.S. Pat. No. 11,695,378 B2 by Harris et al., U.S. Pat. No. 11,768,662 B1 by Harris et al., U.S. Pat. No. 11,860,413 B2 by Harris et al., U.S. Pat. No. 11,860,666 B2 by Bundandar et al., U.S. Pat. No. 11,886,942 B2 by Kenney et al., U.S. Pat. No. 11,936,434 B2 by Bundandar et al., U.S. Pat. No. 11,899,967 B2 by Moore et al., U.S. Pat. No. 12,033,065 B2, by Kenney et al., U.S. 20190354894 A1 by Lazovich et al., U.S. 20190356394 A1 by Bunandar et al., U.S. 20210089906 A1 by Lazovich, U.S. 20210125066 A1 by Lazovich, U.S. 20210157211 A1 by Harris et al., U.S. 20210242124 A1 by Kannan et al., U.S. 20210286128 A1 by Harris, U.S. 20210333818 A1 by Harris et al., U.S. 20220036185 A1 by Dronen et al., U.S. 20220043474 A1 by Bunandar et al., U.S. 20220147280 A1 by Bunandar et al., U.S. 20220156469 A1 by Wang et al., U.S. 20220172052 A1 by Bunandar et al., U.S. 20220229634 A1 by Hein et al., U.S. 20220261645 A1 by Dronen et al., U.S. 20220374575 A1 by Raney et al., U.S. 20220405450 A1 by Bunandar et al., U.S. 20230067275 A1 by Gupta et al., U.S. 20230071600 A1 by Harris et al., U.S. 20230085268 A1 by Harris et al., U.S. 20230110047 A1 by Bunandar, U.S. 20230111197 A1 by Ramey et al., U.S. 20230114842 A1 by Harris et al., U.S. 20230177284 A1 by Bunandar et al., U.S. 20230314711 A1 by Eslampour et al., U.S. 20230352465 A1 by Harris et al., U.S. 20240045464 A1 by Turner et al., U.S. 20240063936 A1 by Bunandar et al., U.S. 20240159967 A1 by Bunandar, U.S. 20240178923 A1 by Bunandar et al., U.S. 20240201444 A1 by Chao et al., U.S. 20240248260 A1 by Prabhu et al., U.S. 20240248950 A1 by Widemann et al., U.S. 20240264395 A1 by Harris et al., U.S. 20240310593 A1 by Turner et al., U.S. 20240310867 A1 by Gould et al., D1,002,984 S by Harris et al., U.S. D1,016,057 S by Harris et al., U.S. D1,018,522 S by Harris et al., CA 3,182,916 by Tremblay, EP 4,414,899 A1 by Arrazola et al., and EP 4,421,690 A1 by Larsen et al., and all of the patents and patent applications recited in this paragraph are hereby incorporated by reference herein.

Mythic, Inc. of Austin, Texas and Redwood City, California has a website: https://www.mythic.ai and the following patents and patent applications are associated with David Fink, Laura Fink, Michael Henry and/or Mythic, Inc: U.S. Pat. No. 8,276,014 B2 by Fojtik et al., U.S. Pat. No. 8,381,155 B1 by Fick et al., U.S. Pat. No. 8,407,025 B2 by Blaauw et al., U.S. Pat. No. 9,335,972 B2 by Yang et al., U.S. Pat. No. 9,760,533 B2 by Fick et al., U.S. Pat. No. 10,255,551 B2 by Fick et al., U.S. Pat. No. 10,409,889 B2 by Fick et al., U.S. Pat. No. 11,049,586 B2 by Parikh et al., U.S. Pat. No. 11,068,641 B1 by Wu et al., U.S. Pat. No. 11,615,165 B2 by Fick et al., U.S. Pat. No. 11,626,884 B2 by Fick et al., U.S. Pat. No. 11,726,925 B2 by Fick et al., U.S. Pat. No. 12,014,214 B2 by Parikh et al., U.S. 20210143832 A1 by Fick et al., U.S. 20110202786 A1 by Fotjik et al., U.S. 20210287077 A1 by Morten et al.,U.S. 20220276983 A1 by Fick et al., and U.S. 20230359571 A1 by Fick et al., and all of the patents and patent applications recited in this paragraph are hereby incorporated by reference herein.

Optalysys of Leeds, England has a website: https://www.optalysis.com and the following patents and patent applications: U.S. Pat. No. 8,610,839 B2 by New et al., U.S. Pat. No. 10,289,151 B2 by New, U.S. Pat. No. 10,409,084 B2 by New et al., 11,062,101 B2 by New et al., U.S. Pat. No. 12,033,066 B2 by Macfaden, U.S. 20200387013 A1 by Palani, U.S. 20230076393 A1 by Cottle et al., U.S. 20230291552 A1 by Michel, U.S. 20230375784 A1 by Todd, WO 9931563 by Wilkinson, WO 2020245436 A1 by Palani, WO 2022053825 A2 by Kundu et al., WO 2023170406 A1 by Kundu, WO 2024184545 A1 by Todd et al., and all of the patents and patent applications recited in this paragraph are hereby incorporated by reference herein.

PsiQuantum of Palo Alto, California has a website https://www.PsiQuantum.com and the following patents and patent applications: U.S. 20200333179 A1 by Chung et al., U.S. Pat. No. 11,101,215 B2, by Najafi et al., U.S. Pat. No. 12,056,571 B2 by Nickerson et al., U.S. 20190189816 A1 by Najafi et al., U.S. Pat. No. 11,847,020 B1 by Nickerson et al., U.S. Pat. No. 11,880,115 B2 by Wang, U.S. Pat. No. 12,095,462 B2 by Najafi, U.S. Pat. No. 12,056,572 B2 by Nickerson et al., U.S. Pat. No. 11,823,012 B2 by Gimeno-Segovia et al., U.S. Pat. No. 11,502,237 B2 by Najafi et al., U.S. Pat. No. 12,015,383 B2 by Najafi et al., U.S. Pat. No. 11,988,554 B2 by Najafi et al., U.S. 20240357946 A1 by Najafi, U.S. Pat. No. 11,742,956 B2 by Gimeno-Segovia et al., U.S. 20200303615 A1 by Najafi, U.S. Pat. No. 12,026,587 B2 by Pant, U.S. 20230213380 A1 by Thompson et al., U.S. Pat. No. 11,936,380 B2 by Najafi, U.S. Pat. No. 10,879,905 B2 by Najafi et al., U.S. Pat. No. 11,108,172 B2 by Najafi et al., U.S. Pat. No. 11,029,203 B2 by Najafi et al., U.S. Pat. No. 9,235,101 B2 by Silverstone et al., U.S. Pat. No. 11,646,803 B2 by Rudolf et al., U.S. Pat. No. 11,698,570 B2 by Vidrighin et al., U.S. Pat. No. 10,197,440 B2 by Najafi, U.S. Pat. No. 12,079,688 B2 by Gimeno-Segovia, U.S. Pat. No. 9,952,482 B2 by Rudolf et al., U.S. Pat. No. 11,972,794 B2 by Najafi, U.S. Pat. No. 9,103,975 B2 by Yu et al., U.S. Pat. No. 11,947,242 B1 by Kieling et al., U.S. Pat. No. 11,475,347 B1 by Rudolf et al., U.S. 20220224996 A1 by Nickerson et al., U.S. 20240303522 A1 by Doherty et al., U.S. Pat. No. 11,892,693 B1 by Mendoza et al., U.S. Pat. No. 11,536,897 B1 by Thompson et al., U.S. Pat. No. 12,100,701 B1 by Alapati et al., U.S. Pat. No. 11,874,496 B2 by Ravi et al., U.S. Pat. No. 11,892,715 B2 by Liang et al., U.S. Pat. No. 11,531,248 B2 by Cable, U.S. Pat. No. 10,627,696 B1 by Chang et al., U.S. 20210278708 A1 by Kumar, U.S. Pat. No. 11,314,143 B2 by Vidrighin et al., U.S. 20210242651 A1 by Dudley et al., U.S. Pat. No. 11,573,375 B2 by Kumar, U.S. Pat. No. 10,677,985 B2 by Nickerson et al., U.S. Pat. No. 11,275,210 B1 by Thompson, U.S. 20220357514 A1 by Kumar, U.S. 20230366913 A1 by Kamineni et al., U.S. Pat. No. 11,501,198 B1 by Birchall et al., U.S. 20210278595 A1 by Kumar, U.S. Pat. No. 11,194,095 B2 by Nickerson et al., U.S. 20240248259 A1 by Nickerson et al., U.S. 20230418011 A1 by Kovall et al., U.S. Pat. No. 11,994,758 B1, by Gibson, U.S. 20230349067 A1 by Liang et al., U.S. Pat. No. 12,130,195 B2 by Snyder et al., U.S. Pat. No. 11,994,428 B1 by Najafi, U.S. 20210278738 A1 by Kumar, U.S. 20230128679 A1 by Wang, U.S. 20230179159 A1 by Stone, U.S. Pat. No. 12,055,755 B1 by Dudley, U.S. Pat. No. 11,558,069 B1 by Sparrow, U.S. Pat. No. 11,569,816 B1 by Najafi et al., U.S. Pat. No. 11,793,090 B1 by Najafi, U.S. 2022/0244583 A1 by Liang et al., U.S. 20230243674 A1 by Gimeno-Segovia, U.S. Pat. No. 11,099,211 B1 by Najafi et al., U.S. Pat. No. 11,940,834 B1 by Nickerson et al., U.S. Pat. No. 11,635,570 B1 by Thompson, U.S. 20230010363 A1 by Cable, U.S. 20220156625 A1 by Pant, U.S. 20230152520 A1 by Johansson, U.S. 20240242100 A1 by Nickerson et al., U.S. 20230152611 A1 by Thompson et al., U.S. Pat. No. 11,719,653 B1, by Najafi et al., U.S. Pat. No. 12,066,661 B2 by Bonneau et al., U.S. Pat. No. 11,703,316 B2 by Ravi, U.S. 20220129779 A1 by Moores et al., U.S. 20230123000 A1 by Kamineni et al., U.S. 20240303521 A1 by Gimeno-Segovia et al., U.S. Pat. No. 11,747,567 B2 by Smith et al., U.S. Pat. No. 11,302,528 B2 by Liang et al., U.S. Pat. No. 11,980,105 B2 by Najafi et al., U.S. 20230297866 A1 by Litinski, U.S. 20180210985 A1 by Johnson, U.S. 20240310582 A1 by Park et al., U.S. Pat. No. 11,817,400 B2 by Liang et al., 20220037145 A1 by Liang et al., U.S. Pat. No. 12,019,354 B2 by Thompson et al., U.S. 20240322019 A1 by Gibson, U.S. 20240168906 A1 by Litinski, U.S. Pat. No. 11,799,020 B1 by Najafi et al., U.S. 20230021995 A1 by Cable, U.S. Pat. No. 10,574,222 B1 by Izadi, U.S. Pat. No. 11,783,967 B1 by Stone et al., U.S. Pat. No. 11,994,426 B1 by Najafi et al., U.S. Pat. No. 11,972,320 B1 by Wang, U.S. Pat. No. 12,141,658 B2 bu Litinski, U.S. Pat. No. 12,149,242 B1 by Gimeno-Segovia et al., WO 2024072487 A3 by Krogen, WO 2024216038 A1 by Lostagilo et al., WO 2023163994 A9 by Melnichuk et al., WO 2023055828 A1 by Rudolf et al., WO 2023172720 A1 by Licausi et al., WO 2023183357 A1 by Rodriguez et al., CA 3112785 C by Rudolf, WO 2023056082 A1 by Fenrich et al., WO 2024054459 A3 by Benyamini et al., WO 2024054460 A3 by Vert et al., WO 2023220442 A1 by Cable et al., WO 2024182458 A1 by Gimeno-Segovia et al., GB 2530500 B by Barreto et al., WO 2023220345 A1 by Schiff et al., WO 2024020060 A1 by Vert et al., WO 2024173851 by Sim et al., WO 2023044101 A1 by Dudley et al., WO 2024112559 A3 by Winget, GB 2588330 B by Barreto, GB 2599048 B by Rudolf et al., WO 2024148294 A1 by Cable, WO 2024112572 A1 by Licausi et al., WO 2024081818 A1 by Thompson et al., WO 2024215387 A2 by Desai et al., WO 2023056086 A1 by Koval et al., WO 2023122348 A1 by Pant, WO 2023055829 A1 by Cable, WO 2024112606 A1 by Weigel et al., WO 2024205668 A2 by Ravi et al., WO 2024118516 A1 by Hu et al., WO 2024112680 A3 by Hosler et al., WO 2024177648 A3 by Rudolf, WO 2023220076 A1 by Moores et al., WO 2023220442 A1 by Cable et al., WO 2924072487 A3 by Krogen, WO 2024054261 A3 by Thompson et al., WO 2024155947 A1 by Dudley et al., WO 2024155732 A1 by Benyamini et al., WO 2023220345 A1 by Schiff et al., WO 2023220441 A1 by Cable et al., WO 2024112560 A1 by Sukumaran et al., WO 2024151861 A1 by Sukumaran et al., WO 2024155600 A1 by Weigel, and WO 2024167869 A1 by Liu et al., and all of the patents and patent applications recited in this paragraph are hereby incorporated by reference herein.

Qubitekk of Vista, California has a website: https://www.qubitekk.com and the following patents and patent applications: U.S. Pat. No. 8,611,534 B2 by Finlayson et al., U.S. Pat. No. 8,650,401 B2 by Wiseman et al., U.S. Pat. No. 8,654,979 B2 by Hicks, U.S. Pat. No. 8,683,192 B2 by Ayling et al., U.S. Pat. No. 8,693,685 B2 by Tapster, U.S. Pat. No. 8,639,932 B2 by Wiseman et al., U.S. Pat. No. 8,681,982 B2 by Wiseman et al., U.S. Pat. No. 8,749,875 B2 by Benton et al., U.S. Pat. No. 8,755,525 B2 by Wiseman, U.S. Pat. No. 8,762,728 B2 by Wiseman, U.S. Pat. No. 8,768,992 B2 by Tapster et al., U.S. Pat. No. 8,792,791 B2 by Wiseman et al., U.S. Pat. No. 8,855,316 B2 by Wiseman et al., U.S. Pat. No. 8,885,828 B2 by Wiseman et al., U.S. Pat. No. 9,692,595 B2 by Lowans et al., U.S. Pat. No. 9,148,225 B2 by Lowans et al., U.S. 20170052427 A1 by Earl et al., U.S. Pat. No. 10,355,857 B2 by Earl, U.S. Pat. No. 11,586,092 B2 by Earl, U.S. 20100085678 A1 by Jefferson et al., and all of the patents and patent applications recited in this paragraph are hereby incorporated by reference herein.

Xanadu Quantum Technologies of Toronto, Canada has a website: https://www.xanadu.ai and the following patents and patent applications: U.S. Pat. No. 10,067,719 B1 by Newman, U.S. Pat. No. 10,158,483 B1 by Newmann, U.S. Pat. No. 10,176,202 B1 by Newman, U.S. Pat. No. 10,275,400 B1 by Newman, U.S. Pat. No. 10,649,307 B2 by Vernon et al., U.S. Pat. No. 10,809,592 B2 by Dutt et al., U.S. Pat. No. 11,003,046 B2 by Liscidini et al., U.S. Pat. No. 11,125,773 B2 by Guha et al., U.S. Pat. No. 11,156,773 B2 by Lu et al., U.S. Pat. No. 11,209,597 B2 by Fini et al., U.S. Pat. No. 11,454,862 B2 by Bradler et al., U.S. Pat. No. 11,543,668 B2 by Bradler et al., 11,762,154 B2 by Raval et al., U.S. Pat. No. 11,815,696 B2 by Sabapathy et al., U.S. Pat. No. 11,982,887 B2 by Buchbinder et al., U.S. Pat. No. 11,989,620 B2 by Dhand et al., U.S. Pat. No. 12,033,030 B2 by Killoran et al., U.S. 20190278854 A1 by Newman, U.S. 20200136809 A1 by Newman et al., U.S. 20210096443 A1 by Dhand et al. U.S. 20210192381 A1 by Ijaz et al., U.S. 20220155538 A1 by Fini et al., U.S. 20220163723 A1 by Meade, U.S. 20220166533 A1 by Stojanovic et al., U.S. 20220196382 A1 by Dhand et al., U.S. 20230130156 A1 by Miatto et al., U.S. 20230177374 A1 by Bradler et al., U.S. 20230224047 A1 by Sysak et al., U.S. 20230042040 A1 by Arrazola et al., U.S. 20230042396 A1 by Dhand et al., U.S. 20230169382 A1 by Bourassa et al., U.S. 20230198632 A1 by Madsen et al., U.S. 20230275671 A1 by Raval et al., U.S. 20230291493 A1 by Raval et al., U.S. 20230384523 A1 by Liscidini et al., U.S. 20220391571 A1 by Dhand et al., U.S. 20230408767 A1 by Kita et al., U.S. 20230281499 A1 by Bourassa et al., U.S. 20240028943 A1 by Izaac et al., U.S. 20240053615 A1 by Sabapathy et al., U.S. 20240169235 A1 by Arrazola et al., U.S. 20240175760 A1 by Tremblay, U.S. 20240184043 A1 by Krasnokutska et al., U.S. 20240184044 A1 by Krasnokutska et al., U.S. 20240214078 A1 by Zhang et al., U.S. 20230387647 A1 by Zhang et al., WO 2021016486 A1 by Wright et al., CA 3,055,860 by Sabapathy et al., CA 3,046,887 by Killoran et al., CA 3,182,916 by Tremblay, EP 4,375,887 A1 by Alexander et al., EP 4,414,899 A1 by Arrazola et al., and EP 4,421,690 A1 by Larsen et al., and all of the patents and patent applications recited in this paragraph are hereby incorporated by reference herein.

The following Clauses provide exemplary methods of making a computer language, and/or exemplary methods of communicating a computer language, and/or at least one exemplary computer language, but also exemplary optical keyboards and optical game controllers for use with electronic computers, optical computers, electro-optical computers, and/or quantum computers.

Clause 1: A method of making a computer language comprising providing a dictionary comprising a list comprising a plurality of member alphabetical letters and/or words and/or numbers and/or symbols, each member of said plurality being represented by a corresponding wave form comprising a specific frequency and wavelength.

Clause 2: The method of making a computer language according to clause 1, wherein said wave form is in the electromagnetic spectrum.

Clause 3: The method of making a computer language according to clause 1, wherein said wave form comprises a photonic wave in the visible light spectrum and/or invisible portion of the infrared light spectrum.

Clause 4: The method of making a computer language according to clause 1, wherein said wave form comprises a sine wave.

Clause 5: The method of making a computer language according to clause 1, wherein said wave form comprises an electronic wave.

Clause 6: The method of making a computer language according to clause 1, wherein said wave form comprises a square wave.

Clause 7: The method of making a computer language according to clause 1, wherein said wave form comprises a product of data compression.

Clause 8: The method of making a computer language according to clause 1, wherein said list of alphabetic letters and/or words further comprises a plurality of sub-lists comprising the following categories: noun, verb, adjective, adverb, pronoun, preposition, conjunction, determiner, and exclamation.

Clause 9: The method of making a computer language according to clause 1, wherein said plurality of member numbers are represented by a first wave form comprising a first frequency and wavelength which represents the base portion of a specific number, and a second wave form comprising a second frequency and wavelength which represents the exponent portion of said specific number, whereby the value of said specific number can be represented and communicated.

Clause 10: The method of making a computer language according to clause 9, wherein a difference exists in time and/or space between the start of said first wave form and said second wave form and said second wave form is substantially identical in amplitude and shape to said first wave form, but said second wave form is phase shifted relative to said first wave form, and said first wave form represents the base portion of said specific number, and the amount to which said second wave form is phase shifted in time and/or space represents the value of the exponent corresponding to said specific number, whereby the value of said specific number can be represented and communicated.

Clause 11: The method of making a computer language according to clause 1, wherein the absence of a break between two of said plurality of member numbers which are represented and/or communicated in a series represents a mathematic function comprising addition.

Clause 12: The method of making a computer language according to clause 1, wherein the absence of a break between two of said plurality of member numbers which are represented and/or communicated in a series represents a mathematical function comprising multiplication.

Clause 13: The method of making a computer language according to clause 1, wherein a break between two of said plurality of member letters and/or words and/or numbers and/or symbols represents a separation between said plurality member letters and/or words and/or numbers and/or symbols.

Clause 14: The method of making a computer language according to clause 1, wherein the presence of a wave form representing a symbol disposed between two of said plurality of member numbers represents a mathematical function and operation between said member numbers.

Clause 15: A method of making a computer language for representing any positive number using the values and numbers 0, 1, 2, 2^{nth} exponential power, 3, and 3^{nth} exponential power and/or a sum of two or more of said values and numbers.

Clause 16: A method of making a computer language for representing and communicating values or numbers each comprising a base portion comprising one or more of the following 0, 1, 2, 3, 4, 5, 6, 7, 8, 9, and an exponent portion, said base portion being represented and communicated by a wave form comprising a first frequency and wavelength, said exponent portion being represented by a second wave form comprising a second frequency and wavelength, wherein a difference exists in time and/or space between the start of said first wave form and said second wave form, and said second wave form is substantially identical in amplitude and shape to said first wave form, and said second wave form is phase shifted relative to said first wave form, and the amount to which said second wave form is phase shifted in time and/or space represents and communicates the exponent, whereby said values or numbers can be represented and communicated.

Clause 17: The method of making a computer language for representing and communicating a plurality of values or numbers according to clause 16, wherein said first wave form and said second wave form comprise square waves.

Clause 18: The method of making a computer language for representing and communicating a plurality of values or numbers according to clause 16, wherein said first wave form and said second wave form comprise sine waves.

Clause 19: The method of making a computer language for representing and communicating a plurality of values or numbers according to clause 16, wherein said first wave form and said second wave form comprise different frequencies and wavelengths.

Clause 20: A method of making a computer language for representing and communicating a value or number in a known base number system, said value or number having a base portion equal to said known base number in said known base number system and an exponent portion comprising a value obtained from a list comprising a table of algorithms, said known base number in said known base number system and said exponent portion being configured to be manipulated by a mathematical function by which a resultant wave form having a specific wavelength is derived to represent and communicate said value or number.

Clause 21: The method of making a computer language according to clause 20, wherein said base number in said known base number system comprises the number 10 in the base 10 number system.

Clause 22: The method of making a computer language according to clause 20, wherein said base number in said known base number system comprises the natural logarithm value e.

Clause 23: An optical keyboard configured to communicate data and information using visible light and/or infrared light.

Clause 24: An optical game controller configured to communicate data and information using visible light and/or infrared light.

Clause 25: A computer keyboard comprising means for producing an output comprising photons and a plurality of sine waves in the visible light spectrum and/or invisible portion of the infrared light spectrum, said output comprising representations of a plurality of alphabetical letters and/or words and/or numbers and/or symbols and/or commands and/or functions and/or operations, said output being communicated by fiber optic cable to a computer, said computer selected from the group of computers consisting of an electronic computer, an optical computer, an electro-optical computer, and a quantum computer.

Clause 26: A method of communicating a computer language comprising providing a dictionary comprising a list comprising a plurality of member alphabetical letters and/or words and/or numbers and/or symbols, each of said plurality of member alphabetical letters and/or words and/or numbers and/or symbols being represented by a corresponding wave form comprising a specific frequency and wavelength.

Clause 27: A computer language comprising a dictionary comprising a list comprising a plurality of member alphabetical letters and/or words and/or numbers and/or symbols, each of said plurality of member alphabetical letters and/or words and/or numbers and/or symbols being represented by a corresponding wave form comprising a specific frequency and wavelength.

Clause 28: A method of making a computer language comprising selecting a value or number X in a base number system comprising a logarithmic function and expression Logⁿ=X, where b is the base portion of a number in said base number system, and where n is the exponent portion of said number in said base number system to which b is raised to produce said value or number X, taking and using n as a first factor, and multiplying n by at least a second factor to yield a specific frequency and associated wavelength comprising a portion of the electromagnetic spectrum.

Clause 29: The method according to clause 28, further including at least a third factor which is randomly generated, and the multiplication of said first factor n and said second factor and said third factor yields said frequency and associated wavelength comprising a portion of the electromagnetic spectrum.

Clause 30: The method according to clause 28, wherein said portion of the electromagnetic spectrum comprises a portion of the visible light spectrum and/or infrared light spectrum.

Clause 31: A method of making a computer language comprising selecting a plurality of wave forms corresponding to specific frequencies and associated wavelengths in the visible light spectrum and/or invisible portion of the infrared light spectrum, and combining at least two of said plurality of wave forms corresponding to specific frequencies and wavelengths to create a coding point.

Clause 32: The method according to clause 31, wherein at least four of said plurality of wave forms are combined to create a coding point.

Clause 33: The method according to clause 31, wherein said coding point is used to represent at least one of an alphabetical letter, a word, a number, a symbol, a command, a function, and an operation.

Clause 34: The method according to clause 31, wherein said at least two of said plurality of wave forms are combined to comprise a plurality of sets, said plurality of sets being disposed in series and/or in parallel to provide a plurality of coding points.

Clause 35: The method according to clause 34, wherein the number of permutations of said plurality of coding points corresponds to the formula: Permutations=(Number of Sets)!/(Number of Sets−2)!, and the number of combinations of said coding points corresponds to the formula: Combinations=(Number of Sets)!/2!×(Number of Sets−2)!Clause 36: A computer non-transitory readable medium which configures at least one of an optical computer, an electro-optical computer, and/or a quantum computer comprising a power supply, at least one input device, at least one output device, a processor device, a memory device, and/or a combined processor and memory device to cause said least one input device to receive a first plurality of different wavelengths and corresponding frequencies of visible and/or invisible light configured to directly represent and encode a first plurality of data and information comprising at least one of an alphabetical letter, a word, a symbol, a number, or an image, and/or to cause said at least one output device to send or transmit a second plurality of different wavelengths and corresponding frequencies of visible and/or invisible light configured to directly represent and encode a second plurality of data and information comprising at least one of an alphabetical letter, a word, a symbol, a number, or an image, and/or to cause said processor device, said memory device, and/or said combined processor and memory device to manipulate said first plurality of data and information and/or said second plurality of data and information and to perform processing of and/or perform processing relating to said first plurality of data and information and/or said second plurality of data and information and/or to cause said first plurality of data and information and/or said second plurality of data and information and/or the result of said processing to be persisted or stored in said memory device and/or said combined processor and memory device.

Clause 37: The computer non-transitory readable medium according to clause 36, wherein said first plurality of data and information and/or said second plurality of data and information comprises an optical pattern selected from the group of optical patterns comprising a linear optical pattern, a circular optical pattern, or other two-dimensional optical pattern, a holographic optical pattern, or other three-dimensional optical pattern, and a four-dimensional optical pattern in which time is the fourth dimension.

Clause 38: The computer non-transitory readable medium according to clause 37, wherein said optical pattern is used or manipulated to perform computations or other computer operations or functions.

Clause 39: The computer non-transitory readable medium according to clause 36, wherein said first plurality of different wavelengths and corresponding frequencies of visible and/or invisible light and/or said second plurality of different wavelengths and corresponding frequencies of visible and/or invisible light comprising a signal, said signal comprising at least one of a continuous or discontinuous signal type, said signal type further comprising at least one of a sinusoidal wave form, a sine wave, a cosine wave, a square wave, a triangular wave, a sawtooth wave, a wavelet, a Morlet wavelet, a pulse, and a Gaussian pulse.

Clause 40: The computer non-transitory readable medium according to clause 36, wherein said at least one input device and/or said at least one output device comprises a plurality of optical channels, and said first plurality of data and information is configured to be received in parallel and/or in serial or a sequence, and/or said second plurality of data and information is configured to be sent or transmitted in parallel and/or in series or a sequence, and said first plurality of data and information and/or said second plurality of data and information is correlated to said plurality of optical channels in order to create, establish or encode and/or to determine, decode or decipher an identifiable sequence, whereby said first plurality of data and information and/or said second plurality of data and information is configured to be received in parallel, and is also further configured to be rendered and/or manipulated in series or a sequence with the use of said identifiable sequence.

Clause 41: The computer non-transitory readable medium according to clause 37, wherein said optical pattern further encodes a binary number system representation and encoding of at least one of an alphabetical letter, a word, a symbol, a number, or an image.

Clause 42: The computer non-transitory readable medium according to clause 37, wherein said optical pattern comprises a constellation configuration associated with a type of modulation, and said first plurality of different wavelengths and corresponding frequencies of visible and/or invisible light and/or said second plurality of different wavelengths and corresponding frequencies of visible and/or invisible light comprising a signal, said signal comprising at least one of a continuous or discontinuous signal type, said signal type further comprising at least one of a sinusoidal wave form, a sine wave, a cosine wave, a square wave, a triangular wave, a sawtooth wave, a wavelet, a Morlet wavelet, a pulse, and a Gaussian pulse, and said signal is configured to be modulated with the use of wavelength and frequency modulation and/or phase shifting modulation and/or amplitude modulation and/or a by a combination of two or more of said signal types, and said modulated signal is configured to be transmitted by at least one of a wire, a fiber optic cable or other waveguide, or wirelessly.

Clause 43: The computer non-transitory readable medium according to clause 37, wherein said optical pattern is configured to represent and encode a number comprising a base portion, and an index, a place holder value, or an exponential value.

Clause 44: The computer non-transitory readable medium according to clause 37, wherein said circular optical pattern comprises a center and at least one position or point located at a radial distance from said center, wherein said at least one position or point is configured to represent and encode a number in the range between and including 0-9.

Clause 45: The computer non-transitory readable medium according to clause 44, wherein said at least one position or point which is used to represent and encode said number in the range between and including 0-9 is further configured using a wavelength and corresponding frequency of visible and/or invisible light which is also used to represent and encode said number, whereby both said optical pattern associated with said position or point, and also said wavelength and corresponding frequency of visible and/or invisible light which is disposed at said position or point represent and encode said number.

Clause 46: The computer non-transitory readable medium according to clause 44, wherein said at least one position or point comprises a set or group of 4 positions or points located at said radial distance from said center which correspond to 4 binary number system digits which each represent and encode either a one (1) or a zero (0) and which together represent and encode said number in the range between and including 0-9.

Clause 47: The computer non-transitory readable medium according to clause 46, wherein said circular optical pattern is used or manipulated to perform mathematical computations.

Clause 48: The computer non-transitory readable medium according to clause 39, wherein said signal is manipulated to comprise half wave rectification and/or full wave rectification.

Clause 49: The computer non-transitory readable medium according to clause 39, wherein said signal is configured to be analyzed for error using one or more of the following: determining with a sine wave unit circle equation whether said first signal and/or said second signal is consistent with cos² x+sin² x=1, error correction code (ECC), block codes, convolutional codes, forward error control (FEC), channel codes, An codes, Algebraic geometry code, BCH code, Barker code, Berger code, Burst error-correcting code, Constant-weight code, Convolutional code, Expander codes, Group codes, Golay codes, Binary Golay code, Goppa code, Hadamard code, Hagelbarger code, Hamming code, Latin square based code Lexicographic code, Linear Network coding, Long code, Low-density parity-check code, Gallager code, LT code, Fountain code, M of N codes, Nordstrom-Robinson code, Online code, Polar code, Raptor code, Reed-Solomon error correction, Reed-Muller code, Repeat-accumulate code, Repetition codes such as Triple modular redundancy, Spinal code, and Tornado code.

Clause 50: The computer non-transitory readable medium according to clause 36, wherein said first plurality of different wavelengths and corresponding frequencies of visible and/or invisible light comprises a first wavelength and corresponding frequency of visible and/or invisible light which comprises a first point, and a second wavelength and corresponding frequency of visible and/or invisible light which comprises a second point, and said first point and said second point are entangled and in superposition, and/or said third plurality of different wavelengths and corresponding frequencies of visible and/or invisible light comprises a third wavelength and corresponding frequency of visible and/or invisible light and comprises a third point, and said fourth plurality of different wavelengths and corresponding frequencies of visible and/or invisible light comprises a fourth wavelength and corresponding frequency of visible and/or invisible light and comprising a fourth point, and said third point and said fourth point are entangled and in superposition.

Clause 51: The computer non-transitory readable medium according to clause 50, wherein said first point and said second point are entangled and in superposition because said first wavelength and corresponding frequency of visible and/or invisible light and said second wavelength and corresponding frequency of visible and/or invisible light both originated from the same light source, and/or were manipulated by a prism, a diffraction grating, a filter, or other optical device or method performing optical manipulation, and said third point and said fourth point are entangled and in superposition because said third wavelength and corresponding frequency of visible and/or invisible light and fourth wavelength and corresponding frequency of visible and/or invisible light both originated from the same light source, and/or were manipulated by a prism, a diffraction grating, a filter, or other optical device or method of performing optical manipulation, wherein said entanglement and said superposition of said first point with said second point and/or said entanglement and said superposition of said third point with said fourth point is configured to perform at least one computation or other computer operation or function.

Clause 52: The computer non-transitory readable medium according to clause 50, wherein said first wavelength and corresponding frequency of visible and/or invisible light and said second wavelength and corresponding frequency of visible and/or invisible light comprise sinusoidal wave forms comprising the same amplitude, and the maximum peak positive amplitude of said first point, said second point, and/or said third point, and said fourth point is configured to represent and encode white and a presence of all colors and all wavelengths and corresponding frequencies within the visible and/or invisible light spectrums, and the maximum peak negative amplitude of said first point, said second point, and/or said third point, and said fourth point is configured to represent and encode black or a dark color or no colors or wavelengths and corresponding frequencies within said visible and/or invisible light spectrums, and/or no data and information, and the range of said all colors and all wavelengths and corresponding frequencies within said visible and/or invisible light spectrums are in the range between and including said maximum peak negative amplitude and said maximum peak positive amplitude, and said range is configured to be used to represent and encode and to manipulate said data and information in order to perform computations, and other computer operations or functions.

Clause 53: An optical computer, and/or an electro-optical computer, and/or a quantum computer comprising a power supply, an input device and/or output device comprising at least one light source and a plurality of optical signal channels configured to receive and/or to send or transmit a plurality of different wavelengths and corresponding frequencies of visible and/or invisible light which directly represent and encode data and information comprising at least one of an alphabetical letter, a word, a sentence, a symbol, a number, or an image, at least two of said plurality of different wavelengths and corresponding frequencies being entangled and in superposition, and a processor device, an optical memory device, and/or a combined optical processor and memory device comprising a holographic memory device, or a glass or crystal memory device.

Clause 54: The optical computer, and/or an electro-optical computer, and/or a quantum computer according to clause 53, wherein said light source comprises at least one of a laser, a femtosecond laser, a laser diode, a micro laser diode, a LED, and a micro laser LED.

Clause 55: The optical computer, and/or an electro-optical computer, and/or a quantum computer according to clause 53, further comprising at least one of a lens, a filter, a shutter, a beam shaper, a beam splitter, a loop, a polarizer, a mirror, a prism, a diamond, a diffraction grating, a camera, a photodetector, a photodetector array, a CMOS photodetector, a spatial light modulator, a multiplexer, a demultiplexer, a wave division multiplexer, an Optical Add Drop Multiplexer (OADM), a transceiver, a transponder, an analog to digital converter, a digital to analog converter, an optical switch, an optical splitter, an optical amplifier, an Erbium doped fiber amplifier, a Raman amplifier, a waveguide, an optical processor device, an optical logic processor device, a wire, a fiber optic cable, a waveguide, an optical connection.

Clause 56: The optical computer, and/or an electro-optical computer, and/or a quantum computer according to clause 53, wherein said optical memory device further comprises at least one of a holographic memory device, a holographic glass or crystal memory device, an optical disk memory device, a cache memory, a RAM memory, a ROM memory, an image, photo, video, or a film memory, a magnetic or optical tape memory, a color coded memory, a DNA color coded memory, a red, green blue (RGB) color coded memory, a sRGB color coded memory.

Clause 57: The optical computer, and/or an electro-optical computer, and/or a quantum computer according to clause 53, wherein said input device and/or said output device comprises at least one of a keyboard, a mouse, a microphone, a voice recognition device or voice command, a camera, a photodetector, a photodetector array, a CMOS device, a video camera, a CD disk, a DVD disk, an optical disk, a holographic optical disk, a magnetic tape, an optical tape, an optical film, an analog to digital converter, a digital to analog converter, a multiplexer, a demultiplexer, a wave division demultiplexer, a transponder, a transceiver, a computer monitor, a computer touchscreen monitor, an oscilloscope, a spectrum analyzer, a Solid State Drive (SSD), a removable Flash drive, a wire, waveguide, a fiber optic cable, a wireless device, a computer printer.

Clause 58: The optical computer, and/or an electro-optical computer, and/or a quantum computer according to clause 53, wherein said holographic memory device and/or combined processor and holographic memory device comprises a geometric shape selected from the group of three-dimensional geometric shapes consisting of a cube, a cylinder, a cone, a sphere, a triangular prism, a pentagonal prism, a hexagonal prism, an octagonal prism, or other polyhedron structure.

Clause 59: The optical computer, and/or an electro-optical computer, and/or a quantum computer according to clause 58, wherein the data and information corresponding to a specific subject area or field is configured to be persisted or stored in close proximity and within a specific defined range of said plurality of wavelengths and corresponding frequencies in the visible light spectrum and frequencies in the infrared light spectrum.

Clause 60: The optical computer, and/or an electro-optical computer, and/or a quantum computer according to clause 53, wherein said data and information comprises an optical pattern or array in said holographic memory device, and/or said combined processor and holographic memory device.

Clause 61: A holographic memory device for use with an optical computer, and/or an electro optical computer, and/or a quantum computer comprising: a holographic storage medium comprising a geometric shape comprising a top surface, a bottom surface, at least one inside surface extending between said top surface and said bottom surface, said inside surface defining an opening, and at least one outside surface extending between said top surface and said bottom surface; at least one optical detector device disposed proximate to said at least one outside surface; at least one light source, at least one beam splitter, and at least one mirror disposed in said opening proximate to said at least one inside surface comprising at least one data beam and at least one reference beam for sending or transmitting and/or for retrieving data and information to and from said holographic storage medium for the purpose of persisting or storing said data and information and/or retrieving said data and information from said holographic storage medium.

Clause 62: The holographic memory device according to clause 61, further comprising at least one of a base, a beam shaper, a lens, a filter, a shutter, a loop, a polarizer, a prism, a diamond, a diffraction grating, a camera, a photodetector, a photodetector array, a CMOS photodetector, a spatial light modulator, a multiplexer, a demultiplexer, a wave division multiplexer, an Optical Add Drop Multiplexer (OADM), a transceiver, a transponder, an analog to digital converter, a digital to analog converter, an optical switch, an optical splitter, an optical amplifier, an Erbium doped fiber amplifier, a Raman amplifier, a waveguide, an optical processor device, an optical logic processor device, a wire, a fiber optic cable, a waveguide, an optical connection, a positive electrical lead, and a negative electrical ground lead.

Clause 63: The holographic memory device according to clause 61, further comprising a turret disposed proximate a middle of said opening, said turret comprising said at least one light source and said at least one beam splitter and said at least one mirror, at least one of said turret, said at least one light source, said at least one beam spitter, and said at least one mirror configured to move such that a plurality of data beams and/or a plurality of reference beams are configured to be selectively directed to said holographic storage medium.

Clause 64: The holographic memory device according to clause 61, wherein said holographic storage medium comprises a plurality sections or portions, each of said plurality of sections or portions comprising a portion of said at least one inside surface and also a portion of said at least one outside surface, said turret comprising a plurality of sides corresponding to the number of said plurality of sections or portions, each of said plurality of sides of said turret comprising said at least one light source, said at least one beam splitter, and said at least one mirror, whereby a plurality of said sections or portions of said holographic storage medium can be simultaneously placed in optical communication with said plurality of data beams and/or said plurality of reference beams which comprise a plurality of optical channels, and at least a portion of one of said sections or portions is configured to provide cache memory, and at least a portion of one of said sections or portions is configured to provide read only memory (ROM) memory, and at least a portion of one of said sections or portions is configured to provide random access memory (RAM) memory.

Clause 65: The holographic memory device according to clause 61, further comprising a processor device.

Clause 66: The holographic memory device according to clause 65, wherein said processor device comprises an optical processor device and/or optical logic processor device which is disposed proximate to said holographic memory device, and said optical processor device and/or optical logic processor device comprises at least one direct optical connection to said holographic memory device, a positive electrical lead, and a negative electrical or ground lead.

Clause 67: The holographic memory device according to clause 64, wherein said holographic storage medium comprises an octagonal configuration and said at least one inside surface comprises eight inside surface portions, and said turret comprises eight sides each comprising said at least one light source which is capable of providing a data beam and/or reference beam to each of said eight inside surface portions of said holographic storage medium.

Clause 68: The holographic memory device according to clause 61, wherein said at least one light source comprises at least one wavelength and corresponding frequency of visible and/or invisible light which is used to represent and encode a plurality of binary number digits representing zero (0) and/or one (1) which are represented and encoded as an optical pattern comprising a plurality of positions or points.

Clause 69: The holographic memory device according to clause 68, where said plurality of positions and/or points comprise at least four positions and/or points.

Clause 70: The holographic memory device according to clause 64, wherein said plurality of data beams and/or said plurality of reference beams which comprise said plurality of optical channels are configured to send or transmit and/or to receive a plurality of wavelengths and corresponding frequencies of visible and/or invisible light which represent and encode said data and information, and said data and information is configured to be correlated to a specific one of said plurality of optical channels which is used to send or transmit and/or to receive data and information such as to create, establish, or encode an identifiable sequence, whereby said data and information can be transmitted in parallel and/or in series or a sequence, and be read, written, persisted or stored in parallel and/or in series or a sequence, and said data and information can be accessed and retrieved in parallel and/or series or a sequence, and said data and information can be manipulated or processed in parallel and/or in series or a sequence by a processor device.

Clause 71: The optical computer, and/or an electro-optical computer, and/or a quantum computer according to clause 61, wherein said data and information which is represented and encoded by said wavelengths and corresponding frequencies of visible and/or invisible light is persisted and/or stored in a red, green, blue (RGB) holographic memory device and/or a combined RGB processor and holographic memory device.

As discussed above, the computer language and code for software application development, data compression, and the communication of data and information can be used with conventional, optical, hybrid electro-optical and quantum computers. Having thus described the subject matter, it should be apparent that numerous software applications, modifications, and adaptations may be resorted to without departing from the scope and fair meaning of the subject matter as set forth hereinabove.

1-36. (canceled)

37. A computer non-transitory readable medium which configures at least one of an optical computer, an electro-optical computer, and/or a quantum computer comprising a power supply, an input device, an output device, a processor device, a memory device, and/or a combined hybrid processor and memory device, to cause said input device to input and/or said output device to output and/or said processor device to process, and/or said memory device to persist or store into memory, and/or said combined hybrid processor and memory device to persist or store into memory and/or to process a plurality of different frequencies of visible light and/or invisible light which are configured to directly represent and encode data comprising an alphabetical letter and/or a word and/or a symbol and/or a number and/or a sound and/or an image, said plurality of different frequencies of visible light and/or invisible light comprising at least a first frequency of visible light and/or invisible light comprising a first portion of said data which is in superposition or otherwise correlated and entangled with at least a second frequency of said plurality of different frequencies of invisible light and/or invisible light and a second portion of said data.

38. The computer non-transitory readable medium according to claim 37, wherein said image comprises an optical pattern selected from the group comprising a linear optical pattern, a circular optical pattern, a two-dimensional optical pattern, a three-dimensional optical pattern, a holographic optical pattern, and a four-dimensional optical pattern in which time is the fourth dimension.

39. The computer non-transitory readable medium according to claim 38, wherein said plurality of different frequencies of visible light and/or invisible light comprise at least 16 different frequencies of visible light and/or invisible light which are in superposition or otherwise correlated and entangled.

40. The computer non-transitory readable medium according to claim 38, wherein said optical pattern comprises a center and at least one position and/or point located at a radial distance from said center, wherein said at least one position and/or point is configured to represent and encode a number.

41. The computer non-transitory readable medium according to claim 40, wherein said number is in the range between and including 0-9.

42. The computer non-transitory readable medium according to claim 40, wherein said number is further configured using a frequency of visible light and/or invisible light which is also used to directly represent and encode said number, whereby both said optical pattern associated with said position and/or point, and also said frequency of visible light and/or invisible light which is disposed at said position and/or point both represent and encode said number.

43. The computer non-transitory readable medium according to claim 37, wherein said input device and/or said output device comprises a plurality of optical channels, and said first portion of said data is configured to be inputted in serial and/or in parallel, and/or said second portion of data is configured to be inputted in serial and/or parallel, and said first portion of said data and/or said second portion of said data are correlated to said plurality of optical channels in order to create or encode and/or to detect or decipher an identifiable sequence, whereby said first portion of said data and/or said second portion of said data is configured to be inputted in parallel, and said first portion of said data and/or said second portion of said data is also further configured to be rendered and/or manipulated in series with the use of said identifiable sequence.

44. The computer non-transitory readable medium according to claim 38, wherein said optical pattern further comprises a binary number system representation and encoding of at least one of said alphabetical letter and/or said word and/or said symbol and/or said number and/or said sound and/or said image.

45. The computer non-transitory readable medium according to claim 38, wherein said optical pattern comprises a constellation configuration associated with a type of communications modulation.

46. The computer non-transitory readable medium according to claim 37, said plurality of different frequencies of visible light and/or invisible light comprising at least one a signal, said at least one signal comprising at least one of a continuous or discontinuous signal type, said signal type comprising at least one of a sinusoidal wave form, a square wave form, a wavelet, a Morlet wavelet, a pulse, and/or a Gaussian pulse.

47. The computer non-transitory readable medium according to claim 38, wherein said optical pattern is configured to represent and encode a base portion of a number and an index corresponding to a place holder value and/or an exponent of said number.

48. The computer non-transitory readable medium according to claim 37, wherein said plurality of different frequencies of visible light and/or invisible light are configured to comprise half wave rectification and/or full wave rectification.

49. The computer non-transitory readable medium according to claim 37, wherein said plurality of different frequencies of visible light and/or invisible light and/or said data is configured to be analyzed for error.

50. The computer non-transitory readable medium according to claim 37, wherein said first frequency of visible and/or invisible light and said first portion of said data and said second frequency of visible and/or invisible light and said second portion of said data are in superposition and entangled because both said first frequency of visible and/or invisible light and said second frequency of visible and/or invisible light originated from the same light source, and/or were configured with the same optical device.

51. The computer non-transitory readable medium according to claim 37, wherein at least said first frequency of visible and/or invisible light comprising said first portion of said data comprises a minimum amplitude and a maximum amplitude which define a range of amplitudes between and including said minimum amplitude and said maximum amplitude, and said minimum amplitude is configured to represent and encode zero (0) and said maximum amplitude is configured to correspond to a number greater than zero (0), and said range of amplitudes between and including said minimum amplitude and said maximum amplitude is configured to further represent and encode said first portion of data.

52. An optical computer, electro-optical computer, and/or quantum computer comprising: a power supply, an input device, an output device, an optical processor device, an optical memory device, said optical memory device comprising an optical storage medium comprising a plurality of sections or portions for persisting or storing data, and a plurality of said plurality of sections or portions of said optical storage medium being configured to be selectively placed in communication with one another, said data comprising a plurality of alphabetical letters and/or a plurality of words and/or a plurality of numbers and/or a plurality of symbols and/or a plurality of sounds and/or a plurality of images which are configured to be communicated with visible light and/or invisible light, said optical processor device, said optical memory device, said input device, and said output device each being configured such that a plurality of said plurality of sections or portions of said optical storage medium can be selectively placed in communication with a plurality of said optical processor device, said input device, and said output device, whereby a plurality of said optical processor device, said optical memory device, said input device, and said output device can simultaneously process, persist or store, input, and output said data in series and/or in parallel.

53. The optical computer, electro-optical computer, and/or quantum computer of claim 52, wherein said optical storage medium comprises a geometric shape comprising a circular shape, a sphere, a cylinder, a cone, and a polygonal or polyhedron shape.

54. The optical computer, electro-optical computer, and/or quantum computer of claim 52, wherein said optical storage medium further comprising a top surface, a bottom surface, an opening, at least one inside surface proximate to said opening and extending between said top surface and said at bottom surface, and at least one outside surface extending between said top surface and said bottom surface.

55. The optical computer, electro-optical computer, and/or quantum computer of claim 54, wherein said optical storage medium further comprises an octagonal shape.

56. The optical computer, electro-optical computer, and/or quantum computer of claim 52, wherein each of said plurality of alphabetical letters and/or said plurality of words and/or said plurality of numbers and/or plurality symbols and/or plurality of sounds and/or said plurality of images being directly represented and encoded by a sinusoidal wave form, and/or a square wave form, and/or a wavelet, and/or a Morlet wavelet, and/or a pulse, and/or a Gaussian pulse comprising a specific corresponding frequency of said visible light and/or invisible light.

57. The optical computer, electro-optical computer, and/or quantum computer of claim 52, wherein said plurality of sections or portions for storing said data comprise a plurality of individual parts and sub-components of said optical storage medium each of said sections or portions comprising a top side, a bottom side, an outside surface, and an inside surface.

58. The optical computer, electro-optical computer, and/or quantum computer of claim 52, wherein said data corresponding to a specific subject area or field and/or a specific type or form of data is configured to be persisted or stored in close proximity within at least one of said sections or portions of said optical storage medium.

59. The optical computer, electro-optical computer, and/or quantum computer of claim 52, wherein said image comprises an optical pattern comprising a two-dimensional, and/or a three-dimensional, and/or a four-dimensional optical pattern in which the fourth dimension is time.

60. The optical computer, electro-optical computer, and/or quantum computer of claim 52, wherein said optical processor device and said optical memory device comprise a hybrid combined optical processor and memory device.

61. The optical computer, electro-optical computer, and/or quantum computer of claim 52, wherein said optical processor device comprises an optical logic processor device, and/or an optical neural network processor device.

62. The optical computer, electro-optical computer, and/or quantum computer of claim 52, further comprising a light source comprising at least one of a laser, a femtosecond laser, a laser diode, a micro laser diode, a LED, and a micro laser LED.

63. The optical computer, electro-optical computer, and/or quantum computer of claim 52, wherein said input device and/or said output device comprises a source of light comprising a beam of light, and/or an optical fiber, and/or a fiber optic cable, and/or a waveguide.

64. The optical computer, electro-optical computer, and/or quantum computer of claim 52, further comprising at least one of a base, a lens, a beam shaper, a filter, a shutter, a loop, a polarizer, a prism, a crystal, a crystalline material, a diamond, a semiconductor, a diffraction grating, a camera, a photodetector, a photodetector array, a CMOS photodetector, a spatial light modulator, a multiplexer, a demultiplexer, a wave division multiplexer, an Optical Add Drop Multiplexer (OADM), a transceiver, a transponder, an analog to digital converter, a digital to analog converter, an optical switch, an optical splitter, an optical amplifier, an Erbium doped fiber amplifier, a Raman amplifier, a waveguide, a wire, an optical fiber, a fiber optic cable, an optical connection, a digital processor device, a digital memory device, a transistor, a resistor, a capacitor, a diode, a positive electrical lead, and a negative electrical ground lead.

65. The optical computer, electro-optical computer, and/or quantum computer of claim 52, wherein said input device and/or said output device comprises at least one of a keyboard, a mouse, a microphone, a printer, a voice recognition device or voice command, a camera, a photodetector, a photodetector array, a CMOS device, a video camera, a CD disk, a DVD disk, a laser disk, an optical disk, a holographic optical disk, a holograph device, an acousto-optical device, a magnetic tape, an optical tape, an optical film, an analog to digital converter, a digital to analog converter, a multiplexer, a demultiplexer, a wave division demultiplexer, a transponder, a transceiver, a computer monitor, a computer touchscreen monitor, an oscilloscope, a spectrum analyzer, a Solid State Drive (SSD), a removable Flash drive, a wire, waveguide, an optical fiber, a fiber optic cable, a wireless device.

66. The optical computer, electro-optical computer, and/or quantum computer of claim 52, wherein said optical memory device comprises at least one of an optical memory, a holographic memory, a glass, crystal, or crystalline memory, an optical disk memory, a cache memory, a RAM memory, a ROM memory, a magnetic tape memory, an optical tape memory, a color coded memory, a DNA color coded memory, a red, green blue (RGB) color coded memory, a sRGB color coded memory, an optical pattern, an image, a photo, a video, a film.

67. The optical computer, electro-optical computer, and/or quantum computer of claim 54, further comprising a turret disposed proximate to a middle of said opening.

68. The optical computer, electro-optical computer, and/or quantum computer of claim 67, said turret comprising at least one of a light source, a remote light source, a laser, a laser diode, an LED, a beam of light, a data beam of light, a reference beam of light, a beam splitter, a mirror, a reference beam mirror, a filter, a multiplexer, a demultiplexer, a wave division demultiplexer, a transponder, a transceiver, a muxponder, a spatial light modulator, a lens, a beam shaper, a beam collimator, a shutter, a glass material, a silicone material, a crystalline material, a doped lithium niobate crystalline material, a camera, a photodetector, a photodetector array, a photonic logic gate, an optical amplifier, a waveguide, a plurality of optical fibers, a fiber optic cable, an optical connection, cache memory, read only memory (ROM) memory, random access memory (RAM) memory, a heat sink, a positive electrical lead, a negative electrical ground lead, and a plurality of other leads or optical connections for electronic and/or optical communication with said output device, said input device, said processor device, and said optical memory device.

69. The optical computer, electro-optical computer, and/or quantum computer of claim 68, wherein at least one of said turret, said light source, said a source of light, said beam of light, said data beam of light, said reference beam of light, said beam splitter, said beam shaper, said mirror, said shutter, said filter, said waveguide, and said lens being configured to selectively direct visible light and/or invisible light comprising said data to said optical storage medium, and/or from said optical storage medium.

70. The optical computer, electro-optical computer, and/or quantum computer of claim 60, wherein said hybrid combined optical processor and memory device comprises said optical processor device and said optical memory device in direct physical and optical communication with one another.

71. The optical computer, electro-optical computer, and/or quantum computer of claim 60, wherein said hybrid combined optical processor and memory device comprises a plurality of hybrid combined optical processor and memory devices.

72. A optical memory device for use with a computer, said computer comprising at least one of an optical computer, an electro optical computer, and/or or a quantum computer comprising a power supply, an input device, an output device, and at least one optical processor device, said optical memory device comprising an optical storage medium for persisting or storing data, said data comprising a plurality of alphabetical letters and/or a plurality of words and/or a plurality of numbers and/or a plurality of symbols and/or a plurality of sounds and/or a plurality of images, each of said plurality of alphabetical letters and/or said plurality of words and/or said plurality of numbers and/or plurality symbols and/or said plurality of images being directly represented and encoded by a sinusoidal wave form, and/or a square wave form, and/or a wavelet, and/or a Morlet wavelet, and/or a pulse, and/or a Gaussian pulse comprising a specific corresponding frequency of visible light and/or invisible light, said optical storage medium comprising a plurality sections or portions, at least a portion of at least one of said plurality of sections or portions being configured to provide a cache memory, and/or a read only memory (ROM) memory, and/or a random access memory (RAM) memory, a plurality of said plurality of sections or portions being in optical communication with one another, and a plurality of said plurality of sections or portions being in optical communication with said optical processor device, and a plurality of said plurality of sections or portions being in optical communication with at least one of said input device and said output device, whereby said plurality of sections or portions of said optical storage medium are configured to be simultaneously placed in optical communication with a plurality of said input device, said output device, and said at least one optical processor device and said data can be inputted and persisted or stored in said optical memory device, and/or said data can be outputted from said optical memory device, and said data can processed by said at least one optical processor device in series and/or parallel.
